(19) United States
(12) Patent Application Publication
(10) Pub. No.: US 2016/0017463 A1
(43) Pub. Date: Jan. 21, 2016

(54) HARD WELD OVERLAYS RESISTANT TO RE-HEAT CRACKING

(71) Applicant: Scoperta, Inc., San Diego, CA (US)

(72) Inventors: Justin Lee Cheney, Encinitas, CA (US); Shengjun Zhang, San Diego, CA (US); John Hamilton Madok, San Diego, CA (US)

(21) Appl. No.: 14/768,162

(22) PCT Filed: Feb. 12, 2014
(86) PCT No.: PCT/US2014/016134

§ 371 Date: Aug. 14, 2015

Related U.S. Application Data
(60) Provisional application No. 61/899,548, filed on Nov. 4, 2013.
(60) Provisional application No. 61/765,638, filed on Feb. 15, 2013.

(51) Int. Cl. C22C 32/00; C22C 49/08; C22C 38/50; C22C 38/44; C22C 38/02; B32B 15/01; C22C 38/48; C22C 38/46; C22C 38/56; C22C 38/06; C22C 37/08; C22C 37/10; C22C 1/10; C22C 38/54

(52) U.S. Cl. CPC C22C 32/00; C22C 32/0073; C22C 32/0052; C22C 32/0068; C22C 32/0078; C22C 32/001; C22C 1/10; C22C 49/08; C22C 38/50; C22C 38/44; C22C 38/02; C22C 38/54; C22C 38/48; C22C 38/46; C22C 38/56; C22C 38/06; C22C 37/08; C22C 37/10; B32B 15/011

(57) ABSTRACT

Disclosed herein are embodiments of a hard weld overlay which can be resistant to cracking. The alloys can be able to resist cracking through prevention of the precipitation and/or growth of embrittling carbide, borides, or borocarbides along the grain boundaries at elevated temperatures. By controlling the thermodynamics of the boride and carbide phases, it is possible to create an alloy which forms hard wear resistant phases that are not present along the grain boundaries of the matrix.

### INCORPORATION BY REFERENCE TO ANY PRIORITY APPLICATIONS

This application claims priority from U.S. Provisional Patent Application No. 61/765,638, filed Feb. 15, 2013, and U.S. Provisional Patent Application No. 61/899,548, filed Nov. 4, 2013, both of which are incorporated herein by reference in their entirety.

### BACKGROUND

1. Field

This disclosure relates in some embodiments to hard coatings and weld overlays used to protect surfaces from wear.

2. Description of the Related Art

The hardfacing process is a technique used to protect a surface from wear. Typical methods of hardfacing include the various methods of welding, GMAW, GTAW, PTA, laser cladding, submerged arc welding, open arc welding, thermal spray, and explosive welding. In certain applications, it is advantageous for the hardfacing coating to be free of cracks. Hardbanding, the process of applying a hardfacing layer to the outer diameter of tool joints on a drill string, is an example of an application where cracks are undesirable. Cracks can allow for corrosion, create welding difficulties when re-building the hardbanding layer, and allow for the propagation of cracks from the hardfacing layer into the substrate material resulting in the failure of the drill pipe itself. Preventing cracking can be achieved in hardbanding materials by increasing the toughness of the hardfacing alloy used. However, hardness and toughness are inversely related material properties. Thus, in order to prevent cracking the hardness is sacrificed. Typical non-cracking hardfacing materials deposited via the GMAW process for the purposes of hardbanding possess hardness in the range of 50-60 HRC. Cracking hardfacing materials such as chromium carbide can exhibit hardness significantly above 60 HRC, in the range of 61-69 HRC.

Several modes of cracking are known to occur in hardbanding. Three types of cracking occur during welding, or slightly after (1 s-180 s) the welding has been completed. Cross checking is defined as a large crack which spans across the entire weld bead width, and can occur during the deposition of a single bead. The two other forms of cracking, dip cracking and circumferential cracking are associated with the re-heating of an existing bead. Dip cracking occurs during the welding of a single bead.

During the hardbanding process, a 1″ wide weld bead is deposited onto a rotating tool joint such that it covers the entire circumference of the joint when completed. The weld is completed when joint has made one full revolution during the weld process, such that new weld material is deposited directly on top of existing weld material. This overlap causes the existing weld material to re-heat, and further causes additional tensile stresses in the existing material as the new weld effectively pulls on the previous layer as it cools and contracts. These additional stresses often lead to cracking in hardfacing materials, due to presence of embrittling carbides, borides or other hard phases in the microstructure. However, hardfacing alloys are designed to contain a significant fraction of embrittling phases due to their beneficial wear properties.

Circumferential cracking can occur when multiple bands are welded next to each other, as is customary in the hardbanding process and other hardfacing processes. In the hardbanding process, it is customary to overlap one bead with subsequent weld passes by ⅛″ to ¼″. This slight overlap between neighboring beads re-heats the existing bead, in addition to applying additional tensile stress, which can lead to circumferential cracking.

A number of disclosures are directed to hardfacing materials for use in various applications, and utilize what this disclosure terms as secondary or grain boundary carbides in significant concentration to achieve high hardness and high wear resistance properties. One hardfacing alloy example is Fe_{bal}Cr₃Nb_{4.3}V_{0.5}C_{0.8}B_{1.25}Mo₂Ti_{0.3}Si_{0.4}Mn₁ disclosed in U.S. application Ser. No. 12/939,093, hereby incorporated by reference in its entirety, utilizes grain boundary Cr₂B phase to achieve high hardness. This microstructure can be predicted accurately using thermodynamic modeling as shown in FIG. 2. The Cr₂B phase, while beneficial to the wear resistance, also increases the cracking tendency of the alloy. US App. Pub. No. 2007/002295 A1, hereby incorporated by reference in its entirety, describes a hardfacing alloy possess which seeks to improve toughness, as compared to CrC hardfacing, through grain size reduction of the grain boundary carbides and borides. These phases can be identified in the presented micrographs some of which are identified as M₂₃C₆, common grain boundary carbide rich in chromium and iron. The most commonly used hardfacing materials contain high fractions of chromium and carbon, which generate a high hardness, highly wear resistant material through the formation of chromium carbides along matrix grain boundaries throughout the microstructure. However, in all these instances, the grain boundary is embrittled due to the presence of a hard phase, which can lead to weld cracking during deposition or in service. Thus, there is a need to develop alloys which are simultaneously highly wear resistant and possess improved toughness to perform in the most demanding industrial applications.

### SUMMARY

Disclosed herein is work piece which can have at least a portion of its surface covered by a layer comprising a microstructure containing primary hard particles comprising one or more of boride, carbide, borocarbide, nitride, carbonitride, aluminide, silicide, oxide, intermetallic, and laves phase, wherein the layer comprises a macro-hardness of 50 HRC or greater and a high resistance to cracking, wherein primary hard particles are defined as forming at least 10K above the solidification temperature of Fe-rich matrix in the alloy, and high resistance to cracking is defined as exhibiting no cracks when hardbanding on a steel pipe which is pre-heated to 300° F. and contains an internal reservoir of cooling water.

In some embodiments, the primary hard particle fraction can be a minimum of 2 volume percent. In some embodiments, the secondary hard particle fraction can be a maximum of 10 volume percent. In some embodiments, the surface can exhibit a mass loss of less than 0.1 grams when subject to 500 carbide hammer impacts possessing 8J of impact energy. In some embodiments, a surface of the layer can exhibit high wear resistance as characterized by an ASTM G65 dry sand wear test mass loss of 0.6 grams or less.

In some embodiments, the layer can comprise in wt. % of Fe: bal, B: 0-1, C: 0-2, Co: 0-2, Cr, 0-20, Mn, 0-3, Mo: 0-15, Nb: 0-6, Ni: 0-2, Si: 0-3, Ti: 0-10, V: 0-2, W: 0-10. In some embodiments, the layer can comprise in wt. % of Fe: bal, B: 0-2.5, C: 0.7-8.5, Mo: 0-30, Nb: 0-20, Ti: 0-12, V: 0-10, W: 0-30. In some embodiments, the layer can comprise in wt. % of Cr: 0-18, Cu: 0-2, Mn: 0-10, and Si: 0-3.

In some embodiments, the alloy composition can be selected from the group consisting of alloys comprising in wt. %:
Fe: bal, C: 1, Cr, 5, Mn, 1.1, Mo: 0.75, Ni: 0.1, Si: 0.77, Ti: 3;
Fe: bal, C: 1.2, Cr, 6, Mn, 1, Mo: 0.85, Ni: 0.25, Si: 0.9, Ti: 3, W: 0.85;
Fe: bal, B: 0.2, C: 1.5, Cr: 0.5, Mn: 0.78, Mo: 0.68, Nb: 2.67, Si: 0.44, Ti: 0.45, V: 0.36;
Fe: bal, B: 0.2, C: 2.3, Cr: 0.5, Mn: 0.75, Mo: 0.7, Nb: 5, Si: 0.44, Ti: 3, V: 0.36;
Fe: bal, B: 0.2, C: 2.1, Cr: 0.5, Mn: 0.75, Mo: 0.7, Nb: 5, Si: 0.44, Ti: 3, V: 0.36;
Fe: bal, B: 0.2, C: 1.8, Cr: 0.5, Mn: 0.75, Mo: 0.7, Nb: 5, Si: 0.44, Ti: 3, V: 0.36;
Fe: bal, B: 0.2, C: 1.6, Cr: 0.5, Mn: 0.75, Mo: 0.7, Nb: 5, Si: 0.44, Ti: 3, V: 0.36;
Fe: bal, B: 0.2, C: 3, Cr: 0.5, Mn: 0.75, Mo: 0.7, Nb: 5, Si: 0.44, Ti: 8, V: 0.36;
Fe: bal, B: 0-0.2, C: 1.1-2, Cr: 0.5-5.04, Mn: 0.75-1.16, Mo: 0-0.74, Nb: 3-5, Si: 0-0.76, Ti: 0-3;
Fe: bal, C: 0.95-1.25, Cr: 0.75-1.75, Mn: 1-1.1, Mo: 1, Nb: 3-3.8, Si: 0.6-0.65, Ti: 0.6-0.65, V: 0.5; and
Fe: bal, A1:0.26, C: 1, Cr: 7.82, Mn: 1.38, Mo: 1.16, Ni: 0.1, Si: 1.01, Ti: 3.37, V: 0.1.

In some embodiments, the layer can be used as a hardfacing layer configured to protect oilfield components used in drilling applications against abrasive wear. In some embodiments, the layer can be used as a hardfacing layer configured to protect mining or oil sands applications against abrasive wear and impact.

Also disclosed herein is method of forming a coated work piece which can comprise depositing a layer on at least a portion of a surface of a work piece, wherein the layer comprises a microstructure containing primary hard particles comprising one or more of boride, carbide, borocarbide, nitride, carbonitride, aluminide, silicide, oxide, intermetallic, and laves phase, wherein the layer comprises a macro-hardness of 50 HRC or greater and a high resistance to cracking, wherein: primary hard particles are defined as forming at least 10K above the solidification temperature of a Fe-based matrix in the alloy, and high resistance to cracking is defined as exhibiting no cracks when hardbanding on a steel pipe which is pre-heated to 300° F. and contains an internal reservoir of cooling water.

In some embodiments, the primary hard particle fraction can be a minimum of 2 volume percent. In some embodiments, the secondary hard particle fraction can be a maximum of 10 volume percent. In some embodiments, the surface can exhibit a mass loss of less than 0.1 grams when subject to 500 carbide hammer impacts possessing 8J of impact energy. In some embodiments, a surface of the of the layer can exhibit high wear resistance as characterized by an ASTM G65 dry sand wear test mass loss of 0.6 grams or less.

In some embodiments, the layer can comprise in wt. % of Fe: bal, B: 0-1, C: 0-2, Co: 0-2, Cr, 0-20, Mn, 0-3, Mo: 0-15, Nb: 0-6, Ni: 0-2, Si: 0-3, Ti: 0-10, V: 0-2, W: 0-10. In some embodiments, the layer can comprise in wt. % of Fe: bal, B: 0-2.5, C: 0.7-8.5, Mo: 0-30, Nb: 0-20, Ti: 0-12, V: 0-10, W: 0-30. The method of any one of claims 12-16 and 18, wherein the layer comprises in wt. % of Cr: 0-18, Cu: 0-2, Mn: 0-10, and Si: 0-3.

In some embodiments, the alloy composition can be selected from the group consisting of alloys comprising in wt. %:
Fe: bal, C: 1, Cr, 5, Mn, 1.1, Mo: 0.75, Ni: 0.1, Si: 0.77, Ti: 3;
Fe: bal, C: 1.2, Cr, 6, Mn, 1, Mo: 0.85, Ni: 0.25, Si: 0.9, Ti: 3, W: 0.85;
Fe: bal, B: 0.2, C: 1.5, Cr: 0.5, Mn: 0.78, Mo: 0.68, Nb: 2.67, Si: 0.44, Ti: 0.45, V: 0.36;
Fe: bal, B: 0.2, C: 2.3, Cr: 0.5, Mn: 0.75, Mo: 0.7, Nb: 5, Si: 0.44, Ti: 3, V: 0.36;
Fe: bal, B: 0.2, C: 2.1, Cr: 0.5, Mn: 0.75, Mo: 0.7, Nb: 5, Si: 0.44, Ti: 3, V: 0.36;
Fe: bal, B: 0.2, C: 1.8, Cr: 0.5, Mn: 0.75, Mo: 0.7, Nb: 5, Si: 0.44, Ti: 3, V: 0.36;
Fe: bal, B: 0.2, C: 1.6, Cr: 0.5, Mn: 0.75, Mo: 0.7, Nb: 5, Si: 0.44, Ti: 3, V: 0.36;
Fe: bal, B: 0.2, C: 3, Cr: 0.5, Mn: 0.75, Mo: 0.7, Nb: 5, Si: 0.44, Ti: 8, V: 0.36;
Fe: bal, B: 0-0.2, C: 1.1-2, Cr: 0.5-5.04, Mn: 0.75-1.16, Mo: 0-0.74, Nb: 3-5, Si: 0-0.76, Ti: 0-3;
Fe: bal, C: 0.95-1.25, Cr: 0.75-1.75, Mn: 1-1.1, Mo: 1, Nb: 3-3.8, Si: 0.6-0.65, Ti: 0.6-0.65, V: 0.5; and
Fe: bal, A1:0.26, C: 1, Cr: 7.82, Mn: 1.38, Mo: 1.16, Ni: 0.1, Si: 1.01, Ti: 3.37, V: 0.1.

In some embodiments, the layer can be used as a hardfacing layer configured to protect oilfield components used in directional drilling applications against abrasive wear. In some embodiments, the layer can be used as a hardfacing layer configured to protect mining or oil sands applications against abrasive wear and impact.

Also disclosed herein is work piece which can have at least a portion of its surface covered by a layer comprising an alloy having an primary hard particle mole fraction equal to or above 2% and an secondary hard particle mole fraction equal to or less than 10%, wherein primary hard particles are defined as forming at least 10K above the solidification temperature of an Fe-based matrix in the alloy, and secondary hard particles are defined as forming at least 50K below the solidification temperature of the Fe-based matrix.

In some embodiments, the minimum carbon content in a liquid phase prior to the formation of austenite or ferrite can be between 0.7 and 1.5 weight percent. In some embodiments, the surface can exhibit a mass loss of less than 0.1 grams when subject to 500 carbide hammer impacts possessing 8J of impact energy. In some embodiments, a surface of the of the layer can exhibit high wear resistance as characterized by an ASTM G65 dry sand wear test mass loss of 0.6 grams or less. In some embodiments, a surface of the of the layer can exhibit high hardness as characterized by a Rockwell C hardness of 50 HRC or greater. In some embodiments, a surface of the of the layer can exhibit high crack resistance as characterized by a crack free surface when welded on a steel pipe which is pre-heated to 300° F. and contains an internal reservoir of cooling water.

In some embodiments, the layer can comprise in wt. % of Fe: bal, B: 0-1, C: 0-2, Co: 0-2, Cr, 0-20, Mn, 0-3, Mo: 0-15, Nb: 0-6, Ni: 0-2, Si: 0-3, Ti: 0-10, V: 0-2, W: 0-10. In some embodiments, the layer can comprise in wt. % of Fe: bal, B: 0-2.5, C: 0.7-8.5, Mo: 0-30, Nb: 0-20, Ti: 0-12, V: 0-10, W: 0-30. In some embodiments, the layer can comprise in wt. % of Cr: 0-18, Cu: 0-2, Mn: 0-10, and Si: 0-3.

In some embodiments, the alloy composition can be selected from the group consisting of alloys comprising in wt. %:
Fe: bal, C: 1, Cr, 5, Mn, 1.1, Mo: 0.75, Ni: 0.1, Si: 0.77, Ti: 3;
Fe: bal, C: 1.2, Cr, 6, Mn, 1, Mo: 0.85, Ni: 0.25, Si: 0.9, Ti: 3, W: 0.85;
Fe: bal, B: 0.2, C: 1.5, Cr: 0.5, Mn: 0.78, Mo: 0.68, Nb: 2.67, Si: 0.44, Ti: 0.45, V: 0.36;
Fe: bal, B: 0.2, C: 2.3, Cr: 0.5, Mn: 0.75, Mo: 0.7, Nb: 5, Si: 0.44, Ti: 3, V: 0.36;
Fe: bal, B: 0.2, C: 2.1, Cr: 0.5, Mn: 0.75, Mo: 0.7, Nb: 5, Si: 0.44, Ti: 3, V: 0.36;
Fe: bal, B: 0.2, C: 1.8, Cr: 0.5, Mn: 0.75, Mo: 0.7, Nb: 5, Si: 0.44, Ti: 3, V: 0.36;
Fe: bal, B: 0.2, C: 1.6, Cr: 0.5, Mn: 0.75, Mo: 0.7, Nb: 5, Si: 0.44, Ti: 3, V: 0.36;
Fe: bal, B: 0.2, C: 3, Cr: 0.5, Mn: 0.75, Mo: 0.7, Nb: 5, Si: 0.44, Ti: 8, V: 0.36;
Fe: bal, B: 0-0.2, C: 1.1-2, Cr: 0.5-5.04, Mn: 0.75-1.16, Mo: 0-0.74, Nb: 3-5, Si: 0-0.76, Ti: 0-3;
Fe: bal, C: 0.95-1.25, Cr: 0.75-1.75, Mn: 1-1.1, Mo: 1, Nb: 3-3.8, Si: 0.6-0.65, Ti: 0.6-0.65, V: 0.5;
Fe: bal, A1:0.26, C: 1, Cr: 7.82, Mn: 1.38, Mo: 1.16, Ni: 0.1, Si: 1.01, Ti: 3.37, V: 0.1.

Disclosed herein are embodiments of a hardfacing weld deposit. In a first embodiment, the weld deposit can comprise a hardness of at least 60 HRC and a microstructure comprising an iron-based austenitic matrix and carbides and/or borides, wherein the carbides and/or borides can comprise only carbides and/or borides which precipitate prior to solidification of the iron-based austenitic matrix.

In a second embodiment, the carbides and/or borides of the first embodiment can be selected from the group consisting of titanium boride, niobium carbide, chromium boride, iron-chromium boride, and combinations thereof.

In a third embodiment, the deposit of any one of the first two embodiments does not form additional carbides or borides when re-heated to a range of 800° C. to 1300° C. for 1 s to 180 s.

In a fourth embodiment, the deposit of any one of the first three embodiments the deposit does not form additional carbides or borides when re-heated to a range of 900° C. to 1200° C. for 1 s to 180 s.

In a fifth embodiment, the deposit of any one of the first four embodiments the deposit does not form additional carbides or borides when re-heated to a range of 1000° C. to 1100° C. for 1 s to 180 s.

In a sixth embodiment, the deposit of any one of the first five embodiments the deposit comprises at least one of:
Fe_{bal}B_{1.45}C_{0.91}Cr_{4.82}Mn_{1.01}Mo_{3.22}Nb_{4.54}Si_{0.59}Ti_{0.39}V_{0.54};
Fe_{bal}B_{1.45}C_{0.91}Cr_{4.82}Mn_{1.01}Mo_{3.22}Nb₆Si_{0.59}Ti₁V_{0.54};
Fe_{bal}B_{1.45}C_{0.91}Cr_{4.82}Mn_{1.01}Mo_{3.22}Nb₆Si_{0.59}Ti₁V₂
Fe_{bal}B_{1.45}C_{0.91}Cr_{4.82}Mn_{1.01}Mo_{3.22}Nb_{4.5}Si_{0.59}Ti₁V_{0.54};
Fe_{bal}C_{1.2}B₂Mn₁Si_{1.1}Ni_{0.07}Cr_{8.33}Mo_{3.33}V_{0.5}W_{0.07}Ti_{1.83}Nb₄ and
Fe_{bal}C₁B_{2.5}Mn₂Si₁Ni_{0.1}Cr_{8.73}Mo₁V_{0.03}W_{0.03}Ti_{1.91}Nb_{4.47}.

Further disclosed is an seventh embodiment of a hardfacing weld deposit which can comprise a hardness of at least 60 HRC and a stable carbide and/or boride structure, wherein a mole fraction of the stable carbide and/or boride structure does not change by more than 25% when reheated.

In an eight embodiment, the stable carbide and/or boride structure in the deposit of the seventh embodiment does not change when re-heated to a range of 800° C. to 1300° C. for 1 s to 180 s.

In a ninth embodiment, the mole fraction of the stable carbide and/or boride structure of any one of the seventh or eighth embodiments does not change by more than 10% when reheated.

In a tenth embodiment, the mole fraction of the stable carbide and/or boride structure of any one of the seventh through ninth embodiments does not change by more than 5% when reheated.

In an eleventh embodiment, the deposit of any one of the seventh through tenth embodiments can further comprise an iron-based austenitic matrix, and the deposit possesses a carbide and/or boride thermodynamic stability such that a mole fraction of the carbides and/or borides does not change by more than 25% over a temperature range between room temperature and a solidification temperature of the iron-based austenitic matrix.

In a twelfth embodiment, the deposit of any one of the seventh through eleventh embodiments can further comprise an iron-based austenitic matrix, and the deposit possesses a carbide and/or boride thermodynamic stability such that any carbides and/or borides do not form at temperatures above the solidification temperature of the iron-based austenitic matrix, and are only stable at temperatures below a re-heat temperature range.

In a thirteenth embodiment, the re-heat temperature range of the twelfth embodiment can be about 800° C. to 1300° C.

In a fourteenth embodiment, the re-heat temperature range of the twelfth embodiment can be about 900° C. to 1200° C.

In a fifteenth embodiment, the re-heat temperature range of the twelfth embodiment can be about 1000° C. to 1100° C.

In a sixteenth embodiment, the deposit of any one of the seventh through fifteenth embodiments can comprise at least one of:
Fe_{bal}B_{1.45}C_{0.91}Cr_{4.82}Mn_{1.01}Mo_{3.22}Nb_{4.54}Si_{0.59}Ti_{0.39}V_{0.54};
Fe_{bal}B_{1.45}C_{0.91}Cr_{4.82}Mn_{1.01}Mo_{3.22}Nb₆Si_{0.59}Ti₁V_{0.54};
Fe_{bal}B_{1.45}C_{0.91}Cr_{4.82}Mn_{1.01}Mo_{3.22}Nb₆Si_{0.59}Ti₁V₂;
Fe_{bal}B_{1.45}C_{0.91}Cr_{4.82}Mn_{1.01}Mo_{3.22}Nb_{4.5}Si_{0.59}Ti₁V_{0.54};
Fe_{bal}C_{1.2}B₂Mn₁Si_{1.1}Ni_{0.07}Cr_{8.33}Mo_{3.33}V_{0.5}W_{0.07}Ti_{1.83}Nb₄; and
Fe_{bal}C₁B_{2.5}Mn₂Si_{1.1}Ni_{0.1}Cr_{8.73}Mo₁V_{0.03}W_{0.03}Ti_{1.91}Nb_{4.47}.

Further disclosed is a seventeenth embodiment of a hardfacing weld deposit comprising a hardness of at least 60 HRC and carbides and/or borides, wherein the carbides and/or borides comprise an iron concentration of 50 wt. % or less.

In an eighteenth embodiment, the carbides and/or borides of the seventeenth embodiment can be selected from the group consisting of niobium carbide, titanium boride, chromium boride, tungsten carbide, molybdenum boride, and vanadium carbide, and combinations thereof.

Further described is a nineteenth embodiment of a hardfacing weld deposit comprising a hardness of at least 60 HRC and an austenite to ferrite transition temperature which is outside a re-heat temperature range.

In a twentieth embodiment, the re-heat temperature range of the nineteenth embodiment can be about 800° C. to 1300° C.

In a twenty-first embodiment, the re-heat temperature range of the nineteenth embodiment can be about 900° C. to 1200° C.

In a twenty-second embodiment, the re-heat temperature range of the nineteenth embodiment can be about 1000° C. to 1100° C.

In a twenty-third embodiment, the deposit of any one of the nineteenth through twenty-second embodiments can comprise at least one of:
Fe_{bal}B_{1.45}C_{0.91}Cr_{4.82}Mn_{1.01}Mo_{3.22}Nb_{4.54}Si_{0.59}Ti_{0.39}V_{0.54};
Fe_{bal}B_{1.45}C_{0.91}Cr_{4.82}Mn_{1.01}Mo_{3.22}Nb₆Si_{0.59}Ti₁V_{0.54};
Fe_{bal}B_{1.45}C_{0.91}Cr_{4.82}Mn_{1.01}Mo_{3.22}Nb₆Si_{0.59}Ti₁V₂;
Fe_{bal}B_{1.45}C_{0.91}Cr_{4.82}Mn_{1.01}Mo_{3.22}Nb_{4.5}Si_{0.59}Ti₁V_{0.54};
Fe_{bal}C_{1.2}B₂Mn₁Si_{1.1}Ni_{0.07}Cr_{8.33}Mo_{3.33}V_{0.5}W_{0.07}Ti_{1.83}Nb₄; and
Fe_{bal}C₁B_{2.5}Mn₂Si_{1.1}Ni_{0.1}Cr_{8.73}Mo₁V_{0.03}W_{0.03}Ti_{1.91}Nb_{4.47}.

### BRIEF DESCRIPTION OF THE DRAWINGS

FIG. 1 illustrates an embodiment of a phase evolution diagram for Alloy 7: Fe: bal, C: 1, Cr, 5, Mn, 1.1, Mo, 075, Ni: 0.1, Si: 0.77, Ti: 3.

FIG. 2 illustrates an embodiment of a phase evolution diagram for Fe_{bal}Cr₃Nb_{4.3}V_{0.5}C_{0.8}B_{1.25}Mo₂Ti_{0.3}Si_{0.4}Mn₁.

FIG. 3 illustrates a comparison of local carbon minimum and hardness in embodiments of the disclosed alloys.

FIG. 4 illustrates carbon content in the liquid as a function of temperature in an embodiment of a P21-X36 alloy.

FIG. 5 illustrates a scanning electron micrograph of Alloy 7 deposited as a weld bead on a steel plate.

FIG. 6 illustrates a scanning electron micrograph of Fe: bal, B: 1.35, C: 0.92, Cr: 5.32, Mn: 0.5, Mo: 1.02, Nb: 4.33, Si: 0.58, Ti: 0.64, V: 0.5 deposited as a weld bead on a steel plate.

FIG. 7 illustrates a scanning electron micrograph of an embodiment of a P21-X30 ingot.

FIG. 8 illustrates a scanning electron micrograph of an embodiment of a P21-X33 ingot.

FIG. 9 illustrates an embodiment of a phase evolution diagram for P21-X30.

FIG. 10 illustrates an embodiment of a phase evolution diagram for P21-X33.

FIG. 11 illustrates a photograph of an embodiment of alloy 7 welded onto a S135T tool joint using process #2.

FIG. 12 illustrates a photograph of an embodiment of alloy 7 welded onto a S135T tool joint using process #2 and undergoing magnetic particle inspection and revealing a crack free overlay.

FIG. 13 illustrates an embodiment of a phase evolution diagram of Alloy 3: Fe_{bal}B_{1.45}C_{0.91}Cr_{4.82}Mn_{1.01}Mo_{3.22}Nb₆Si_{0.59}Ti₁V₂.

FIG. 14 illustrates an elemental concentration in a NbC phase.

FIG. 15 illustrates an embodiment of FCC to BCC transition temperatures in selected hardbanding alloys.

FIG. 16 illustrates an embodiment of a phase evolution diagram of Fe_{bal}B_{1.45}C_{0.91}Cr_{4.82}Mn_{1.01}Mo_{3.22}Nb_{4.5}Si_{0.59}Ti₁V_{0.54}.

FIGS. 17A-B illustrate an optical microstructure at 500× of embodiments of alloy 5 (17A) and alloy 6 (17B).

### DETAILED DESCRIPTION

A hard weld overlay which can be resistant to cracking is disclosed. The alloys can be able to resist cracking through prevention of the precipitation and/or growth of embrittling carbide, borides, or borocarbides along the grain boundaries at elevated temperatures. By controlling the thermodynamics of the boride and carbide phases, it is possible to create an alloy which forms hard wear resistant phases that are not present along the grain boundaries of the matrix. When designing such alloys, different carbides and borides can be classified into three distinct groups: primary carbides, secondary austenite carbides, and secondary ferrite carbides. Secondary carbides tend to form at the grain boundaries of the Fe-based matrix and are thus also referred to as grain boundary carbides within this disclosure. Although the term carbides is used in this disclosure, carbides may generally refer to borides, carbides, borocarbides, silicides, nitrides, carbonitrides, aluminide, oxides, intermetallics, and laves phases.

Primary carbides can be thermodynamically stable at temperatures higher than or within 5° C. (or higher than or within about 5° C.) of the initial solidification temperature of the austenite matrix. Secondary austenite carbides can become thermodynamically stable at temperatures above the ferrite to austenite transition temperature but no more than 5° C. (or about 5° C.) below the initial solidification temperature of the austenite matrix. Finally, secondary ferrite carbides are only thermodynamically stable at temperatures near to or below the austenite to ferrite transition.

In some embodiments, the alloy can possess primary carbides and secondary austenite carbides, but the secondary carbides can have a mole fraction of less than 10% (or less than about 10%). In some embodiments, the thermodynamics of the alloy system can possess only primary carbides and secondary ferrite carbides. In some embodiments, the secondary ferrite carbides can have a mole fraction less than 10% (or less than about 10%). In some embodiments, the alloy can possess only primary carbides. In some embodiments, the primary carbide phase fraction can be at least 2% by volume (or at least about 2% by volume). In some embodiments, the primary carbide phase fraction can be up to 50% by volume (or up to about 50% by volume).

In some embodiments, the primary carbides can be at least one of: chromium boride, chromium carbide, titanium boride, titanium carbide, niobium carbide, niobium-titanium carbide, niobium-titanium-tungsten carbide, tungsten-titanium carbide, niobium boride, tungsten carbide, or tungsten boride.

Thermo-Calc is a powerful software package used to perform thermodynamic and phase diagram calculations for multi-component systems of practical importance. Calculations using Thermo-Calc are based on thermodynamic databases, which are produced by expert evaluation of experimental data using the CALPHAD method.

TCFE7 is a thermodynamic database for different kinds of steels, Fe-based alloys (stainless steels, high-speed steels, tool steels, HSLA steels, cast iron, corrosion-resistant high strength steels and more) and cemented carbides for use with the Thermo-Calc, DICTRA and TCPRISMA software packages. TCFE7 includes elements such as Ar, Al, B, C, Ca, Co, Cr, Cu, H, Mg, Mn, Mo, N, Nb, Ni, 0, P, S, Si, Ta, Ti, V, W, Zr and Fe.

In some embodiments, the thermodynamic properties of the alloy can be calculated using the CALPHAD method. In some embodiments, the Thermo-Calc software can be used to perform these calculations.

### Non-Cracking Trait 1:

In some embodiments, all of the carbide, boride, and boro-carbide phases can be primary carbides. Thus, they can be thermodynamically stable at the relatively high temperatures as defined previously. An alloy which possesses this thermodynamic profile can be more resistant to cracking than conventional hardfacing materials. As an alloy of this type is initially deposited in the form of a weld bead, the primary carbides can begin to precipitate and grow during the initial solidification of the material. Typically, a large fraction of primary carbides can precipitate prior to the solidification of the austenite matrix. This solidification can be advantageous for improving crack resistance, in that the existing primary carbides may not inflict high stresses on solidifying austenite or during the transformation of austenite to ferrite. The formation of primary carbides can effectively reduce the total carbon in the solidifying austenite such that is less likely for the iron-based matrix to become super saturated with carbon. This can aid in a final structure of the metal being ferritin as opposed to austenitic, and aids in the resistance of cracking during re-heating or when the metal is subjected to stresses or impact.

In conventional hardfacing materials, the iron-based matrix is often super saturated with carbon. Upon re-heating, the carbon can be allowed to diffuse throughout the microstructure and form carbides. As the matrix transforms to austenite and the grain size increases, these newly form carbides cause stresses on the microstructure of the material, which can lead to cracking in the hardfacing material.

Other conventional hardfacing materials may utilize alloying elements to form carbides which can effectively prevent the matrix from becoming supersaturated. However, such carbides when present in a significant fraction (˜10% or greater) can brittle the material due to their tendency to form along grain boundaries.

### Metal Alloy Composition

In some embodiments, the alloy can be described by a composition in weight percent comprising the following elemental ranges:
Fe: bal, B: 0-1, C: 0-2, Co: 0-2, Cr: 0-20, Mn: 0-3, Mo: 0-15, Nb: 0-6, Ni: 0-2, Si: 0-3, Ti: 0-10, V: 0-2, W: 0-10
Fe: bal, B: about 0-1, C: about 0-2, Co: about 0-2, Cr: about 0-20, Mn: about 0-3, Mo: about 0-15, Nb: about 0-6, Ni: about 0-2, Si: about 0-3, Ti: about 0-10, V: about 0-2, W: about 0-10

In some embodiments of crack resistant hardfacing, at least partially based on Table 1, an alloy can comprise the following elements ranges in weight percent:
Fe: bal, B: 0-2, C: 0-2.5, Cr: 0-6, Mn: 0-1.2, Mo: 0-1, Nb: 0-10, Si: 0-1, Ti: 0-10
Fe: bal, B: about 0-2, C: about 0-2.5, Cr: about 0-6, Mn: about 0-1.2, Mo: about 0-1, Nb: about 0-10, Si: about 0-1, Ti: about 0-10

In some embodiments of crack resistant hardfacing, at least partially based on Table 2, an alloy can comprise the following elements ranges, which can be advantageous to developing the desired microstructure in hardfacing coatings, in weight percent:
Fe: bal, B: about 0-2.5, C: about 0.7-8.5, Mo: about 0-30, Nb: about 0-20, Ni: about 0-10, Ti: about 0-12, V: about 0-10, W: about 0-30

In some embodiments the above alloy range, which is at least partially based on Table 2, may further comprise the following elements, which can be advantageous to the development of the disclosed microstructure and may be added for other beneficial effects
Cr: about 0-18.4, Cu: about 0-2, Mn: about 0-10, Si: about 0-0.76,

In some embodiments of crack resistant hardfacing, at least partially based on Table 3, is an alloy can comprise the following element ranges, which can be advantageous to developing the desired microstructure in hardfacing coatings, in weight percent:
Fe: bal, B: 0-2, C: 0.65-4, Mo: 0-8, Nb: 0-12, Ti: 0.45-12. V: 0-10, W: 0-13
Fe: bal, B: about 0-2, C: about 0.65-4, Mo: about 0-8, Nb: about 0-12, Ti: about 0.45-12. V: about 0-10, W: about 0-13

In some embodiments the above alloy range, which is at least partially based on Table 2, may further comprise the following elements, which can be advantageous to the development of the disclosed microstructure and may be added for other beneficial effects
Cr: 0-6, Mn: 0.7-1.1, Si: 0.44-0.9,
Cr: about 0-6, Mn: about 0.7-1.1, Si: about 0.44-0.9,

In some embodiments of crack resistant hardfacing, at least partially based on the exemplary alloys contained in Table 3, an alloy can comprise the following element ranges in weight percent:
Fe: bal, B: 0-0.2, C: 1-3, Cr: 0.5-6, Mn: 0.75-1.1, Mo: 0.68-0.85, Nb: 0-8, Si: 0.44-0.9, Ti: 0.45-8, V: 0-0.36
Fe: bal, B: about 0-0.2, C: about 1-3, Cr: about 0.5-6, Mn: about 0.75-1.1, Mo: about 0.68-0.85, Nb: about 0-8, Si: about 0.44-0.9, Ti: about 0.45-8, V: about 0-0.36

In some embodiments of non-cracking trait 1 an alloy can comprise the following elements in weight percent:
Alloy 7: Fe: bal, C: 1, Cr: 5, Mn: 1.1, Mo: 0.75, Ni: 0.1, Si: 0.77, Ti: 3; or Fe: bal, C: about 1, Cr: about 5, Mn: about 1.1, Mo: about 0.75, Ni: about 0.1, Si: about 0.77, Ti: about 3
Alloy 7*: Fe: bal, C: 1.2, Cr: 6, Mn: 1, Mo: 0.85, Ni: 0.25, Si: 0.9, Ti: 3, W: 0.85; or Fe: bal, C: about 1.2, Cr: about 6, Mn: about 1, Mo: about 0.85, Ni: about 0.25, Si: about 0.9, Ti: about 3, W: about 0.85
Alloy 18: Fe: bal, B: 0.2, C: 1.5, Cr: 0.5, Mn: 0.78, Mo: 0.68, Nb: 2.67, Si: 0.44, Ti: 0.45, V: 0.36; or Fe: bal, B: about 0.2, C: about 1.5, Cr: about 0.5, Mn: about 0.78, Mo: about 0.68, Nb: about 2.67, Si: about 0.44, Ti: about 0.45, V: about 0.36
Alloy 19: Fe: bal, B: 0.2, C: 2.3, Cr: 0.5, Mn: 0.75, Mo: 0.7, Nb: 5, Si: 0.44, Ti: 3, V: 0.36; or Fe: bal, B: about 0.2, C: about 2.3, Cr: about 0.5, Mn: about 0.75, Mo: about 0.7, Nb: about 5, Si: about 0.44, Ti: about 3, V: about 0.36
Alloy 20: Fe: bal, B: 0.2, C: 2.1, Cr: 0.5, Mn: 0.75, Mo: 0.7, Nb: 5, Si: 0.44, Ti: 3, V: 0.36; or Fe: bal, B: about 0.2, C: about 2.1, Cr: about 0.5, Mn: about 0.75, Mo: about 0.7, Nb: about 5, Si: about 0.44, Ti: about 3, V: about 0.36
Alloy 21: Fe: bal, B: 0.2, C: 1.8, Cr: 0.5, Mn: 0.75, Mo: 0.7, Nb: 5, Si: 0.44, Ti: 3, V: 0.36; or Fe: bal, B: about 0.2, C: about 1.8, Cr: about 0.5, Mn: about 0.75, Mo: about 0.7, Nb: about 5, Si: about 0.44, Ti: about 3, V: about 0.36
Alloy 23: Fe: bal, B: 0.2, C: 1.6, Cr: 0.5, Mn: 0.75, Mo: 0.7, Nb: 5, Si: 0.44, Ti: 3, V: 0.36; or Fe: bal, B: about 0.2, C: about 1.6, Cr: about 0.5, Mn: about 0.75, Mo: about 0.7, Nb: about 5, Si: about 0.44, Ti: about 3, V: 0.36
Alloy 26: Fe: bal, B: 0.2, C: 3, Cr: 0.5, Mn: 0.75, Mo: 0.7, Nb: 5, Si: 0.44, Ti: 8, V: 0.36; or Fe: bal, B: about 0.2, C: about 3, Cr: about 0.5, Mn: about 0.75, Mo: about 0.7, Nb: about 5, Si: about 0.44, Ti: about 8, V: about 0.36
Alloys 40-46: Fe: bal, B: 0-0.2, C: 1.1-2, Cr: 0.5-5.04, Mn: 0.75-1.16, Mo: 0-0.74, Nb: 3-5, Si: 0-0.76, Ti: 0-3, or Fe: bal, B about 0 to 0.2, C: about 1.1 to 2, Cr: about 0.5 to 5.04, Mn: about 0.75 to 1.16, Mo: about 0-0.74, Si: about 0 to 0.76, Ti: about 0 to 3
Alloys 55-59: Fe: bal, C: 0.95-1.25, Cr: 0.75-1.75, Mn: 1-1.1, Mo: 1, Nb: 3-3.8, Si: 0.6-0.65, Ti: 0.6-0.65, V: 0.5; or Fe: bal, C: about 0.95 to 1.25, Cr: about 0.95 to 1.25, Mn: about 1 to 1.1, Mo: about 1, Si: about 0.6 to 0.65, Ti: about 0.6 to 0.65, V: about 0.50
Alloy 61: Fe: bal, A1:0.26, C: 1, Cr: 7.82, Mn: 1.38, Mo: 1.16, Ni: 0.1, Si: 1.01, Ti: 3.37, V: 0.1; or Fe: bal, C: about 1, Cr: about 7.82, Mn: about 1.38, Mo: about 1.16, Ni: about 0.1, Si: about 1.01, Ti: about 3.37, V: about 0.10

### Thermodynamic Criteria: Toughness and Crack Resistance

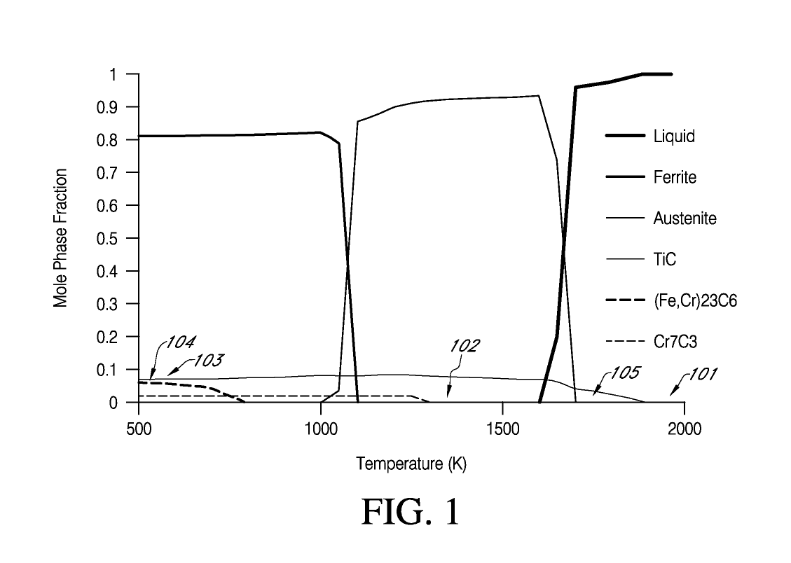

The phase evolution diagram for alloy 7 is shown in FIG. 1. This diagram can be used to describe the solidification process of alloy 7 as it cools from a liquid state to a solid during a welding process. As shown, at 1900K and above (or at about 1900K and above), the alloy can be entirely in liquid state. As the material cools to 1850 K and below (or about 185 K and below), Titanium Carbide (TiC) can begin to form [101]. The TiC mole phase fraction can increase as temperature decreases, but eventually can reach a near maximum of 8% at 1300K (or a maximum of about 8% at about 1300K) [103]. The TiC is referred to as a primary carbide because it can solidify prior to the austenite phase. The austenite phase can begin to solidify at 1650K (or about 1650K) and can make up the majority of the mole phase fraction of the material. Thus, it can be defined as the matrix phase. As is common in most steels, the austenite then can undergo a complete transformation to ferrite at a lower temperature. Several secondary carbides also are present in this alloy, Cr₇C₃ which can begin to precipitate from the austenite at 1250K (or about 1250K) [102] and (Fe,Cr)₂₃C₆, which can begin to precipitate from the ferrite at 750K (or about 750K). Thus, Cr₇C₃ can be defined as a secondary austenite carbide and (Fe,Cr)₂₃C₆ can be defined as a secondary ferrite carbide. As described, it can be advantageous to avoid the formation of secondary carbides in the alloy microstructure to improve toughness. However, due to the relatively small phase fraction[104] and low precipitation temperature, it is likely that these two undesirable phases will either not be present in significant fractions or not form at all. As the phase evolution diagram depicts an equilibrium process, it may not accurately represent the final structure of an alloy which has cooled from a liquid with significantly rapid cooling rate. For example, welding processes can exhibit cooling rates from 1K/s to 500K/s (or about 1K/s to about 500K/s) resulting in microstructures which can be metastable, thus they cannot be predicted by equilibrium thermodynamics. The secondary carbides in Alloy 7 can be less likely to form during a weld deposition process. At the low temperatures at which these secondary carbides can be thermodynamically driven to form, the kinetics of the system are reduced increasing the precipitation and growth times of the carbides from the matrix phase (austenite or ferrite). In a weld process with a effectively non-zero cooling rate, the precipitation and growth time can exceed the time at which the material is at an elevated temperature and the microstructure is effectively frozen in its current state. The precipitation and growth of these secondary carbides would thus require heating the material to an elevated temperature for a prolonged period of time to allow for the sluggish carbide formation kinetics to reach equilibrium.

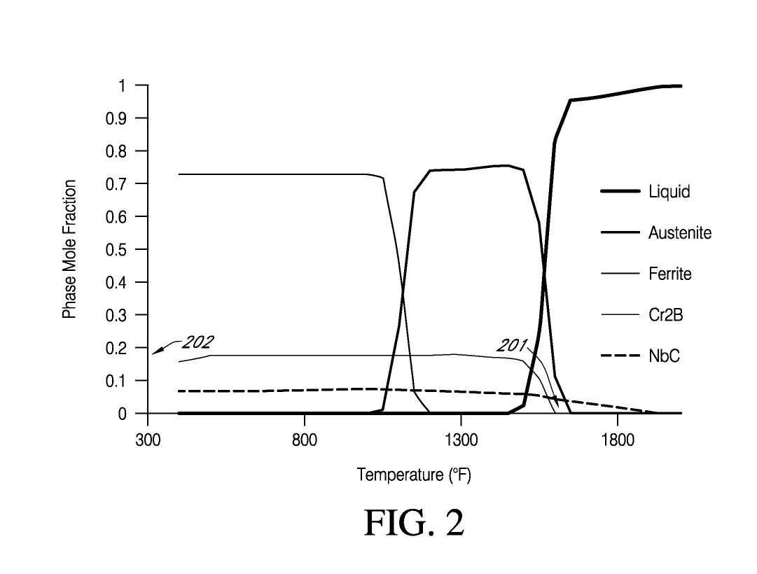

The phase evolution diagram of a typical hardbanding alloy: Fe: bal, B: 1.35, C: 0.92, Cr: 5.32, Mn: 0.5, Mo: 1.02, Nb: 4.33, Si: 0.58, Ti: 0.64, V: 0.5, is shown in FIG. 2 for use as a comparison with the thermodynamics of Alloy 7. As shown, the primary NbC formation thermodynamics are very similar. However, this alloy has a secondary carbide which forms at a temperature very near the initial solidification of the austenite [201]. This secondary carbide, chromium boride (Cr₂B), also has an equilibrium mole fraction[202] which is significantly higher than that of the primary carbide in the system, NbC. The Cr₂B is very likely to form during a welding process due to the high precipitation temperature. Furthermore, due to its precipitation at a temperature below the solidification the austenite, the Cr₂B is likely to form at the grain boundaries of the matrix and reduce the toughness of the material.

In some embodiments, the alloys can be defined by the thermodynamic criteria which result in the specified performance of the alloy. For example, an alloy can be said to meet the thermodynamic criteria when it simultaneously meets two conditions that indicate it meets a minimum hardness or wear resistance criteria and a minimum toughness and crack resistant criteria.

The primary carbide phase fraction is one measure which can be used to predict the hardness and wear resistance of the alloy. In some embodiments, the primary carbide phase fraction can exceed 0.02 (or about 0.02) mole fraction. In some embodiments, the primary carbide phase fraction can exceed 0.05 (or about 0.05) mole fraction. In some embodiments, the primary carbide phase fraction can exceed 0.08 (or about 0.08) mole fraction. In the example of Alloy 7 shown in FIG. 1, the TiC is the primary carbide and has a mole fraction of 0.083, [103], as shown in FIG. 1. The primary carbide phase fraction can be defined as maximum mole fraction of the primary carbide over the span of temperatures in which it exists. In Alloy 7, TiC can be defined as a primary carbide because it precipitates at a temperature [101] above the solidification of the austenite [105]. In some embodiments, the primary carbide can precipitate at a temperature at least 10K (or at least about 10K) above the solidification of the austenite. In some embodiments, the primary carbide can precipitate at a temperature at least 50K (or at least about 50K) above the solidification of the austenite. In some embodiments, the primary carbide can precipitate at a temperature at least 100K (or at least about 100K) above the solidification of the austenite. In the example of 7, the TiC can precipitate at 1850K (or about 1850K), 200K (or about 200K) above the solidification of the austenite.

The precipitation temperature, and maximum mole fraction of the secondary carbides can be used to predict the toughness and crack resistance of the alloy. Generally, a lower secondary carbide phase fraction and lower precipitation temperature can result in higher toughness and crack resistance. In some embodiments, the precipitation temperature of any secondary carbides can be lower than the solidification temperature of the austenite by at least 50K (or at least about 50K). In some embodiments, the precipitation temperature of any secondary carbides can be lower than the solidification temperature of the austenite by at least 100K (or at least about 100K). In some embodiments, the precipitation temperature of any secondary carbides can be lower than the solidification temperature of the austenite by at least 250K (or at least about 250K). The lower the precipitation temperature, the greater the probability that the secondary carbides will not reach equilibrium concentration in non-zero cooling rate solidification processes. In the case of Alloy 7, the precipitation temperature of Cr₇C₃ phase can be 1250K [102], 400K (or about 400K) below the solidification temperature of the austenite. A second thermodynamic criterion related to the toughness and crack resistance of the alloy can be the maximum phase fraction of the secondary carbides. In some embodiments, the maximum phase fraction of the secondary carbides may not exceed 0.10 (or about 0.10). In some embodiments, the maximum phase fraction of the secondary carbides may not exceed 0.05 (or about 0.05). In some embodiments, the maximum phase fraction of the secondary carbides may not exceed 0.03 (or about 0.03). The maximum phase fraction of the secondary carbides can be calculated by summing the phase fractions of all secondary carbides at 300K (or about 300K). In the case of Alloy 7, the maximum phase fraction of secondary carbides is 0.057 (or about 0.057), the phase fraction of (Fe,Cr)₂₃C₆ at room temperature [104] is 0.053 (or about 0.053) and the phase fraction of Cr₇C₃ is 0.003 (or about 0.003). Primary and secondary carbides is a general term which refers to any hard particle which forms during the solidification process. The distinction between primary and secondary can be determined by the precipitation temperature of the phase relative to the solidification temperature of austenite in the alloy. Generally primary and secondary carbides comprise the following: boride, carbide, borocarbide, nitride, carbonitride, aluminide, silicide, oxide, intermetallic, laves phases, and combinations thereof.

Table 1 shows a summary of alloys which meet the primary and secondary carbide thermodynamic criteria. The alloys in Table 1 represent a small fraction of the potential alloy compositions which can be created by varying boron, carbon, chromium, manganese, molybdenum, niobium, silicon, and titanium. Most potential Fe-based alloys will not meet these criteria, however, many compositions may meet the thermodynamic criteria which are not present on this list. In a preferred embodiment, the alloy compositions on this list can possess a specific ratio between the Nb, Ti, C, and B content in the alloy such that (Nb+Ti)/(C+B) can be between 3 and 7. In some embodiments, the (Nb+Ti)/(C+B) content can be between 4 and 6 (or between about 4 and about 6). Many alloy compositions exist which meet this specific ratio but don't meet the thermodynamic composition. To a lesser degree, some alloys which don't meet this criteria, do meet the thermodynamic criteria.

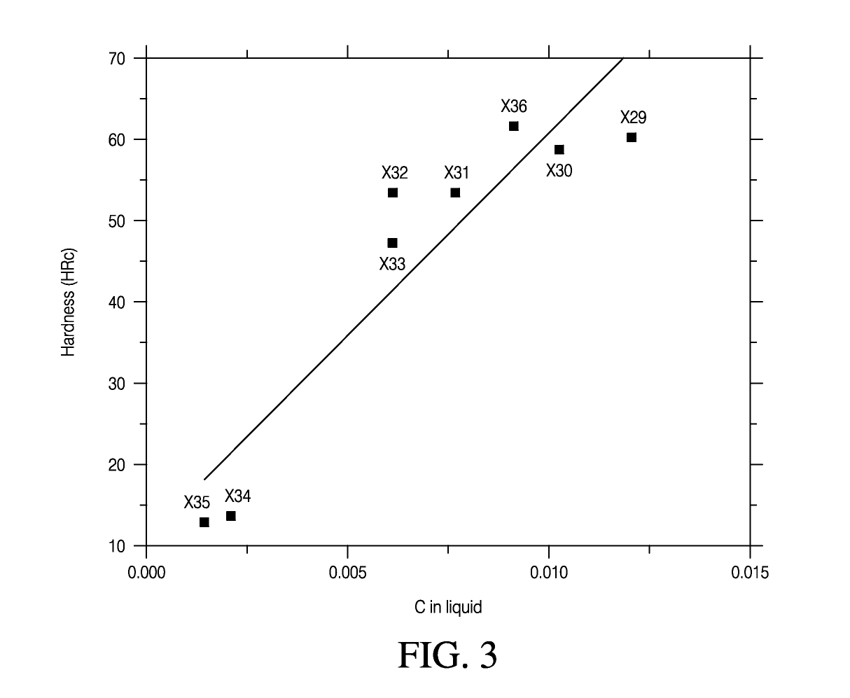

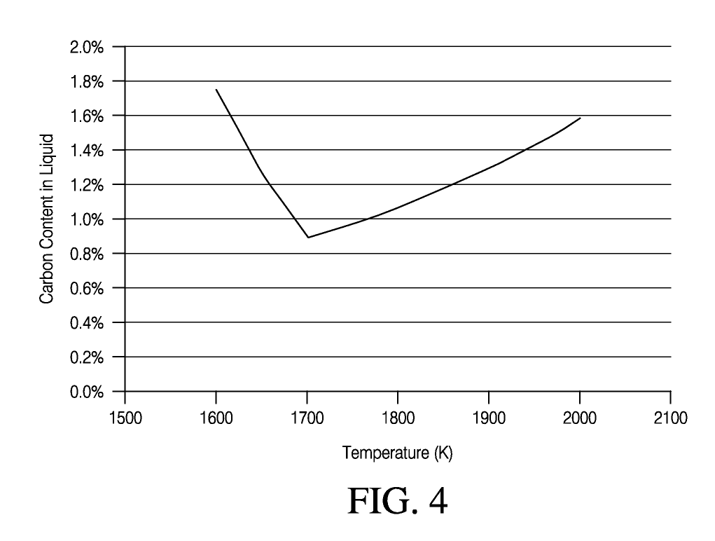

In some embodiments, the alloy can be said to meet an additional thermodynamic criteria. This additional criteria can more accurately predict the phase and hardness of the Fe-based matrix, and can be defined as the local minimum of the carbon in the liquid. FIG. 3 illustrates a comparison of local carbon minimum and hardness. As shown in FIG. 3, the local minimum of carbon in the liquid is an indicator of the final hardness of the alloy. Based on experimental observations of this type, it has been determined that a local minimum of carbon in the liquid between 0.7 wt. % and 1.5 wt. % can be an advantageous thermodynamic criteria for designing hardfacing alloys of at least 50 HRC. However, the actual hardness of the material may depend on processing conditions, particularly the cooling rate. A further example of the carbon content in the liquid as a function of temperature is shown in FIG. 4. As shown, the carbon can tend to decrease as the formation of primary carbides occurs prior to the solidification of the austenite matrix. In this case, the carbon content of the liquid reaches a local minimum at a temperature of 1700K (or about 1700K). For other alloys the carbon may reach a minimum at a different temperature. In the case shown in FIG. 4, the local minimum of carbon is 0.9 weight percent (or about 0.9 weight percent). In some embodiments, the carbon content in the liquid may begin to decrease again after the initial formation of the Fe-rich matrix (either austenite or ferrite) due to the formation of other grain boundary carbides. This decrease may bring the carbon content in the liquid to a lower value than what is defined in this disclosure as the local minimum. Thus, the local minimum is defined as the minimum carbon concentration in weight percent present in the liquid as a function of temperature, prior to the formation of the Fe-rich matrix.

In some embodiments, the Fe-based matrix can be relatively hard as defined by a hardness minimum of at least 50 HRC (or about 50 HRC). In such embodiments, the minimum carbon content in the liquid can be between 0.7 wt. % and 1.5 wt. % (or between about 0.7 wt. % and about 1.5 wt. %). In some embodiments, the minimum carbon content in the liquid can be between 0.8 wt. % and 1.4 wt. % (or between about 0.8 wt. % and about 1.4 wt. %). In some embodiments, the minimum carbon content in the liquid can be between 0.9 wt. % and 1.3 wt. % (or between about 0.9 wt. % and about 1.3 wt. %).

TABLE 1
Disclosed Alloys (in weight percent) Which Meet Thermodynamic
Criteria for Crack Resistance and Toughness

| Alloy | B | C | Cr | Mn | Mo | Nb | Si | Ti | Primary | Secondary |
|---|---|---|---|---|---|---|---|---|---|---|
| M1 | 0 | 2.5 | 2 | 1.16 | 0.74 | 8 | 0.76 | 6 | 2.1% | 4.9% |
| M2 | 0.5 | 2.5 | 2 | 1.16 | 0.74 | 7 | 0.76 | 8 | 2.5% | 5.5% |
| M3 | 0.5 | 2.5 | 4 | 1.16 | 0.74 | 4 | 0.76 | 10 | 2.9% | 7.5% |
| M4 | 0.5 | 2.5 | 2 | 1.16 | 0.74 | 4 | 0.76 | 10 | 2.9% | 5.3% |
| M5 | 0.5 | 2.5 | 4 | 1.16 | 0.74 | 5 | 0.76 | 10 | 2.9% | 9.0% |
| M6 | 0 | 1 | 5.04 | 1.16 | 0.74 | 2 | 0.76 | 3 | 3.1% | 8.8% |
| M7 | 1 | 2.5 | 2 | 1.16 | 0.74 | 7 | 0.76 | 8 | 3.6% | 6.8% |
| M8 | 1 | 2.5 | 4 | 1.16 | 0.74 | 8 | 0.76 | 8 | 4.0% | 9.2% |
| M9 | 1 | 2.5 | 4 | 1.16 | 0.74 | 9 | 0.76 | 8 | 4.5% | 9.6% |
| M10 | 0 | 1.07 | 5.04 | 1.16 | 0.74 | 0 | 0.76 | 2 | 4.6% | 9.7% |
| M11 | 1 | 2.5 | 4 | 1.16 | 0.74 | 5 | 0.76 | 10 | 4.8% | 8.7% |
| M12 | 1 | 2.5 | 2 | 1.16 | 0.74 | 4 | 0.76 | 10 | 4.9% | 5.6% |
| M13 | 1 | 2.5 | 2 | 1.16 | 0.74 | 8 | 0.76 | 8 | 4.9% | 5.7% |
| M14 | 0 | 1.07 | 5.04 | 1.16 | 0.74 | 2 | 0.76 | 0 | 5.2% | 8.3% |
| M15 | 0 | 1.07 | 5.04 | 1.16 | 0.74 | 6 | 0.76 | 2 | 5.3% | 10.0% |
| M16 | 0 | 2.5 | 4 | 1.16 | 0.74 | 7 | 0.76 | 6 | 5.4% | 7.4% |
| M17 | 0 | 2.5 | 2 | 1.16 | 0.74 | 9 | 0.76 | 6 | 5.4% | 5.3% |
| M18 | 1 | 2.5 | 4 | 1.16 | 0.74 | 6 | 0.76 | 10 | 5.4% | 9.1% |
| M19 | 0 | 2.5 | 0 | 1.16 | 0.74 | 5 | 0.76 | 0 | 5.6% | 9.5% |
| M20 | 1 | 2.5 | 2 | 1.16 | 0.74 | 5 | 0.76 | 10 | 5.7% | 5.4% |
| M21 | 1.5 | 2.5 | 4 | 1.16 | 0.74 | 5 | 0.76 | 10 | 6.1% | 9.2% |
| M22 | 0 | 2.5 | 4 | 1.16 | 0.74 | 8 | 0.76 | 6 | 6.2% | 7.8% |
| M23 | 0 | 1.07 | 5.04 | 1.16 | 0.74 | 4 | 0.76 | 0 | 6.4% | 8.0% |
| M24 | 1 | 1.07 | 5.04 | 1.16 | 0.74 | 2 | 0.76 | 6 | 6.5% | 9.3% |
| M25 | 1.5 | 2.5 | 2 | 1.16 | 0.74 | 9 | 0.76 | 8 | 6.6% | 7.1% |
| M26 | 0 | 1.07 | 5.04 | 1.16 | 0.74 | 2 | 0.76 | 2 | 6.7% | 8.8% |
| M27 | 0 | 2.5 | 0 | 1.16 | 0.74 | 6 | 0.76 | 0 | 6.7% | 9.0% |
| M28 | 0.5 | 1.07 | 5.04 | 1.16 | 0.74 | 2 | 0.76 | 0 | 7.5% | 9.3% |
| M29 | 0 | 1.07 | 5.04 | 1.16 | 0.74 | 6 | 0.76 | 0 | 7.6% | 8.6% |
| M30 | 0 | 2.5 | 0 | 1.16 | 0.74 | 7 | 0.76 | 0 | 7.8% | 8.5% |
| M31 | 1.5 | 2.5 | 2 | 1.16 | 0.74 | 6 | 0.76 | 10 | 7.9% | 5.6% |
| M32 | 1.5 | 2.5 | 2 | 1.16 | 0.74 | 10 | 0.76 | 8 | 7.9% | 5.9% |
| M33 | 1.5 | 2.5 | 4 | 1.16 | 0.74 | 7 | 0.76 | 10 | 7.9% | 8.7% |
| M34 | 1.5 | 2.5 | 4 | 1.16 | 0.74 | 8 | 0.76 | 10 | 8.1% | 10.0% |
| M35 | 0 | 2.5 | 2 | 1.16 | 0.74 | 4 | 0.76 | 0 | 8.4% | 8.0% |
| M36 | 0 | 2 | 5.04 | 1.16 | 0.74 | 0 | 0.76 | 3 | 8.7% | 9.6% |
| M37 | 0.5 | 1.07 | 5.04 | 1.16 | 0.74 | 4 | 0.76 | 0 | 8.7% | 9.0% |
| M38 | 0 | 2.5 | 0 | 1.16 | 0.74 | 4 | 0.76 | 2 | 8.7% | 7.8% |
| M39 | 0 | 2.5 | 0 | 1.16 | 0.74 | 8 | 0.76 | 0 | 9.0% | 8.0% |
| M40 | 0 | 1 | 5.04 | 1.16 | 0.74 | 0 | 0.76 | 3 | 9.2% | 9.0% |
| M41 | 0 | 1.5 | 5.04 | 1.16 | 0.74 | 2 | 0.76 | 3 | 9.4% | 8.8% |
| M42 | 0 | 2.5 | 2 | 1.16 | 0.74 | 5 | 0.76 | 0 | 9.6% | 7.5% |
| M43 | 1.5 | 2.5 | 2 | 1.16 | 0.74 | 8 | 0.76 | 10 | 9.6% | 5.2% |
| M44 | 2 | 2.5 | 2 | 1.16 | 0.74 | 7 | 0.76 | 10 | 9.7% | 7.0% |
| M45 | 1.5 | 0 | 5.04 | 1.16 | 0.74 | 0 | 0.76 | 3 | 9.8% | 9.2% |
| M46 | 1.5 | 1.07 | 5.04 | 1.16 | 0.74 | 2 | 0.76 | 8 | 9.8% | 10.0% |
| M47 | 0 | 2.5 | 0 | 1.16 | 0.74 | 5 | 0.76 | 2 | 9.9% | 7.3% |
| M48 | 2 | 2.5 | 4 | 1.16 | 0.74 | 8 | 0.76 | 10 | 10.1% | 9.0% |
| M49 | 0 | 2.5 | 0 | 1.16 | 0.74 | 9 | 0.76 | 0 | 10.2% | 7.4% |
| M50 | 0 | 2 | 5.04 | 1.16 | 0.74 | 2 | 0.76 | 3 | 10.3% | 9.3% |
| M51 | 0 | 2.5 | 2 | 1.16 | 0.74 | 6 | 0.76 | 0 | 10.7% | 7.0% |
| M52 | 0 | 2.5 | 0 | 1.16 | 0.74 | 4 | 0.76 | 3 | 10.9% | 6.8% |
| M53 | 2 | 2.5 | 4 | 1.16 | 0.74 | 9 | 0.76 | 10 | 10.9% | 8.7% |
| M54 | 0 | 2.5 | 0 | 1.16 | 0.74 | 6 | 0.76 | 2 | 11.0% | 6.8% |
| M55 | 0 | 2 | 0 | 1.16 | 0.74 | 4 | 0.76 | 3 | 11.1% | 4.7% |
| M56 | 0 | 2.5 | 0 | 1.16 | 0.74 | 10 | 0.76 | 0 | 11.3% | 6.9% |
| M57 | 2 | 2.5 | 2 | 1.16 | 0.74 | 9 | 0.76 | 10 | 11.8% | 5.3% |
| M58 | 0 | 2.5 | 2 | 1.16 | 0.74 | 7 | 0.76 | 0 | 11.9% | 6.4% |
| M59 | 0 | 2.5 | 0 | 1.16 | 0.74 | 7 | 0.76 | 2 | 12.2% | 6.2% |
| M60 | 0 | 2.5 | 4 | 1.16 | 0.74 | 4 | 0.76 | 0 | 12.4% | 6.0% |
| M61 | 0.5 | 2 | 2 | 1.16 | 0.74 | 4 | 0.76 | 3 | 12.5% | 9.2% |
| M62 | 0 | 2.5 | 2 | 1.16 | 0.74 | 4 | 0.76 | 2 | 12.7% | 5.8% |
| M63 | 0.5 | 1.07 | 5.04 | 1.16 | 0.74 | 0 | 0.76 | 6 | 12.9% | 9.2% |
| M64 | 0 | 2.5 | 0 | 1.16 | 0.74 | 4 | 0.76 | 4 | 13.0% | 5.7% |
| M65 | 0 | 2 | 6 | 1.16 | 0.74 | 4 | 0.76 | 3 | 13.0% | 9.3% |
| M66 | 0 | 2.5 | 2 | 1.16 | 0.74 | 8 | 0.76 | 0 | 13.1% | 5.9% |
| M67 | 2 | 1.07 | 5.04 | 1.16 | 0.74 | 2 | 0.76 | 8 | 13.1% | 8.3% |
| M68 | 0.5 | 2 | 0 | 1.16 | 0.74 | 6 | 0.76 | 3 | 13.2% | 9.0% |
| M69 | 0 | 2.5 | 0 | 1.16 | 0.74 | 6 | 0.76 | 3 | 13.2% | 5.7% |
| M70 | 0 | 2.5 | 0 | 1.16 | 0.74 | 8 | 0.76 | 2 | 13.4% | 5.7% |
| M71 | 0.5 | 2 | 5.04 | 1.16 | 0.74 | 2 | 0.76 | 3 | 13.4% | 9.9% |
| M72 | 0 | 2 | 0 | 1.16 | 0.74 | 6 | 0.76 | 3 | 13.4% | 3.6% |
| M73 | 0 | 2.5 | 4 | 1.16 | 0.74 | 5 | 0.76 | 0 | 13.5% | 5.5% |
| M74 | 0 | 1.5 | 5.04 | 1.16 | 0.74 | 6 | 0.76 | 3 | 13.6% | 9.0% |
| M75 | 0 | 2.5 | 2 | 1.16 | 0.74 | 5 | 0.76 | 2 | 13.9% | 5.3% |
| M76 | 0 | 2 | 6 | 1.16 | 0.74 | 6 | 0.76 | 3 | 13.9% | 9.8% |
| M77 | 0 | 2 | 5.04 | 1.16 | 0.74 | 4 | 0.76 | 3 | 14.0% | 7.6% |
| M78 | 0 | 2 | 5.04 | 1.16 | 0.74 | 6 | 0.76 | 3 | 14.1% | 8.4% |
| M79 | 0 | 2 | 4 | 1.16 | 0.74 | 4 | 0.76 | 3 | 14.1% | 6.4% |
| M80 | 0 | 2.5 | 0 | 1.16 | 0.74 | 5 | 0.76 | 4 | 14.2% | 5.1% |
| M81 | 0 | 2.5 | 2 | 1.16 | 0.74 | 9 | 0.76 | 0 | 14.2% | 5.3% |
| M82 | 0 | 1.07 | 5.04 | 1.16 | 0.74 | 8 | 0.76 | 0 | 14.3% | 9.6% |
| M83 | 0 | 2.5 | 0 | 1.16 | 0.74 | 9 | 0.76 | 2 | 14.6% | 5.2% |
| M84 | 0 | 2 | 4 | 1.16 | 0.74 | 6 | 0.76 | 3 | 14.6% | 7.0% |
| M85 | 0 | 2.5 | 4 | 1.16 | 0.74 | 6 | 0.76 | 0 | 14.7% | 5.0% |
| M86 | 0 | 2.5 | 6 | 1.16 | 0.74 | 4 | 0.76 | 3 | 14.8% | 9.1% |
| M87 | 0 | 2.5 | 2 | 1.16 | 0.74 | 4 | 0.76 | 3 | 14.8% | 4.8% |
| M88 | 0.5 | 2 | 2 | 1.16 | 0.74 | 6 | 0.76 | 3 | 15.0% | 8.1% |
| M89 | 0 | 2.5 | 2 | 1.16 | 0.74 | 6 | 0.76 | 2 | 15.0% | 4.8% |
| M90 | 0.5 | 2.5 | 0 | 1.16 | 0.74 | 6 | 0.76 | 4 | 15.0% | 9.9% |
| M91 | 0.5 | 2.5 | 4 | 1.16 | 0.74 | 5 | 0.76 | 2 | 15.1% | 9.8% |
| M92 | 0 | 2 | 2 | 1.16 | 0.74 | 4 | 0.76 | 3 | 15.1% | 2.7% |
| M93 | 0.5 | 2.5 | 0 | 1.16 | 0.74 | 8 | 0.76 | 3 | 15.2% | 10.0% |
| M94 | 0 | 2.5 | 0 | 1.16 | 0.74 | 6 | 0.76 | 4 | 15.3% | 4.6% |
| M95 | 0 | 2.5 | 2 | 1.16 | 0.74 | 10 | 0.76 | 0 | 15.4% | 4.8% |
| M96 | 0.5 | 2 | 0 | 1.16 | 0.74 | 8 | 0.76 | 3 | 15.5% | 8.0% |
| M97 | 0 | 2.5 | 0 | 1.16 | 0.74 | 8 | 0.76 | 3 | 15.5% | 4.6% |
| M98 | 0.5 | 2.5 | 2 | 1.16 | 0.74 | 5 | 0.76 | 4 | 15.6% | 9.6% |
| M99 | 0 | 2.5 | 0 | 1.16 | 0.74 | 10 | 0.76 | 2 | 15.8% | 4.6% |
| M100 | 0 | 2 | 0 | 1.16 | 0.74 | 8 | 0.76 | 3 | 15.8% | 2.5% |
| M101 | 0.5 | 2.5 | 2 | 1.16 | 0.74 | 8 | 0.76 | 2 | 15.8% | 9.7% |
| M102 | 0 | 2.5 | 4 | 1.16 | 0.74 | 7 | 0.76 | 0 | 15.9% | 4.4% |
| M103 | 0.5 | 2 | 5.04 | 1.16 | 0.74 | 4 | 0.76 | 3 | 15.9% | 8.5% |
| M104 | 0.5 | 2.5 | 4 | 1.16 | 0.74 | 4 | 0.76 | 3 | 15.9% | 9.3% |
| M105 | 0 | 2 | 2 | 1.16 | 0.74 | 8 | 0.76 | 3 | 16.0% | 4.6% |
| M106 | 0 | 2 | 4 | 1.16 | 0.74 | 8 | 0.76 | 3 | 16.0% | 7.4% |
| M107 | 0 | 2 | 2 | 1.16 | 0.74 | 6 | 0.76 | 3 | 16.1% | 3.2% |
| M108 | 0.5 | 2 | 5.04 | 1.16 | 0.74 | 6 | 0.76 | 3 | 16.2% | 9.4% |
| M109 | 0.5 | 2 | 4 | 1.16 | 0.74 | 4 | 0.76 | 3 | 16.2% | 7.4% |
| M110 | 0 | 2.5 | 2 | 1.16 | 0.74 | 7 | 0.76 | 2 | 16.2% | 4.2% |
| M111 | 0.5 | 2.5 | 0 | 1.16 | 0.74 | 7 | 0.76 | 4 | 16.2% | 9.4% |
| M112 | 0.5 | 2.5 | 4 | 1.16 | 0.74 | 6 | 0.76 | 2 | 16.3% | 9.3% |
| M113 | 0.5 | 2.5 | 4 | 1.16 | 0.74 | 9 | 0.76 | 0 | 16.4% | 9.5% |
| M114 | 0.5 | 2 | 4 | 1.16 | 0.74 | 8 | 0.76 | 3 | 16.4% | 9.3% |
| M115 | 0 | 2.5 | 0 | 1.16 | 0.74 | 7 | 0.76 | 4 | 16.5% | 4.1% |
| M116 | 0 | 2.5 | 5.04 | 1.16 | 0.74 | 2 | 0.76 | 3 | 16.6% | 7.9% |
| M117 | 0 | 2.5 | 4 | 1.16 | 0.74 | 4 | 0.76 | 2 | 16.6% | 3.9% |
| M118 | 0.5 | 2 | 4 | 1.16 | 0.74 | 6 | 0.76 | 3 | 16.7% | 7.8% |
| M119 | 0.5 | 2.5 | 2 | 1.16 | 0.74 | 6 | 0.76 | 4 | 16.8% | 9.0% |
| M120 | 0.5 | 2.5 | 0 | 1.16 | 0.74 | 4 | 0.76 | 6 | 16.9% | 8.8% |
| M121 | 0 | 2.5 | 2 | 1.16 | 0.74 | 4 | 0.76 | 4 | 16.9% | 3.7% |
| M122 | 0 | 2.5 | 4 | 1.16 | 0.74 | 8 | 0.76 | 0 | 17.1% | 3.9% |
| M123 | 0 | 2.5 | 2 | 1.16 | 0.74 | 6 | 0.76 | 3 | 17.2% | 3.7% |
| M124 | 0.5 | 2.5 | 2 | 1.16 | 0.74 | 9 | 0.76 | 2 | 17.2% | 9.0% |
| M125 | 0 | 2.5 | 0 | 1.16 | 0.74 | 4 | 0.76 | 6 | 17.3% | 3.5% |
| M126 | 0.5 | 2 | 2 | 1.16 | 0.74 | 8 | 0.76 | 3 | 17.3% | 7.0% |
| M127 | 0.5 | 2.5 | 0 | 1.16 | 0.74 | 8 | 0.76 | 4 | 17.4% | 8.9% |
| M128 | 0 | 2.5 | 2 | 1.16 | 0.74 | 8 | 0.76 | 2 | 17.4% | 3.7% |
| M129 | 0.5 | 2.5 | 4 | 1.16 | 0.74 | 7 | 0.76 | 2 | 17.5% | 8.8% |
| M130 | 0 | 2 | 5.04 | 1.16 | 0.74 | 10 | 0.76 | 3 | 17.5% | 9.1% |
| M131 | 0.5 | 2.5 | 2 | 1.16 | 0.74 | 8 | 0.76 | 3 | 17.6% | 8.8% |
| M132 | 0.5 | 2.5 | 0 | 1.16 | 0.74 | 10 | 0.76 | 3 | 17.6% | 8.9% |
| M133 | 0 | 2.5 | 4 | 1.16 | 0.74 | 4 | 0.76 | 4 | 17.6% | 5.0% |
| M134 | 0.5 | 2.5 | 5.04 | 1.16 | 0.74 | 4 | 0.76 | 3 | 17.6% | 8.6% |
| M135 | 0.5 | 2 | 4 | 1.16 | 0.74 | 10 | 0.76 | 3 | 17.7% | 9.8% |
| M136 | 0 | 2.5 | 0 | 1.16 | 0.74 | 8 | 0.76 | 4 | 17.7% | 3.5% |
| M137 | 0 | 2.5 | 4 | 1.16 | 0.74 | 5 | 0.76 | 2 | 17.8% | 3.3% |
| M138 | 0 | 2 | 0 | 1.16 | 0.74 | 10 | 0.76 | 3 | 17.8% | 1.3% |
| M139 | 0.5 | 2.5 | 4 | 1.16 | 0.74 | 10 | 0.76 | 0 | 17.8% | 8.8% |
| M140 | 0.5 | 2 | 0 | 1.16 | 0.74 | 10 | 0.76 | 3 | 18.0% | 6.3% |
| M141 | 0.5 | 2.5 | 4 | 1.16 | 0.74 | 4 | 0.76 | 4 | 18.0% | 8.3% |
| M142 | 0.5 | 2.5 | 2 | 1.16 | 0.74 | 7 | 0.76 | 4 | 18.0% | 8.5% |
| M143 | 0 | 2.5 | 6 | 1.16 | 0.74 | 10 | 0.76 | 3 | 18.1% | 9.6% |
| M144 | 0.5 | 2.5 | 0 | 1.16 | 0.74 | 5 | 0.76 | 6 | 18.1% | 8.3% |
| M145 | 0 | 2.5 | 2 | 1.16 | 0.74 | 5 | 0.76 | 4 | 18.1% | 3.1% |
| M146 | 0 | 2.5 | 6 | 1.16 | 0.74 | 8 | 0.76 | 3 | 18.3% | 8.3% |
| M147 | 0 | 2.5 | 4 | 1.16 | 0.74 | 9 | 0.76 | 0 | 18.3% | 3.3% |
| M148 | 0.5 | 2.5 | 4 | 1.16 | 0.74 | 6 | 0.76 | 3 | 18.3% | 8.2% |
| M149 | 0 | 2.5 | 0 | 1.16 | 0.74 | 10 | 0.76 | 3 | 18.3% | 3.5% |
| M150 | 0 | 2.5 | 4 | 1.16 | 0.74 | 4 | 0.76 | 6 | 18.4% | 6.9% |
| M151 | 0 | 2.5 | 0 | 1.16 | 0.74 | 5 | 0.76 | 6 | 18.4% | 3.0% |
| M152 | 0 | 2.5 | 6 | 1.16 | 0.74 | 6 | 0.76 | 3 | 18.4% | 7.1% |
| M153 | 0.5 | 2.5 | 2 | 1.16 | 0.74 | 4 | 0.76 | 6 | 18.5% | 8.0% |
| M154 | 0 | 2.5 | 4 | 1.16 | 0.74 | 5 | 0.76 | 4 | 18.5% | 5.3% |
| M155 | 0.5 | 2.5 | 0 | 1.16 | 0.74 | 9 | 0.76 | 4 | 18.5% | 8.4% |
| M156 | 0.5 | 2.5 | 2 | 1.16 | 0.74 | 10 | 0.76 | 2 | 18.6% | 8.4% |
| M157 | 0 | 2.5 | 2 | 1.16 | 0.74 | 9 | 0.76 | 2 | 18.6% | 3.1% |
| M158 | 0 | 2.5 | 5.04 | 1.16 | 0.74 | 10 | 0.76 | 3 | 18.6% | 8.2% |
| M159 | 0.5 | 2.5 | 4 | 1.16 | 0.74 | 8 | 0.76 | 2 | 18.7% | 8.2% |
| M160 | 0 | 2.5 | 4 | 1.16 | 0.74 | 4 | 0.76 | 3 | 18.8% | 2.8% |
| M161 | 0 | 2.5 | 4 | 1.16 | 0.74 | 5 | 0.76 | 6 | 18.9% | 7.3% |
| M162 | 0 | 2.5 | 0 | 1.16 | 0.74 | 9 | 0.76 | 4 | 18.9% | 3.0% |
| M163 | 0 | 2.5 | 4 | 1.16 | 0.74 | 6 | 0.76 | 4 | 18.9% | 5.7% |
| M164 | 0 | 2.5 | 4 | 1.16 | 0.74 | 6 | 0.76 | 2 | 19.0% | 2.8% |
| M165 | 0 | 2.5 | 4 | 1.16 | 0.74 | 10 | 0.76 | 3 | 19.2% | 6.7% |
| M166 | 0.5 | 2.5 | 4 | 1.16 | 0.74 | 5 | 0.76 | 4 | 19.2% | 7.7% |
| M167 | 0.5 | 2.5 | 6 | 1.16 | 0.74 | 4 | 0.76 | 3 | 19.2% | 7.9% |
| M168 | 0.5 | 2.5 | 0 | 1.16 | 0.74 | 6 | 0.76 | 6 | 19.2% | 7.8% |
| M169 | 1.5 | 1.07 | 5.04 | 1.16 | 0.74 | 0 | 0.76 | 8 | 19.3% | 8.3% |
| M170 | 0 | 2.5 | 2 | 1.16 | 0.74 | 6 | 0.76 | 4 | 19.3% | 2.6% |
| M171 | 0 | 2.5 | 2 | 1.16 | 0.74 | 4 | 0.76 | 6 | 19.3% | 3.8% |
| M172 | 0.5 | 2.5 | 2 | 1.16 | 0.74 | 8 | 0.76 | 4 | 19.4% | 7.9% |
| M173 | 0 | 2.5 | 4 | 1.16 | 0.74 | 10 | 0.76 | 0 | 19.5% | 2.8% |
| M174 | 0 | 2.5 | 4 | 1.16 | 0.74 | 7 | 0.76 | 4 | 19.6% | 6.1% |
| M175 | 0 | 2.5 | 2 | 1.16 | 0.74 | 5 | 0.76 | 6 | 19.6% | 4.2% |
| M176 | 0 | 2.5 | 0 | 1.16 | 0.74 | 6 | 0.76 | 6 | 19.6% | 2.4% |
| M177 | 0 | 2.5 | 2 | 1.16 | 0.74 | 6 | 0.76 | 6 | 19.7% | 4.6% |
| M178 | 0.5 | 2.5 | 2 | 1.16 | 0.74 | 5 | 0.76 | 6 | 19.7% | 7.5% |
| M179 | 0.5 | 2.5 | 0 | 1.16 | 0.74 | 10 | 0.76 | 4 | 19.7% | 7.8% |
| M180 | 0 | 2.5 | 4 | 1.16 | 0.74 | 8 | 0.76 | 3 | 19.7% | 4.8% |
| M181 | 0 | 2.5 | 4 | 1.16 | 0.74 | 6 | 0.76 | 3 | 19.8% | 3.8% |
| M182 | 0 | 2.5 | 2 | 1.16 | 0.74 | 10 | 0.76 | 2 | 19.8% | 2.6% |
| M183 | 0 | 2.5 | 4 | 1.16 | 0.74 | 8 | 0.76 | 2 | 19.8% | 3.5% |
| M184 | 0 | 2.5 | 2 | 1.16 | 0.74 | 8 | 0.76 | 3 | 19.9% | 2.6% |
| M185 | 0.5 | 2.5 | 4 | 1.16 | 0.74 | 9 | 0.76 | 2 | 20.0% | 7.6% |
| M186 | 0.5 | 2.5 | 4 | 1.16 | 0.74 | 4 | 0.76 | 6 | 20.0% | 8.1% |
| M187 | 0 | 2.5 | 2 | 1.16 | 0.74 | 7 | 0.76 | 4 | 20.0% | 2.6% |
| M188 | 0.5 | 2.5 | 4 | 1.16 | 0.74 | 6 | 0.76 | 6 | 20.1% | 9.2% |
| M189 | 0 | 2.5 | 0 | 1.16 | 0.74 | 10 | 0.76 | 4 | 20.1% | 2.4% |
| M190 | 0 | 2.5 | 4 | 1.16 | 0.74 | 7 | 0.76 | 2 | 20.1% | 2.3% |
| M191 | 0.5 | 2.5 | 5.04 | 1.16 | 0.74 | 6 | 0.76 | 3 | 20.3% | 7.3% |
| M192 | 0.5 | 2.5 | 4 | 1.16 | 0.74 | 5 | 0.76 | 6 | 20.3% | 8.4% |
| M193 | 0.5 | 2.5 | 6 | 1.16 | 0.74 | 8 | 0.76 | 3 | 20.3% | 9.2% |
| M194 | 0.5 | 2.5 | 2 | 1.16 | 0.74 | 10 | 0.76 | 3 | 20.4% | 7.5% |
| M195 | 0.5 | 2.5 | 4 | 1.16 | 0.74 | 6 | 0.76 | 4 | 20.4% | 7.2% |
| M196 | 0.5 | 2.5 | 0 | 1.16 | 0.74 | 7 | 0.76 | 6 | 20.4% | 7.2% |
| M197 | 0 | 2.5 | 2 | 1.16 | 0.74 | 8 | 0.76 | 4 | 20.4% | 3.0% |
| M198 | 0.5 | 2.5 | 6 | 1.16 | 0.74 | 6 | 0.76 | 3 | 20.4% | 7.9% |
| M199 | 0.5 | 2.5 | 5.04 | 1.16 | 0.74 | 10 | 0.76 | 3 | 20.5% | 9.3% |
| M200 | 0.5 | 2.5 | 4 | 1.16 | 0.74 | 10 | 0.76 | 4 | 20.6% | 9.2% |
| M201 | 0 | 2.5 | 5.04 | 1.16 | 0.74 | 4 | 0.76 | 3 | 20.6% | 5.2% |
| M202 | 0.5 | 2.5 | 4 | 1.16 | 0.74 | 9 | 0.76 | 4 | 20.7% | 8.5% |
| M203 | 0 | 2.5 | 0 | 1.16 | 0.74 | 7 | 0.76 | 6 | 20.8% | 2.1% |
| M204 | 0.5 | 2.5 | 4 | 1.16 | 0.74 | 8 | 0.76 | 3 | 20.8% | 7.2% |
| M205 | 0.5 | 2.5 | 5.04 | 1.16 | 0.74 | 8 | 0.76 | 3 | 20.8% | 7.8% |
| M206 | 0.5 | 2.5 | 2 | 1.16 | 0.74 | 9 | 0.76 | 4 | 20.8% | 7.2% |
| M207 | 0 | 2.5 | 2 | 1.16 | 0.74 | 10 | 0.76 | 3 | 20.8% | 2.8% |
| M208 | 0.5 | 2.5 | 4 | 1.16 | 0.74 | 8 | 0.76 | 4 | 20.8% | 7.7% |
| M209 | 0 | 1.07 | 5.04 | 1.16 | 0.74 | 10 | 0.76 | 0 | 20.9% | 9.8% |
| M210 | 0 | 2.5 | 2 | 1.16 | 0.74 | 9 | 0.76 | 4 | 20.9% | 3.7% |
| M211 | 0.5 | 2.5 | 2 | 1.16 | 0.74 | 6 | 0.76 | 6 | 20.9% | 6.9% |
| M212 | 0.5 | 2.5 | 2 | 1.16 | 0.74 | 4 | 0.76 | 8 | 20.9% | 7.0% |
| M213 | 0 | 2.5 | 4 | 1.16 | 0.74 | 9 | 0.76 | 2 | 20.9% | 3.5% |
| M214 | 0 | 2.5 | 4 | 1.16 | 0.74 | 8 | 0.76 | 4 | 20.9% | 6.9% |
| M215 | 0 | 2.5 | 2 | 1.16 | 0.74 | 4 | 0.76 | 8 | 21.1% | 4.8% |
| M216 | 0 | 2.5 | 2 | 1.16 | 0.74 | 7 | 0.76 | 6 | 21.1% | 4.3% |
| M217 | 0.5 | 2.5 | 2 | 1.16 | 0.74 | 7 | 0.76 | 6 | 21.1% | 6.9% |
| M218 | 0.5 | 2.5 | 4 | 1.16 | 0.74 | 7 | 0.76 | 4 | 21.1% | 6.9% |
| M219 | 0 | 2.5 | 0 | 1.16 | 0.74 | 4 | 0.76 | 8 | 21.1% | 1.4% |
| M220 | 0.5 | 2.5 | 4 | 1.16 | 0.74 | 10 | 0.76 | 3 | 21.2% | 7.6% |
| M221 | 0.5 | 2.5 | 0 | 1.16 | 0.74 | 4 | 0.76 | 8 | 21.2% | 6.2% |
| M222 | 0.5 | 2.5 | 4 | 1.16 | 0.74 | 10 | 0.76 | 2 | 21.2% | 7.1% |
| M223 | 0.5 | 2.5 | 4 | 1.16 | 0.74 | 8 | 0.76 | 6 | 21.3% | 9.6% |
| M224 | 0.5 | 2.5 | 2 | 1.16 | 0.74 | 8 | 0.76 | 6 | 21.4% | 7.1% |
| M225 | 0 | 2.5 | 4 | 1.16 | 0.74 | 6 | 0.76 | 6 | 21.4% | 6.8% |
| M226 | 0.5 | 2.5 | 2 | 1.16 | 0.74 | 10 | 0.76 | 4 | 21.4% | 6.9% |
| M227 | 0 | 2.5 | 0 | 1.16 | 0.74 | 8 | 0.76 | 6 | 21.6% | 1.3% |
| M228 | 0.5 | 2.5 | 0 | 1.16 | 0.74 | 8 | 0.76 | 6 | 21.7% | 5.9% |
| M229 | 0 | 2.5 | 5.04 | 1.16 | 0.74 | 6 | 0.76 | 3 | 21.8% | 6.0% |
| M230 | 0.5 | 2.5 | 2 | 1.16 | 0.74 | 5 | 0.76 | 8 | 21.9% | 6.5% |
| M231 | 0 | 2.5 | 0 | 1.16 | 0.74 | 5 | 0.76 | 8 | 21.9% | 0.9% |
| M232 | 0.5 | 2.5 | 4 | 1.16 | 0.74 | 9 | 0.76 | 6 | 22.0% | 9.7% |
| M233 | 0 | 2.5 | 5.04 | 1.16 | 0.74 | 8 | 0.76 | 3 | 22.1% | 7.0% |
| M234 | 0 | 2.5 | 4 | 1.16 | 0.74 | 10 | 0.76 | 2 | 22.2% | 4.7% |
| M235 | 0.5 | 2.5 | 2 | 1.16 | 0.74 | 9 | 0.76 | 6 | 22.2% | 6.7% |
| M236 | 0 | 2.5 | 2 | 1.16 | 0.74 | 10 | 0.76 | 4 | 22.3% | 4.5% |
| M237 | 0 | 2.5 | 2 | 1.16 | 0.74 | 5 | 0.76 | 8 | 22.4% | 5.2% |
| M238 | 1 | 2.5 | 2 | 1.16 | 0.74 | 5 | 0.76 | 8 | 22.4% | 9.7% |
| M239 | 1 | 2.5 | 0 | 1.16 | 0.74 | 5 | 0.76 | 8 | 22.4% | 9.7% |
| M240 | 0 | 2.5 | 0 | 1.16 | 0.74 | 4 | 0.76 | 10 | 22.6% | 4.1% |
| M241 | 0 | 2.5 | 0 | 1.16 | 0.74 | 6 | 0.76 | 8 | 22.6% | 1.5% |
| M242 | 0.5 | 2.5 | 4 | 1.16 | 0.74 | 6 | 0.76 | 8 | 22.7% | 9.3% |
| M243 | 0.5 | 2.5 | 0 | 1.16 | 0.74 | 5 | 0.76 | 8 | 22.7% | 3.5% |
| M244 | 0 | 2.5 | 0 | 1.16 | 0.74 | 9 | 0.76 | 6 | 22.9% | 0.9% |
| M245 | 0 | 2.5 | 4 | 1.16 | 0.74 | 4 | 0.76 | 8 | 22.9% | 7.6% |
| M246 | 1 | 2.5 | 2 | 1.16 | 0.74 | 9 | 0.76 | 6 | 23.0% | 9.6% |
| M247 | 1 | 2.5 | 0 | 1.16 | 0.74 | 9 | 0.76 | 6 | 23.0% | 9.6% |
| M248 | 0.5 | 2.5 | 0 | 1.16 | 0.74 | 9 | 0.76 | 6 | 23.1% | 3.6% |
| M249 | 0 | 2.5 | 0 | 1.16 | 0.74 | 5 | 0.76 | 10 | 23.2% | 5.7% |
| M250 | 0 | 2.5 | 0 | 1.16 | 0.74 | 7 | 0.76 | 8 | 23.2% | 3.2% |
| M251 | 0.5 | 2.5 | 2 | 1.16 | 0.74 | 6 | 0.76 | 8 | 23.3% | 5.7% |
| M252 | 0.5 | 2.5 | 0 | 1.16 | 0.74 | 6 | 0.76 | 8 | 23.6% | 2.6% |
| M253 | 1 | 2.5 | 2 | 1.16 | 0.74 | 6 | 0.76 | 8 | 23.7% | 7.8% |
| M254 | 0.5 | 2.5 | 2 | 1.16 | 0.74 | 10 | 0.76 | 6 | 23.7% | 5.8% |
| M255 | 0.5 | 2.5 | 0 | 1.16 | 0.74 | 10 | 0.76 | 6 | 24.0% | 2.8% |
| M256 | 1 | 2.5 | 2 | 1.16 | 0.74 | 10 | 0.76 | 6 | 24.1% | 8.1% |
| M257 | 1 | 2.5 | 0 | 1.16 | 0.74 | 6 | 0.76 | 8 | 24.1% | 6.6% |
| M258 | 0 | 2.5 | 4 | 1.16 | 0.74 | 9 | 0.76 | 4 | 24.2% | 7.3% |
| M259 | 0 | 2.5 | 2 | 1.16 | 0.74 | 4 | 0.76 | 10 | 24.6% | 7.1% |
| M260 | 0 | 2.5 | 2 | 1.16 | 0.74 | 6 | 0.76 | 8 | 24.7% | 4.6% |
| M261 | 1 | 2.5 | 0 | 1.16 | 0.74 | 10 | 0.76 | 6 | 24.7% | 6.4% |
| M262 | 0.5 | 2.5 | 0 | 1.16 | 0.74 | 7 | 0.76 | 8 | 24.8% | 1.0% |
| M263 | 0 | 2.5 | 0 | 1.16 | 0.74 | 6 | 0.76 | 10 | 24.9% | 7.3% |
| M264 | 0 | 2.5 | 0 | 1.16 | 0.74 | 8 | 0.76 | 8 | 24.9% | 4.8% |
| M265 | 0.5 | 2.5 | 0 | 1.16 | 0.74 | 4 | 0.76 | 10 | 24.9% | 1.0% |
| M266 | 0.5 | 2.5 | 2 | 1.16 | 0.74 | 5 | 0.76 | 10 | 25.0% | 6.9% |
| M267 | 0.5 | 2.5 | 0 | 1.16 | 0.74 | 5 | 0.76 | 10 | 25.0% | 2.5% |
| M268 | 0 | 2.5 | 0 | 1.16 | 0.74 | 10 | 0.76 | 6 | 25.1% | 2.0% |
| M269 | 0.5 | 2.5 | 2 | 1.16 | 0.74 | 6 | 0.76 | 10 | 25.1% | 8.5% |
| M270 | 0.5 | 2.5 | 0 | 1.16 | 0.74 | 6 | 0.76 | 10 | 25.1% | 4.1% |
| M271 | 1 | 2.5 | 4 | 1.16 | 0.74 | 4 | 0.76 | 10 | 25.2% | 9.1% |
| M272 | 0.5 | 2.5 | 2 | 1.16 | 0.74 | 8 | 0.76 | 8 | 25.2% | 6.0% |
| M273 | 0.5 | 2.5 | 0 | 1.16 | 0.74 | 7 | 0.76 | 10 | 25.2% | 5.7% |
| M274 | 0.5 | 2.5 | 0 | 1.16 | 0.74 | 8 | 0.76 | 8 | 25.3% | 1.5% |
| M275 | 0.5 | 2.5 | 2 | 1.16 | 0.74 | 9 | 0.76 | 8 | 25.3% | 7.6% |
| M276 | 0.5 | 2.5 | 0 | 1.16 | 0.74 | 8 | 0.76 | 10 | 25.3% | 7.4% |
| M277 | 0.5 | 2.5 | 0 | 1.16 | 0.74 | 9 | 0.76 | 8 | 25.4% | 3.1% |
| M278 | 0.5 | 2.5 | 2 | 1.16 | 0.74 | 10 | 0.76 | 8 | 25.4% | 9.3% |
| M279 | 0.5 | 2.5 | 0 | 1.16 | 0.74 | 9 | 0.76 | 10 | 25.4% | 9.0% |
| M280 | 0.5 | 2.5 | 0 | 1.16 | 0.74 | 10 | 0.76 | 8 | 25.5% | 4.7% |
| M281 | 1 | 2.5 | 0 | 1.16 | 0.74 | 7 | 0.76 | 8 | 25.7% | 3.6% |
| M282 | 0 | 2.5 | 4 | 1.16 | 0.74 | 10 | 0.76 | 4 | 26.0% | 6.9% |
| M283 | 1 | 2.5 | 0 | 1.16 | 0.74 | 4 | 0.76 | 10 | 26.1% | 2.8% |
| M284 | 1.5 | 2.5 | 2 | 1.16 | 0.74 | 4 | 0.76 | 10 | 26.1% | 7.9% |
| M285 | 1.5 | 2.5 | 0 | 1.16 | 0.74 | 4 | 0.76 | 10 | 26.4% | 7.2% |
| M286 | 1 | 2.5 | 0 | 1.16 | 0.74 | 8 | 0.76 | 8 | 26.6% | 2.9% |
| M287 | 1.5 | 2.5 | 2 | 1.16 | 0.74 | 8 | 0.76 | 8 | 26.6% | 8.0% |
| M288 | 1.5 | 2.5 | 0 | 1.16 | 0.74 | 8 | 0.76 | 8 | 27.0% | 7.0% |
| M289 | 1.5 | 2.5 | 2 | 1.16 | 0.74 | 5 | 0.76 | 10 | 27.1% | 6.8% |
| M290 | 1.5 | 2.5 | 4 | 1.16 | 0.74 | 9 | 0.76 | 8 | 27.2% | 9.5% |
| M291 | 0 | 2.5 | 4 | 1.16 | 0.74 | 5 | 0.76 | 8 | 27.3% | 7.3% |
| M292 | 1 | 2.5 | 0 | 1.16 | 0.74 | 5 | 0.76 | 10 | 27.3% | 1.0% |
| M293 | 1 | 2.5 | 2 | 1.16 | 0.74 | 9 | 0.76 | 8 | 27.4% | 5.5% |
| M294 | 1 | 2.5 | 0 | 1.16 | 0.74 | 9 | 0.76 | 8 | 27.8% | 1.3% |
| M295 | 1 | 2.5 | 2 | 1.16 | 0.74 | 6 | 0.76 | 10 | 27.9% | 5.3% |
| M296 | 1 | 2.5 | 0 | 1.16 | 0.74 | 6 | 0.76 | 10 | 28.0% | 1.0% |
| M297 | 0 | 2.5 | 2 | 1.16 | 0.74 | 5 | 0.76 | 10 | 28.0% | 8.7% |
| M298 | 1.5 | 2.5 | 0 | 1.16 | 0.74 | 5 | 0.76 | 10 | 28.0% | 4.1% |
| M299 | 1.5 | 2.5 | 4 | 1.16 | 0.74 | 6 | 0.76 | 10 | 28.1% | 9.0% |
| M300 | 0 | 2.5 | 2 | 1.16 | 0.74 | 7 | 0.76 | 8 | 28.1% | 6.2% |
| M301 | 1 | 2.5 | 2 | 1.16 | 0.74 | 7 | 0.76 | 10 | 28.1% | 6.8% |
| M302 | 1 | 2.5 | 0 | 1.16 | 0.74 | 7 | 0.76 | 10 | 28.1% | 2.5% |
| M303 | 1 | 2.5 | 2 | 1.16 | 0.74 | 8 | 0.76 | 10 | 28.2% | 8.4% |
| M304 | 1 | 2.5 | 0 | 1.16 | 0.74 | 8 | 0.76 | 10 | 28.2% | 4.1% |
| M305 | 0 | 2.5 | 0 | 1.16 | 0.74 | 7 | 0.76 | 10 | 28.2% | 9.0% |
| M306 | 1 | 2.5 | 2 | 1.16 | 0.74 | 10 | 0.76 | 8 | 28.3% | 5.9% |
| M307 | 0 | 2.5 | 0 | 1.16 | 0.74 | 9 | 0.76 | 8 | 28.3% | 6.5% |
| M308 | 1 | 2.5 | 0 | 1.16 | 0.74 | 9 | 0.76 | 10 | 28.3% | 5.7% |
| M309 | 1 | 2.5 | 0 | 1.16 | 0.74 | 10 | 0.76 | 8 | 28.4% | 1.3% |
| M310 | 1 | 2.5 | 0 | 1.16 | 0.74 | 10 | 0.76 | 10 | 28.4% | 7.3% |
| M311 | 1.5 | 2.5 | 4 | 1.16 | 0.74 | 10 | 0.76 | 8 | 28.5% | 9.2% |
| M312 | 1.5 | 2.5 | 0 | 1.16 | 0.74 | 9 | 0.76 | 8 | 28.7% | 3.9% |
| M313 | 0 | 2.5 | 4 | 1.16 | 0.74 | 9 | 0.76 | 6 | 28.7% | 7.5% |
| M314 | 0 | 2.5 | 4 | 1.16 | 0.74 | 4 | 0.76 | 10 | 28.7% | 9.8% |
| M315 | 0 | 2.5 | 4 | 1.16 | 0.74 | 6 | 0.76 | 8 | 28.8% | 7.4% |
| M316 | 0 | 2.5 | 2 | 1.16 | 0.74 | 8 | 0.76 | 8 | 29.0% | 7.9% |
| M317 | 0 | 2.5 | 4 | 1.16 | 0.74 | 7 | 0.76 | 8 | 29.0% | 9.0% |
| M318 | 2 | 2.5 | 2 | 1.16 | 0.74 | 6 | 0.76 | 10 | 29.0% | 8.0% |
| M319 | 1.5 | 2.5 | 0 | 1.16 | 0.74 | 6 | 0.76 | 10 | 29.0% | 3.0% |
| M320 | 0 | 2.5 | 2 | 1.16 | 0.74 | 10 | 0.76 | 6 | 29.1% | 5.1% |
| M321 | 2 | 2.5 | 0 | 1.16 | 0.74 | 6 | 0.76 | 10 | 29.2% | 7.6% |
| M322 | 0 | 2.5 | 0 | 1.16 | 0.74 | 10 | 0.76 | 8 | 29.2% | 8.2% |
| M323 | 0 | 2.5 | 2 | 1.16 | 0.74 | 9 | 0.76 | 8 | 29.2% | 9.6% |
| M324 | 0 | 2.5 | 4 | 1.16 | 0.74 | 10 | 0.76 | 6 | 29.3% | 7.9% |
| M325 | 2 | 2.5 | 2 | 1.16 | 0.74 | 10 | 0.76 | 8 | 29.5% | 8.3% |
| M326 | 2 | 2.5 | 4 | 1.16 | 0.74 | 7 | 0.76 | 10 | 29.5% | 9.4% |
| M327 | 1.5 | 2.5 | 0 | 1.16 | 0.74 | 10 | 0.76 | 8 | 29.6% | 3.1% |
| M328 | 2 | 2.5 | 0 | 1.16 | 0.74 | 10 | 0.76 | 8 | 29.8% | 7.4% |
| M329 | 1.5 | 2.5 | 2 | 1.16 | 0.74 | 7 | 0.76 | 10 | 29.8% | 5.4% |
| M330 | 1.5 | 2.5 | 0 | 1.16 | 0.74 | 7 | 0.76 | 10 | 30.1% | 1.6% |
| M331 | 2 | 2.5 | 0 | 1.16 | 0.74 | 7 | 0.76 | 10 | 30.8% | 4.5% |
| M332 | 1.5 | 2.5 | 0 | 1.16 | 0.74 | 8 | 0.76 | 10 | 31.0% | 0.9% |
| M333 | 1.5 | 2.5 | 2 | 1.16 | 0.74 | 9 | 0.76 | 10 | 31.1% | 6.7% |
| M334 | 1.5 | 2.5 | 0 | 1.16 | 0.74 | 9 | 0.76 | 10 | 31.1% | 2.4% |
| M335 | 1.5 | 2.5 | 2 | 1.16 | 0.74 | 10 | 0.76 | 10 | 31.2% | 8.3% |
| M336 | 1.5 | 2.5 | 0 | 1.16 | 0.74 | 10 | 0.76 | 10 | 31.3% | 3.9% |
| M337 | 2 | 2.5 | 2 | 1.16 | 0.74 | 8 | 0.76 | 10 | 31.3% | 5.8% |
| M338 | 2 | 2.5 | 0 | 1.16 | 0.74 | 8 | 0.76 | 10 | 31.9% | 3.1% |
| M339 | 2 | 2.5 | 0 | 1.16 | 0.74 | 9 | 0.76 | 10 | 32.9% | 2.1% |
| M340 | 2 | 2.5 | 2 | 1.16 | 0.74 | 10 | 0.76 | 10 | 33.7% | 5.2% |
| M341 | 2 | 2.5 | 0 | 1.16 | 0.74 | 10 | 0.76 | 10 | 33.9% | 0.9% |

Table 2 shows a summary of alloy composition embodiments which meet the additional thermodynamic criteria: local carbon minimum in the liquid, and the difference between the grain boundary and Fe-rich matrix formation temperature.

TABLE 2
Disclosed Alloys (in weight percent) Which Meet Thermodynamic Criteria for Crack Resistance and Toughness

| | | | | | | | | | | | | | | | | Cmin | |
|---|---|---|---|---|---|---|---|---|---|---|---|---|---|---|---|---|---|
| Alloy | B | C | Cr | Cu | Fe | Mn | Mo | Nb | Ni | Si | Ti | V | W | GB | PC | (liquid) | GBΔT |
| N1 | 0 | 1.8 | 0 | 0 | BAL | 1.16 | 0.74 | 0 | 0 | 0.76 | 3 | 0 | 0 | 6.02% | 6.51% | 1.36% | 750 |
| N2 | 0 | 1.8 | 0 | 0 | BAL | 1.16 | 0.74 | 0 | 0 | 0.76 | 4 | 0 | 0 | 3.16% | 8.67% | 1.16% | 650 |
| N3 | 0 | 1.8 | 0 | 0 | BAL | 1.16 | 0.74 | 0 | 0 | 0.76 | 5 | 0 | 0 | 3.84% | 10.82% | 1.05% | 850 |
| N4 | 0 | 1.8 | 0 | 0 | BAL | 1.16 | 0.74 | 1 | 0 | 0.76 | 2 | 0 | 0 | 6.58% | 5.49% | 1.41% | 600 |
| N5 | 0 | 1.8 | 0 | 0 | BAL | 1.16 | 0.74 | 1 | 0 | 0.76 | 3 | 0 | 0 | 5.49% | 7.66% | 1.22% | 650 |
| N6 | 0 | 1.8 | 0 | 0 | BAL | 1.16 | 0.74 | 1 | 0 | 0.76 | 4 | 0 | 0 | 2.61% | 9.82% | 1.09% | 700 |
| N7 | 0 | 1.8 | 0 | 0 | BAL | 1.16 | 0.74 | 1 | 0 | 0.76 | 5 | 0 | 0 | 3.30% | 11.97% | 0.92% | 750 |
| N8 | 0 | 1.8 | 0 | 0 | BAL | 1.16 | 0.74 | 2 | 0 | 0.76 | 1 | 0 | 0 | 7.15% | 4.45% | 1.47% | 550 |
| N9 | 0 | 1.8 | 0 | 0 | BAL | 1.16 | 0.74 | 2 | 0 | 0.76 | 2 | 0 | 0 | 6.05% | 6.63% | 1.28% | 550 |
| N10 | 0 | 1.8 | 0 | 0 | BAL | 1.16 | 0.74 | 2 | 0 | 0.76 | 3 | 0 | 0 | 4.94% | 8.81% | 1.11% | 650 |
| N11 | 0 | 1.8 | 0 | 0 | BAL | 1.16 | 0.74 | 2 | 0 | 0.76 | 4 | 0 | 0 | 3.84% | 10.98% | 0.97% | 700 |
| N12 | 0 | 1.8 | 0 | 0 | BAL | 1.16 | 0.74 | 2 | 0 | 0.76 | 5 | 0 | 0 | 2.75% | 13.14% | 0.80% | 700 |
| N13 | 0 | 1.8 | 0 | 0 | BAL | 1.16 | 0.74 | 3 | 0 | 0.76 | 1 | 0 | 0 | 6.61% | 5.60% | 1.36% | 550 |
| N14 | 0 | 1.8 | 0 | 0 | BAL | 1.16 | 0.74 | 3 | 0 | 0.76 | 2 | 0 | 0 | 5.50% | 7.79% | 1.16% | 550 |
| N15 | 0 | 1.8 | 0 | 0 | BAL | 1.16 | 0.74 | 3 | 0 | 0.76 | 3 | 0 | 0 | 1.80% | 9.97% | 1.02% | 0 |
| N16 | 0 | 1.8 | 0 | 0 | BAL | 1.16 | 0.74 | 3 | 0 | 0.76 | 4 | 0 | 0 | 3.29% | 12.15% | 0.85% | 650 |
| N17 | 0 | 1.8 | 0 | 0 | BAL | 1.16 | 0.74 | 4 | 0 | 0.76 | 0 | 0 | 0 | 7.20% | 4.54% | 1.49% | 550 |
| N18 | 0 | 1.8 | 0 | 0 | BAL | 1.16 | 0.74 | 4 | 0 | 0.76 | 1 | 0 | 0 | 6.07% | 6.76% | 1.26% | 550 |
| N19 | 0 | 1.8 | 0 | 0 | BAL | 1.16 | 0.74 | 4 | 0 | 0.76 | 2 | 0 | 0 | 4.95% | 8.96% | 1.09% | 600 |
| N20 | 0 | 1.8 | 0 | 0 | BAL | 1.16 | 0.74 | 4 | 0 | 0.76 | 3 | 0 | 0 | 3.85% | 11.15% | 0.91% | 600 |
| N21 | 0 | 1.8 | 0 | 0 | BAL | 1.16 | 0.74 | 4 | 0 | 0.76 | 4 | 0 | 0 | 2.74% | 13.33% | 0.74% | 650 |
| N22 | 0 | 1.8 | 0 | 0 | BAL | 1.16 | 0.74 | 5 | 0 | 0.76 | 0 | 0 | 0 | 6.66% | 5.70% | 1.39% | 550 |
| N23 | 0 | 1.8 | 0 | 0 | BAL | 1.16 | 0.74 | 5 | 0 | 0.76 | 1 | 0 | 0 | 5.52% | 7.93% | 1.15% | 550 |
| N24 | 0 | 1.8 | 0 | 0 | BAL | 1.16 | 0.74 | 5 | 0 | 0.76 | 2 | 0 | 0 | 2.59% | 10.13% | 0.99% | 600 |
| N25 | 0 | 1.8 | 0 | 0 | BAL | 1.16 | 0.74 | 5 | 0 | 0.76 | 3 | 0 | 0 | 3.29% | 12.33% | 0.81% | 600 |
| N26 | 0 | 2 | 0 | 0 | BAL | 1.16 | 0.74 | 0 | 0 | 0.76 | 4 | 0 | 0 | 5.75% | 8.61% | 1.35% | 800 |
| N27 | 0 | 2 | 0 | 0 | BAL | 1.16 | 0.74 | 0 | 0 | 0.76 | 5 | 0 | 0 | 2.91% | 10.74% | 1.15% | 650 |
| N28 | 0 | 2 | 0 | 0 | BAL | 1.16 | 0.74 | 1 | 0 | 0.76 | 3 | 0 | 0 | 6.31% | 7.60% | 1.41% | 650 |
| N29 | 0 | 2 | 0 | 0 | BAL | 1.16 | 0.74 | 1 | 0 | 0.76 | 4 | 0 | 0 | 5.22% | 9.75% | 1.21% | 700 |
| N30 | 0 | 2 | 0 | 0 | BAL | 1.16 | 0.74 | 1 | 0 | 0.76 | 5 | 0 | 0 | 2.37% | 11.89% | 1.08% | 700 |
| N31 | 0 | 2 | 0 | 0 | BAL | 1.16 | 0.74 | 2 | 0 | 0.76 | 2 | 0 | 0 | 6.87% | 6.59% | 1.48% | 550 |
| N32 | 0 | 2 | 0 | 0 | BAL | 1.16 | 0.74 | 2 | 0 | 0.76 | 3 | 0 | 0 | 5.77% | 8.75% | 1.28% | 600 |
| N33 | 0 | 2 | 0 | 0 | BAL | 1.16 | 0.74 | 2 | 0 | 0.76 | 4 | 0 | 0 | 4.68% | 10.90% | 1.10% | 700 |
| N34 | 0 | 2 | 0 | 0 | BAL | 1.16 | 0.74 | 2 | 0 | 0.76 | 5 | 0 | 0 | 3.59% | 13.05% | 0.97% | 700 |
| N35 | 0 | 2 | 0 | 0 | BAL | 1.16 | 0.74 | 3 | 0 | 0.76 | 2 | 0 | 0 | 6.33% | 7.74% | 1.36% | 550 |
| N36 | 0 | 2 | 0 | 0 | BAL | 1.16 | 0.74 | 3 | 0 | 0.76 | 3 | 0 | 0 | 5.24% | 9.91% | 1.16% | 600 |
| N37 | 0 | 2 | 0 | 0 | BAL | 1.16 | 0.74 | 3 | 0 | 0.76 | 4 | 0 | 0 | 1.78% | 12.07% | 1.02% | 450 |
| N38 | 0 | 2 | 0 | 0 | BAL | 1.16 | 0.74 | 3 | 0 | 0.76 | 5 | 0 | 0 | 3.05% | 14.22% | 0.85% | 700 |
| N39 | 0 | 2 | 0 | 0 | BAL | 1.16 | 0.74 | 4 | 0 | 0.76 | 1 | 0 | 0 | 6.90% | 6.72% | 1.45% | 550 |
| N40 | 0 | 2 | 0 | 0 | BAL | 1.16 | 0.74 | 4 | 0 | 0.76 | 2 | 0 | 0 | 5.79% | 8.90% | 1.24% | 550 |
| N41 | 0 | 2 | 0 | 0 | BAL | 1.16 | 0.74 | 4 | 0 | 0.76 | 4 | 0 | 0 | 3.59% | 13.24% | 0.91% | 650 |
| N42 | 0 | 2 | 0 | 0 | BAL | 1.16 | 0.74 | 4 | 0 | 0.76 | 5 | 0 | 0 | 1.78% | 15.40% | 0.74% | 150 |
| N43 | 0 | 2 | 0 | 0 | BAL | 1.16 | 0.74 | 5 | 0 | 0.76 | 1 | 0 | 0 | 6.36% | 7.88% | 1.34% | 550 |
| N44 | 0 | 2 | 0 | 0 | BAL | 1.16 | 0.74 | 5 | 0 | 0.76 | 2 | 0 | 0 | 5.25% | 10.06% | 1.13% | 550 |
| N45 | 0 | 2 | 0 | 0 | BAL | 1.16 | 0.74 | 5 | 0 | 0.76 | 3 | 0 | 0 | 2.35% | 12.24% | 0.98% | 600 |
| N46 | 0 | 2 | 0 | 0 | BAL | 1.16 | 0.74 | 5 | 0 | 0.76 | 4 | 0 | 0 | 3.04% | 14.42% | 0.80% | 650 |
| N47 | 0 | 2.2 | 0 | 0 | BAL | 1.16 | 0.74 | 0 | 0 | 0.76 | 5 | 0 | 0 | 5.49% | 10.67% | 1.34% | 800 |
| N48 | 0 | 2.2 | 0 | 0 | BAL | 1.16 | 0.74 | 1 | 0 | 0.76 | 4 | 0 | 0 | 6.04% | 9.69% | 1.41% | 700 |
| N49 | 0 | 2.2 | 0 | 0 | BAL | 1.16 | 0.74 | 1 | 0 | 0.76 | 5 | 0 | 0 | 4.96% | 11.81% | 1.21% | 700 |
| N50 | 0 | 2.2 | 0 | 0 | BAL | 1.16 | 0.74 | 2 | 0 | 0.76 | 3 | 0 | 0 | 6.60% | 8.69% | 1.48% | 600 |
| N51 | 0 | 2.2 | 0 | 0 | BAL | 1.16 | 0.74 | 2 | 0 | 0.76 | 4 | 0 | 0 | 5.51% | 10.83% | 1.28% | 650 |
| N52 | 0 | 2.2 | 0 | 0 | BAL | 1.16 | 0.74 | 2 | 0 | 0.76 | 5 | 0 | 0 | 1.76% | 12.96% | 1.10% | 0 |
| N53 | 0 | 2.2 | 0 | 0 | BAL | 1.16 | 0.74 | 3 | 0 | 0.76 | 3 | 0 | 0 | 6.06% | 9.84% | 1.35% | 600 |
| N54 | 0 | 2.2 | 0 | 0 | BAL | 1.16 | 0.74 | 3 | 0 | 0.76 | 4 | 0 | 0 | 4.97% | 11.98% | 1.15% | 600 |
| N55 | 0 | 2.2 | 0 | 0 | BAL | 1.16 | 0.74 | 3 | 0 | 0.76 | 5 | 0 | 0 | 1.77% | 14.12% | 1.02% | 0 |
| N56 | 0 | 2.2 | 0 | 0 | BAL | 1.16 | 0.74 | 4 | 0 | 0.76 | 2 | 0 | 0 | 6.62% | 8.84% | 1.44% | 550 |
| N57 | 0 | 2.2 | 0 | 0 | BAL | 1.16 | 0.74 | 4 | 0 | 0.76 | 3 | 0 | 0 | 5.53% | 10.99% | 1.24% | 550 |
| N58 | 0 | 2.2 | 0 | 0 | BAL | 1.16 | 0.74 | 4 | 0 | 0.76 | 4 | 0 | 0 | 2.66% | 13.15% | 1.09% | 650 |
| N59 | 0 | 2.2 | 0 | 0 | BAL | 1.16 | 0.74 | 4 | 0 | 0.76 | 5 | 0 | 0 | 3.34% | 15.29% | 0.91% | 650 |
| N60 | 0 | 2.2 | 0 | 0 | BAL | 1.16 | 0.74 | 5 | 0 | 0.76 | 2 | 0 | 0 | 6.08% | 9.99% | 1.33% | 550 |
| N61 | 0 | 2.2 | 0 | 0 | BAL | 1.16 | 0.74 | 5 | 0 | 0.76 | 3 | 0 | 0 | 4.98% | 12.16% | 1.12% | 550 |
| N62 | 0 | 2.2 | 0 | 0 | BAL | 1.16 | 0.74 | 5 | 0 | 0.76 | 4 | 0 | 0 | 3.89% | 14.32% | 0.98% | 650 |
| N63 | 0 | 2.2 | 0 | 0 | BAL | 1.16 | 0.74 | 5 | 0 | 0.76 | 5 | 0 | 0 | 2.79% | 16.47% | 0.80% | 650 |
| N64 | 0 | 2.4 | 0 | 0 | BAL | 1.16 | 0.74 | 1 | 0 | 0.76 | 5 | 0 | 0 | 5.78% | 11.73% | 1.40% | 700 |
| N65 | 0 | 2.4 | 0 | 0 | BAL | 1.16 | 0.74 | 2 | 0 | 0.76 | 4 | 0 | 0 | 6.32% | 10.76% | 1.48% | 650 |
| N66 | 0 | 2.4 | 0 | 0 | BAL | 1.16 | 0.74 | 2 | 0 | 0.76 | 5 | 0 | 0 | 5.25% | 12.88% | 1.27% | 650 |
| N67 | 0 | 2.4 | 0 | 0 | BAL | 1.16 | 0.74 | 3 | 0 | 0.76 | 4 | 0 | 0 | 5.79% | 11.90% | 1.35% | 600 |
| N68 | 0 | 2.4 | 0 | 0 | BAL | 1.16 | 0.74 | 3 | 0 | 0.76 | 5 | 0 | 0 | 4.71% | 14.03% | 1.15% | 650 |
| N69 | 0 | 2.4 | 0 | 0 | BAL | 1.16 | 0.74 | 4 | 0 | 0.76 | 3 | 0 | 0 | 6.35% | 10.92% | 1.43% | 550 |
| N70 | 0 | 2.4 | 0 | 0 | BAL | 1.16 | 0.74 | 4 | 0 | 0.76 | 4 | 0 | 0 | 5.26% | 13.06% | 1.23% | 600 |
| N71 | 0 | 2.4 | 0 | 0 | BAL | 1.16 | 0.74 | 4 | 0 | 0.76 | 5 | 0 | 0 | 2.42% | 15.19% | 1.08% | 650 |
| N72 | 0 | 2.4 | 0 | 0 | BAL | 1.16 | 0.74 | 5 | 0 | 0.76 | 3 | 0 | 0 | 5.81% | 12.08% | 1.32% | 550 |
| N73 | 0 | 2.4 | 0 | 0 | BAL | 1.16 | 0.74 | 5 | 0 | 0.76 | 4 | 0 | 0 | 4.72% | 14.22% | 1.11% | 600 |
| N74 | 0 | 2.4 | 0 | 0 | BAL | 1.16 | 0.74 | 5 | 0 | 0.76 | 5 | 0 | 0 | 3.64% | 16.36% | 0.97% | 650 |
| N75 | 0 | 2.6 | 0 | 0 | BAL | 1.16 | 0.74 | 2 | 0 | 0.76 | 5 | 0 | 0 | 6.06% | 12.79% | 1.47% | 650 |
| N76 | 0 | 2.6 | 0 | 0 | BAL | 1.16 | 0.74 | 3 | 0 | 0.76 | 5 | 0 | 0 | 5.53% | 13.94% | 1.35% | 650 |
| N77 | 0 | 2.6 | 0 | 0 | BAL | 1.16 | 0.74 | 4 | 0 | 0.76 | 4 | 0 | 0 | 6.08% | 12.97% | 1.43% | 600 |
| N78 | 0 | 2.6 | 0 | 0 | BAL | 1.16 | 0.74 | 4 | 0 | 0.76 | 5 | 0 | 0 | 5.00% | 15.09% | 1.22% | 600 |
| N79 | 0 | 2.6 | 0 | 0 | BAL | 1.16 | 0.74 | 5 | 0 | 0.76 | 4 | 0 | 0 | 5.55% | 14.12% | 1.31% | 600 |
| N80 | 0 | 2.6 | 0 | 0 | BAL | 1.16 | 0.74 | 5 | 0 | 0.76 | 5 | 0 | 0 | 3.85% | 16.25% | 1.10% | 0 |
| N81 | 0.2 | 1.8 | 0 | 0 | BAL | 1.16 | 0.74 | 0 | 0 | 0.76 | 3 | 0 | 0 | 7.59% | 6.46% | 1.39% | 400 |
| N82 | 0.2 | 1.8 | 0 | 0 | BAL | 1.16 | 0.74 | 0 | 0 | 0.76 | 4 | 0 | 0 | 6.51% | 8.60% | 1.19% | 450 |
| N83 | 0.2 | 1.8 | 0 | 0 | BAL | 1.16 | 0.74 | 0 | 0 | 0.76 | 5 | 0 | 0 | 5.42% | 10.73% | 0.99% | 450 |
| N84 | 0.2 | 1.8 | 0 | 0 | BAL | 1.16 | 0.74 | 1 | 0 | 0.76 | 2 | 0 | 0 | 8.16% | 5.44% | 1.42% | 350 |
| N85 | 0.2 | 1.8 | 0 | 0 | BAL | 1.16 | 0.74 | 1 | 0 | 0.76 | 3 | 0 | 0 | 7.07% | 7.60% | 1.24% | 350 |
| N86 | 0.2 | 1.8 | 0 | 0 | BAL | 1.16 | 0.74 | 1 | 0 | 0.76 | 4 | 0 | 0 | 5.98% | 9.74% | 1.05% | 400 |
| N87 | 0.2 | 1.8 | 0 | 0 | BAL | 1.16 | 0.74 | 1 | 0 | 0.76 | 5 | 0 | 0 | 4.89% | 11.88% | 0.86% | 400 |
| N88 | 0.2 | 1.8 | 0 | 0 | BAL | 1.16 | 0.74 | 2 | 0 | 0.76 | 1 | 0 | 0 | 8.73% | 4.42% | 1.48% | 300 |
| N89 | 0.2 | 1.8 | 0 | 0 | BAL | 1.16 | 0.74 | 2 | 0 | 0.76 | 2 | 0 | 0 | 7.63% | 6.58% | 1.29% | 300 |
| N90 | 0.2 | 1.8 | 0 | 0 | BAL | 1.16 | 0.74 | 2 | 0 | 0.76 | 3 | 0 | 0 | 6.53% | 8.74% | 1.10% | 350 |
| N91 | 0.2 | 1.8 | 0 | 0 | BAL | 1.16 | 0.74 | 2 | 0 | 0.76 | 4 | 0 | 0 | 5.44% | 10.89% | 0.92% | 350 |
| N92 | 0.2 | 1.8 | 0 | 0 | BAL | 1.16 | 0.74 | 2 | 0 | 0.76 | 5 | 0 | 0 | 4.35% | 13.04% | 0.76% | 450 |
| N93 | 0.2 | 1.8 | 0 | 0 | BAL | 1.16 | 0.74 | 3 | 0 | 0.76 | 1 | 0 | 0 | 8.20% | 5.56% | 1.37% | 250 |
| N94 | 0.2 | 1.8 | 0 | 0 | BAL | 1.16 | 0.74 | 3 | 0 | 0.76 | 2 | 0 | 0 | 7.10% | 7.73% | 1.17% | 300 |
| N95 | 0.2 | 1.8 | 0 | 0 | BAL | 1.16 | 0.74 | 3 | 0 | 0.76 | 3 | 0 | 0 | 6.00% | 9.90% | 0.98% | 300 |
| N96 | 0.2 | 1.8 | 0 | 0 | BAL | 1.16 | 0.74 | 3 | 0 | 0.76 | 4 | 0 | 0 | 4.90% | 12.05% | 0.80% | 400 |
| N97 | 0.2 | 1.8 | 0 | 0 | BAL | 1.16 | 0.74 | 4 | 0 | 0.76 | 0 | 0 | 0 | 8.80% | 4.51% | 1.46% | 300 |
| N98 | 0.2 | 1.8 | 0 | 0 | BAL | 1.16 | 0.74 | 4 | 0 | 0.76 | 1 | 0 | 0 | 7.67% | 6.71% | 1.26% | 250 |
| N99 | 0.2 | 1.8 | 0 | 0 | BAL | 1.16 | 0.74 | 4 | 0 | 0.76 | 2 | 0 | 0 | 6.56% | 8.89% | 1.06% | 250 |
| N100 | 0.2 | 1.8 | 0 | 0 | BAL | 1.16 | 0.74 | 4 | 0 | 0.76 | 3 | 0 | 0 | 5.46% | 11.06% | 0.87% | 300 |
| N101 | 0.2 | 1.8 | 0 | 0 | BAL | 1.16 | 0.74 | 4 | 0 | 0.76 | 4 | 0 | 0 | 4.36% | 13.22% | 0.73% | 400 |
| N102 | 0.2 | 1.8 | 0 | 0 | BAL | 1.16 | 0.74 | 5 | 0 | 0.76 | 0 | 0 | 0 | 8.27% | 5.65% | 1.38% | 250 |
| N103 | 0.2 | 1.8 | 0 | 0 | BAL | 1.16 | 0.74 | 5 | 0 | 0.76 | 1 | 0 | 0 | 7.13% | 7.87% | 1.15% | 250 |
| N104 | 0.2 | 1.8 | 0 | 0 | BAL | 1.16 | 0.74 | 5 | 0 | 0.76 | 2 | 0 | 0 | 6.02% | 10.05% | 0.95% | 250 |
| N105 | 0.2 | 1.8 | 0 | 0 | BAL | 1.16 | 0.74 | 5 | 0 | 0.76 | 3 | 0 | 0 | 4.91% | 12.23% | 0.77% | 350 |
| N106 | 0.2 | 2 | 0 | 0 | BAL | 1.16 | 0.74 | 0 | 0 | 0.76 | 4 | 0 | 0 | 7.31% | 8.54% | 1.37% | 450 |
| N107 | 0.2 | 2 | 0 | 0 | BAL | 1.16 | 0.74 | 0 | 0 | 0.76 | 5 | 0 | 0 | 6.24% | 10.66% | 1.17% | 450 |
| N108 | 0.2 | 2 | 0 | 0 | BAL | 1.16 | 0.74 | 1 | 0 | 0.76 | 3 | 0 | 0 | 7.87% | 7.55% | 1.43% | 350 |
| N109 | 0.2 | 2 | 0 | 0 | BAL | 1.16 | 0.74 | 1 | 0 | 0.76 | 4 | 0 | 0 | 6.79% | 9.68% | 1.24% | 400 |
| N110 | 0.2 | 2 | 0 | 0 | BAL | 1.16 | 0.74 | 1 | 0 | 0.76 | 5 | 0 | 0 | 5.71% | 11.80% | 1.04% | 400 |
| N111 | 0.2 | 2 | 0 | 0 | BAL | 1.16 | 0.74 | 2 | 0 | 0.76 | 2 | 0 | 0 | 8.44% | 6.54% | 1.49% | 300 |
| N112 | 0.2 | 2 | 0 | 0 | BAL | 1.16 | 0.74 | 2 | 0 | 0.76 | 3 | 0 | 0 | 7.35% | 8.68% | 1.30% | 350 |
| N113 | 0.2 | 2 | 0 | 0 | BAL | 1.16 | 0.74 | 2 | 0 | 0.76 | 4 | 0 | 0 | 6.26% | 10.82% | 1.10% | 350 |
| N114 | 0.2 | 2 | 0 | 0 | BAL | 1.16 | 0.74 | 2 | 0 | 0.76 | 5 | 0 | 0 | 5.18% | 12.95% | 0.92% | 400 |
| N115 | 0.2 | 2 | 0 | 0 | BAL | 1.16 | 0.74 | 3 | 0 | 0.76 | 2 | 0 | 0 | 7.91% | 7.68% | 1.36% | 300 |
| N116 | 0.2 | 2 | 0 | 0 | BAL | 1.16 | 0.74 | 3 | 0 | 0.76 | 3 | 0 | 0 | 6.82% | 9.83% | 1.17% | 300 |
| N117 | 0.2 | 2 | 0 | 0 | BAL | 1.16 | 0.74 | 3 | 0 | 0.76 | 4 | 0 | 0 | 5.73% | 11.97% | 0.98% | 350 |
| N118 | 0.2 | 2 | 0 | 0 | BAL | 1.16 | 0.74 | 3 | 0 | 0.76 | 5 | 0 | 0 | 4.64% | 14.11% | 0.80% | 350 |
| N119 | 0.2 | 2 | 0 | 0 | BAL | 1.16 | 0.74 | 4 | 0 | 0.76 | 1 | 0 | 0 | 8.48% | 6.66% | 1.45% | 300 |
| N120 | 0.2 | 2 | 0 | 0 | BAL | 1.16 | 0.74 | 4 | 0 | 0.76 | 2 | 0 | 0 | 7.38% | 8.83% | 1.25% | 250 |
| N121 | 0.2 | 2 | 0 | 0 | BAL | 1.16 | 0.74 | 4 | 0 | 0.76 | 3 | 0 | 0 | 6.28% | 10.98% | 1.05% | 300 |
| N122 | 0.2 | 2 | 0 | 0 | BAL | 1.16 | 0.74 | 4 | 0 | 0.76 | 4 | 0 | 0 | 5.19% | 13.13% | 0.86% | 350 |
| N123 | 0.2 | 2 | 0 | 0 | BAL | 1.16 | 0.74 | 4 | 0 | 0.76 | 5 | 0 | 0 | 4.10% | 15.28% | 0.72% | 400 |
| N124 | 0.2 | 2 | 0 | 0 | BAL | 1.16 | 0.74 | 5 | 0 | 0.76 | 1 | 0 | 0 | 7.95% | 7.81% | 1.34% | 250 |
| N125 | 0.2 | 2 | 0 | 0 | BAL | 1.16 | 0.74 | 5 | 0 | 0.76 | 2 | 0 | 0 | 6.85% | 9.98% | 1.14% | 250 |
| N126 | 0.2 | 2 | 0 | 0 | BAL | 1.16 | 0.74 | 5 | 0 | 0.76 | 3 | 0 | 0 | 5.75% | 12.15% | 0.94% | 300 |
| N127 | 0.2 | 2 | 0 | 0 | BAL | 1.16 | 0.74 | 5 | 0 | 0.76 | 4 | 0 | 0 | 4.65% | 14.30% | 0.76% | 350 |
| N128 | 0.2 | 2.2 | 0 | 0 | BAL | 1.16 | 0.74 | 0 | 0 | 0.76 | 5 | 0 | 0 | 7.04% | 10.59% | 1.36% | 450 |
| N129 | 0.2 | 2.2 | 0 | 0 | BAL | 1.16 | 0.74 | 1 | 0 | 0.76 | 4 | 0 | 0 | 7.59% | 9.61% | 1.43% | 400 |
| N130 | 0.2 | 2.2 | 0 | 0 | BAL | 1.16 | 0.74 | 1 | 0 | 0.76 | 5 | 0 | 0 | 6.52% | 11.72% | 1.23% | 400 |
| N131 | 0 | 1 | 18 | 0 | BAL | 10 | 0 | 4 | 0 | 0 | 0 | 0 | 2 | 1.28% | 5.03% | 0.89% | 100 |
| N132 | 0 | 1 | 18 | 0 | BAL | 10 | 0 | 4 | 0 | 0 | 0 | 0 | 4 | 2.61% | 5.08% | 0.89% | 100 |
| N133 | 0 | 1 | 18 | 0 | BAL | 10 | 0 | 4 | 0 | 0 | 0 | 2 | 0 | 6.57% | 4.03% | 0.93% | 150 |
| N134 | 0 | 1 | 18 | 0 | BAL | 10 | 0 | 4 | 0 | 0 | 0 | 2 | 2 | 1.38% | 4.78% | 0.94% | 150 |
| N135 | 0 | 1 | 18 | 0 | BAL | 10 | 0 | 4 | 0 | 0 | 0 | 2 | 4 | 2.87% | 4.84% | 0.94% | 100 |
| N136 | 0 | 1 | 18 | 0 | BAL | 10 | 0 | 4 | 0 | 0 | 0 | 4 | 0 | 6.63% | 4.38% | 0.99% | 150 |
| N137 | 0 | 1 | 18 | 0 | BAL | 10 | 0 | 4 | 0 | 0 | 0 | 4 | 4 | 4.20% | 2.02% | 1.00% | 150 |
| N138 | 0 | 1 | 18 | 0 | BAL | 10 | 0 | 4 | 0 | 0 | 0 | 6 | 0 | 0.00% | 4.08% | 1.00% | 150 |
| N139 | 0 | 1 | 18 | 0 | BAL | 10 | 0 | 4 | 0 | 0 | 0 | 6 | 2 | 2.07% | 4.02% | 1.00% | 150 |
| N140 | 0 | 1 | 18 | 0 | BAL | 10 | 0 | 4 | 0 | 0 | 0 | 6 | 4 | 4.20% | 3.96% | 1.00% | 150 |
| N141 | 0.5 | 1 | 18 | 0 | BAL | 10 | 0 | 4 | 0 | 0 | 0 | 0 | 0 | 0.00% | 12.44% | 0.85% | 150 |
| N142 | 0.5 | 1 | 18 | 0 | BAL | 10 | 0 | 4 | 0 | 0 | 0 | 0 | 2 | 1.45% | 10.81% | 0.85% | 100 |
| N143 | 0.5 | 1 | 18 | 0 | BAL | 10 | 0 | 4 | 0 | 0 | 0 | 0 | 4 | 2.95% | 9.14% | 0.85% | 100 |
| N144 | 0.5 | 1 | 18 | 0 | BAL | 10 | 0 | 4 | 0 | 0 | 0 | 2 | 0 | 5.84% | 11.36% | 0.86% | 150 |
| N145 | 0.5 | 1 | 18 | 0 | BAL | 10 | 0 | 4 | 0 | 0 | 0 | 2 | 2 | 1.45% | 4.86% | 0.82% | 150 |
| N146 | 0.5 | 1 | 18 | 0 | BAL | 10 | 0 | 4 | 0 | 0 | 0 | 2 | 4 | 2.95% | 4.87% | 0.82% | 100 |
| N147 | 0.5 | 1 | 18 | 0 | BAL | 10 | 0 | 4 | 0 | 0 | 0 | 4 | 0 | 4.29% | 9.24% | 0.85% | 150 |
| N148 | 0.5 | 1 | 18 | 0 | BAL | 10 | 0 | 4 | 0 | 0 | 0 | 4 | 2 | 2.03% | 4.35% | 0.85% | 100 |
| N149 | 0.5 | 1 | 18 | 0 | BAL | 10 | 0 | 4 | 0 | 0 | 0 | 4 | 4 | 4.12% | 4.40% | 0.85% | 100 |
| N150 | 1 | 1 | 18 | 0 | BAL | 10 | 0 | 4 | 0 | 0 | 0 | 0 | 2 | 1.43% | 18.07% | 1.00% | 100 |
| N151 | 1 | 1 | 18 | 0 | BAL | 10 | 0 | 4 | 0 | 0 | 0 | 0 | 4 | 2.89% | 16.54% | 1.00% | 100 |
| N152 | 1 | 1 | 18 | 0 | BAL | 10 | 0 | 4 | 0 | 0 | 0 | 2 | 0 | 4.04% | 19.36% | 1.00% | 150 |
| N153 | 1 | 1 | 18 | 0 | BAL | 10 | 0 | 4 | 0 | 0 | 0 | 2 | 2 | 6.42% | 16.92% | 1.00% | 100 |
| N154 | 1 | 1 | 18 | 0 | BAL | 10 | 0 | 4 | 0 | 0 | 0 | 2 | 4 | 7.90% | 15.39% | 1.00% | 100 |
| N155 | 1 | 1 | 18 | 0 | BAL | 10 | 0 | 4 | 0 | 0 | 0 | 4 | 0 | 4.21% | 16.23% | 1.00% | 150 |
| N156 | 1 | 1 | 18 | 0 | BAL | 10 | 0 | 4 | 0 | 0 | 0 | 6 | 0 | 0.00% | 18.25% | 1.00% | 550 |
| N157 | 1 | 1 | 18 | 0 | BAL | 10 | 0 | 4 | 0 | 0 | 2 | 4 | 0 | 7.31% | 6.00% | 1.01% | 300 |
| N158 | 1 | 1 | 18 | 0 | BAL | 10 | 0 | 4 | 0 | 0 | 2 | 4 | 2 | 9.31% | 6.01% | 1.01% | 300 |
| N159 | 1 | 1 | 18 | 0 | BAL | 10 | 0 | 4 | 0 | 0 | 2 | 6 | 0 | 6.23% | 4.66% | 1.00% | 350 |
| N160 | 1 | 1 | 18 | 0 | BAL | 10 | 0 | 4 | 0 | 0 | 2 | 6 | 2 | 8.36% | 4.51% | 1.00% | 350 |
| N161 | 0.2 | 2.2 | 0 | 0 | BAL | 1.16 | 0.74 | 2 | 0 | 0.76 | 3 | 0 | 0 | 8.15% | 8.62% | 1.49% | 350 |
| N162 | 0.2 | 2.2 | 0 | 0 | BAL | 1.16 | 0.74 | 2 | 0 | 0.76 | 4 | 0 | 0 | 7.07% | 10.75% | 1.30% | 350 |
| N163 | 0.2 | 2.2 | 0 | 0 | BAL | 1.16 | 0.74 | 2 | 0 | 0.76 | 5 | 0 | 0 | 5.99% | 12.87% | 1.10% | 400 |
| N164 | 0.2 | 2.2 | 0 | 0 | BAL | 1.16 | 0.74 | 3 | 0 | 0.76 | 3 | 0 | 0 | 7.63% | 9.76% | 1.36% | 300 |
| N165 | 0.2 | 2.2 | 0 | 0 | BAL | 1.16 | 0.74 | 3 | 0 | 0.76 | 4 | 0 | 0 | 6.54% | 11.89% | 1.17% | 350 |
| N166 | 0.2 | 2.2 | 0 | 0 | BAL | 1.16 | 0.74 | 3 | 0 | 0.76 | 5 | 0 | 0 | 5.46% | 14.02% | 0.98% | 350 |
| N167 | 0.2 | 2.2 | 0 | 0 | BAL | 1.16 | 0.74 | 4 | 0 | 0.76 | 2 | 0 | 0 | 8.19% | 8.77% | 1.44% | 300 |
| N168 | 0.2 | 2.2 | 0 | 0 | BAL | 1.16 | 0.74 | 4 | 0 | 0.76 | 3 | 0 | 0 | 7.10% | 10.91% | 1.24% | 300 |
| N169 | 0.2 | 2.2 | 0 | 0 | BAL | 1.16 | 0.74 | 4 | 0 | 0.76 | 4 | 0 | 0 | 6.01% | 13.05% | 1.05% | 350 |
| N170 | 0.2 | 2.2 | 0 | 0 | BAL | 1.16 | 0.74 | 4 | 0 | 0.76 | 5 | 0 | 0 | 4.93% | 15.17% | 0.86% | 350 |
| N171 | 0.2 | 2.2 | 0 | 0 | BAL | 1.16 | 0.74 | 5 | 0 | 0.76 | 2 | 0 | 0 | 7.66% | 9.92% | 1.33% | 250 |
| N172 | 0.2 | 2.2 | 0 | 0 | BAL | 1.16 | 0.74 | 5 | 0 | 0.76 | 3 | 0 | 0 | 6.57% | 12.07% | 1.13% | 300 |
| N173 | 0.2 | 2.2 | 0 | 0 | BAL | 1.16 | 0.74 | 5 | 0 | 0.76 | 4 | 0 | 0 | 5.48% | 14.21% | 0.93% | 300 |
| N174 | 0.2 | 2.2 | 0 | 0 | BAL | 1.16 | 0.74 | 5 | 0 | 0.76 | 5 | 0 | 0 | 4.39% | 16.34% | 0.76% | 400 |
| N175 | 0.2 | 2.4 | 0 | 0 | BAL | 1.16 | 0.74 | 1 | 0 | 0.76 | 5 | 0 | 0 | 7.32% | 11.65% | 1.42% | 400 |
| N176 | 0.2 | 2.4 | 0 | 0 | BAL | 1.16 | 0.74 | 2 | 0 | 0.76 | 4 | 0 | 0 | 7.87% | 10.68% | 1.49% | 350 |
| N177 | 0.2 | 2.4 | 0 | 0 | BAL | 1.16 | 0.74 | 2 | 0 | 0.76 | 5 | 0 | 0 | 6.80% | 12.78% | 1.29% | 400 |
| N178 | 0.2 | 2.4 | 0 | 0 | BAL | 1.16 | 0.74 | 3 | 0 | 0.76 | 4 | 0 | 0 | 7.35% | 11.81% | 1.36% | 350 |
| N179 | 0.2 | 2.4 | 0 | 0 | BAL | 1.16 | 0.74 | 3 | 0 | 0.76 | 5 | 0 | 0 | 6.28% | 13.92% | 1.17% | 350 |
| N180 | 0.2 | 2.4 | 0 | 0 | BAL | 1.16 | 0.74 | 4 | 0 | 0.76 | 3 | 0 | 0 | 7.91% | 10.84% | 1.44% | 300 |
| N181 | 0.2 | 2.4 | 0 | 0 | BAL | 1.16 | 0.74 | 4 | 0 | 0.76 | 4 | 0 | 0 | 6.83% | 12.96% | 1.24% | 350 |
| N182 | 0.2 | 2.4 | 0 | 0 | BAL | 1.16 | 0.74 | 4 | 0 | 0.76 | 5 | 0 | 0 | 5.75% | 15.07% | 1.04% | 350 |
| N183 | 0.2 | 2.4 | 0 | 0 | BAL | 1.16 | 0.74 | 5 | 0 | 0.76 | 2 | 0 | 0 | 8.47% | 9.85% | 1.50% | 250 |
| N184 | 0.2 | 2.4 | 0 | 0 | BAL | 1.16 | 0.74 | 5 | 0 | 0.76 | 3 | 0 | 0 | 7.38% | 11.98% | 1.32% | 300 |
| N185 | 0.2 | 2.4 | 0 | 0 | BAL | 1.16 | 0.74 | 5 | 0 | 0.76 | 4 | 0 | 0 | 6.30% | 14.11% | 1.12% | 300 |
| N186 | 0.2 | 2.4 | 0 | 0 | BAL | 1.16 | 0.74 | 5 | 0 | 0.76 | 5 | 0 | 0 | 5.22% | 16.23% | 0.92% | 350 |
| N187 | 0.2 | 2.6 | 0 | 0 | BAL | 1.16 | 0.74 | 2 | 0 | 0.76 | 5 | 0 | 0 | 7.59% | 12.70% | 1.48% | 400 |
| N188 | 0.2 | 2.6 | 0 | 0 | BAL | 1.16 | 0.74 | 3 | 0 | 0.76 | 5 | 0 | 0 | 7.08% | 13.83% | 1.36% | 400 |
| N189 | 0.2 | 2.6 | 0 | 0 | BAL | 1.16 | 0.74 | 4 | 0 | 0.76 | 4 | 0 | 0 | 7.63% | 12.87% | 1.44% | 350 |
| N190 | 0.2 | 2.6 | 0 | 0 | BAL | 1.16 | 0.74 | 4 | 0 | 0.76 | 5 | 0 | 0 | 6.56% | 14.97% | 1.24% | 350 |
| N191 | 0.2 | 2.6 | 0 | 0 | BAL | 1.16 | 0.74 | 5 | 0 | 0.76 | 3 | 0 | 0 | 8.18% | 11.90% | 1.49% | 250 |
| N192 | 0.2 | 2.6 | 0 | 0 | BAL | 1.16 | 0.74 | 5 | 0 | 0.76 | 4 | 0 | 0 | 7.11% | 14.02% | 1.32% | 300 |
| N193 | 0.2 | 2.6 | 0 | 0 | BAL | 1.16 | 0.74 | 5 | 0 | 0.76 | 5 | 0 | 0 | 6.03% | 16.12% | 1.12% | 350 |
| N194 | 0.4 | 1.8 | 0 | 0 | BAL | 1.16 | 0.74 | 0 | 0 | 0.76 | 3 | 0 | 0 | 9.94% | 6.41% | 1.36% | 500 |
| N195 | 0.4 | 1.8 | 0 | 0 | BAL | 1.16 | 0.74 | 0 | 0 | 0.76 | 4 | 0 | 0 | 8.86% | 8.53% | 1.24% | 550 |
| N196 | 0.4 | 1.8 | 0 | 0 | BAL | 1.16 | 0.74 | 0 | 0 | 0.76 | 5 | 0 | 0 | 7.78% | 10.65% | 1.05% | 600 |
| N197 | 0.4 | 1.8 | 0 | 0 | BAL | 1.16 | 0.74 | 1 | 0 | 0.76 | 3 | 0 | 0 | 9.43% | 7.54% | 1.26% | 400 |
| N198 | 0.4 | 1.8 | 0 | 0 | BAL | 1.16 | 0.74 | 1 | 0 | 0.76 | 4 | 0 | 0 | 8.34% | 9.67% | 1.09% | 550 |
| N199 | 0.4 | 1.8 | 0 | 0 | BAL | 1.16 | 0.74 | 1 | 0 | 0.76 | 5 | 0 | 0 | 7.26% | 11.79% | 0.92% | 550 |
| N200 | 0.4 | 1.8 | 0 | 0 | BAL | 1.16 | 0.74 | 2 | 0 | 0.76 | 3 | 0 | 0 | 8.91% | 8.67% | 1.13% | 350 |
| N201 | 0.4 | 1.8 | 0 | 0 | BAL | 1.16 | 0.74 | 2 | 0 | 0.76 | 4 | 0 | 0 | 7.82% | 10.81% | 0.96% | 500 |
| N202 | 0.4 | 1.8 | 0 | 0 | BAL | 1.16 | 0.74 | 2 | 0 | 0.76 | 5 | 0 | 0 | 6.74% | 12.94% | 0.80% | 550 |
| N203 | 0.4 | 1.8 | 0 | 0 | BAL | 1.16 | 0.74 | 3 | 0 | 0.76 | 2 | 0 | 0 | 9.48% | 7.67% | 1.18% | 250 |
| N204 | 0.4 | 1.8 | 0 | 0 | BAL | 1.16 | 0.74 | 3 | 0 | 0.76 | 3 | 0 | 0 | 8.38% | 9.82% | 1.00% | 350 |
| N205 | 0.4 | 1.8 | 0 | 0 | BAL | 1.16 | 0.74 | 3 | 0 | 0.76 | 4 | 0 | 0 | 7.29% | 11.96% | 0.84% | 500 |
| N206 | 0.4 | 1.8 | 0 | 0 | BAL | 1.16 | 0.74 | 4 | 0 | 0.76 | 2 | 0 | 0 | 8.95% | 8.82% | 1.06% | 250 |
| N207 | 0.4 | 1.8 | 0 | 0 | BAL | 1.16 | 0.74 | 4 | 0 | 0.76 | 3 | 0 | 0 | 7.86% | 10.97% | 0.88% | 350 |
| N208 | 0.4 | 1.8 | 0 | 0 | BAL | 1.16 | 0.74 | 4 | 0 | 0.76 | 4 | 0 | 0 | 6.76% | 13.12% | 0.73% | 450 |
| N209 | 0.4 | 1.8 | 0 | 0 | BAL | 1.16 | 0.74 | 5 | 0 | 0.76 | 1 | 0 | 0 | 9.53% | 7.81% | 1.15% | 250 |
| N210 | 0.4 | 1.8 | 0 | 0 | BAL | 1.16 | 0.74 | 5 | 0 | 0.76 | 2 | 0 | 0 | 8.43% | 9.97% | 0.95% | 250 |
| N211 | 0.4 | 1.8 | 0 | 0 | BAL | 1.16 | 0.74 | 5 | 0 | 0.76 | 3 | 0 | 0 | 7.33% | 12.14% | 0.77% | 300 |
| N212 | 0.4 | 2 | 0 | 0 | BAL | 1.16 | 0.74 | 0 | 0 | 0.76 | 4 | 0 | 0 | 9.65% | 8.48% | 1.36% | 500 |
| N213 | 0.4 | 2 | 0 | 0 | BAL | 1.16 | 0.74 | 0 | 0 | 0.76 | 5 | 0 | 0 | 8.58% | 10.58% | 1.23% | 600 |
| N214 | 0.4 | 2 | 0 | 0 | BAL | 1.16 | 0.74 | 1 | 0 | 0.76 | 4 | 0 | 0 | 9.14% | 9.60% | 1.27% | 500 |
| N215 | 0.4 | 2 | 0 | 0 | BAL | 1.16 | 0.74 | 1 | 0 | 0.76 | 5 | 0 | 0 | 8.06% | 11.71% | 1.09% | 550 |
| N216 | 0.4 | 2 | 0 | 0 | BAL | 1.16 | 0.74 | 2 | 0 | 0.76 | 3 | 0 | 0 | 9.70% | 8.62% | 1.27% | 300 |
| N217 | 0.4 | 2 | 0 | 0 | BAL | 1.16 | 0.74 | 2 | 0 | 0.76 | 4 | 0 | 0 | 8.62% | 10.74% | 1.14% | 450 |
| N218 | 0.4 | 2 | 0 | 0 | BAL | 1.16 | 0.74 | 2 | 0 | 0.76 | 5 | 0 | 0 | 7.54% | 12.85% | 0.97% | 500 |
| N219 | 0.4 | 2 | 0 | 0 | BAL | 1.16 | 0.74 | 3 | 0 | 0.76 | 3 | 0 | 0 | 9.18% | 9.75% | 1.18% | 300 |
| N220 | 0.4 | 2 | 0 | 0 | BAL | 1.16 | 0.74 | 3 | 0 | 0.76 | 4 | 0 | 0 | 8.10% | 11.88% | 1.01% | 450 |
| N221 | 0.4 | 2 | 0 | 0 | BAL | 1.16 | 0.74 | 3 | 0 | 0.76 | 5 | 0 | 0 | 7.02% | 14.00% | 0.85% | 500 |
| N222 | 0.4 | 2 | 0 | 0 | BAL | 1.16 | 0.74 | 4 | 0 | 0.76 | 2 | 0 | 0 | 9.75% | 8.76% | 1.23% | 250 |
| N223 | 0.4 | 2 | 0 | 0 | BAL | 1.16 | 0.74 | 4 | 0 | 0.76 | 3 | 0 | 0 | 8.66% | 10.90% | 1.06% | 300 |
| N224 | 0.4 | 2 | 0 | 0 | BAL | 1.16 | 0.74 | 4 | 0 | 0.76 | 4 | 0 | 0 | 7.57% | 13.03% | 0.89% | 400 |
| N225 | 0.4 | 2 | 0 | 0 | BAL | 1.16 | 0.74 | 4 | 0 | 0.76 | 5 | 0 | 0 | 6.49% | 15.16% | 0.73% | 550 |
| N226 | 0.4 | 2 | 0 | 0 | BAL | 1.16 | 0.74 | 5 | 0 | 0.76 | 2 | 0 | 0 | 9.23% | 9.91% | 1.14% | 250 |
| N227 | 0.4 | 2 | 0 | 0 | BAL | 1.16 | 0.74 | 5 | 0 | 0.76 | 3 | 0 | 0 | 8.14% | 12.05% | 0.95% | 250 |
| N228 | 0.4 | 2 | 0 | 0 | BAL | 1.16 | 0.74 | 5 | 0 | 0.76 | 4 | 0 | 0 | 7.05% | 14.19% | 0.78% | 450 |
| N229 | 0.4 | 2.2 | 0 | 0 | BAL | 1.16 | 0.74 | 0 | 0 | 0.76 | 5 | 0 | 0 | 9.36% | 10.51% | 1.36% | 500 |
| N230 | 0.4 | 2.2 | 0 | 0 | BAL | 1.16 | 0.74 | 1 | 0 | 0.76 | 4 | 0 | 0 | 9.92% | 9.54% | 1.40% | 400 |
| N231 | 0.4 | 2.2 | 0 | 0 | BAL | 1.16 | 0.74 | 1 | 0 | 0.76 | 5 | 0 | 0 | 8.85% | 11.63% | 1.27% | 500 |
| N232 | 0.4 | 2.2 | 0 | 0 | BAL | 1.16 | 0.74 | 2 | 0 | 0.76 | 4 | 0 | 0 | 9.41% | 10.67% | 1.29% | 400 |
| N233 | 0.4 | 2.2 | 0 | 0 | BAL | 1.16 | 0.74 | 2 | 0 | 0.76 | 5 | 0 | 0 | 8.33% | 12.77% | 1.14% | 500 |
| N234 | 0.4 | 2.2 | 0 | 0 | BAL | 1.16 | 0.74 | 3 | 0 | 0.76 | 3 | 0 | 0 | 9.97% | 9.69% | 1.33% | 250 |
| N235 | 0.4 | 2.2 | 0 | 0 | BAL | 1.16 | 0.74 | 3 | 0 | 0.76 | 4 | 0 | 0 | 8.89% | 11.80% | 1.19% | 400 |
| N236 | 0.4 | 2.2 | 0 | 0 | BAL | 1.16 | 0.74 | 3 | 0 | 0.76 | 5 | 0 | 0 | 7.82% | 13.91% | 1.02% | 500 |
| N237 | 0.4 | 2.2 | 0 | 0 | BAL | 1.16 | 0.74 | 4 | 0 | 0.76 | 3 | 0 | 0 | 9.46% | 10.83% | 1.23% | 300 |
| N238 | 0.4 | 2.2 | 0 | 0 | BAL | 1.16 | 0.74 | 4 | 0 | 0.76 | 4 | 0 | 0 | 8.37% | 12.95% | 1.07% | 350 |
| N239 | 0.4 | 2.2 | 0 | 0 | BAL | 1.16 | 0.74 | 4 | 0 | 0.76 | 5 | 0 | 0 | 7.30% | 15.06% | 0.90% | 500 |
| N240 | 0.4 | 2.2 | 0 | 0 | BAL | 1.16 | 0.74 | 5 | 0 | 0.76 | 3 | 0 | 0 | 8.94% | 11.97% | 1.14% | 250 |
| N241 | 0.4 | 2.2 | 0 | 0 | BAL | 1.16 | 0.74 | 5 | 0 | 0.76 | 4 | 0 | 0 | 7.85% | 14.10% | 0.95% | 350 |
| N242 | 0.4 | 2.2 | 0 | 0 | BAL | 1.16 | 0.74 | 5 | 0 | 0.76 | 5 | 0 | 0 | 6.77% | 16.22% | 0.79% | 500 |
| N243 | 0.4 | 2.4 | 0 | 0 | BAL | 1.16 | 0.74 | 1 | 0 | 0.76 | 5 | 0 | 0 | 9.62% | 11.56% | 1.40% | 450 |
| N244 | 0.4 | 2.4 | 0 | 0 | BAL | 1.16 | 0.74 | 2 | 0 | 0.76 | 5 | 0 | 0 | 9.12% | 12.68% | 1.30% | 500 |
| N245 | 0.4 | 2.4 | 0 | 0 | BAL | 1.16 | 0.74 | 3 | 0 | 0.76 | 4 | 0 | 0 | 9.68% | 11.72% | 1.33% | 300 |
| N246 | 0.4 | 2.4 | 0 | 0 | BAL | 1.16 | 0.74 | 3 | 0 | 0.76 | 5 | 0 | 0 | 8.61% | 13.82% | 1.19% | 450 |
| N247 | 0.4 | 2.4 | 0 | 0 | BAL | 1.16 | 0.74 | 4 | 0 | 0.76 | 4 | 0 | 0 | 9.17% | 12.86% | 1.22% | 300 |
| N248 | 0.4 | 2.4 | 0 | 0 | BAL | 1.16 | 0.74 | 4 | 0 | 0.76 | 5 | 0 | 0 | 8.09% | 14.96% | 1.07% | 450 |
| N249 | 0.4 | 2.4 | 0 | 0 | BAL | 1.16 | 0.74 | 5 | 0 | 0.76 | 3 | 0 | 0 | 9.73% | 11.89% | 1.29% | 250 |
| N250 | 0.4 | 2.4 | 0 | 0 | BAL | 1.16 | 0.74 | 5 | 0 | 0.76 | 4 | 0 | 0 | 8.65% | 14.00% | 1.13% | 300 |
| N251 | 0.4 | 2.4 | 0 | 0 | BAL | 1.16 | 0.74 | 5 | 0 | 0.76 | 5 | 0 | 0 | 7.57% | 16.11% | 0.96% | 450 |
| N252 | 1 | 1 | 18 | 0 | BAL | 10 | 0 | 4 | 0 | 0 | 0 | 0 | 0 | 0.00% | 19.55% | 1.00% | 200 |
| N253 | 0 | 1.5 | 18 | 0 | BAL | 10 | 0 | 4 | 0 | 0 | 0 | 0 | 2 | 1.27% | 5.19% | 1.31% | 100 |
| N254 | 0 | 1.5 | 18 | 0 | BAL | 10 | 0 | 4 | 0 | 0 | 0 | 0 | 4 | 2.60% | 5.25% | 1.32% | 100 |
| N255 | 0 | 1.5 | 18 | 0 | BAL | 10 | 0 | 4 | 0 | 0 | 0 | 2 | 2 | 1.27% | 4.10% | 1.35% | 150 |
| N256 | 0 | 1.5 | 18 | 0 | BAL | 10 | 0 | 4 | 0 | 0 | 0 | 2 | 4 | 2.59% | 4.13% | 1.35% | 100 |
| N257 | 0 | 1.5 | 18 | 0 | BAL | 10 | 0 | 4 | 0 | 0 | 0 | 4 | 0 | 8.21% | 7.95% | 1.38% | 150 |
| N258 | 0 | 1.5 | 18 | 0 | BAL | 10 | 0 | 4 | 0 | 0 | 0 | 4 | 4 | 2.66% | 7.91% | 1.37% | 150 |
| N259 | 0 | 1.5 | 18 | 0 | BAL | 10 | 0 | 4 | 0 | 0 | 0 | 6 | 0 | 9.43% | 4.30% | 1.41% | 150 |
| N260 | 0 | 1.5 | 18 | 0 | BAL | 10 | 0 | 4 | 0 | 0 | 0 | 6 | 2 | 2.03% | 4.35% | 1.38% | 150 |
| N261 | 0 | 1.5 | 18 | 0 | BAL | 10 | 0 | 4 | 0 | 0 | 0 | 6 | 4 | 4.12% | 4.42% | 1.36% | 150 |
| N262 | 0 | 1.5 | 18 | 0 | BAL | 10 | 0 | 4 | 0 | 0 | 2 | 0 | 0 | 0.00% | 8.82% | 0.85% | 200 |
| N263 | 0 | 1.5 | 18 | 0 | BAL | 10 | 0 | 4 | 0 | 0 | 2 | 2 | 4 | 2.76% | 9.01% | 0.87% | 150 |
| N264 | 0 | 1.5 | 18 | 0 | BAL | 10 | 0 | 4 | 0 | 0 | 2 | 4 | 0 | 0.00% | 2.21% | 0.88% | 200 |
| N265 | 0 | 1.5 | 18 | 0 | BAL | 10 | 0 | 4 | 0 | 0 | 2 | 4 | 2 | 2.03% | 2.24% | 0.87% | 200 |
| N266 | 0 | 1.5 | 18 | 0 | BAL | 10 | 0 | 4 | 0 | 0 | 2 | 4 | 4 | 4.12% | 2.27% | 0.88% | 200 |
| N267 | 0 | 1.5 | 18 | 0 | BAL | 10 | 0 | 4 | 0 | 0 | 2 | 6 | 0 | 0.00% | 8.44% | 0.87% | 150 |
| N268 | 0 | 1.5 | 18 | 0 | BAL | 10 | 0 | 4 | 0 | 0 | 2 | 6 | 2 | 2.03% | 8.54% | 0.87% | 150 |
| N269 | 0 | 1.5 | 18 | 0 | BAL | 10 | 0 | 4 | 0 | 0 | 2 | 6 | 4 | 4.11% | 8.64% | 0.88% | 200 |
| N270 | 0 | 2 | 18 | 0 | BAL | 10 | 0 | 4 | 0 | 0 | 2 | 0 | 0 | 0.00% | 8.70% | 1.27% | 100 |
| N271 | 0 | 2 | 18 | 0 | BAL | 10 | 0 | 4 | 0 | 0 | 2 | 2 | 0 | 0.00% | 3.99% | 1.28% | 150 |
| N272 | 0 | 2 | 18 | 0 | BAL | 10 | 0 | 4 | 0 | 0 | 2 | 2 | 2 | 1.24% | 4.02% | 1.28% | 100 |
| N273 | 0 | 2 | 18 | 0 | BAL | 10 | 0 | 4 | 0 | 0 | 2 | 2 | 4 | 2.53% | 4.05% | 1.28% | 100 |
| N274 | 0 | 2 | 18 | 0 | BAL | 10 | 0 | 4 | 0 | 0 | 2 | 4 | 4 | 2.59% | 7.78% | 1.29% | 150 |
| N275 | 0 | 2 | 18 | 0 | BAL | 10 | 0 | 4 | 0 | 0 | 4 | 0 | 0 | 0.00% | 12.93% | 0.90% | 150 |
| N276 | 0 | 2 | 18 | 0 | BAL | 10 | 0 | 4 | 0 | 0 | 4 | 2 | 0 | 0.00% | 12.87% | 0.91% | 200 |
| N277 | 0 | 2 | 18 | 0 | BAL | 10 | 0 | 4 | 0 | 0 | 4 | 2 | 2 | 1.30% | 13.03% | 0.90% | 200 |
| N278 | 0 | 2 | 18 | 0 | BAL | 10 | 0 | 4 | 0 | 0 | 4 | 4 | 0 | 0.00% | 2.80% | 0.91% | 200 |
| N279 | 0 | 2 | 18 | 0 | BAL | 10 | 0 | 4 | 0 | 0 | 4 | 4 | 2 | 1.99% | 2.83% | 0.90% | 200 |
| N280 | 0 | 2 | 18 | 0 | BAL | 10 | 0 | 4 | 0 | 0 | 4 | 4 | 4 | 4.03% | 2.87% | 0.91% | 150 |
| N281 | 0 | 2.5 | 18 | 0 | BAL | 10 | 0 | 4 | 0 | 0 | 4 | 0 | 0 | 0.00% | 12.75% | 1.33% | 100 |
| N282 | 0 | 2.5 | 18 | 0 | BAL | 10 | 0 | 4 | 0 | 0 | 4 | 2 | 0 | 0.00% | 3.91% | 1.33% | 150 |
| N283 | 0 | 2.5 | 18 | 0 | BAL | 10 | 0 | 4 | 0 | 0 | 4 | 2 | 2 | 1.22% | 3.94% | 1.32% | 100 |
| N284 | 0 | 2.5 | 18 | 0 | BAL | 10 | 0 | 4 | 0 | 0 | 4 | 2 | 4 | 2.48% | 3.96% | 1.32% | 100 |
| N285 | 0 | 2.5 | 18 | 0 | BAL | 10 | 0 | 4 | 0 | 0 | 4 | 4 | 4 | 2.54% | 7.63% | 1.33% | 150 |
| N286 | 0 | 2.5 | 18 | 0 | BAL | 10 | 0 | 4 | 0 | 0 | 4 | 6 | 0 | 0.55% | 12.44% | 1.35% | 150 |
| N287 | 0 | 2.5 | 18 | 0 | BAL | 10 | 0 | 4 | 0 | 0 | 4 | 6 | 2 | 1.95% | 12.61% | 1.34% | 150 |
| N288 | 0 | 2.5 | 18 | 0 | BAL | 10 | 0 | 4 | 0 | 0 | 4 | 6 | 4 | 3.95% | 12.82% | 1.34% | 150 |
| N289 | 0 | 2.5 | 18 | 0 | BAL | 10 | 0 | 4 | 0 | 0 | 6 | 0 | 0 | 0.00% | 16.87% | 0.92% | 150 |
| N290 | 0 | 2.5 | 18 | 0 | BAL | 10 | 0 | 4 | 0 | 0 | 6 | 2 | 2 | 1.27% | 17.02% | 0.91% | 200 |
| N291 | 0 | 2.5 | 18 | 0 | BAL | 10 | 0 | 4 | 0 | 0 | 6 | 2 | 4 | 2.61% | 17.24% | 0.91% | 150 |
| N292 | 0 | 2.5 | 18 | 0 | BAL | 10 | 0 | 4 | 0 | 0 | 6 | 4 | 0 | 0.00% | 3.42% | 0.92% | 150 |
| N293 | 0 | 2.5 | 18 | 0 | BAL | 10 | 0 | 4 | 0 | 0 | 6 | 4 | 2 | 1.95% | 3.47% | 0.92% | 200 |
| N294 | 0 | 2.5 | 18 | 0 | BAL | 10 | 0 | 4 | 0 | 0 | 6 | 4 | 4 | 3.95% | 3.51% | 0.93% | 150 |
| N295 | 0 | 3 | 18 | 0 | BAL | 10 | 0 | 4 | 0 | 0 | 6 | 0 | 0 | 0.00% | 16.64% | 1.40% | 100 |
| N296 | 0 | 3 | 18 | 0 | BAL | 10 | 0 | 4 | 0 | 0 | 6 | 2 | 4 | 2.43% | 3.86% | 1.37% | 100 |
| N297 | 0.5 | 1.5 | 18 | 0 | BAL | 10 | 0 | 4 | 0 | 0 | 0 | 0 | 0 | 0.00% | 12.38% | 1.24% | 100 |
| N298 | 0.5 | 1.5 | 18 | 0 | BAL | 10 | 0 | 4 | 0 | 0 | 0 | 0 | 2 | 1.43% | 10.80% | 1.24% | 50 |
| N299 | 0.5 | 1.5 | 18 | 0 | BAL | 10 | 0 | 4 | 0 | 0 | 0 | 0 | 4 | 2.90% | 9.18% | 1.24% | 50 |
| N300 | 0.5 | 1.5 | 18 | 0 | BAL | 10 | 0 | 4 | 0 | 0 | 0 | 2 | 0 | 4.06% | 12.24% | 1.26% | 100 |
| N301 | 0.5 | 1.5 | 18 | 0 | BAL | 10 | 0 | 4 | 0 | 0 | 0 | 2 | 2 | 5.52% | 10.64% | 1.26% | 100 |
| N302 | 0.5 | 1.5 | 18 | 0 | BAL | 10 | 0 | 4 | 0 | 0 | 0 | 2 | 4 | 7.03% | 9.00% | 1.26% | 100 |
| N303 | 0.5 | 1.5 | 18 | 0 | BAL | 10 | 0 | 4 | 0 | 0 | 0 | 4 | 0 | 7.95% | 12.00% | 1.28% | 100 |
| N304 | 0.8 | 0.95 | 0 | 0 | BAL | 0 | 1 | 2.5 | 0 | 0.5 | 2.5 | 0.5 | 0 | 9.12% | 7.15% | 0.95% | 550 |
| N305 | 0.8 | 0.95 | 0 | 0 | BAL | 0 | 1 | 3 | 0 | 0.5 | 2 | 0.5 | 0 | 9.42% | 7.19% | 0.95% | 500 |
| N306 | 0.8 | 0.95 | 1 | 0 | BAL | 0 | 1 | 2.5 | 0 | 0.5 | 2.5 | 0.5 | 0 | 9.21% | 7.20% | 0.95% | 550 |
| N307 | 0.8 | 0.95 | 1.5 | 0 | BAL | 0 | 1 | 2.5 | 0 | 0.5 | 2.5 | 0.5 | 0 | 9.21% | 7.19% | 0.95% | 550 |
| N308 | 0.8 | 0.95 | 2 | 0 | BAL | 0 | 1 | 2.5 | 0 | 0.5 | 2.5 | 0.5 | 0 | 9.20% | 7.19% | 0.95% | 550 |
| N309 | 0.8 | 0.95 | 3 | 0 | BAL | 0 | 1 | 3 | 0 | 0.5 | 2.5 | 0.5 | 0 | 9.07% | 7.61% | 0.95% | 550 |
| N310 | 0.5 | 1.5 | 18 | 0 | BAL | 10 | 0 | 4 | 0 | 0 | 0 | 4 | 2 | 1.42% | 4.82% | 1.28% | 100 |
| N311 | 0.5 | 1.5 | 18 | 0 | BAL | 10 | 0 | 4 | 0 | 0 | 0 | 4 | 4 | 7.72% | 12.00% | 1.28% | 100 |
| N312 | 0.5 | 1.5 | 18 | 0 | BAL | 10 | 0 | 4 | 0 | 0 | 0 | 6 | 0 | 5.55% | 16.43% | 1.30% | 150 |
| N313 | 0.5 | 1.5 | 18 | 0 | BAL | 10 | 0 | 4 | 0 | 0 | 0 | 6 | 2 | 1.99% | 4.27% | 1.30% | 100 |
| N314 | 0.5 | 1.5 | 18 | 0 | BAL | 10 | 0 | 4 | 0 | 0 | 0 | 6 | 4 | 4.04% | 4.33% | 1.30% | 100 |
| N315 | 0.5 | 1.5 | 18 | 0 | BAL | 10 | 0 | 4 | 0 | 0 | 2 | 0 | 0 | 0.00% | 15.88% | 0.79% | 150 |
| N316 | 0.5 | 1.5 | 18 | 0 | BAL | 10 | 0 | 4 | 0 | 0 | 2 | 0 | 2 | 1.42% | 14.37% | 0.79% | 100 |
| N317 | 0.5 | 1.5 | 18 | 0 | BAL | 10 | 0 | 4 | 0 | 0 | 2 | 0 | 4 | 2.89% | 12.81% | 0.79% | 100 |
| N318 | 0.5 | 1.5 | 18 | 0 | BAL | 10 | 0 | 4 | 0 | 0 | 2 | 2 | 0 | 0.00% | 8.64% | 0.81% | 150 |
| N319 | 0.5 | 1.5 | 18 | 0 | BAL | 10 | 0 | 4 | 0 | 0 | 2 | 2 | 2 | 1.42% | 8.74% | 0.81% | 150 |
| N320 | 0.5 | 1.5 | 18 | 0 | BAL | 10 | 0 | 4 | 0 | 0 | 2 | 2 | 4 | 2.88% | 8.85% | 0.81% | 150 |
| N321 | 0.5 | 1.5 | 18 | 0 | BAL | 10 | 0 | 4 | 0 | 0 | 2 | 4 | 0 | 0.00% | 8.47% | 0.83% | 150 |
| N322 | 0.5 | 1.5 | 18 | 0 | BAL | 10 | 0 | 4 | 0 | 0 | 2 | 4 | 2 | 1.99% | 8.58% | 0.83% | 150 |
| N323 | 0.5 | 1.5 | 18 | 0 | BAL | 10 | 0 | 4 | 0 | 0 | 2 | 4 | 4 | 4.03% | 8.69% | 0.83% | 150 |
| N324 | 0.5 | 2 | 18 | 0 | BAL | 10 | 0 | 4 | 0 | 0 | 2 | 0 | 0 | 0.00% | 15.63% | 1.25% | 100 |
| N325 | 0.5 | 2 | 18 | 0 | BAL | 10 | 0 | 4 | 0 | 0 | 2 | 0 | 2 | 1.40% | 14.15% | 1.24% | 50 |
| N326 | 0.5 | 2 | 18 | 0 | BAL | 10 | 0 | 4 | 0 | 0 | 2 | 0 | 4 | 2.84% | 12.62% | 1.24% | 50 |
| N327 | 0.5 | 2 | 18 | 0 | BAL | 10 | 0 | 4 | 0 | 0 | 2 | 2 | 0 | 3.98% | 15.59% | 1.25% | 100 |
| N328 | 0.5 | 2 | 18 | 0 | BAL | 10 | 0 | 4 | 0 | 0 | 2 | 2 | 2 | 5.42% | 14.11% | 1.24% | 100 |
| N329 | 0.5 | 2 | 18 | 0 | BAL | 10 | 0 | 4 | 0 | 0 | 2 | 2 | 4 | 6.89% | 12.58% | 1.24% | 100 |
| N330 | 0.5 | 2 | 18 | 0 | BAL | 10 | 0 | 4 | 0 | 0 | 2 | 4 | 0 | 0.00% | 8.48% | 1.25% | 100 |
| N331 | 0.5 | 2 | 18 | 0 | BAL | 10 | 0 | 4 | 0 | 0 | 2 | 4 | 2 | 1.39% | 7.87% | 1.25% | 100 |
| N332 | 0.5 | 2 | 18 | 0 | BAL | 10 | 0 | 4 | 0 | 0 | 2 | 4 | 4 | 2.83% | 7.93% | 1.24% | 100 |
| N333 | 0.5 | 2 | 18 | 0 | BAL | 10 | 0 | 4 | 0 | 0 | 4 | 0 | 0 | 7.05% | 12.72% | 0.85% | 50 |
| N334 | 0.5 | 2 | 18 | 0 | BAL | 10 | 0 | 4 | 0 | 0 | 4 | 0 | 2 | 6.86% | 12.88% | 0.85% | 50 |
| N335 | 0.5 | 2 | 18 | 0 | BAL | 10 | 0 | 4 | 0 | 0 | 4 | 0 | 4 | 6.67% | 13.04% | 0.84% | 50 |
| N336 | 0.5 | 2 | 18 | 0 | BAL | 10 | 0 | 4 | 0 | 0 | 4 | 2 | 0 | 0.00% | 12.67% | 0.86% | 100 |
| N337 | 0.5 | 2 | 18 | 0 | BAL | 10 | 0 | 4 | 0 | 0 | 4 | 2 | 2 | 1.39% | 12.82% | 0.86% | 100 |
| N338 | 0.5 | 2 | 18 | 0 | BAL | 10 | 0 | 4 | 0 | 0 | 4 | 2 | 4 | 2.83% | 12.98% | 0.85% | 100 |
| N339 | 0.5 | 2 | 18 | 0 | BAL | 10 | 0 | 4 | 0 | 0 | 4 | 4 | 0 | 0.00% | 12.43% | 0.91% | 150 |
| N340 | 0.5 | 2 | 18 | 0 | BAL | 10 | 0 | 4 | 0 | 0 | 4 | 4 | 2 | 1.95% | 12.59% | 0.88% | 150 |
| N341 | 0.5 | 2 | 18 | 0 | BAL | 10 | 0 | 4 | 0 | 0 | 4 | 4 | 4 | 3.95% | 12.75% | 0.87% | 150 |
| N342 | 0.5 | 2 | 18 | 0 | BAL | 10 | 0 | 4 | 0 | 0 | 4 | 6 | 0 | 5.03% | 11.61% | 0.87% | 200 |
| N343 | 0.5 | 2 | 18 | 0 | BAL | 10 | 0 | 4 | 0 | 0 | 4 | 6 | 2 | 7.01% | 11.75% | 0.87% | 200 |
| N344 | 0.5 | 2 | 18 | 0 | BAL | 10 | 0 | 4 | 0 | 0 | 4 | 6 | 4 | 9.04% | 11.89% | 0.86% | 200 |
| N345 | 0.5 | 2.5 | 18 | 0 | BAL | 10 | 0 | 4 | 0 | 0 | 4 | 0 | 2 | 1.37% | 18.07% | 1.31% | 50 |
| N346 | 0.5 | 2.5 | 18 | 0 | BAL | 10 | 0 | 4 | 0 | 0 | 4 | 0 | 4 | 2.78% | 16.62% | 1.30% | 50 |
| N347 | 0.5 | 2.5 | 18 | 0 | BAL | 10 | 0 | 4 | 0 | 0 | 4 | 2 | 2 | 5.30% | 18.03% | 1.30% | 100 |
| N348 | 0.5 | 2.5 | 18 | 0 | BAL | 10 | 0 | 4 | 0 | 0 | 4 | 2 | 4 | 6.75% | 16.58% | 1.29% | 100 |
| N349 | 0.5 | 2.5 | 18 | 0 | BAL | 10 | 0 | 4 | 0 | 0 | 4 | 4 | 0 | 0.00% | 12.45% | 1.30% | 100 |
| N350 | 0.5 | 2.5 | 18 | 0 | BAL | 10 | 0 | 4 | 0 | 0 | 4 | 4 | 2 | 1.37% | 7.71% | 1.29% | 100 |
| N351 | 0.5 | 2.5 | 18 | 0 | BAL | 10 | 0 | 4 | 0 | 0 | 4 | 4 | 4 | 2.77% | 7.77% | 1.28% | 100 |
| N352 | 0.5 | 2.5 | 18 | 0 | BAL | 10 | 0 | 4 | 0 | 0 | 6 | 0 | 2 | 6.73% | 16.80% | 0.92% | 150 |
| N353 | 0.5 | 2.5 | 18 | 0 | BAL | 10 | 0 | 4 | 0 | 0 | 6 | 0 | 4 | 6.54% | 17.00% | 0.91% | 150 |
| N354 | 0.5 | 2.5 | 18 | 0 | BAL | 10 | 0 | 4 | 0 | 0 | 6 | 2 | 0 | 0.00% | 16.56% | 0.97% | 200 |
| N355 | 0.5 | 2.5 | 18 | 0 | BAL | 10 | 0 | 4 | 0 | 0 | 6 | 2 | 2 | 1.37% | 16.75% | 0.94% | 200 |
| N356 | 0.5 | 2.5 | 18 | 0 | BAL | 10 | 0 | 4 | 0 | 0 | 6 | 2 | 4 | 2.77% | 16.95% | 0.92% | 200 |
| N357 | 0.5 | 2.5 | 18 | 0 | BAL | 10 | 0 | 4 | 0 | 0 | 6 | 4 | 0 | 0.00% | 16.24% | 0.92% | 200 |
| N358 | 0.5 | 2.5 | 18 | 0 | BAL | 10 | 0 | 4 | 0 | 0 | 6 | 4 | 2 | 1.91% | 16.44% | 0.90% | 200 |
| N359 | 0.5 | 3 | 18 | 0 | BAL | 10 | 0 | 4 | 0 | 0 | 6 | 0 | 0 | 6.81% | 16.36% | 1.39% | 50 |
| N360 | 0.5 | 3 | 18 | 0 | BAL | 10 | 0 | 4 | 0 | 0 | 6 | 0 | 2 | 6.62% | 16.56% | 1.38% | 50 |
| N361 | 0.5 | 3 | 18 | 0 | BAL | 10 | 0 | 4 | 0 | 0 | 6 | 0 | 4 | 2.73% | 20.46% | 1.36% | 50 |
| N362 | 0.5 | 3 | 18 | 0 | BAL | 10 | 0 | 4 | 0 | 0 | 6 | 4 | 0 | 0.00% | 16.27% | 1.35% | 100 |
| N363 | 0.5 | 3 | 18 | 0 | BAL | 10 | 0 | 4 | 0 | 0 | 6 | 4 | 2 | 1.34% | 16.46% | 1.34% | 100 |
| N364 | 0.5 | 3 | 18 | 0 | BAL | 10 | 0 | 4 | 0 | 0 | 6 | 4 | 4 | 2.72% | 16.66% | 1.33% | 50 |
| N365 | 0.5 | 3 | 18 | 0 | BAL | 10 | 0 | 4 | 0 | 0 | 6 | 6 | 0 | 0.00% | 15.95% | 1.34% | 150 |
| N366 | 0.5 | 3 | 18 | 0 | BAL | 10 | 0 | 4 | 0 | 0 | 6 | 6 | 2 | 1.88% | 16.20% | 1.33% | 100 |
| N367 | 1 | 1.5 | 18 | 0 | BAL | 10 | 0 | 4 | 0 | 0 | 0 | 0 | 0 | 0.00% | 19.28% | 1.50% | 100 |
| N368 | 1 | 1.5 | 18 | 0 | BAL | 10 | 0 | 4 | 0 | 0 | 0 | 0 | 2 | 1.40% | 17.84% | 1.50% | 50 |
| N369 | 1 | 1.5 | 18 | 0 | BAL | 10 | 0 | 4 | 0 | 0 | 0 | 0 | 4 | 2.84% | 16.35% | 1.50% | 50 |
| N370 | 1 | 1.5 | 18 | 0 | BAL | 10 | 0 | 4 | 0 | 0 | 0 | 2 | 0 | 5.07% | 18.18% | 1.50% | 100 |
| N371 | 1 | 1.5 | 18 | 0 | BAL | 10 | 0 | 4 | 0 | 0 | 0 | 2 | 2 | 5.48% | 17.75% | 1.50% | 100 |
| N372 | 1 | 1.5 | 18 | 0 | BAL | 10 | 0 | 4 | 0 | 0 | 0 | 2 | 4 | 7.99% | 15.22% | 1.50% | 100 |
| N373 | 1 | 1.5 | 18 | 0 | BAL | 10 | 0 | 4 | 0 | 0 | 0 | 4 | 0 | 7.95% | 19.04% | 1.50% | 100 |
| N374 | 1 | 1.5 | 18 | 0 | BAL | 10 | 0 | 4 | 0 | 0 | 0 | 4 | 2 | 6.34% | 20.64% | 1.50% | 100 |
| N375 | 1 | 1.5 | 18 | 0 | BAL | 10 | 0 | 4 | 0 | 0 | 0 | 4 | 4 | 7.79% | 19.16% | 1.50% | 100 |
| N376 | 1 | 1.5 | 18 | 0 | BAL | 10 | 0 | 4 | 0 | 0 | 0 | 6 | 0 | 5.44% | 23.17% | 1.50% | 150 |
| N377 | 1 | 1.5 | 18 | 0 | BAL | 10 | 0 | 4 | 0 | 0 | 0 | 6 | 2 | 1.40% | 4.19% | 1.50% | 150 |
| N378 | 1 | 1.5 | 18 | 0 | BAL | 10 | 0 | 4 | 0 | 0 | 0 | 6 | 4 | 2.83% | 4.24% | 1.50% | 100 |
| N379 | 1 | 1.5 | 18 | 0 | BAL | 10 | 0 | 4 | 0 | 0 | 2 | 2 | 0 | 0.00% | 8.50% | 0.84% | 200 |
| N380 | 1 | 1.5 | 18 | 0 | BAL | 10 | 0 | 4 | 0 | 0 | 2 | 4 | 0 | 0.00% | 8.31% | 0.86% | 250 |
| N381 | 1 | 1.5 | 18 | 0 | BAL | 10 | 0 | 4 | 0 | 0 | 2 | 4 | 2 | 1.39% | 2.16% | 0.84% | 250 |
| N382 | 1 | 1.5 | 18 | 0 | BAL | 10 | 0 | 4 | 0 | 0 | 2 | 4 | 4 | 2.83% | 2.18% | 0.81% | 250 |
| N383 | 1 | 1.5 | 18 | 0 | BAL | 10 | 0 | 4 | 0 | 0 | 4 | 4 | 0 | 5.27% | 9.42% | 0.71% | 400 |
| N384 | 1 | 1.5 | 18 | 0 | BAL | 10 | 0 | 4 | 0 | 0 | 4 | 4 | 2 | 7.24% | 9.52% | 0.70% | 400 |
| N385 | 1 | 1.5 | 18 | 0 | BAL | 10 | 0 | 4 | 0 | 0 | 4 | 6 | 0 | 1.27% | 8.07% | 0.73% | 400 |
| N386 | 1 | 1.5 | 18 | 0 | BAL | 10 | 0 | 4 | 0 | 0 | 4 | 6 | 2 | 3.12% | 8.12% | 0.73% | 400 |
| N387 | 1 | 1.5 | 18 | 0 | BAL | 10 | 0 | 4 | 0 | 0 | 4 | 6 | 4 | 5.02% | 8.18% | 0.72% | 400 |
| N388 | 1 | 2 | 18 | 0 | BAL | 10 | 0 | 4 | 0 | 0 | 2 | 2 | 0 | 0.00% | 8.39% | 1.31% | 150 |
| N389 | 1 | 2 | 18 | 0 | BAL | 10 | 0 | 4 | 0 | 0 | 2 | 4 | 0 | 0.00% | 8.35% | 1.31% | 200 |
| N390 | 1 | 2 | 18 | 0 | BAL | 10 | 0 | 4 | 0 | 0 | 2 | 4 | 2 | 1.37% | 7.87% | 1.31% | 200 |
| N391 | 1 | 2 | 18 | 0 | BAL | 10 | 0 | 4 | 0 | 0 | 2 | 4 | 4 | 2.78% | 7.94% | 1.30% | 200 |
| N392 | 1 | 2 | 18 | 0 | BAL | 10 | 0 | 4 | 0 | 0 | 2 | 6 | 0 | 1.05% | 8.16% | 1.32% | 200 |
| N393 | 1 | 2 | 18 | 0 | BAL | 10 | 0 | 4 | 0 | 0 | 4 | 2 | 0 | 0.00% | 12.47% | 0.92% | 300 |
| N394 | 1 | 2 | 18 | 0 | BAL | 10 | 0 | 4 | 0 | 0 | 4 | 2 | 2 | 1.37% | 12.62% | 0.91% | 300 |
| N395 | 1 | 2 | 18 | 0 | BAL | 10 | 0 | 4 | 0 | 0 | 4 | 2 | 4 | 2.77% | 12.77% | 0.89% | 300 |
| N396 | 1 | 2 | 18 | 0 | BAL | 10 | 0 | 4 | 0 | 0 | 4 | 4 | 0 | 0.00% | 12.20% | 0.89% | 350 |
| N397 | 1 | 2 | 18 | 0 | BAL | 10 | 0 | 4 | 0 | 0 | 4 | 4 | 2 | 1.37% | 12.36% | 0.86% | 350 |
| N398 | 1 | 2 | 18 | 0 | BAL | 10 | 0 | 4 | 0 | 0 | 4 | 4 | 4 | 2.77% | 12.51% | 0.85% | 350 |
| N399 | 1 | 2.5 | 18 | 0 | BAL | 10 | 0 | 4 | 0 | 0 | 4 | 2 | 0 | 0.00% | 12.30% | 1.37% | 250 |
| N400 | 0.8 | 0.95 | 4 | 0 | BAL | 0 | 1 | 3 | 0 | 0.5 | 2.5 | 0.5 | 0 | 9.15% | 8.07% | 0.95% | 500 |
| N401 | 0.8 | 0.95 | 4.5 | 0 | BAL | 0 | 1 | 3 | 0 | 0.5 | 2.5 | 0.5 | 0 | 9.69% | 8.24% | 0.95% | 500 |
| N402 | 0 | 0.8 | 5.04 | 0 | BAL | 1.16 | 0.74 | 0 | 0 | 0.76 | 1 | 0 | 0 | 5.79% | 2.34% | 0.80% | 500 |
| N403 | 0 | 0.8 | 5.04 | 0 | BAL | 1.16 | 0.74 | 0 | 0 | 0.76 | 2 | 0 | 0 | 4.01% | 4.43% | 0.74% | 600 |
| N404 | 0 | 0.8 | 5.04 | 0 | BAL | 1.16 | 0.74 | 1 | 0 | 0.76 | 0 | 0 | 0 | 5.18% | 2.59% | 0.80% | 450 |
| N405 | 0 | 0.8 | 5.04 | 0 | BAL | 1.16 | 0.74 | 1 | 0 | 0.76 | 1 | 0 | 0 | 9.05% | 3.45% | 0.73% | 500 |
| N406 | 0 | 0.8 | 5.04 | 0 | BAL | 1.16 | 0.74 | 2 | 0 | 0.76 | 0 | 0 | 0 | 4.26% | 3.81% | 0.80% | 500 |
| N407 | 0 | 0.8 | 5.04 | 0 | BAL | 1.16 | 0.74 | 3 | 0 | 0.76 | 0 | 0 | 0 | 3.99% | 4.02% | 0.80% | 500 |
| N408 | 0 | 0.8 | 5.04 | 0 | BAL | 1.16 | 0.74 | 4 | 0 | 0.76 | 0 | 0 | 0 | 7.21% | 5.07% | 0.74% | 550 |
| N409 | 0 | 1 | 5.04 | 0 | BAL | 1.16 | 0.74 | 0 | 0 | 0.76 | 1 | 0 | 0 | 8.69% | 2.39% | 1.00% | 450 |
| N410 | 0 | 1 | 5.04 | 0 | BAL | 1.16 | 0.74 | 1 | 0 | 0.76 | 0 | 0 | 0 | 8.06% | 2.71% | 1.00% | 400 |
| N411 | 0 | 1 | 5.04 | 0 | BAL | 1.16 | 0.74 | 1 | 0 | 0.76 | 1 | 0 | 0 | 5.67% | 4.00% | 0.90% | 450 |
| N412 | 0 | 1 | 5.04 | 0 | BAL | 1.16 | 0.74 | 1 | 0 | 0.76 | 2 | 0 | 0 | 4.22% | 5.57% | 0.74% | 550 |
| N413 | 0 | 1 | 5.04 | 0 | BAL | 1.16 | 0.74 | 2 | 0 | 0.76 | 1 | 0 | 0 | 4.01% | 5.35% | 0.80% | 500 |
| N414 | 0 | 1 | 5.04 | 0 | BAL | 1.16 | 0.74 | 3 | 0 | 0.76 | 0 | 0 | 0 | 4.03% | 5.79% | 0.90% | 400 |
| N415 | 0 | 1 | 5.04 | 0 | BAL | 1.16 | 0.74 | 3 | 0 | 0.76 | 1 | 0 | 0 | 4.03% | 5.68% | 0.71% | 550 |
| N416 | 0 | 1 | 5.04 | 0 | BAL | 1.16 | 0.74 | 5 | 0 | 0.76 | 0 | 0 | 0 | 4.06% | 6.56% | 0.78% | 550 |
| N417 | 0 | 1.2 | 5.04 | 0 | BAL | 1.16 | 0.74 | 0 | 0 | 0.76 | 1 | 0 | 0 | 0.19% | 2.41% | 1.19% | 350 |
| N418 | 0 | 1.2 | 5.04 | 0 | BAL | 1.16 | 0.74 | 0 | 0 | 0.76 | 2 | 0 | 0 | 7.76% | 4.73% | 1.00% | 500 |
| N419 | 0 | 1.2 | 5.04 | 0 | BAL | 1.16 | 0.74 | 0 | 0 | 0.76 | 3 | 0 | 0 | 3.94% | 6.73% | 0.89% | 600 |
| N420 | 0 | 1.2 | 5.04 | 0 | BAL | 1.16 | 0.74 | 0 | 0 | 0.76 | 4 | 0 | 0 | 4.87% | 8.67% | 0.72% | 650 |
| N421 | 0 | 1.2 | 5.04 | 0 | BAL | 1.16 | 0.74 | 1 | 0 | 0.76 | 0 | 0 | 0 | 7.21% | 3.52% | 1.20% | 300 |
| N422 | 0 | 1.2 | 5.04 | 0 | BAL | 1.16 | 0.74 | 1 | 0 | 0.76 | 1 | 0 | 0 | 8.66% | 4.16% | 1.02% | 350 |
| N423 | 0 | 1.2 | 5.04 | 0 | BAL | 1.16 | 0.74 | 1 | 0 | 0.76 | 2 | 0 | 0 | 5.77% | 6.01% | 0.91% | 500 |
| N424 | 0 | 1.2 | 5.04 | 0 | BAL | 1.16 | 0.74 | 1 | 0 | 0.76 | 3 | 0 | 0 | 4.76% | 7.70% | 0.75% | 600 |
| N425 | 0 | 1.2 | 5.04 | 0 | BAL | 1.16 | 0.74 | 2 | 0 | 0.76 | 0 | 0 | 0 | 6.68% | 5.41% | 1.17% | 350 |
| N426 | 0 | 1.2 | 5.04 | 0 | BAL | 1.16 | 0.74 | 2 | 0 | 0.76 | 1 | 0 | 0 | 4.79% | 6.37% | 0.97% | 450 |
| N427 | 0 | 1.2 | 5.04 | 0 | BAL | 1.16 | 0.74 | 2 | 0 | 0.76 | 2 | 0 | 0 | 3.98% | 6.98% | 0.79% | 500 |
| N428 | 0 | 1.2 | 5.04 | 0 | BAL | 1.16 | 0.74 | 3 | 0 | 0.76 | 0 | 0 | 0 | 4.07% | 7.79% | 1.07% | 350 |
| N429 | 0 | 1.2 | 5.04 | 0 | BAL | 1.16 | 0.74 | 3 | 0 | 0.76 | 1 | 0 | 0 | 4.00% | 7.33% | 0.87% | 450 |
| N430 | 0 | 1.2 | 5.04 | 0 | BAL | 1.16 | 0.74 | 4 | 0 | 0.76 | 0 | 0 | 0 | 3.33% | 7.76% | 0.98% | 400 |
| N431 | 0 | 1.2 | 5.04 | 0 | BAL | 1.16 | 0.74 | 4 | 0 | 0.76 | 1 | 0 | 0 | 4.01% | 7.23% | 0.78% | 500 |
| N432 | 0 | 1.2 | 5.04 | 0 | BAL | 1.16 | 0.74 | 5 | 0 | 0.76 | 0 | 0 | 0 | 3.80% | 7.68% | 0.88% | 400 |
| N433 | 0 | 1.2 | 5.04 | 0 | BAL | 1.16 | 0.74 | 5 | 0 | 0.76 | 1 | 0 | 0 | 4.81% | 8.00% | 0.70% | 550 |
| N434 | 0 | 1.4 | 5.04 | 0 | BAL | 1.16 | 0.74 | 0 | 0 | 0.76 | 1 | 0 | 0 | 9.10% | 2.96% | 1.38% | 300 |
| N435 | 0 | 1.4 | 5.04 | 0 | BAL | 1.16 | 0.74 | 0 | 0 | 0.76 | 2 | 0 | 0 | 7.57% | 4.78% | 1.17% | 400 |
| N436 | 0 | 1.4 | 5.04 | 0 | BAL | 1.16 | 0.74 | 0 | 0 | 0.76 | 3 | 0 | 0 | 6.85% | 7.04% | 0.99% | 500 |
| N437 | 0 | 1.4 | 5.04 | 0 | BAL | 1.16 | 0.74 | 0 | 0 | 0.76 | 4 | 0 | 0 | 3.91% | 8.69% | 0.87% | 650 |
| N438 | 0 | 1.4 | 5.04 | 0 | BAL | 1.16 | 0.74 | 0 | 0 | 0.76 | 5 | 0 | 0 | 4.12% | 10.71% | 0.71% | 650 |
| N439 | 0 | 1.4 | 5.04 | 0 | BAL | 1.16 | 0.74 | 1 | 0 | 0.76 | 0 | 0 | 0 | 7.84% | 3.74% | 1.40% | 250 |
| N440 | 0 | 1.4 | 5.04 | 0 | BAL | 1.16 | 0.74 | 1 | 0 | 0.76 | 1 | 0 | 0 | 9.75% | 4.72% | 1.21% | 300 |
| N441 | 0 | 1.4 | 5.04 | 0 | BAL | 1.16 | 0.74 | 1 | 0 | 0.76 | 2 | 0 | 0 | 8.19% | 6.19% | 1.03% | 400 |
| N442 | 0 | 1.4 | 5.04 | 0 | BAL | 1.16 | 0.74 | 1 | 0 | 0.76 | 3 | 0 | 0 | 4.56% | 8.15% | 0.91% | 550 |
| N443 | 0 | 1.4 | 5.04 | 0 | BAL | 1.16 | 0.74 | 1 | 0 | 0.76 | 4 | 0 | 0 | 3.93% | 9.80% | 0.74% | 650 |
| N444 | 0 | 1.4 | 5.04 | 0 | BAL | 1.16 | 0.74 | 2 | 0 | 0.76 | 0 | 0 | 0 | 7.37% | 6.64% | 1.35% | 300 |
| N445 | 0 | 1.4 | 5.04 | 0 | BAL | 1.16 | 0.74 | 2 | 0 | 0.76 | 1 | 0 | 0 | 7.49% | 6.62% | 1.10% | 350 |
| N446 | 0 | 1.4 | 5.04 | 0 | BAL | 1.16 | 0.74 | 2 | 0 | 0.76 | 2 | 0 | 0 | 5.10% | 7.89% | 0.96% | 450 |
| N447 | 0 | 1.4 | 5.04 | 0 | BAL | 1.16 | 0.74 | 2 | 0 | 0.76 | 3 | 0 | 0 | 3.94% | 8.82% | 0.79% | 550 |
| N448 | 0 | 1.4 | 5.04 | 0 | BAL | 1.16 | 0.74 | 3 | 0 | 0.76 | 0 | 0 | 0 | 4.42% | 8.09% | 1.25% | 300 |
| N449 | 0 | 1.4 | 5.04 | 0 | BAL | 1.16 | 0.74 | 3 | 0 | 0.76 | 1 | 0 | 0 | 3.56% | 8.85% | 1.00% | 350 |
| N450 | 0 | 1.4 | 5.04 | 0 | BAL | 1.16 | 0.74 | 3 | 0 | 0.76 | 2 | 0 | 0 | 3.99% | 8.88% | 0.85% | 500 |
| N451 | 0 | 1.4 | 5.04 | 0 | BAL | 1.16 | 0.74 | 4 | 0 | 0.76 | 0 | 0 | 0 | 3.93% | 9.72% | 1.15% | 350 |
| N452 | 0 | 1.4 | 5.04 | 0 | BAL | 1.16 | 0.74 | 4 | 0 | 0.76 | 1 | 0 | 0 | 3.98% | 9.28% | 0.95% | 450 |
| N453 | 0 | 1.4 | 5.04 | 0 | BAL | 1.16 | 0.74 | 4 | 0 | 0.76 | 2 | 0 | 0 | 4.00% | 8.95% | 0.76% | 550 |
| N454 | 0 | 1.4 | 5.04 | 0 | BAL | 1.16 | 0.74 | 5 | 0 | 0.76 | 0 | 0 | 0 | 2.95% | 9.70% | 1.05% | 350 |
| N455 | 0 | 1.4 | 5.04 | 0 | BAL | 1.16 | 0.74 | 5 | 0 | 0.76 | 1 | 0 | 0 | 4.27% | 9.15% | 0.86% | 500 |
| N456 | 0 | 1.6 | 5.04 | 0 | BAL | 1.16 | 0.74 | 0 | 0 | 0.76 | 2 | 0 | 0 | 8.05% | 5.87% | 1.36% | 350 |
| N457 | 0 | 1.6 | 5.04 | 0 | BAL | 1.16 | 0.74 | 0 | 0 | 0.76 | 3 | 0 | 0 | 6.90% | 7.11% | 1.16% | 400 |
| N458 | 0 | 1.6 | 5.04 | 0 | BAL | 1.16 | 0.74 | 0 | 0 | 0.76 | 4 | 0 | 0 | 5.51% | 9.15% | 0.98% | 550 |
| N459 | 0 | 1.6 | 5.04 | 0 | BAL | 1.16 | 0.74 | 0 | 0 | 0.76 | 5 | 0 | 0 | 3.87% | 10.74% | 0.86% | 650 |
| N460 | 0 | 1.6 | 5.04 | 0 | BAL | 1.16 | 0.74 | 1 | 0 | 0.76 | 1 | 0 | 0 | 7.78% | 5.68% | 1.40% | 300 |
| N461 | 0 | 1.6 | 5.04 | 0 | BAL | 1.16 | 0.74 | 1 | 0 | 0.76 | 2 | 0 | 0 | 0.26% | 6.30% | 1.22% | 350 |
| N462 | 0 | 1.6 | 5.04 | 0 | BAL | 1.16 | 0.74 | 1 | 0 | 0.76 | 3 | 0 | 0 | 8.07% | 8.41% | 1.02% | 450 |
| N463 | 0 | 1.6 | 5.04 | 0 | BAL | 1.16 | 0.74 | 1 | 0 | 0.76 | 4 | 0 | 0 | 4.99% | 10.12% | 0.91% | 600 |
| N464 | 0 | 1.6 | 5.04 | 0 | BAL | 1.16 | 0.74 | 1 | 0 | 0.76 | 5 | 0 | 0 | 3.95% | 11.84% | 0.74% | 650 |
| N465 | 0 | 1.6 | 5.04 | 0 | BAL | 1.16 | 0.74 | 2 | 0 | 0.76 | 1 | 0 | 0 | 6.24% | 7.64% | 1.29% | 300 |
| N466 | 0 | 1.6 | 5.04 | 0 | BAL | 1.16 | 0.74 | 2 | 0 | 0.76 | 2 | 0 | 0 | 7.96% | 8.12% | 1.09% | 350 |
| N467 | 0 | 1.6 | 5.04 | 0 | BAL | 1.16 | 0.74 | 2 | 0 | 0.76 | 3 | 0 | 0 | 5.38% | 9.70% | 0.96% | 500 |
| N468 | 0 | 1.6 | 5.04 | 0 | BAL | 1.16 | 0.74 | 2 | 0 | 0.76 | 4 | 0 | 0 | 3.76% | 10.90% | 0.79% | 600 |
| N469 | 0 | 1.6 | 5.04 | 0 | BAL | 1.16 | 0.74 | 3 | 0 | 0.76 | 0 | 0 | 0 | 3.78% | 9.69% | 1.43% | 250 |
| N470 | 0 | 1.6 | 5.04 | 0 | BAL | 1.16 | 0.74 | 3 | 0 | 0.76 | 1 | 0 | 0 | 6.19% | 9.17% | 1.18% | 300 |
| N471 | 0 | 1.6 | 5.04 | 0 | BAL | 1.16 | 0.74 | 3 | 0 | 0.76 | 2 | 0 | 0 | 5.13% | 10.22% | 0.99% | 450 |
| N472 | 0 | 1.6 | 5.04 | 0 | BAL | 1.16 | 0.74 | 3 | 0 | 0.76 | 3 | 0 | 0 | 4.76% | 10.46% | 0.85% | 550 |
| N473 | 0 | 1.6 | 5.04 | 0 | BAL | 1.16 | 0.74 | 4 | 0 | 0.76 | 0 | 0 | 0 | 3.94% | 10.75% | 1.33% | 300 |
| N474 | 0 | 1.6 | 5.04 | 0 | BAL | 1.16 | 0.74 | 4 | 0 | 0.76 | 1 | 0 | 0 | 4.33% | 11.32% | 1.08% | 350 |
| N475 | 0 | 1.6 | 5.04 | 0 | BAL | 1.16 | 0.74 | 4 | 0 | 0.76 | 2 | 0 | 0 | 3.95% | 10.81% | 0.93% | 450 |
| N476 | 0 | 1.6 | 5.04 | 0 | BAL | 1.16 | 0.74 | 4 | 0 | 0.76 | 3 | 0 | 0 | 3.95% | 11.06% | 0.74% | 550 |
| N477 | 0 | 1.6 | 5.04 | 0 | BAL | 1.16 | 0.74 | 5 | 0 | 0.76 | 0 | 0 | 0 | 3.85% | 11.57% | 1.23% | 300 |
| N478 | 0 | 1.6 | 5.04 | 0 | BAL | 1.16 | 0.74 | 5 | 0 | 0.76 | 1 | 0 | 0 | 3.26% | 11.21% | 0.98% | 400 |
| N479 | 0 | 1.6 | 5.04 | 0 | BAL | 1.16 | 0.74 | 5 | 0 | 0.76 | 2 | 0 | 0 | 4.61% | 10.68% | 0.83% | 500 |
| N480 | 0.4 | 2.6 | 0 | 0 | BAL | 1.16 | 0.74 | 2 | 0 | 0.76 | 5 | 0 | 0 | 9.89% | 12.60% | 1.46% | 350 |
| N481 | 0.4 | 2.6 | 0 | 0 | BAL | 1.16 | 0.74 | 3 | 0 | 0.76 | 5 | 0 | 0 | 9.39% | 13.73% | 1.33% | 400 |
| N482 | 0.4 | 2.6 | 0 | 0 | BAL | 1.16 | 0.74 | 4 | 0 | 0.76 | 4 | 0 | 0 | 9.94% | 12.77% | 1.41% | 250 |
| N483 | 0.4 | 2.6 | 0 | 0 | BAL | 1.16 | 0.74 | 4 | 0 | 0.76 | 5 | 0 | 0 | 8.88% | 14.86% | 1.25% | 400 |
| N484 | 0.4 | 2.6 | 0 | 0 | BAL | 1.16 | 0.74 | 5 | 0 | 0.76 | 4 | 0 | 0 | 9.44% | 13.91% | 1.29% | 250 |
| N485 | 0.4 | 2.6 | 0 | 0 | BAL | 1.16 | 0.74 | 5 | 0 | 0.76 | 5 | 0 | 0 | 8.37% | 16.00% | 1.13% | 400 |
| N486 | 0.6 | 1.8 | 0 | 0 | BAL | 1.16 | 0.74 | 2 | 0 | 0.76 | 5 | 0 | 0 | 5.23% | 12.84% | 0.88% | 650 |
| N487 | 0.6 | 1.8 | 0 | 0 | BAL | 1.16 | 0.74 | 3 | 0 | 0.76 | 5 | 0 | 0 | 4.70% | 13.99% | 0.76% | 700 |
| N488 | 0.6 | 1.8 | 0 | 0 | BAL | 1.16 | 0.74 | 4 | 0 | 0.76 | 4 | 0 | 0 | 9.57% | 13.02% | 0.80% | 600 |
| N489 | 0.6 | 1.8 | 0 | 0 | BAL | 1.16 | 0.74 | 5 | 0 | 0.76 | 4 | 0 | 0 | 9.05% | 14.18% | 0.70% | 650 |
| N490 | 0.6 | 2 | 0 | 0 | BAL | 1.16 | 0.74 | 3 | 0 | 0.76 | 5 | 0 | 0 | 9.79% | 13.90% | 0.92% | 650 |
| N491 | 0.6 | 2 | 0 | 0 | BAL | 1.16 | 0.74 | 4 | 0 | 0.76 | 5 | 0 | 0 | 9.27% | 15.04% | 0.81% | 700 |
| N492 | 0.6 | 2 | 0 | 0 | BAL | 1.16 | 0.74 | 5 | 0 | 0.76 | 4 | 0 | 0 | 9.84% | 14.08% | 0.86% | 600 |
| N493 | 0.6 | 2 | 0 | 0 | BAL | 1.16 | 0.74 | 5 | 0 | 0.76 | 5 | 0 | 0 | 8.76% | 16.20% | 0.70% | 650 |
| N494 | 0.6 | 2.2 | 0 | 0 | BAL | 1.16 | 0.74 | 5 | 0 | 0.76 | 5 | 0 | 0 | 9.54% | 16.09% | 0.86% | 600 |
| N495 | 0.5 | 1.25 | 0 | 0 | BAL | 0 | 1 | 2.5 | 0 | 0.5 | 1 | 0.5 | 0 | 7.05% | 6.33% | 0.92% | 200 |
| N496 | 0.5 | 1.25 | 0 | 0 | BAL | 0 | 1 | 3 | 0 | 0.5 | 1 | 0.5 | 0 | 7.06% | 6.91% | 0.86% | 200 |
| N497 | 0.5 | 1.25 | 0 | 0 | BAL | 0 | 1 | 3.5 | 0 | 0.5 | 1 | 0.5 | 0 | 8.86% | 7.49% | 0.81% | 200 |
| N498 | 0.5 | 1.25 | 0.5 | 0 | BAL | 0 | 1 | 2.5 | 0 | 0.5 | 0 | 0.5 | 0 | 6.97% | 3.62% | 1.13% | 250 |
| N499 | 0.5 | 1.25 | 0.5 | 0 | BAL | 0 | 1 | 2.5 | 0 | 0.5 | 1 | 0.5 | 0 | 8.33% | 5.34% | 0.92% | 200 |
| N500 | 0.5 | 1.25 | 0.5 | 0 | BAL | 0 | 1 | 2.5 | 0 | 0.5 | 1.5 | 0.5 | 0 | 8.32% | 6.35% | 0.83% | 250 |
| N501 | 0.5 | 1.25 | 0.5 | 0 | BAL | 0 | 1 | 2.5 | 0 | 0.5 | 2 | 0.5 | 0 | 8.32% | 7.39% | 0.77% | 350 |
| N502 | 0.5 | 1.25 | 0.5 | 0 | BAL | 0 | 1 | 2.5 | 0 | 0.5 | 2.5 | 0.5 | 0 | 8.31% | 8.46% | 0.70% | 450 |
| N503 | 0.5 | 1.25 | 0.5 | 0 | BAL | 0 | 1 | 3 | 0 | 0.5 | 0 | 0.5 | 0 | 8.36% | 4.25% | 1.08% | 200 |
| N504 | 0.5 | 1.25 | 0.5 | 0 | BAL | 0 | 1 | 3 | 0 | 0.5 | 1 | 0.5 | 0 | 8.35% | 6.01% | 0.86% | 200 |
| N505 | 0.5 | 1.25 | 0.5 | 0 | BAL | 0 | 1 | 3 | 0 | 0.5 | 1.5 | 0.5 | 0 | 8.34% | 6.99% | 0.78% | 250 |
| N506 | 0.5 | 1.25 | 0.5 | 0 | BAL | 0 | 1 | 3 | 0 | 0.5 | 2 | 0.5 | 0 | 8.33% | 8.02% | 0.72% | 350 |
| N507 | 0.5 | 1.25 | 0.5 | 0 | BAL | 0 | 1 | 3.5 | 0 | 0.5 | 0 | 0.5 | 0 | 8.37% | 4.87% | 1.03% | 200 |
| N508 | 0.5 | 1.25 | 0.5 | 0 | BAL | 0 | 1 | 3.5 | 0 | 0.5 | 1 | 0.5 | 0 | 8.36% | 6.66% | 0.81% | 200 |
| N509 | 0.5 | 1.25 | 0.5 | 0 | BAL | 0 | 1 | 3.5 | 0 | 0.5 | 1.5 | 0.5 | 0 | 8.35% | 7.64% | 0.72% | 250 |
| N510 | 0.5 | 1.25 | 0.5 | 0 | BAL | 0 | 1 | 4 | 0 | 0.5 | 0 | 0.5 | 0 | 8.39% | 5.48% | 0.98% | 200 |
| N511 | 0.5 | 1.25 | 0.5 | 0 | BAL | 0 | 1 | 4.5 | 0 | 0.5 | 0 | 0.5 | 0 | 8.41% | 6.09% | 0.93% | 200 |
| N512 | 0.5 | 1.25 | 0.5 | 0 | BAL | 0 | 1 | 4.5 | 0 | 0.5 | 1 | 0.5 | 0 | 8.02% | 9.26% | 0.72% | 200 |
| N513 | 0.5 | 1.25 | 0.5 | 0 | BAL | 0 | 1 | 5 | 0 | 0.5 | 0 | 0.5 | 0 | 8.42% | 6.69% | 0.88% | 200 |
| N514 | 0.5 | 1.25 | 0.5 | 0 | BAL | 0 | 1 | 5.5 | 0 | 0.5 | 0 | 0.5 | 0 | 8.44% | 7.29% | 0.84% | 200 |
| N515 | 0.5 | 1.25 | 1 | 0 | BAL | 0 | 1 | 2.5 | 0 | 0.5 | 1.5 | 0.5 | 0 | 8.32% | 6.87% | 0.83% | 250 |
| N516 | 0.5 | 1.25 | 1 | 0 | BAL | 0 | 1 | 3 | 0 | 0.5 | 0.5 | 0.5 | 0 | 8.35% | 5.69% | 0.96% | 200 |
| N517 | 0.5 | 1.25 | 1 | 0 | BAL | 0 | 1 | 3 | 0 | 0.5 | 1.5 | 0.5 | 0 | 8.34% | 7.56% | 0.78% | 200 |
| N518 | 0.5 | 1.25 | 1 | 0 | BAL | 0 | 1 | 3 | 0 | 0.5 | 2 | 0.5 | 0 | 8.33% | 8.57% | 0.71% | 300 |
| N519 | 0.5 | 1.25 | 1 | 0 | BAL | 0 | 1 | 3.5 | 0 | 0.5 | 0 | 0.5 | 0 | 8.37% | 5.53% | 1.03% | 200 |
| N520 | 0.5 | 1.25 | 1 | 0 | BAL | 0 | 1 | 3.5 | 0 | 0.5 | 1.5 | 0.5 | 0 | 8.35% | 8.24% | 0.72% | 200 |
| N521 | 0.5 | 1.25 | 1 | 0 | BAL | 0 | 1 | 4 | 0 | 0.5 | 0 | 0.5 | 0 | 7.00% | 6.19% | 0.98% | 200 |
| N522 | 0.5 | 1.25 | 1 | 0 | BAL | 0 | 1 | 4.5 | 0 | 0.5 | 0 | 0.5 | 0 | 7.02% | 6.84% | 0.93% | 200 |
| N523 | 0.5 | 1.25 | 1 | 0 | BAL | 0 | 1 | 5 | 0 | 0.5 | 0 | 0.5 | 0 | 7.03% | 7.47% | 0.89% | 200 |
| N524 | 0.5 | 1.25 | 1 | 0 | BAL | 0 | 1 | 5.5 | 0 | 0.5 | 0 | 0.5 | 0 | 8.44% | 8.11% | 0.84% | 200 |
| N525 | 0.5 | 1.25 | 1 | 0 | BAL | 0 | 1 | 5.5 | 0 | 0.5 | 0.5 | 0.5 | 0 | 8.43% | 9.02% | 0.73% | 200 |
| N526 | 0.5 | 1.25 | 1.5 | 0 | BAL | 0 | 1 | 2.5 | 0 | 0.5 | 0 | 0.5 | 0 | 7.05% | 6.06% | 1.14% | 250 |
| N527 | 0.5 | 1.25 | 1.5 | 0 | BAL | 0 | 1 | 2.5 | 0 | 0.5 | 0.5 | 0.5 | 0 | 8.33% | 5.63% | 1.01% | 200 |
| N528 | 0.5 | 1.25 | 1.5 | 0 | BAL | 0 | 1 | 3 | 0 | 0.5 | 0 | 0.5 | 0 | 5.69% | 6.77% | 1.09% | 200 |
| N529 | 0.5 | 1.25 | 1.5 | 0 | BAL | 0 | 1 | 3 | 0 | 0.5 | 0.5 | 0.5 | 0 | 6.97% | 6.35% | 0.96% | 200 |
| N530 | 0.5 | 1.25 | 1.5 | 0 | BAL | 0 | 1 | 3 | 0 | 0.5 | 1.5 | 0.5 | 0 | 8.33% | 8.26% | 0.78% | 200 |
| N531 | 0.5 | 1.25 | 1.5 | 0 | BAL | 0 | 1 | 3 | 0 | 0.5 | 2 | 0.5 | 0 | 8.58% | 9.22% | 0.71% | 300 |
| N532 | 0.5 | 1.25 | 1.5 | 0 | BAL | 0 | 1 | 3.5 | 0 | 0.5 | 1.5 | 0.5 | 0 | 8.35% | 8.96% | 0.72% | 200 |
| N533 | 0.5 | 1.25 | 1.5 | 0 | BAL | 0 | 1 | 4.5 | 0 | 0.5 | 1 | 0.5 | 0 | 7.00% | 9.36% | 0.72% | 200 |
| N534 | 0.5 | 1.25 | 1.5 | 0 | BAL | 0 | 1 | 5 | 0 | 0.5 | 0.5 | 0.5 | 0 | 7.02% | 9.10% | 0.77% | 200 |
| N535 | 0.5 | 1.25 | 1.5 | 0 | BAL | 0 | 1 | 5.5 | 0 | 0.5 | 0.5 | 0.5 | 0 | 7.04% | 9.77% | 0.73% | 200 |
| N536 | 0.5 | 1.25 | 2 | 0 | BAL | 0 | 1 | 2.5 | 0 | 0.5 | 0 | 0.5 | 0 | 8.33% | 5.43% | 1.13% | 200 |
| N537 | 0.5 | 1.25 | 2 | 0 | BAL | 0 | 1 | 3 | 0 | 0.5 | 0 | 0.5 | 0 | 8.35% | 6.16% | 1.09% | 200 |
| N538 | 0.5 | 1.25 | 2 | 0 | BAL | 0 | 1 | 3 | 0 | 0.5 | 1 | 0.5 | 0 | 7.05% | 9.03% | 0.86% | 200 |
| N539 | 0.5 | 1.25 | 2 | 0 | BAL | 0 | 1 | 3 | 0 | 0.5 | 1.5 | 0.5 | 0 | 8.98% | 8.42% | 0.78% | 200 |
| N540 | 0.5 | 1.25 | 2 | 0 | BAL | 0 | 1 | 3.5 | 0 | 0.5 | 0 | 0.5 | 0 | 8.37% | 6.87% | 1.04% | 200 |
| N541 | 0.5 | 1.25 | 2 | 0 | BAL | 0 | 1 | 3.5 | 0 | 0.5 | 1 | 0.5 | 0 | 7.06% | 10.03% | 0.81% | 200 |
| N542 | 0.5 | 1.25 | 2 | 0 | BAL | 0 | 1 | 3.5 | 0 | 0.5 | 1.5 | 0.5 | 0 | 8.35% | 9.48% | 0.72% | 200 |
| N543 | 0.5 | 1.25 | 2 | 0 | BAL | 0 | 1 | 4 | 0 | 0.5 | 0 | 0.5 | 0 | 8.38% | 7.57% | 0.99% | 200 |
| N544 | 0.5 | 1.25 | 2 | 0 | BAL | 0 | 1 | 4 | 0 | 0.5 | 0.5 | 0.5 | 0 | 9.03% | 8.48% | 0.87% | 200 |
| N545 | 0.5 | 1.25 | 2 | 0 | BAL | 0 | 1 | 4 | 0 | 0.5 | 1 | 0.5 | 0 | 8.54% | 9.43% | 0.77% | 200 |
| N546 | 0.5 | 1.25 | 2 | 0 | BAL | 0 | 1 | 4.5 | 0 | 0.5 | 0 | 0.5 | 0 | 7.01% | 8.26% | 0.94% | 200 |
| N547 | 0.5 | 1.25 | 2 | 0 | BAL | 0 | 1 | 4.5 | 0 | 0.5 | 0.5 | 0.5 | 0 | 8.39% | 9.17% | 0.82% | 200 |
| N548 | 0.5 | 1.25 | 2 | 0 | BAL | 0 | 1 | 4.5 | 0 | 0.5 | 1 | 0.5 | 0 | 5.71% | 11.09% | 0.72% | 200 |
| N549 | 0.5 | 1.25 | 2 | 0 | BAL | 0 | 1 | 5 | 0 | 0.5 | 0 | 0.5 | 0 | 7.03% | 8.93% | 0.89% | 200 |
| N550 | 0.5 | 1.25 | 2 | 0 | BAL | 0 | 1 | 5 | 0 | 0.5 | 0.5 | 0.5 | 0 | 8.40% | 9.82% | 0.77% | 200 |
| N551 | 0.5 | 1.25 | 2 | 0 | BAL | 0 | 1 | 5.5 | 0 | 0.5 | 0 | 0.5 | 0 | 5.74% | 10.91% | 0.84% | 200 |
| N552 | 0.5 | 1.25 | 2 | 0 | BAL | 0 | 1 | 5.5 | 0 | 0.5 | 0.5 | 0.5 | 0 | 8.37% | 9.89% | 0.73% | 150 |
| N553 | 0.5 | 1.25 | 2.5 | 0 | BAL | 0 | 1 | 2.5 | 0 | 0.5 | 1.5 | 0.5 | 0 | 8.18% | 8.68% | 0.83% | 200 |
| N554 | 0.5 | 1.25 | 2.5 | 0 | BAL | 0 | 1 | 2.5 | 0 | 0.5 | 2 | 0.5 | 0 | 9.02% | 8.26% | 0.76% | 300 |
| N555 | 0.5 | 1.25 | 2.5 | 0 | BAL | 0 | 1 | 3 | 0 | 0.5 | 1.5 | 0.5 | 0 | 7.04% | 9.70% | 0.78% | 200 |
| N556 | 0.5 | 1.25 | 2.5 | 0 | BAL | 0 | 1 | 3.5 | 0 | 0.5 | 0 | 0.5 | 0 | 7.07% | 8.90% | 1.04% | 200 |
| N557 | 0.5 | 1.25 | 2.5 | 0 | BAL | 0 | 1 | 3.5 | 0 | 0.5 | 1.5 | 0.5 | 0 | 7.05% | 10.77% | 0.72% | 200 |
| N558 | 0.5 | 1.25 | 2.5 | 0 | BAL | 0 | 1 | 4 | 0 | 0.5 | 0 | 0.5 | 0 | 7.08% | 9.61% | 0.99% | 200 |
| N612 | 0.5 | 1.25 | 5 | 0 | BAL | 0 | 1 | 2.5 | 0 | 0.5 | 0 | 0.5 | 0 | 8.32% | 8.59% | 1.11% | 100 |
| N613 | 0.5 | 1.25 | 5 | 0 | BAL | 0 | 1 | 2.5 | 0 | 0.5 | 0.5 | 0.5 | 0 | 7.05% | 10.94% | 1.02% | 150 |
| N614 | 0.5 | 1.25 | 5 | 0 | BAL | 0 | 1 | 2.5 | 0 | 0.5 | 1 | 0.5 | 0 | 9.96% | 8.38% | 0.92% | 150 |
| N615 | 0.5 | 1.25 | 5 | 0 | BAL | 0 | 1 | 2.5 | 0 | 0.5 | 1.5 | 0.5 | 0 | 8.60% | 7.56% | 0.83% | 150 |
| N616 | 0.5 | 1.25 | 5 | 0 | BAL | 0 | 1 | 3 | 0 | 0.5 | 0.5 | 0.5 | 0 | 7.40% | 9.38% | 0.97% | 150 |
| N617 | 0.5 | 1.25 | 5 | 0 | BAL | 0 | 1 | 3 | 0 | 0.5 | 1 | 0.5 | 0 | 8.21% | 8.11% | 0.87% | 150 |
| N618 | 0.5 | 1.25 | 5 | 0 | BAL | 0 | 1 | 3.5 | 0 | 0.5 | 0 | 0.5 | 0 | 8.33% | 9.77% | 1.03% | 150 |
| N619 | 0.5 | 1.25 | 5 | 0 | BAL | 0 | 1 | 4 | 0 | 0.5 | 0 | 0.5 | 0 | 8.28% | 9.87% | 0.99% | 150 |
| N620 | 0.5 | 1.25 | 5 | 0 | BAL | 0 | 1 | 4 | 0 | 0.5 | 0.5 | 0.5 | 0 | 9.23% | 9.31% | 0.88% | 100 |
| N621 | 0.5 | 1.25 | 5 | 0 | BAL | 0 | 1 | 5 | 0 | 0.5 | 0 | 0.5 | 0 | 8.95% | 9.61% | 0.90% | 100 |
| N622 | 0.5 | 1.25 | 5 | 0 | BAL | 0 | 1 | 5.5 | 0 | 0.5 | 0 | 0.5 | 0 | 9.23% | 9.71% | 0.85% | 100 |
| N623 | 0.8 | 1.8 | 0 | 0 | BAL | 1.16 | 0.74 | 4 | 0 | 0.76 | 5 | 0 | 0 | 4.13% | 15.03% | 0.72% | 650 |
| N624 | 0 | 2.6 | 0 | 0 | BAL | 1.16 | 0.74 | 6 | 0 | 0.76 | 6 | 0 | 0 | 2.85% | 19.54% | 0.85% | 650 |
| N625 | 0 | 2.6 | 0 | 0 | BAL | 1.16 | 0.74 | 7 | 0 | 0.76 | 6 | 0 | 0 | 2.30% | 20.72% | 0.75% | 650 |
| N626 | 0.2 | 2.6 | 0 | 0 | BAL | 1.16 | 0.74 | 6 | 0 | 0.76 | 6 | 0 | 0 | 4.43% | 19.39% | 0.80% | 350 |
| N627 | 0.2 | 2.6 | 0 | 0 | BAL | 1.16 | 0.74 | 7 | 0 | 0.76 | 6 | 0 | 0 | 3.89% | 20.56% | 0.71% | 400 |
| N628 | 0.5 | 0.95 | 0.5 | 0 | BAL | 1 | 1 | 0.5 | 0 | 0.5 | 1 | 0 | 0 | 8.47% | 2.80% | 0.95% | 300 |
| N629 | 0.5 | 0.95 | 0.5 | 0 | BAL | 1 | 1 | 0.5 | 0 | 0.5 | 1.5 | 0 | 0 | 7.91% | 3.90% | 0.95% | 400 |
| N630 | 0.5 | 0.95 | 0.5 | 0 | BAL | 1 | 1 | 0.5 | 0 | 0.5 | 2 | 0 | 0 | 7.35% | 5.01% | 0.95% | 500 |
| N631 | 0.5 | 0.95 | 0.5 | 0 | BAL | 1 | 1 | 1 | 0 | 0.5 | 0.5 | 0 | 0 | 8.71% | 2.38% | 0.90% | 200 |
| N632 | 0.5 | 0.95 | 0.5 | 0 | BAL | 1 | 1 | 1 | 0 | 0.5 | 1 | 0 | 0 | 8.18% | 3.41% | 0.84% | 300 |
| N633 | 0.5 | 0.95 | 0.5 | 0 | BAL | 1 | 1 | 1 | 0 | 0.5 | 1.5 | 0 | 0 | 7.63% | 4.50% | 0.78% | 350 |
| N634 | 0.5 | 0.95 | 0.5 | 0 | BAL | 1 | 1 | 1 | 0 | 0.5 | 2 | 0 | 0 | 7.07% | 5.60% | 0.72% | 450 |
| N635 | 0.5 | 0.95 | 0.5 | 0 | BAL | 1 | 1 | 1.5 | 0 | 0.5 | 0.5 | 0 | 0 | 8.36% | 3.10% | 0.84% | 200 |
| N636 | 0.5 | 0.95 | 0.5 | 0 | BAL | 1 | 1 | 1.5 | 0 | 0.5 | 1 | 0 | 0 | 7.88% | 4.06% | 0.77% | 300 |
| N637 | 0.5 | 0.95 | 0.5 | 0 | BAL | 1 | 1 | 1.5 | 0 | 0.5 | 1.5 | 0 | 0 | 7.34% | 5.12% | 0.72% | 350 |
| N638 | 0.5 | 0.95 | 0.5 | 0 | BAL | 1 | 1 | 2 | 0 | 0.5 | 0.5 | 0 | 0 | 8.02% | 3.82% | 0.79% | 200 |
| N639 | 0.5 | 0.95 | 0.5 | 0 | BAL | 1 | 1 | 2 | 0 | 0.5 | 1 | 0 | 0 | 7.56% | 4.73% | 0.72% | 300 |
| N640 | 0.5 | 0.95 | 0.5 | 0 | BAL | 1 | 1 | 2.5 | 0 | 0.5 | 0.5 | 0 | 0 | 7.69% | 4.52% | 0.75% | 200 |
| N641 | 0.5 | 0.95 | 0.5 | 0 | BAL | 1 | 1 | 3 | 0 | 0.5 | 0.5 | 0 | 0 | 7.37% | 5.20% | 0.70% | 200 |
| N642 | 0.65 | 0.95 | 0.5 | 0 | BAL | 1 | 1 | 0.5 | 0 | 0.5 | 2 | 0 | 0 | 9.50% | 4.96% | 0.95% | 550 |
| N643 | 0.65 | 0.95 | 0.5 | 0 | BAL | 1 | 1 | 1 | 0 | 0.5 | 1.5 | 0 | 0 | 9.79% | 4.46% | 0.95% | 450 |
| N644 | 0.65 | 0.95 | 0.5 | 0 | BAL | 1 | 1 | 1 | 0 | 0.5 | 2 | 0 | 0 | 9.23% | 5.55% | 0.95% | 550 |
| N645 | 0.65 | 0.95 | 0.5 | 0 | BAL | 1 | 1 | 1.5 | 0 | 0.5 | 1.5 | 0 | 0 | 9.51% | 5.05% | 0.95% | 450 |
| N646 | 0.65 | 0.95 | 0.5 | 0 | BAL | 1 | 1 | 1.5 | 0 | 0.5 | 2 | 0 | 0 | 8.96% | 6.14% | 0.95% | 500 |
| N647 | 0.65 | 0.95 | 0.5 | 0 | BAL | 1 | 1 | 2 | 0 | 0.5 | 1 | 0 | 0 | 9.75% | 4.63% | 0.75% | 400 |
| N648 | 0.65 | 0.95 | 0.5 | 0 | BAL | 1 | 1 | 2 | 0 | 0.5 | 1.5 | 0 | 0 | 9.22% | 5.67% | 0.95% | 400 |
| N649 | 0.65 | 0.95 | 0.5 | 0 | BAL | 1 | 1 | 2 | 0 | 0.5 | 2 | 0 | 0 | 8.68% | 6.75% | 0.95% | 500 |
| N650 | 0.65 | 0.95 | 0.5 | 0 | BAL | 1 | 1 | 2.5 | 0 | 0.5 | 0.5 | 0 | 0 | 9.90% | 4.40% | 0.75% | 200 |
| N651 | 0.65 | 0.95 | 0.5 | 0 | BAL | 1 | 1 | 2.5 | 0 | 0.5 | 1 | 0 | 0 | 9.44% | 5.30% | 0.70% | 400 |
| N652 | 0.65 | 0.95 | 0.5 | 0 | BAL | 1 | 1 | 2.5 | 0 | 0.5 | 2 | 0 | 0 | 8.39% | 7.36% | 0.95% | 500 |
| N653 | 0.65 | 0.95 | 0.5 | 0 | BAL | 1 | 1 | 3 | 0 | 0.5 | 0.5 | 0 | 0 | 9.58% | 5.08% | 0.70% | 200 |
| N654 | 0.4 | 2.6 | 0 | 0 | BAL | 1.16 | 0.74 | 6 | 0 | 0.76 | 6 | 0 | 0 | 6.78% | 19.24% | 0.85% | 500 |
| N655 | 0.4 | 2.6 | 0 | 0 | BAL | 1.16 | 0.74 | 7 | 0 | 0.76 | 6 | 0 | 0 | 6.26% | 20.41% | 0.74% | 550 |
| N656 | 1 | 1.5 | 6 | 0 | BAL | 4 | 0 | 2 | 4 | 0 | 0.2 | 0.5 | 5 | 5.40% | 21.27% | 1.31% | 100 |
| N657 | 1 | 1.5 | 6 | 0 | BAL | 4 | 0 | 2 | 4 | 0 | 0.2 | 0.5 | 10 | 7.26% | 21.59% | 1.31% | 50 |
| N658 | 1 | 1.5 | 6 | 0 | BAL | 4 | 0 | 2 | 4 | 0 | 0.2 | 0.5 | 15 | 8.46% | 16.76% | 1.33% | 0 |
| N659 | 1 | 1.5 | 6 | 0 | BAL | 4 | 0 | 2 | 6 | 0 | 0.2 | 0.5 | 5 | 4.54% | 20.42% | 1.31% | 100 |
| N660 | 1 | 1.5 | 6 | 0 | BAL | 4 | 0 | 2 | 6 | 0 | 0.2 | 0.5 | 10 | 6.18% | 21.12% | 1.30% | 0 |
| N661 | 1 | 1.5 | 6 | 0 | BAL | 4 | 0 | 2 | 6 | 0 | 0.2 | 0.5 | 15 | 8.19% | 16.74% | 1.33% | 0 |
| N662 | 1 | 1.5 | 6 | 0 | BAL | 4 | 0 | 2 | 8 | 0 | 0.2 | 0.5 | 5 | 4.76% | 20.03% | 1.31% | 0 |
| N663 | 1 | 1.5 | 6 | 0 | BAL | 4 | 0 | 2 | 8 | 0 | 0.2 | 0.5 | 10 | 6.41% | 20.71% | 1.29% | 0 |
| N664 | 1 | 1.5 | 6 | 0 | BAL | 4 | 0 | 2 | 8 | 0 | 0.2 | 0.5 | 15 | 8.05% | 16.73% | 1.33% | 0 |
| N665 | 1 | 1.5 | 6 | 0 | BAL | 4 | 0 | 2 | 10 | 0 | 0.2 | 0.5 | 5 | 4.76% | 20.05% | 1.30% | 50 |
| N666 | 1 | 1.5 | 6 | 0 | BAL | 4 | 0 | 2 | 10 | 0 | 0.2 | 0.5 | 10 | 6.41% | 20.73% | 1.29% | 0 |
| N667 | 1 | 1.5 | 6 | 0 | BAL | 4 | 0 | 2 | 10 | 0 | 0.2 | 0.5 | 15 | 8.02% | 16.75% | 1.33% | 0 |
| N668 | 1 | 1.5 | 6 | 0 | BAL | 4 | 0 | 4 | 4 | 0 | 0.2 | 0.5 | 5 | 2.89% | 16.05% | 1.11% | 100 |
| N669 | 1 | 1.5 | 6 | 0 | BAL | 4 | 0 | 4 | 4 | 0 | 0.2 | 0.5 | 10 | 7.71% | 20.88% | 1.10% | 0 |
| N670 | 1 | 1.5 | 6 | 0 | BAL | 4 | 0 | 4 | 4 | 0 | 0.2 | 0.5 | 15 | 4.61% | 22.65% | 1.13% | 0 |
| N671 | 1 | 1.5 | 6 | 0 | BAL | 4 | 0 | 4 | 6 | 0 | 0.2 | 0.5 | 5 | 2.95% | 15.89% | 1.11% | 100 |
| N672 | 1 | 1.5 | 6 | 0 | BAL | 4 | 0 | 4 | 6 | 0 | 0.2 | 0.5 | 10 | 6.63% | 12.73% | 1.10% | 0 |
| N673 | 1 | 1.5 | 6 | 0 | BAL | 4 | 0 | 4 | 8 | 0 | 0.2 | 0.5 | 5 | 3.18% | 15.41% | 1.10% | 100 |
| N674 | 1 | 1.5 | 6 | 0 | BAL | 4 | 0 | 4 | 8 | 0 | 0.2 | 0.5 | 10 | 6.71% | 12.30% | 1.09% | 0 |
| N675 | 1 | 1.5 | 6 | 0 | BAL | 4 | 0 | 4 | 10 | 0 | 0.2 | 0.5 | 5 | 3.18% | 15.43% | 1.10% | 0 |
| N676 | 1 | 1.5 | 6 | 0 | BAL | 4 | 0 | 4 | 10 | 0 | 0.2 | 0.5 | 10 | 3.07% | 15.88% | 1.08% | 0 |
| N677 | 0 | 0.95 | 5.5 | 0 | BAL | 1 | 0.7 | 0 | 0 | 0.5 | 2.3 | 0.07 | 0 | 8.02% | 5.20% | 0.81% | 600 |
| N678 | 0 | 0.95 | 5.5 | 0 | BAL | 1 | 0.7 | 0.25 | 0 | 0.5 | 2.3 | 0.07 | 0 | 7.43% | 5.46% | 0.76% | 600 |
| N679 | 0 | 0.95 | 5.5 | 0 | BAL | 1 | 0.7 | 0.5 | 0 | 0.5 | 2.3 | 0.07 | 0 | 6.89% | 5.71% | 0.72% | 600 |
| N680 | 0.1 | 0.95 | 5.5 | 0 | BAL | 1 | 0.7 | 0 | 0 | 0.5 | 2.3 | 0.07 | 0 | 9.58% | 5.20% | 0.79% | 400 |
| N681 | 0.1 | 0.95 | 5.5 | 0 | BAL | 1 | 0.7 | 0.25 | 0 | 0.5 | 2.3 | 0.07 | 0 | 9.64% | 5.48% | 0.77% | 400 |
| N682 | 0.1 | 0.95 | 5.5 | 0 | BAL | 1 | 0.7 | 0.5 | 0 | 0.5 | 2.3 | 0.07 | 0 | 9.69% | 5.75% | 0.74% | 400 |
| N683 | 0.3 | 0.95 | 5.5 | 0 | BAL | 1 | 0.7 | 0 | 0 | 0.5 | 2.3 | 0.07 | 0 | 9.85% | 5.25% | 0.76% | 300 |
| N684 | 0.6 | 2.4 | 0 | 0 | BAL | 1.16 | 0.74 | 6 | 0 | 0.76 | 6 | 0 | 0 | 8.74% | 19.23% | 0.76% | 700 |
| N685 | 0.6 | 2.6 | 0 | 0 | BAL | 1.16 | 0.74 | 6 | 0 | 0.76 | 6 | 0 | 0 | 9.52% | 19.10% | 0.93% | 700 |
| N686 | 0.6 | 2.6 | 0 | 0 | BAL | 1.16 | 0.74 | 6 | 0 | 0.76 | 7 | 0 | 0 | 8.46% | 21.17% | 0.76% | 700 |
| N687 | 0.6 | 2.6 | 0 | 0 | BAL | 1.16 | 0.74 | 7 | 0 | 0.76 | 6 | 0 | 0 | 9.01% | 20.25% | 0.82% | 650 |
| N688 | 0.6 | 2.6 | 0 | 0 | BAL | 1.16 | 0.74 | 8 | 0 | 0.76 | 6 | 0 | 0 | 8.50% | 21.42% | 0.72% | 650 |
| N689 | 0 | 1 | 0 | 0 | BAL | 1.16 | 0.74 | 0 | 0 | 0.76 | 3 | 0.5 | 0 | 2.20% | 7.68% | 0.76% | 850 |
| N690 | 0 | 1 | 0 | 0 | BAL | 1.16 | 0.74 | 0 | 0 | 0.76 | 3 | 0.5 | 2 | 3.14% | 7.92% | 0.75% | 750 |
| N691 | 0 | 1 | 0 | 0 | BAL | 1.16 | 0.74 | 0 | 0 | 0.76 | 3 | 0.5 | 4 | 1.09% | 7.84% | 0.73% | 600 |
| N692 | 0 | 1 | 0 | 0 | BAL | 1.16 | 0.74 | 0 | 0 | 0.76 | 3 | 0.5 | 6 | 4.49% | 7.74% | 0.72% | 450 |
| N693 | 0 | 1 | 0 | 0 | BAL | 1.16 | 0.74 | 0 | 0 | 0.76 | 3 | 0.5 | 8 | 0.58% | 7.52% | 0.71% | 350 |
| N694 | 0 | 1 | 0 | 0 | BAL | 1.16 | 0.74 | 0 | 0 | 0.76 | 3 | 0.5 | 10 | 1.24% | 7.54% | 0.70% | 300 |
| N695 | 0 | 1.5 | 0 | 0 | BAL | 1.16 | 0.74 | 0 | 0 | 0.76 | 3 | 0.5 | 0 | 1.79% | 6.78% | 1.08% | 800 |
| N696 | 0 | 1.5 | 0 | 0 | BAL | 1.16 | 0.74 | 0 | 0 | 0.76 | 3 | 0.5 | 8 | 0.51% | 8.13% | 1.01% | 300 |
| N697 | 0 | 1.5 | 0 | 0 | BAL | 1.16 | 0.74 | 0 | 0 | 0.76 | 3 | 0.5 | 10 | 3.65% | 8.22% | 1.00% | 200 |
| N698 | 0 | 1.5 | 0 | 0 | BAL | 1.16 | 0.74 | 0 | 0 | 0.76 | 3 | 0.5 | 12 | 4.98% | 8.33% | 0.99% | 150 |
| N699 | 0 | 1.5 | 0 | 0 | BAL | 1.16 | 0.74 | 0 | 0 | 0.76 | 3 | 0.5 | 14 | 7.21% | 8.45% | 0.97% | 100 |
| N700 | 0 | 1.5 | 0 | 0 | BAL | 1.16 | 0.74 | 0 | 0 | 0.76 | 3 | 0.5 | 16 | 9.51% | 8.58% | 0.96% | 100 |
| N701 | 0 | 1.5 | 0 | 0 | BAL | 1.16 | 0.74 | 0 | 0 | 0.76 | 3 | 0.5 | 28 | 2.29% | 9.15% | 0.88% | 50 |
| N702 | 0 | 1.5 | 0 | 0 | BAL | 1.16 | 0.74 | 0 | 0 | 0.76 | 3 | 0.5 | 30 | 2.13% | 9.03% | 0.87% | 0 |
| N703 | 0 | 1.5 | 0 | 0 | BAL | 1.16 | 0.74 | 2 | 0 | 0.76 | 3 | 0.5 | 0 | 1.73% | 8.90% | 0.88% | 700 |
| N704 | 0 | 1.5 | 0 | 0 | BAL | 1.16 | 0.74 | 2 | 0 | 0.76 | 3 | 0.5 | 14 | 3.48% | 9.77% | 0.76% | 100 |
| N705 | 0 | 1.5 | 0 | 0 | BAL | 1.16 | 0.74 | 2 | 0 | 0.76 | 3 | 0.5 | 16 | 3.24% | 9.86% | 0.75% | 100 |
| N706 | 0 | 1.5 | 0 | 0 | BAL | 1.16 | 0.74 | 2 | 0 | 0.76 | 3 | 0.5 | 18 | 1.99% | 10.83% | 0.74% | 100 |
| N707 | 0 | 1.5 | 0 | 0 | BAL | 1.16 | 0.74 | 2 | 0 | 0.76 | 3 | 0.5 | 24 | 1.38% | 10.39% | 0.72% | 50 |
| N708 | 0 | 1.5 | 0 | 0 | BAL | 1.16 | 0.74 | 2 | 0 | 0.76 | 3 | 0.5 | 26 | 0.75% | 10.55% | 0.71% | 0 |
| N709 | 0 | 1.5 | 0 | 0 | BAL | 1.16 | 0.74 | 2 | 0 | 0.76 | 3 | 0.5 | 30 | 0.63% | 10.90% | 0.71% | 0 |
| N710 | 0 | 2 | 0 | 0 | BAL | 1.16 | 0.74 | 0 | 0 | 0.76 | 3 | 0.5 | 4 | 2.37% | 7.20% | 1.50% | 450 |
| N711 | 0 | 2 | 0 | 0 | BAL | 1.16 | 0.74 | 0 | 0 | 0.76 | 3 | 0.5 | 6 | 2.40% | 7.30% | 1.49% | 350 |
| N712 | 0 | 2 | 0 | 0 | BAL | 1.16 | 0.74 | 0 | 0 | 0.76 | 3 | 0.5 | 8 | 9.63% | 7.40% | 1.45% | 300 |
| N713 | 0 | 2 | 0 | 0 | BAL | 1.16 | 0.74 | 0 | 0 | 0.76 | 3 | 0.5 | 10 | 0.77% | 7.51% | 1.39% | 150 |
| N714 | 0 | 2 | 0 | 0 | BAL | 1.16 | 0.74 | 0 | 0 | 0.76 | 3 | 0.5 | 16 | 2.16% | 8.43% | 1.35% | 50 |
| N715 | 0 | 2 | 0 | 0 | BAL | 1.16 | 0.74 | 0 | 0 | 0.76 | 3 | 0.5 | 18 | 4.20% | 8.54% | 1.33% | 50 |
| N716 | 0 | 2 | 0 | 0 | BAL | 1.16 | 0.74 | 0 | 0 | 0.76 | 3 | 0.5 | 20 | 5.62% | 8.66% | 1.32% | 50 |
| N717 | 0 | 2 | 0 | 0 | BAL | 1.16 | 0.74 | 0 | 0 | 0.76 | 3 | 0.5 | 22 | 7.95% | 8.79% | 1.30% | 50 |
| N718 | 0 | 2 | 0 | 0 | BAL | 1.16 | 0.74 | 2 | 0 | 0.76 | 3 | 0.5 | 0 | 1.70% | 8.75% | 1.28% | 600 |
| N719 | 0 | 2 | 0 | 0 | BAL | 1.16 | 0.74 | 2 | 0 | 0.76 | 3 | 0.5 | 2 | 7.11% | 8.87% | 1.27% | 550 |
| N720 | 0 | 2 | 0 | 0 | BAL | 1.16 | 0.74 | 2 | 0 | 0.76 | 3 | 0.5 | 4 | 7.78% | 8.99% | 1.25% | 450 |
| N721 | 0 | 2 | 0 | 0 | BAL | 1.16 | 0.74 | 2 | 0 | 0.76 | 3 | 0.5 | 6 | 8.47% | 9.11% | 1.24% | 350 |
| N722 | 0 | 2 | 0 | 0 | BAL | 1.16 | 0.74 | 2 | 0 | 0.76 | 3 | 0.5 | 18 | 8.36% | 11.05% | 1.13% | 50 |
| N723 | 0 | 2 | 0 | 0 | BAL | 1.16 | 0.74 | 4 | 0 | 0.76 | 3 | 0.5 | 0 | 1.72% | 11.07% | 1.06% | 600 |
| N724 | 0 | 2 | 0 | 0 | BAL | 1.16 | 0.74 | 4 | 0 | 0.76 | 3 | 0.5 | 8 | 8.16% | 11.63% | 1.01% | 250 |
| N725 | 0 | 2 | 0 | 0 | BAL | 1.16 | 0.74 | 4 | 0 | 0.76 | 3 | 0.5 | 10 | 8.01% | 11.76% | 1.00% | 150 |
| N726 | 0 | 2 | 0 | 0 | BAL | 1.16 | 0.74 | 4 | 0 | 0.76 | 3 | 0.5 | 12 | 3.40% | 11.93% | 0.99% | 100 |
| N727 | 0 | 2 | 0 | 0 | BAL | 1.16 | 0.74 | 4 | 0 | 0.76 | 3 | 0.5 | 14 | 3.44% | 12.10% | 0.98% | 100 |
| N728 | 0 | 2 | 0 | 0 | BAL | 1.16 | 0.74 | 4 | 0 | 0.76 | 3 | 0.5 | 16 | 3.48% | 12.27% | 0.97% | 100 |
| N729 | 0 | 2 | 0 | 0 | BAL | 1.16 | 0.74 | 4 | 0 | 0.76 | 3 | 0.5 | 22 | 3.62% | 12.84% | 0.95% | 50 |
| N730 | 0 | 2 | 0 | 0 | BAL | 1.16 | 0.74 | 4 | 0 | 0.76 | 3 | 0.5 | 24 | 4.21% | 13.03% | 0.94% | 50 |
| N731 | 0 | 2 | 0 | 0 | BAL | 1.16 | 0.74 | 4 | 0 | 0.76 | 3 | 0.5 | 28 | 2.64% | 14.23% | 0.92% | 0 |
| N732 | 0 | 2 | 0 | 0 | BAL | 1.16 | 0.74 | 4 | 0 | 0.76 | 3 | 0.5 | 30 | 3.12% | 36.84% | 0.90% | 0 |
| N733 | 0 | 2 | 0 | 0 | BAL | 1.16 | 0.74 | 6 | 0 | 0.76 | 3 | 0.5 | 0 | 2.37% | 13.42% | 0.88% | 650 |
| N734 | 0 | 2 | 0 | 0 | BAL | 1.16 | 0.74 | 6 | 0 | 0.76 | 3 | 0.5 | 4 | 3.17% | 13.73% | 0.85% | 450 |
| N735 | 0 | 2 | 0 | 0 | BAL | 1.16 | 0.74 | 6 | 0 | 0.76 | 3 | 0.5 | 6 | 5.62% | 13.86% | 0.81% | 350 |
| N736 | 0 | 2 | 0 | 0 | BAL | 1.16 | 0.74 | 6 | 0 | 0.76 | 3 | 0.5 | 8 | 5.95% | 14.05% | 0.80% | 200 |
| N737 | 0 | 2 | 0 | 0 | BAL | 1.16 | 0.74 | 6 | 0 | 0.76 | 3 | 0.5 | 10 | 4.56% | 14.25% | 0.80% | 150 |
| N738 | 0 | 2 | 0 | 0 | BAL | 1.16 | 0.74 | 6 | 0 | 0.76 | 3 | 0.5 | 12 | 2.26% | 15.62% | 0.79% | 100 |
| N739 | 0.8 | 2.6 | 0 | 0 | BAL | 1.16 | 0.74 | 7 | 0 | 0.76 | 7 | 0 | 0 | 9.40% | 21.66% | 0.73% | 700 |
| N740 | 1 | 2.6 | 0 | 0 | BAL | 1.16 | 0.74 | 6 | 0 | 0.76 | 8 | 0 | 0 | 9.02% | 21.39% | 0.75% | 700 |
| N741 | 1 | 2.6 | 0 | 0 | BAL | 1.16 | 0.74 | 8 | 0 | 0.76 | 7 | 0 | 0 | 8.92% | 21.57% | 0.71% | 650 |
| N742 | 0 | 2 | 0 | 0 | BAL | 1.16 | 0.74 | 6 | 0 | 0.76 | 3 | 0.5 | 24 | 0.67% | 33.26% | 0.75% | 0 |
| N743 | 0 | 2 | 0 | 0 | BAL | 1.16 | 0.74 | 6 | 0 | 0.76 | 3 | 0.5 | 26 | 0.37% | 34.15% | 0.74% | 0 |
| N744 | 0 | 2 | 0 | 0 | BAL | 1.16 | 0.74 | 6 | 0 | 0.76 | 3 | 0.5 | 28 | 0.78% | 35.07% | 0.74% | 0 |
| N745 | 0 | 2 | 0 | 0 | BAL | 1.16 | 0.74 | 6 | 0 | 0.76 | 3 | 0.5 | 30 | 0.00% | 35.86% | 0.75% | 0 |
| N746 | 0 | 2.5 | 0 | 0 | BAL | 1.16 | 0.74 | 4 | 0 | 0.76 | 3 | 0.5 | 6 | 9.47% | 11.32% | 1.48% | 300 |
| N747 | 0 | 2.5 | 0 | 0 | BAL | 1.16 | 0.74 | 4 | 0 | 0.76 | 3 | 0.5 | 14 | 2.90% | 11.94% | 1.41% | 100 |
| N748 | 0 | 2.5 | 0 | 0 | BAL | 1.16 | 0.74 | 4 | 0 | 0.76 | 3 | 0.5 | 20 | 3.52% | 12.40% | 1.37% | 50 |
| N749 | 0 | 2.5 | 0 | 0 | BAL | 1.16 | 0.74 | 4 | 0 | 0.76 | 3 | 0.5 | 22 | 2.71% | 13.44% | 1.35% | 0 |
| N750 | 0 | 2.5 | 0 | 0 | BAL | 1.16 | 0.74 | 6 | 0 | 0.76 | 3 | 0.5 | 0 | 6.19% | 13.19% | 1.30% | 550 |
| N751 | 0 | 2.5 | 0 | 0 | BAL | 1.16 | 0.74 | 6 | 0 | 0.76 | 3 | 0.5 | 2 | 7.02% | 13.36% | 1.29% | 500 |
| N752 | 0 | 2.5 | 0 | 0 | BAL | 1.16 | 0.74 | 6 | 0 | 0.76 | 3 | 0.5 | 4 | 7.69% | 13.54% | 1.28% | 400 |
| N753 | 0 | 2.5 | 0 | 0 | BAL | 1.16 | 0.74 | 6 | 0 | 0.76 | 3 | 0.5 | 6 | 4.03% | 13.72% | 1.27% | 300 |
| N754 | 0 | 2.5 | 0 | 0 | BAL | 1.16 | 0.74 | 6 | 0 | 0.76 | 3 | 0.5 | 8 | 9.09% | 13.91% | 1.26% | 250 |
| N755 | 0 | 2.5 | 0 | 0 | BAL | 1.16 | 0.74 | 6 | 0 | 0.76 | 3 | 0.5 | 10 | 2.88% | 14.08% | 1.25% | 200 |
| N756 | 0 | 2.5 | 0 | 0 | BAL | 1.16 | 0.74 | 6 | 0 | 0.76 | 3 | 0.5 | 18 | 3.50% | 14.81% | 1.17% | 50 |
| N757 | 0 | 2.5 | 0 | 0 | BAL | 1.16 | 0.74 | 6 | 0 | 0.76 | 3 | 0.5 | 28 | 5.97% | 16.87% | 1.10% | 350 |
| N758 | 0 | 1 | 0 | 0 | BAL | 1.16 | 0 | 0 | 0 | 0.76 | 3 | 0.5 | 0 | 2.35% | 7.14% | 0.76% | 950 |
| N759 | 0 | 1 | 0 | 0 | BAL | 1.16 | 2 | 0 | 0 | 0.76 | 3 | 0.5 | 0 | 2.07% | 7.76% | 0.76% | 650 |
| N760 | 0 | 1 | 0 | 0 | BAL | 1.16 | 4 | 0 | 0 | 0.76 | 3 | 0.5 | 0 | 4.74% | 7.69% | 0.75% | 450 |
| N761 | 0 | 1.5 | 0 | 0 | BAL | 1.16 | 0 | 0 | 0 | 0.76 | 3 | 0.5 | 0 | 4.51% | 7.02% | 1.11% | 950 |
| N762 | 0 | 1.5 | 0 | 0 | BAL | 1.16 | 0 | 2 | 0 | 0.76 | 3 | 0.5 | 0 | 2.66% | 10.16% | 0.88% | 950 |
| N763 | 0 | 1.5 | 0 | 0 | BAL | 1.16 | 2 | 0 | 0 | 0.76 | 3 | 0.5 | 0 | 1.43% | 6.81% | 1.07% | 650 |
| N764 | 0 | 1.5 | 0 | 0 | BAL | 1.16 | 2 | 2 | 0 | 0.76 | 3 | 0.5 | 0 | 1.79% | 8.95% | 0.88% | 500 |
| N765 | 0 | 1.5 | 0 | 0 | BAL | 1.16 | 4 | 0 | 0 | 0.76 | 3 | 0.5 | 0 | 1.44% | 6.87% | 1.07% | 350 |
| N766 | 0 | 1.5 | 0 | 0 | BAL | 1.16 | 4 | 2 | 0 | 0.76 | 3 | 0.5 | 0 | 3.68% | 9.02% | 0.82% | 350 |
| N767 | 0 | 1.5 | 0 | 0 | BAL | 1.16 | 6 | 0 | 0 | 0.76 | 3 | 0.5 | 0 | 3.19% | 6.92% | 1.07% | 200 |
| N768 | 0 | 1.5 | 0 | 0 | BAL | 1.16 | 6 | 2 | 0 | 0.76 | 3 | 0.5 | 0 | 8.62% | 9.09% | 0.81% | 200 |
| N769 | 0 | 1.5 | 0 | 0 | BAL | 1.16 | 8 | 0 | 0 | 0.76 | 3 | 0.5 | 0 | 7.86% | 6.97% | 1.07% | 100 |
| N770 | 0 | 1.5 | 0 | 0 | BAL | 1.16 | 10 | 0 | 0 | 0.76 | 3 | 0.5 | 0 | 9.07% | 7.03% | 1.06% | 100 |
| N771 | 0 | 1.5 | 0 | 0 | BAL | 1.16 | 16 | 0 | 0 | 0.76 | 3 | 0.5 | 0 | 1.76% | 25.03% | 0.99% | 0 |
| N772 | 0 | 1.5 | 0 | 0 | BAL | 1.16 | 18 | 0 | 0 | 0.76 | 3 | 0.5 | 0 | 1.41% | 27.06% | 0.99% | 0 |
| N773 | 0 | 1.5 | 0 | 0 | BAL | 1.16 | 18 | 2 | 0 | 0.76 | 3 | 0.5 | 0 | 1.47% | 28.06% | 0.76% | 0 |
| N774 | 0 | 1.5 | 0 | 0 | BAL | 1.16 | 20 | 0 | 0 | 0.76 | 3 | 0.5 | 0 | 0.85% | 28.89% | 0.99% | 0 |
| N775 | 0 | 1.5 | 0 | 0 | BAL | 1.16 | 20 | 2 | 0 | 0.76 | 3 | 0.5 | 0 | 0.00% | 28.96% | 0.76% | 0 |
| N776 | 0 | 1.5 | 0 | 0 | BAL | 1.16 | 22 | 0 | 0 | 0.76 | 3 | 0.5 | 0 | 0.00% | 31.13% | 0.99% | 1300 |
| N777 | 0 | 1.5 | 0 | 0 | BAL | 1.16 | 22 | 2 | 0 | 0.76 | 3 | 0.5 | 0 | 0.00% | 29.58% | 0.73% | 0 |
| N778 | 0 | 1.5 | 0 | 0 | BAL | 1.16 | 24 | 0 | 0 | 0.76 | 3 | 0.5 | 0 | 0.00% | 33.34% | 0.90% | 1350 |
| N779 | 0 | 1.5 | 0 | 0 | BAL | 1.16 | 26 | 0 | 0 | 0.76 | 3 | 0.5 | 0 | 0.00% | 34.63% | 0.76% | 450 |
| N780 | 0 | 2 | 0 | 0 | BAL | 1.16 | 0 | 6 | 0 | 0.76 | 3 | 0.5 | 0 | 2.91% | 13.38% | 0.88% | 900 |
| N781 | 0 | 2 | 0 | 0 | BAL | 1.16 | 2 | 2 | 0 | 0.76 | 3 | 0.5 | 0 | 1.79% | 8.79% | 1.27% | 500 |
| N782 | 0 | 2 | 0 | 0 | BAL | 1.16 | 2 | 4 | 0 | 0.76 | 3 | 0.5 | 0 | 1.80% | 11.12% | 1.03% | 450 |
| N783 | 0 | 2 | 0 | 0 | BAL | 1.16 | 2 | 6 | 0 | 0.76 | 3 | 0.5 | 0 | 1.79% | 13.49% | 0.87% | 500 |
| N784 | 0 | 2 | 0 | 0 | BAL | 1.16 | 4 | 2 | 0 | 0.76 | 3 | 0.5 | 0 | 1.80% | 8.86% | 1.26% | 300 |
| N785 | 0 | 2 | 0 | 0 | BAL | 1.16 | 4 | 4 | 0 | 0.76 | 3 | 0.5 | 0 | 1.87% | 11.21% | 1.03% | 300 |
| N786 | 0 | 2 | 0 | 0 | BAL | 1.16 | 4 | 6 | 0 | 0.76 | 3 | 0.5 | 0 | 5.05% | 13.59% | 0.81% | 300 |
| N787 | 0 | 2 | 0 | 0 | BAL | 1.16 | 6 | 0 | 0 | 0.76 | 3 | 0.5 | 0 | 1.80% | 6.80% | 1.46% | 150 |
| N788 | 0 | 2 | 0 | 0 | BAL | 1.16 | 6 | 2 | 0 | 0.76 | 3 | 0.5 | 0 | 1.81% | 8.93% | 1.26% | 150 |
| N789 | 0 | 2 | 0 | 0 | BAL | 1.16 | 6 | 4 | 0 | 0.76 | 3 | 0.5 | 0 | 3.80% | 11.30% | 1.02% | 150 |
| N790 | 0 | 2 | 0 | 0 | BAL | 1.16 | 6 | 6 | 0 | 0.76 | 3 | 0.5 | 0 | 9.01% | 13.68% | 0.81% | 200 |
| N791 | 0 | 2 | 0 | 0 | BAL | 1.16 | 8 | 0 | 0 | 0.76 | 3 | 0.5 | 0 | 1.44% | 6.86% | 1.45% | 100 |
| N792 | 0 | 2 | 0 | 0 | BAL | 1.16 | 8 | 2 | 0 | 0.76 | 3 | 0.5 | 0 | 3.70% | 9.00% | 1.25% | 150 |
| N793 | 0 | 2 | 0 | 0 | BAL | 1.16 | 8 | 4 | 0 | 0.76 | 3 | 0.5 | 0 | 6.75% | 11.39% | 1.01% | 100 |
| N794 | 0 | 2 | 0 | 0 | BAL | 1.16 | 10 | 0 | 0 | 0.76 | 3 | 0.5 | 0 | 3.25% | 6.91% | 1.45% | 100 |
| N795 | 0 | 2 | 0 | 0 | BAL | 1.16 | 10 | 4 | 0 | 0.76 | 3 | 0.5 | 0 | 9.68% | 11.48% | 1.01% | 100 |
| N796 | 0 | 2 | 0 | 0 | BAL | 1.16 | 12 | 0 | 0 | 0.76 | 3 | 0.5 | 0 | 6.22% | 6.96% | 1.44% | 50 |
| N797 | 0 | 2 | 0 | 0 | BAL | 1.16 | 14 | 0 | 0 | 0.76 | 3 | 0.5 | 0 | 9.15% | 7.02% | 1.43% | 50 |
| N798 | 0 | 2 | 0 | 0 | BAL | 1.16 | 16 | 0 | 0 | 0.76 | 3 | 0.5 | 0 | 1.48% | 17.68% | 1.37% | 0 |
| N799 | 0 | 2 | 0 | 0 | BAL | 1.16 | 16 | 4 | 0 | 0.76 | 3 | 0.5 | 0 | 2.90% | 28.50% | 0.95% | 0 |
| N800 | 0 | 2 | 0 | 0 | BAL | 1.16 | 16 | 6 | 0 | 0.76 | 3 | 0.5 | 0 | 0.31% | 30.99% | 0.75% | 0 |
| N801 | 0 | 2 | 0 | 0 | BAL | 1.16 | 18 | 0 | 0 | 0.76 | 3 | 0.5 | 0 | 1.50% | 20.68% | 1.35% | 450 |
| N802 | 0 | 2 | 0 | 0 | BAL | 1.16 | 18 | 2 | 0 | 0.76 | 3 | 0.5 | 0 | 1.87% | 25.98% | 1.17% | 0 |
| N803 | 0 | 2 | 0 | 0 | BAL | 1.16 | 18 | 4 | 0 | 0.76 | 3 | 0.5 | 0 | 2.50% | 30.65% | 0.95% | 0 |
| N804 | 0 | 2 | 0 | 0 | BAL | 1.16 | 18 | 6 | 0 | 0.76 | 3 | 0.5 | 0 | 0.73% | 33.10% | 0.75% | 0 |
| N805 | 0 | 2 | 0 | 0 | BAL | 1.16 | 20 | 0 | 0 | 0.76 | 3 | 0.5 | 0 | 1.51% | 23.71% | 1.28% | 500 |
| N806 | 0 | 2 | 0 | 0 | BAL | 1.16 | 20 | 2 | 0 | 0.76 | 3 | 0.5 | 0 | 1.76% | 29.43% | 1.16% | 550 |
| N807 | 0 | 2 | 0 | 0 | BAL | 1.16 | 20 | 4 | 0 | 0.76 | 3 | 0.5 | 0 | 1.98% | 32.66% | 0.95% | 0 |
| N808 | 0 | 2 | 0 | 0 | BAL | 1.16 | 20 | 6 | 0 | 0.76 | 3 | 0.5 | 0 | 1.62% | 34.87% | 0.75% | 0 |
| N809 | 0 | 2 | 0 | 0 | BAL | 1.16 | 22 | 0 | 0 | 0.76 | 3 | 0.5 | 0 | 1.52% | 26.78% | 1.22% | 550 |
| N810 | 0 | 2 | 0 | 0 | BAL | 1.16 | 22 | 2 | 0 | 0.76 | 3 | 0.5 | 0 | 3.38% | 32.80% | 1.09% | 550 |
| N811 | 0 | 2 | 0 | 0 | BAL | 1.16 | 22 | 4 | 0 | 0.76 | 3 | 0.5 | 0 | 0.42% | 24.04% | 0.89% | 1250 |
| N812 | 0 | 2 | 0 | 0 | BAL | 1.16 | 24 | 0 | 0 | 0.76 | 3 | 0.5 | 0 | 1.53% | 29.89% | 1.20% | 550 |
| N813 | 0 | 2 | 0 | 0 | BAL | 1.16 | 24 | 2 | 0 | 0.76 | 3 | 0.5 | 0 | 2.93% | 35.48% | 1.01% | 600 |
| N814 | 0 | 2 | 0 | 0 | BAL | 1.16 | 24 | 4 | 0 | 0.76 | 3 | 0.5 | 0 | 0.11% | 38.07% | 0.82% | 1350 |
| N815 | 0 | 2 | 0 | 0 | BAL | 1.16 | 26 | 0 | 0 | 0.76 | 3 | 0.5 | 0 | 1.55% | 33.05% | 1.16% | 600 |
| N816 | 0 | 2 | 0 | 0 | BAL | 1.16 | 26 | 4 | 0 | 0.76 | 3 | 0.5 | 0 | 0.00% | 39.80% | 0.71% | 1250 |
| N817 | 0 | 2 | 0 | 0 | BAL | 1.16 | 28 | 0 | 0 | 0.76 | 3 | 0.5 | 0 | 1.31% | 36.63% | 1.07% | 600 |
| N818 | 0 | 2 | 0 | 0 | BAL | 1.16 | 30 | 0 | 0 | 0.76 | 3 | 0.5 | 0 | 2.58% | 40.59% | 0.99% | 650 |
| N819 | 0 | 2 | 0 | 0 | BAL | 1.16 | 30 | 2 | 0 | 0.76 | 3 | 0.5 | 0 | 0.97% | 42.47% | 0.73% | 1250 |
| N820 | 0 | 2.5 | 0 | 0 | BAL | 1.16 | 2 | 6 | 0 | 0.76 | 3 | 0.5 | 0 | 1.78% | 13.26% | 1.28% | 450 |
| N821 | 0 | 2.5 | 0 | 0 | BAL | 1.16 | 4 | 4 | 0 | 0.76 | 3 | 0.5 | 0 | 1.76% | 11.02% | 1.50% | 300 |
| N822 | 0 | 2.5 | 0 | 0 | BAL | 1.16 | 4 | 6 | 0 | 0.76 | 3 | 0.5 | 0 | 1.77% | 13.36% | 1.27% | 300 |
| N823 | 0 | 2.5 | 0 | 0 | BAL | 1.16 | 6 | 4 | 0 | 0.76 | 3 | 0.5 | 0 | 1.80% | 11.10% | 1.45% | 150 |
| N824 | 0 | 2.5 | 0 | 0 | BAL | 1.16 | 6 | 6 | 0 | 0.76 | 3 | 0.5 | 0 | 1.79% | 13.47% | 1.25% | 150 |
| N825 | 0 | 2.5 | 0 | 0 | BAL | 1.16 | 8 | 4 | 0 | 0.76 | 3 | 0.5 | 0 | 1.88% | 11.19% | 1.44% | 100 |
| N826 | 0 | 2.5 | 0 | 0 | BAL | 1.16 | 8 | 6 | 0 | 0.76 | 3 | 0.5 | 0 | 3.96% | 13.57% | 1.23% | 150 |
| N827 | 0 | 2.5 | 0 | 0 | BAL | 1.16 | 10 | 4 | 0 | 0.76 | 3 | 0.5 | 0 | 5.12% | 11.28% | 1.43% | 100 |
| N828 | 0 | 2.5 | 0 | 0 | BAL | 1.16 | 10 | 6 | 0 | 0.76 | 3 | 0.5 | 0 | 6.92% | 13.68% | 1.19% | 50 |
| N829 | 0 | 2.5 | 0 | 0 | BAL | 1.16 | 12 | 4 | 0 | 0.76 | 3 | 0.5 | 0 | 6.83% | 11.37% | 1.41% | 50 |
| N830 | 0 | 2.5 | 0 | 0 | BAL | 1.16 | 12 | 6 | 0 | 0.76 | 3 | 0.5 | 0 | 9.85% | 13.79% | 1.18% | 50 |
| N831 | 0 | 2.5 | 0 | 0 | BAL | 1.16 | 14 | 4 | 0 | 0.76 | 3 | 0.5 | 0 | 9.76% | 11.46% | 1.40% | 50 |
| N832 | 0 | 2.5 | 0 | 0 | BAL | 1.16 | 16 | 4 | 0 | 0.76 | 3 | 0.5 | 0 | 1.84% | 22.41% | 1.37% | 0 |
| N833 | 0 | 2.5 | 0 | 0 | BAL | 1.16 | 16 | 6 | 0 | 0.76 | 3 | 0.5 | 0 | 1.86% | 27.89% | 1.16% | 0 |
| N834 | 0 | 2.5 | 0 | 0 | BAL | 1.16 | 18 | 4 | 0 | 0.76 | 3 | 0.5 | 0 | 1.86% | 25.45% | 1.32% | 350 |
| N835 | 0 | 2.5 | 0 | 0 | BAL | 1.16 | 18 | 6 | 0 | 0.76 | 3 | 0.5 | 0 | 1.88% | 30.97% | 1.15% | 0 |
| N836 | 0 | 2.5 | 0 | 0 | BAL | 1.16 | 20 | 2 | 0 | 0.76 | 3 | 0.5 | 0 | 1.86% | 23.00% | 1.49% | 350 |
| N837 | 0 | 2.5 | 0 | 0 | BAL | 1.16 | 20 | 4 | 0 | 0.76 | 3 | 0.5 | 0 | 1.88% | 28.51% | 1.24% | 400 |
| N838 | 0 | 2.5 | 0 | 0 | BAL | 1.16 | 20 | 6 | 0 | 0.76 | 3 | 0.5 | 0 | 2.37% | 34.59% | 1.11% | 550 |
| N839 | 0 | 2.5 | 0 | 0 | BAL | 1.16 | 22 | 2 | 0 | 0.76 | 3 | 0.5 | 0 | 1.87% | 26.04% | 1.42% | 350 |
| N840 | 0 | 2.5 | 0 | 0 | BAL | 1.16 | 22 | 4 | 0 | 0.76 | 3 | 0.5 | 0 | 1.89% | 31.62% | 1.22% | 450 |
| N841 | 0 | 2.5 | 0 | 0 | BAL | 1.16 | 22 | 6 | 0 | 0.76 | 3 | 0.5 | 0 | 3.31% | 37.64% | 1.03% | 550 |
| N842 | 0 | 2.5 | 0 | 0 | BAL | 1.16 | 24 | 2 | 0 | 0.76 | 3 | 0.5 | 0 | 1.89% | 29.13% | 1.34% | 400 |
| N843 | 0 | 2.5 | 0 | 0 | BAL | 1.16 | 24 | 4 | 0 | 0.76 | 3 | 0.5 | 0 | 1.91% | 34.76% | 1.17% | 500 |
| N844 | 0 | 2.5 | 0 | 0 | BAL | 1.16 | 24 | 6 | 0 | 0.76 | 3 | 0.5 | 0 | 1.75% | 41.55% | 0.96% | 600 |
| N845 | 0 | 2.5 | 0 | 0 | BAL | 1.16 | 26 | 2 | 0 | 0.76 | 3 | 0.5 | 0 | 1.90% | 32.25% | 1.25% | 400 |
| N846 | 0 | 2.5 | 0 | 0 | BAL | 1.16 | 26 | 4 | 0 | 0.76 | 3 | 0.5 | 0 | 1.92% | 37.95% | 1.09% | 500 |
| N847 | 0 | 2.5 | 0 | 0 | BAL | 1.16 | 26 | 6 | 0 | 0.76 | 3 | 0.5 | 0 | 1.40% | 43.55% | 0.89% | 650 |
| N848 | 0 | 2.5 | 0 | 0 | BAL | 1.16 | 28 | 0 | 0 | 0.76 | 3 | 0.5 | 0 | 1.53% | 29.95% | 1.44% | 400 |
| N849 | 0 | 2.5 | 0 | 0 | BAL | 1.16 | 28 | 2 | 0 | 0.76 | 3 | 0.5 | 0 | 1.92% | 35.42% | 1.19% | 450 |
| N850 | 0 | 2.5 | 0 | 0 | BAL | 1.16 | 28 | 4 | 0 | 0.76 | 3 | 0.5 | 0 | 2.52% | 41.75% | 1.01% | 550 |
| N851 | 0 | 2.5 | 0 | 0 | BAL | 1.16 | 28 | 6 | 0 | 0.76 | 3 | 0.5 | 0 | 1.06% | 31.08% | 0.82% | 850 |
| N852 | 0 | 2.5 | 0 | 0 | BAL | 1.16 | 30 | 0 | 0 | 0.76 | 3 | 0.5 | 0 | 1.55% | 33.10% | 1.35% | 400 |
| N853 | 0 | 2.5 | 0 | 0 | BAL | 1.16 | 30 | 2 | 0 | 0.76 | 3 | 0.5 | 0 | 1.94% | 38.63% | 1.15% | 500 |
| N854 | 0 | 2.5 | 0 | 0 | BAL | 1.16 | 30 | 4 | 0 | 0.76 | 3 | 0.5 | 0 | 3.38% | 44.91% | 0.93% | 600 |
| N855 | 0 | 2.5 | 0 | 0 | BAL | 1.16 | 30 | 6 | 0 | 0.76 | 3 | 0.5 | 0 | 0.64% | 33.33% | 0.72% | 1250 |
| N856 | 0 | 3 | 0 | 0 | BAL | 1.16 | 20 | 6 | 0 | 0.76 | 3 | 0.5 | 0 | 1.86% | 27.96% | 1.47% | 300 |
| N857 | 0 | 3 | 0 | 0 | BAL | 1.16 | 22 | 6 | 0 | 0.76 | 3 | 0.5 | 0 | 1.87% | 31.04% | 1.40% | 300 |
| N858 | 0 | 3 | 0 | 0 | BAL | 1.16 | 24 | 6 | 0 | 0.76 | 3 | 0.5 | 0 | 1.89% | 34.15% | 1.33% | 350 |
| N859 | 0 | 3 | 0 | 0 | BAL | 1.16 | 26 | 6 | 0 | 0.76 | 3 | 0.5 | 0 | 1.90% | 37.31% | 1.25% | 350 |
| N860 | 0 | 3 | 0 | 0 | BAL | 1.16 | 28 | 4 | 0 | 0.76 | 3 | 0.5 | 0 | 1.90% | 34.81% | 1.44% | 300 |
| N861 | 0 | 3 | 0 | 0 | BAL | 1.16 | 28 | 6 | 0 | 0.76 | 3 | 0.5 | 0 | 1.92% | 40.51% | 1.18% | 400 |
| N862 | 0 | 3 | 0 | 0 | BAL | 1.16 | 30 | 4 | 0 | 0.76 | 3 | 0.5 | 0 | 1.92% | 38.00% | 1.35% | 350 |
| N863 | 0 | 3 | 0 | 0 | BAL | 1.16 | 30 | 6 | 0 | 0.76 | 3 | 0.5 | 0 | 1.94% | 43.76% | 1.13% | 450 |
| N864 | 0.5 | 2.5 | 0 | 0 | BAL | 1.16 | 0.74 | 4 | 0 | 0.76 | 6 | 4 | 0 | 9.23% | 14.94% | 0.98% | 600 |
| N865 | 0.5 | 2.5 | 0 | 0 | BAL | 1.16 | 0.74 | 4 | 0 | 0.76 | 6 | 6 | 0 | 3.90% | 14.48% | 0.92% | 600 |
| N866 | 0.5 | 2.5 | 0 | 0 | BAL | 1.16 | 0.74 | 6 | 0 | 0.76 | 6 | 4 | 0 | 4.15% | 2.53% | 0.79% | 600 |
| N867 | 0.5 | 2.5 | 0 | 0 | BAL | 1.16 | 0.74 | 6 | 0 | 0.76 | 6 | 6 | 0 | 7.97% | 16.43% | 0.79% | 700 |
| N868 | 0.5 | 2.5 | 0 | 0 | BAL | 1.16 | 0.74 | 10 | 0 | 0.76 | 4 | 2 | 0 | 7.39% | 18.17% | 0.72% | 450 |
| N869 | 0.5 | 2.5 | 0 | 0 | BAL | 1.16 | 0.74 | 10 | 0 | 0.76 | 4 | 6 | 0 | 8.79% | 16.55% | 0.71% | 500 |
| N870 | 0.5 | 3 | 0 | 0 | BAL | 1.16 | 0.74 | 4 | 0 | 0.76 | 6 | 0 | 0 | 6.68% | 16.66% | 1.45% | 500 |
| N871 | 0.5 | 3 | 0 | 0 | BAL | 1.16 | 0.74 | 4 | 0 | 0.76 | 8 | 0 | 0 | 6.66% | 20.73% | 1.12% | 650 |
| N872 | 0.5 | 3 | 0 | 0 | BAL | 1.16 | 0.74 | 4 | 0 | 0.76 | 8 | 2 | 0 | 9.57% | 20.17% | 1.07% | 650 |
| N873 | 0.5 | 3 | 0 | 0 | BAL | 1.16 | 0.74 | 4 | 0 | 0.76 | 8 | 4 | 0 | 9.23% | 18.77% | 1.00% | 600 |
| N874 | 0.5 | 3 | 0 | 0 | BAL | 1.16 | 0.74 | 4 | 0 | 0.76 | 8 | 6 | 0 | 4.50% | 18.21% | 0.94% | 700 |
| N875 | 0.5 | 3 | 0 | 0 | BAL | 1.16 | 0.74 | 4 | 0 | 0.76 | 10 | 0 | 0 | 5.06% | 24.57% | 0.76% | 700 |
| N876 | 0.5 | 3 | 0 | 0 | BAL | 1.16 | 0.74 | 4 | 0 | 0.76 | 10 | 2 | 0 | 4.32% | 22.24% | 0.73% | 750 |
| N877 | 0.5 | 3 | 0 | 0 | BAL | 1.16 | 0.74 | 4 | 0 | 0.76 | 10 | 4 | 0 | 1.33% | 21.90% | 0.71% | 800 |
| N878 | 0.5 | 3 | 0 | 0 | BAL | 1.16 | 0.74 | 4 | 0 | 0.76 | 10 | 6 | 0 | 1.67% | 21.68% | 0.71% | 850 |
| N879 | 0.5 | 3 | 0 | 0 | BAL | 1.16 | 0.74 | 6 | 0 | 0.76 | 6 | 0 | 0 | 6.73% | 18.92% | 1.21% | 550 |
| N880 | 0.5 | 3 | 0 | 0 | BAL | 1.16 | 0.74 | 6 | 0 | 0.76 | 8 | 0 | 0 | 6.71% | 23.01% | 0.89% | 650 |
| N881 | 0.5 | 3 | 0 | 0 | BAL | 1.16 | 0.74 | 6 | 0 | 0.76 | 8 | 4 | 0 | 4.44% | 20.41% | 0.84% | 700 |
| N882 | 0.5 | 3 | 0 | 0 | BAL | 1.16 | 0.74 | 6 | 0 | 0.76 | 8 | 6 | 0 | 8.15% | 20.12% | 0.83% | 700 |
| N883 | 0.5 | 3 | 0 | 0 | BAL | 1.16 | 0.74 | 8 | 0 | 0.76 | 4 | 0 | 0 | 6.79% | 17.08% | 1.34% | 250 |
| N884 | 0.5 | 3 | 0 | 0 | BAL | 1.16 | 0.74 | 8 | 0 | 0.76 | 6 | 0 | 0 | 6.77% | 21.22% | 1.02% | 550 |
| N885 | 0.5 | 3 | 0 | 0 | BAL | 1.16 | 0.74 | 8 | 0 | 0.76 | 6 | 2 | 0 | 5.08% | 25.23% | 0.99% | 550 |
| N886 | 0.5 | 3 | 0 | 0 | BAL | 1.16 | 0.74 | 8 | 0 | 0.76 | 6 | 6 | 0 | 7.17% | 2.82% | 0.89% | 550 |
| N887 | 0.5 | 3 | 0 | 0 | BAL | 1.16 | 0.74 | 10 | 0 | 0.76 | 4 | 0 | 0 | 6.84% | 19.38% | 1.10% | 250 |
| N888 | 0.5 | 3 | 0 | 0 | BAL | 1.16 | 0.74 | 10 | 0 | 0.76 | 6 | 0 | 0 | 6.82% | 23.55% | 0.80% | 550 |
| N889 | 0.5 | 3 | 0 | 0 | BAL | 1.16 | 0.74 | 10 | 0 | 0.76 | 6 | 4 | 0 | 1.96% | 2.57% | 0.79% | 550 |
| N890 | 0.5 | 3 | 0 | 0 | BAL | 1.16 | 0.74 | 10 | 0 | 0.76 | 6 | 6 | 0 | 8.34% | 20.52% | 0.77% | 600 |
| N891 | 0.5 | 3.5 | 0 | 0 | BAL | 1.16 | 0.74 | 4 | 0 | 0.76 | 10 | 0 | 0 | 6.53% | 24.39% | 1.20% | 700 |
| N892 | 0.5 | 3.5 | 0 | 0 | BAL | 1.16 | 0.74 | 4 | 0 | 0.76 | 10 | 2 | 0 | 9.28% | 23.85% | 1.12% | 700 |
| N893 | 0.5 | 3.5 | 0 | 0 | BAL | 1.16 | 0.74 | 4 | 0 | 0.76 | 10 | 4 | 0 | 9.21% | 22.48% | 1.01% | 700 |
| N894 | 0.5 | 3.5 | 0 | 0 | BAL | 1.16 | 0.74 | 4 | 0 | 0.76 | 10 | 6 | 0 | 5.07% | 21.81% | 0.95% | 700 |
| N895 | 0.5 | 3.5 | 0 | 0 | BAL | 1.16 | 0.74 | 6 | 0 | 0.76 | 8 | 0 | 0 | 6.60% | 22.65% | 1.30% | 600 |
| N896 | 0.5 | 3.5 | 0 | 0 | BAL | 1.16 | 0.74 | 6 | 0 | 0.76 | 10 | 0 | 0 | 6.58% | 26.65% | 0.97% | 700 |
| N897 | 0.5 | 3.5 | 0 | 0 | BAL | 1.16 | 0.74 | 6 | 0 | 0.76 | 10 | 2 | 0 | 6.88% | 25.24% | 0.92% | 650 |
| N898 | 0.5 | 3.5 | 0 | 0 | BAL | 1.16 | 0.74 | 6 | 0 | 0.76 | 10 | 4 | 0 | 7.27% | 23.99% | 0.88% | 700 |
| N899 | 0.5 | 3.5 | 0 | 0 | BAL | 1.16 | 0.74 | 6 | 0 | 0.76 | 10 | 6 | 0 | 1.26% | 23.70% | 0.86% | 750 |
| N900 | 0.5 | 3.5 | 0 | 0 | BAL | 1.16 | 0.74 | 8 | 0 | 0.76 | 6 | 0 | 0 | 6.66% | 20.87% | 1.45% | 400 |
| N901 | 0.5 | 3.5 | 0 | 0 | BAL | 1.16 | 0.74 | 8 | 0 | 0.76 | 8 | 0 | 0 | 6.65% | 24.93% | 1.11% | 600 |
| N902 | 0.5 | 3.5 | 0 | 0 | BAL | 1.16 | 0.74 | 8 | 0 | 0.76 | 8 | 2 | 0 | 9.33% | 24.27% | 1.06% | 600 |
| N903 | 0.5 | 3.5 | 0 | 0 | BAL | 1.16 | 0.74 | 8 | 0 | 0.76 | 8 | 6 | 0 | 5.94% | 3.69% | 0.92% | 650 |
| N904 | 0.5 | 3.5 | 0 | 0 | BAL | 1.16 | 0.74 | 8 | 0 | 0.76 | 10 | 0 | 0 | 4.63% | 28.60% | 0.75% | 650 |
| N905 | 0.5 | 3.5 | 0 | 0 | BAL | 1.16 | 0.74 | 8 | 0 | 0.76 | 10 | 2 | 0 | 1.33% | 3.41% | 0.72% | 700 |
| N906 | 0.5 | 3.5 | 0 | 0 | BAL | 1.16 | 0.74 | 8 | 0 | 0.76 | 10 | 4 | 0 | 1.27% | 25.92% | 0.71% | 800 |
| N907 | 0.5 | 3.5 | 0 | 0 | BAL | 1.16 | 0.74 | 8 | 0 | 0.76 | 10 | 6 | 0 | 6.21% | 25.62% | 0.71% | 800 |
| N908 | 0.5 | 3.5 | 0 | 0 | BAL | 1.16 | 0.74 | 10 | 0 | 0.76 | 6 | 0 | 0 | 6.71% | 23.16% | 1.22% | 450 |
| N909 | 0.5 | 3.5 | 0 | 0 | BAL | 1.16 | 0.74 | 10 | 0 | 0.76 | 8 | 0 | 0 | 6.69% | 27.24% | 0.89% | 650 |
| N910 | 0.5 | 3.5 | 0 | 0 | BAL | 1.16 | 0.74 | 10 | 0 | 0.76 | 8 | 4 | 0 | 1.60% | 3.43% | 0.84% | 650 |
| N911 | 0.5 | 3.5 | 0 | 0 | BAL | 1.16 | 0.74 | 10 | 0 | 0.76 | 8 | 6 | 0 | 8.40% | 24.17% | 0.81% | 650 |
| N912 | 0.5 | 4 | 0 | 0 | BAL | 1.16 | 0.74 | 6 | 0 | 0.76 | 10 | 0 | 0 | 6.48% | 26.24% | 1.40% | 650 |
| N913 | 0.5 | 4 | 0 | 0 | BAL | 1.16 | 0.74 | 8 | 0 | 0.76 | 10 | 0 | 0 | 6.52% | 28.50% | 1.21% | 650 |
| N914 | 0.5 | 4 | 0 | 0 | BAL | 1.16 | 0.74 | 8 | 0 | 0.76 | 10 | 2 | 0 | 9.03% | 27.81% | 1.10% | 650 |
| N915 | 0.5 | 4 | 0 | 0 | BAL | 1.16 | 0.74 | 8 | 0 | 0.76 | 10 | 6 | 0 | 5.59% | 25.72% | 0.94% | 650 |
| N916 | 0.5 | 4 | 0 | 0 | BAL | 1.16 | 0.74 | 10 | 0 | 0.76 | 8 | 0 | 0 | 6.59% | 26.80% | 1.32% | 550 |
| N917 | 0.5 | 4 | 0 | 0 | BAL | 1.16 | 0.74 | 10 | 0 | 0.76 | 10 | 0 | 0 | 6.57% | 30.79% | 0.97% | 650 |
| N918 | 0.5 | 4 | 0 | 0 | BAL | 1.16 | 0.74 | 10 | 0 | 0.76 | 10 | 4 | 0 | 2.58% | 4.19% | 0.89% | 650 |
| N919 | 0.5 | 4 | 0 | 0 | BAL | 1.16 | 0.74 | 10 | 0 | 0.76 | 10 | 6 | 0 | 0.93% | 27.69% | 0.83% | 750 |
| N920 | 0.5 | 4.5 | 0 | 0 | BAL | 1.16 | 0.74 | 10 | 0 | 0.76 | 10 | 0 | 0 | 6.46% | 30.31% | 1.42% | 600 |
| N921 | 1 | 2.5 | 0 | 0 | BAL | 1.16 | 0.74 | 4 | 0 | 0.76 | 8 | 2 | 0 | 7.05% | 17.11% | 0.86% | 750 |
| N922 | 1 | 2.5 | 0 | 0 | BAL | 1.16 | 0.74 | 4 | 0 | 0.76 | 8 | 4 | 0 | 4.47% | 15.98% | 0.84% | 800 |
| N923 | 1 | 2.5 | 0 | 0 | BAL | 1.16 | 0.74 | 4 | 0 | 0.76 | 8 | 6 | 0 | 7.98% | 15.74% | 0.84% | 850 |
| N924 | 1 | 2.5 | 0 | 0 | BAL | 1.16 | 0.74 | 6 | 0 | 0.76 | 6 | 4 | 0 | 9.61% | 14.74% | 0.93% | 700 |
| N925 | 1 | 2.5 | 0 | 0 | BAL | 1.16 | 0.74 | 6 | 0 | 0.76 | 6 | 6 | 0 | 6.92% | 2.91% | 0.90% | 750 |
| N926 | 1 | 2.5 | 0 | 0 | BAL | 1.16 | 0.74 | 8 | 0 | 0.76 | 6 | 2 | 0 | 7.26% | 17.46% | 0.78% | 650 |
| N927 | 1 | 2.5 | 0 | 0 | BAL | 1.16 | 0.74 | 8 | 0 | 0.76 | 6 | 4 | 0 | 4.64% | 2.60% | 0.78% | 700 |
| N928 | 1 | 2.5 | 0 | 0 | BAL | 1.16 | 0.74 | 8 | 0 | 0.76 | 6 | 6 | 0 | 8.16% | 16.06% | 0.78% | 800 |
| N929 | 1 | 2.5 | 0 | 0 | BAL | 1.16 | 0.74 | 10 | 0 | 0.76 | 4 | 6 | 0 | 8.72% | 2.21% | 0.83% | 650 |
| N930 | 1 | 3 | 0 | 0 | BAL | 1.16 | 0.74 | 4 | 0 | 0.76 | 10 | 2 | 0 | 6.89% | 20.86% | 0.92% | 750 |
| N931 | 1 | 3 | 0 | 0 | BAL | 1.16 | 0.74 | 4 | 0 | 0.76 | 10 | 4 | 0 | 5.04% | 19.61% | 0.89% | 800 |
| N932 | 1 | 3 | 0 | 0 | BAL | 1.16 | 0.74 | 4 | 0 | 0.76 | 10 | 6 | 0 | 1.26% | 19.36% | 0.87% | 900 |
| N933 | 1 | 3 | 0 | 0 | BAL | 1.16 | 0.74 | 6 | 0 | 0.76 | 8 | 6 | 0 | 5.06% | 17.82% | 0.93% | 800 |
| N934 | 1 | 3 | 0 | 0 | BAL | 1.16 | 0.74 | 6 | 0 | 0.76 | 10 | 0 | 0 | 5.47% | 24.29% | 0.74% | 750 |
| N935 | 1 | 3 | 0 | 0 | BAL | 1.16 | 0.74 | 6 | 0 | 0.76 | 10 | 2 | 0 | 0.37% | 3.39% | 0.72% | 750 |
| N936 | 1 | 3 | 0 | 0 | BAL | 1.16 | 0.74 | 6 | 0 | 0.76 | 10 | 4 | 0 | 5.36% | 21.52% | 0.71% | 850 |
| N937 | 1 | 1.07 | 5.04 | 0 | BAL | 1.16 | 0.74 | 0 | 0 | 0.76 | 6 | 0 | 0 | 5.64% | 9.52% | 1.08% | 800 |
| N938 | 1 | 1.07 | 5.04 | 0 | BAL | 1.16 | 0.74 | 0 | 0 | 0.76 | 8 | 0 | 0 | 0.96% | 9.70% | 1.08% | 1000 |
| N939 | 2 | 1.07 | 5.04 | 0 | BAL | 1.16 | 0.74 | 0 | 0 | 0.76 | 8 | 0 | 0 | 6.41% | 9.09% | 1.12% | 750 |
| N940 | 2 | 1.07 | 5.04 | 0 | BAL | 1.16 | 0.74 | 0 | 0 | 0.76 | 10 | 0 | 0 | 8.04% | 9.32% | 1.12% | 1050 |
| N941 | 1 | 3 | 0 | 0 | BAL | 1.16 | 0.74 | 6 | 0 | 0.76 | 10 | 6 | 0 | 5.96% | 21.28% | 0.71% | 900 |
| N942 | 1 | 3 | 0 | 0 | BAL | 1.16 | 0.74 | 8 | 0 | 0.76 | 8 | 2 | 0 | 7.11% | 21.21% | 0.85% | 700 |
| N943 | 1 | 3 | 0 | 0 | BAL | 1.16 | 0.74 | 8 | 0 | 0.76 | 8 | 4 | 0 | 3.33% | 3.53% | 0.84% | 750 |
| N944 | 1 | 3 | 0 | 0 | BAL | 1.16 | 0.74 | 8 | 0 | 0.76 | 8 | 6 | 0 | 8.26% | 19.75% | 0.82% | 800 |
| N945 | 1 | 3 | 0 | 0 | BAL | 1.16 | 0.74 | 10 | 0 | 0.76 | 6 | 6 | 0 | 7.34% | 3.06% | 0.90% | 700 |
| N946 | 1 | 3.5 | 0 | 0 | BAL | 1.16 | 0.74 | 6 | 0 | 0.76 | 10 | 4 | 0 | 9.44% | 22.12% | 1.00% | 750 |
| N947 | 1 | 3.5 | 0 | 0 | BAL | 1.16 | 0.74 | 6 | 0 | 0.76 | 10 | 6 | 0 | 5.60% | 21.37% | 0.95% | 800 |
| N948 | 1 | 3.5 | 0 | 0 | BAL | 1.16 | 0.74 | 8 | 0 | 0.76 | 10 | 2 | 0 | 6.98% | 24.83% | 0.92% | 700 |
| N949 | 1 | 3.5 | 0 | 0 | BAL | 1.16 | 0.74 | 8 | 0 | 0.76 | 10 | 4 | 0 | 5.57% | 23.54% | 0.89% | 750 |
| N950 | 1 | 3.5 | 0 | 0 | BAL | 1.16 | 0.74 | 8 | 0 | 0.76 | 10 | 6 | 0 | 8.30% | 23.32% | 0.85% | 850 |
| N951 | 1 | 3.5 | 0 | 0 | BAL | 1.16 | 0.74 | 10 | 0 | 0.76 | 8 | 2 | 0 | 9.85% | 24.06% | 1.01% | 700 |
| N952 | 1 | 3.5 | 0 | 0 | BAL | 1.16 | 0.74 | 10 | 0 | 0.76 | 8 | 6 | 0 | 6.10% | 3.90% | 0.94% | 750 |
| N953 | 1 | 3.5 | 0 | 0 | BAL | 1.16 | 0.74 | 10 | 0 | 0.76 | 10 | 0 | 0 | 5.05% | 28.28% | 0.74% | 700 |
| N954 | 1 | 3.5 | 0 | 0 | BAL | 1.16 | 0.74 | 10 | 0 | 0.76 | 10 | 2 | 0 | 0.86% | 3.39% | 0.72% | 700 |
| N955 | 1 | 3.5 | 0 | 0 | BAL | 1.16 | 0.74 | 10 | 0 | 0.76 | 10 | 4 | 0 | 5.54% | 25.51% | 0.71% | 800 |
| N956 | 1 | 3.5 | 0 | 0 | BAL | 1.16 | 0.74 | 10 | 0 | 0.76 | 10 | 6 | 0 | 7.34% | 24.86% | 0.71% | 850 |
| N957 | 1 | 4 | 0 | 0 | BAL | 1.16 | 0.74 | 10 | 0 | 0.76 | 10 | 2 | 0 | 9.51% | 27.54% | 1.08% | 700 |
| N958 | 1 | 4 | 0 | 0 | BAL | 1.16 | 0.74 | 10 | 0 | 0.76 | 10 | 6 | 0 | 5.04% | 4.66% | 0.97% | 750 |
| N959 | 1.5 | 2.5 | 0 | 0 | BAL | 1.16 | 0.74 | 4 | 0 | 0.76 | 8 | 6 | 0 | 5.08% | 13.50% | 0.94% | 800 |
| N960 | 1.5 | 2.5 | 0 | 0 | BAL | 1.16 | 0.74 | 4 | 0 | 0.76 | 10 | 2 | 0 | 4.64% | 17.58% | 0.72% | 750 |
| N961 | 1.5 | 2.5 | 0 | 0 | BAL | 1.16 | 0.74 | 4 | 0 | 0.76 | 10 | 4 | 0 | 5.25% | 17.20% | 0.72% | 850 |
| N962 | 1.5 | 2.5 | 0 | 0 | BAL | 1.16 | 0.74 | 4 | 0 | 0.76 | 10 | 6 | 0 | 1.64% | 17.01% | 0.72% | 900 |
| N963 | 1.5 | 2.5 | 0 | 0 | BAL | 1.16 | 0.74 | 6 | 0 | 0.76 | 8 | 2 | 0 | 7.18% | 16.79% | 0.85% | 700 |
| N964 | 1.5 | 2.5 | 0 | 0 | BAL | 1.16 | 0.74 | 6 | 0 | 0.76 | 8 | 4 | 0 | 3.04% | 3.67% | 0.84% | 750 |
| N965 | 1.5 | 2.5 | 0 | 0 | BAL | 1.16 | 0.74 | 6 | 0 | 0.76 | 8 | 6 | 0 | 1.31% | 15.42% | 0.84% | 800 |
| N966 | 1.5 | 2.5 | 0 | 0 | BAL | 1.16 | 0.74 | 8 | 0 | 0.76 | 6 | 4 | 0 | 9.93% | 14.52% | 0.90% | 650 |
| N967 | 1.5 | 2.5 | 0 | 0 | BAL | 1.16 | 0.74 | 8 | 0 | 0.76 | 6 | 6 | 0 | 7.34% | 3.02% | 0.90% | 700 |
| N968 | 1.5 | 2.5 | 0 | 0 | BAL | 1.16 | 0.74 | 10 | 0 | 0.76 | 6 | 2 | 0 | 7.41% | 17.16% | 0.77% | 600 |
| N969 | 1.5 | 2.5 | 0 | 0 | BAL | 1.16 | 0.74 | 10 | 0 | 0.76 | 6 | 4 | 0 | 4.81% | 2.90% | 0.76% | 650 |
| N970 | 1.5 | 2.5 | 0 | 0 | BAL | 1.16 | 0.74 | 10 | 0 | 0.76 | 6 | 6 | 0 | 8.35% | 15.70% | 0.72% | 700 |
| N971 | 1.5 | 3 | 0 | 0 | BAL | 1.16 | 0.74 | 4 | 0 | 0.76 | 10 | 4 | 0 | 9.41% | 17.83% | 1.00% | 750 |
| N972 | 1.5 | 3 | 0 | 0 | BAL | 1.16 | 0.74 | 4 | 0 | 0.76 | 10 | 6 | 0 | 5.63% | 17.10% | 0.96% | 800 |
| N973 | 1.5 | 3 | 0 | 0 | BAL | 1.16 | 0.74 | 6 | 0 | 0.76 | 10 | 4 | 0 | 5.58% | 19.21% | 0.89% | 750 |
| N974 | 1.5 | 3 | 0 | 0 | BAL | 1.16 | 0.74 | 6 | 0 | 0.76 | 10 | 6 | 0 | 8.19% | 19.02% | 0.86% | 850 |
| N975 | 1.5 | 3 | 0 | 0 | BAL | 1.16 | 0.74 | 8 | 0 | 0.76 | 8 | 4 | 0 | 9.74% | 18.22% | 0.97% | 700 |
| N976 | 1.5 | 3 | 0 | 0 | BAL | 1.16 | 0.74 | 8 | 0 | 0.76 | 8 | 6 | 0 | 5.92% | 3.95% | 0.95% | 750 |
| N977 | 1.5 | 3 | 0 | 0 | BAL | 1.16 | 0.74 | 8 | 0 | 0.76 | 10 | 0 | 0 | 5.87% | 24.02% | 0.73% | 700 |
| N978 | 1.5 | 3 | 0 | 0 | BAL | 1.16 | 0.74 | 8 | 0 | 0.76 | 10 | 2 | 0 | 0.85% | 3.37% | 0.71% | 700 |
| N979 | 1.5 | 3 | 0 | 0 | BAL | 1.16 | 0.74 | 8 | 0 | 0.76 | 10 | 4 | 0 | 5.44% | 21.16% | 0.71% | 800 |
| N980 | 1.5 | 3 | 0 | 0 | BAL | 1.16 | 0.74 | 8 | 0 | 0.76 | 10 | 6 | 0 | 6.89% | 20.63% | 0.71% | 850 |
| N981 | 1.5 | 3 | 0 | 0 | BAL | 1.16 | 0.74 | 10 | 0 | 0.76 | 8 | 2 | 0 | 7.22% | 20.87% | 0.85% | 650 |
| N982 | 1.5 | 3 | 0 | 0 | BAL | 1.16 | 0.74 | 10 | 0 | 0.76 | 8 | 4 | 0 | 3.55% | 3.74% | 0.84% | 700 |
| N983 | 1.5 | 3 | 0 | 0 | BAL | 1.16 | 0.74 | 10 | 0 | 0.76 | 8 | 6 | 0 | 8.35% | 19.39% | 0.77% | 750 |
| N984 | 1.5 | 3.5 | 0 | 0 | BAL | 1.16 | 0.74 | 8 | 0 | 0.76 | 10 | 4 | 0 | 9.61% | 21.79% | 1.02% | 700 |
| N985 | 1.5 | 3.5 | 0 | 0 | BAL | 1.16 | 0.74 | 8 | 0 | 0.76 | 10 | 6 | 0 | 4.76% | 4.77% | 0.98% | 800 |
| N986 | 1.5 | 3.5 | 0 | 0 | BAL | 1.16 | 0.74 | 10 | 0 | 0.76 | 10 | 2 | 0 | 7.06% | 24.45% | 0.92% | 700 |
| N987 | 1.5 | 3.5 | 0 | 0 | BAL | 1.16 | 0.74 | 10 | 0 | 0.76 | 10 | 4 | 0 | 2.46% | 4.53% | 0.88% | 750 |
| N988 | 1.5 | 3.5 | 0 | 0 | BAL | 1.16 | 0.74 | 10 | 0 | 0.76 | 10 | 6 | 0 | 8.32% | 22.95% | 0.81% | 800 |
| N989 | 0 | 1 | 5.04 | 0 | BAL | 1.16 | 0.74 | 0 | 0 | 0.76 | 3 | 0 | 0 | 5.75% | 6.57% | 0.73% | 650 |
| N990 | 0 | 1.5 | 5.04 | 0 | BAL | 1.16 | 0.74 | 0 | 0 | 0.76 | 3 | 0 | 0 | 8.08% | 7.01% | 1.06% | 450 |
| N991 | 0 | 1.5 | 5.04 | 0 | BAL | 1.16 | 0.74 | 2 | 0 | 0.76 | 3 | 0 | 0 | 4.91% | 9.38% | 0.87% | 550 |
| N992 | 0 | 2 | 5.04 | 0 | BAL | 1.16 | 0.74 | 2 | 0 | 0.76 | 3 | 0 | 0 | 0.48% | 10.26% | 1.28% | 350 |
| N993 | 0 | 2 | 5.04 | 0 | BAL | 1.16 | 0.74 | 4 | 0 | 0.76 | 3 | 0 | 0 | 4.53% | 14.00% | 1.04% | 400 |
| N994 | 0 | 2 | 5.04 | 0 | BAL | 1.16 | 0.74 | 6 | 0 | 0.76 | 3 | 0 | 0 | 4.49% | 14.08% | 0.88% | 500 |
| N995 | 0 | 2.5 | 5.04 | 0 | BAL | 1.16 | 0.74 | 6 | 0 | 0.76 | 3 | 0 | 0 | 5.71% | 18.56% | 1.31% | 300 |
| N996 | 0 | 2.5 | 5.04 | 0 | BAL | 1.16 | 0.74 | 8 | 0 | 0.76 | 3 | 0 | 0 | 3.11% | 18.79% | 1.09% | 400 |
| N997 | 0 | 2.5 | 5.04 | 0 | BAL | 1.16 | 0.74 | 10 | 0 | 0.76 | 3 | 0 | 0 | 4.29% | 18.60% | 0.90% | 500 |
| N998 | 0.5 | 2 | 5.04 | 0 | BAL | 1.16 | 0.74 | 2 | 0 | 0.76 | 3 | 0 | 0 | 9.85% | 13.39% | 1.26% | 200 |
| N999 | 0.5 | 2 | 5.04 | 0 | BAL | 1.16 | 0.74 | 4 | 0 | 0.76 | 3 | 0 | 0 | 7.83% | 15.90% | 1.01% | 150 |
| N1000 | 0.5 | 2 | 5.04 | 0 | BAL | 1.16 | 0.74 | 6 | 0 | 0.76 | 3 | 0 | 0 | 6.96% | 16.17% | 0.84% | 100 |
| N1001 | 0.5 | 2.5 | 5.04 | 0 | BAL | 1.16 | 0.74 | 6 | 0 | 0.76 | 3 | 0 | 0 | 7.27% | 20.26% | 1.28% | 100 |
| N1002 | 0.5 | 2.5 | 5.04 | 0 | BAL | 1.16 | 0.74 | 8 | 0 | 0.76 | 3 | 0 | 0 | 7.17% | 20.79% | 1.05% | 50 |
| N1003 | 0.5 | 2.5 | 5.04 | 0 | BAL | 1.16 | 0.74 | 10 | 0 | 0.76 | 3 | 0 | 0 | 6.95% | 20.49% | 0.83% | 100 |
| N1004 | 0 | 1.07 | 5.04 | 0 | BAL | 1.16 | 0.74 | 0 | 0 | 0.76 | 2 | 0 | 0 | 5.72% | 4.65% | 0.89% | 555 |
| N1005 | 0 | 1.07 | 5.04 | 0 | BAL | 1.16 | 0.74 | 2 | 0 | 0.76 | 0 | 0 | 0 | 5.96% | 5.20% | 1.05% | 440 |
| N1006 | 0 | 1.07 | 5.04 | 0 | BAL | 1.16 | 0.74 | 4 | 0 | 0.76 | 0 | 0 | 0 | 4.04% | 6.43% | 0.87% | 445 |
| N1007 | 0.5 | 1.07 | 5.04 | 0 | BAL | 1.16 | 0.74 | 2 | 0 | 0.76 | 0 | 0 | 0 | 7.31% | 2.41% | 0.99% | 80 |
| N1008 | 0 | 1.07 | 5.04 | 0 | BAL | 1.16 | 0.74 | 6 | 0 | 0.76 | 0 | 0 | 0 | 1.50% | 7.64% | 0.70% | 600 |
| N1009 | 0.5 | 1.07 | 5.04 | 0 | BAL | 1.16 | 0.74 | 4 | 0 | 0.76 | 0 | 0 | 0 | 7.36% | 4.74% | 0.80% | 65 |
| N1010 | 0 | 2 | 0 | 0 | BAL | 1.16 | 0.74 | 4 | 0 | 0.76 | 3 | 0 | 0 | 2.90% | 11.07% | 1.09% | 600 |
| N1011 | 0 | 2 | 0 | 0 | BAL | 1.16 | 0.74 | 6 | 0 | 0.76 | 3 | 0 | 0 | 1.79% | 13.42% | 0.88% | 600 |
| N1012 | 0 | 2 | 2 | 0 | BAL | 1.16 | 0.74 | 4 | 0 | 0.76 | 3 | 0 | 0 | 0.89% | 15.08% | 1.06% | 600 |
| N1013 | 0 | 2 | 2 | 0 | BAL | 1.16 | 0.74 | 6 | 0 | 0.76 | 3 | 0 | 0 | 1.04% | 16.14% | 0.88% | 600 |
| N1014 | 0 | 2 | 4 | 0 | BAL | 1.16 | 0.74 | 4 | 0 | 0.76 | 3 | 0 | 0 | 2.56% | 14.13% | 1.04% | 450 |
| N1015 | 0 | 2 | 4 | 0 | BAL | 1.16 | 0.74 | 6 | 0 | 0.76 | 3 | 0 | 0 | 3.08% | 14.64% | 0.88% | 550 |
| N1016 | 0 | 2 | 6 | 0 | BAL | 1.16 | 0.74 | 4 | 0 | 0.76 | 3 | 0 | 0 | 5.39% | 13.05% | 1.04% | 350 |
| N1017 | 0 | 2 | 6 | 0 | BAL | 1.16 | 0.74 | 6 | 0 | 0.76 | 3 | 0 | 0 | 3.92% | 13.54% | 0.89% | 450 |
| N1018 | 0 | 2 | 8 | 0 | BAL | 1.16 | 0.74 | 4 | 0 | 0.76 | 3 | 0 | 0 | 7.26% | 11.53% | 1.05% | 300 |
| N1019 | 0 | 2 | 8 | 0 | BAL | 1.16 | 0.74 | 6 | 0 | 0.76 | 3 | 0 | 0 | 5.21% | 13.11% | 0.83% | 350 |
| N1020 | 0 | 2 | 10 | 0 | BAL | 1.16 | 0.74 | 4 | 0 | 0.76 | 3 | 0 | 0 | 9.63% | 10.98% | 1.05% | 250 |
| N1021 | 0 | 2 | 10 | 0 | BAL | 1.16 | 0.74 | 8 | 0 | 0.76 | 3 | 0 | 0 | 6.64% | 15.27% | 0.70% | 450 |
| N1022 | 0 | 2.5 | 0 | 0 | BAL | 1.16 | 0.74 | 6 | 0 | 0.76 | 3 | 0 | 0 | 3.92% | 13.20% | 1.30% | 550 |
| N1023 | 0 | 2.5 | 0 | 0 | BAL | 1.16 | 0.74 | 8 | 0 | 0.76 | 3 | 0 | 0 | 2.82% | 15.54% | 1.08% | 600 |
| N1024 | 0 | 2.5 | 0 | 0 | BAL | 1.16 | 0.74 | 10 | 0 | 0.76 | 3 | 0 | 0 | 1.71% | 17.93% | 0.91% | 600 |
| N1025 | 0 | 2.5 | 2 | 0 | BAL | 1.16 | 0.74 | 6 | 0 | 0.76 | 3 | 0 | 0 | 1.92% | 17.16% | 1.30% | 500 |
| N1026 | 0 | 2.5 | 2 | 0 | BAL | 1.16 | 0.74 | 8 | 0 | 0.76 | 3 | 0 | 0 | 0.81% | 19.54% | 1.08% | 550 |
| N1027 | 0 | 2.5 | 2 | 0 | BAL | 1.16 | 0.74 | 10 | 0 | 0.76 | 3 | 0 | 0 | 1.37% | 20.84% | 0.92% | 600 |
| N1028 | 0 | 2.5 | 4 | 0 | BAL | 1.16 | 0.74 | 6 | 0 | 0.76 | 3 | 0 | 0 | 2.39% | 19.36% | 1.31% | 350 |
| N1029 | 0 | 2.5 | 4 | 0 | BAL | 1.16 | 0.74 | 8 | 0 | 0.76 | 3 | 0 | 0 | 2.78% | 19.75% | 1.08% | 450 |
| N1030 | 0 | 2.5 | 4 | 0 | BAL | 1.16 | 0.74 | 10 | 0 | 0.76 | 3 | 0 | 0 | 3.68% | 19.17% | 0.92% | 550 |
| N1031 | 0 | 2.5 | 6 | 0 | BAL | 1.16 | 0.74 | 6 | 0 | 0.76 | 3 | 0 | 0 | 3.28% | 18.43% | 1.31% | 300 |
| N1032 | 0 | 2.5 | 6 | 0 | BAL | 1.16 | 0.74 | 8 | 0 | 0.76 | 3 | 0 | 0 | 3.88% | 18.25% | 1.09% | 350 |
| N1033 | 0 | 2.5 | 6 | 0 | BAL | 1.16 | 0.74 | 10 | 0 | 0.76 | 3 | 0 | 0 | 5.68% | 18.07% | 0.87% | 400 |
| N1034 | 0 | 2.5 | 8 | 0 | BAL | 1.16 | 0.74 | 6 | 0 | 0.76 | 3 | 0 | 0 | 7.09% | 16.36% | 1.32% | 200 |
| N1035 | 0 | 2.5 | 8 | 0 | BAL | 1.16 | 0.74 | 8 | 0 | 0.76 | 3 | 0 | 0 | 6.69% | 16.67% | 1.09% | 250 |
| N1036 | 0 | 2.5 | 8 | 0 | BAL | 1.16 | 0.74 | 10 | 0 | 0.76 | 3 | 0 | 0 | 3.97% | 17.48% | 0.88% | 350 |
| N1037 | 0.5 | 2 | 0 | 0 | BAL | 1.16 | 0.74 | 6 | 0 | 0.76 | 3 | 0 | 0 | 9.02% | 13.17% | 0.87% | 400 |
| N1038 | 0.5 | 2 | 2 | 0 | BAL | 1.16 | 0.74 | 4 | 0 | 0.76 | 3 | 0 | 0 | 9.21% | 12.51% | 1.08% | 350 |
| N1039 | 0.5 | 2 | 2 | 0 | BAL | 1.16 | 0.74 | 6 | 0 | 0.76 | 3 | 0 | 0 | 8.09% | 14.98% | 0.85% | 300 |
| N1040 | 0.5 | 2 | 4 | 0 | BAL | 1.16 | 0.74 | 4 | 0 | 0.76 | 3 | 0 | 0 | 7.36% | 16.17% | 1.04% | 150 |
| N1041 | 0.5 | 2 | 4 | 0 | BAL | 1.16 | 0.74 | 6 | 0 | 0.76 | 3 | 0 | 0 | 7.26% | 16.71% | 0.84% | 200 |
| N1042 | 0.5 | 2 | 6 | 0 | BAL | 1.16 | 0.74 | 6 | 0 | 0.76 | 3 | 0 | 0 | 6.96% | 15.54% | 0.84% | 100 |
| N1043 | 0.5 | 2 | 8 | 0 | BAL | 1.16 | 0.74 | 6 | 0 | 0.76 | 3 | 0 | 0 | 9.30% | 14.13% | 0.80% | 100 |
| N1044 | 0.5 | 2.5 | 0 | 0 | BAL | 1.16 | 0.74 | 8 | 0 | 0.76 | 3 | 0 | 0 | 9.96% | 15.25% | 1.05% | 250 |
| N1045 | 0.5 | 2.5 | 0 | 0 | BAL | 1.16 | 0.74 | 10 | 0 | 0.76 | 3 | 0 | 0 | 8.92% | 17.58% | 0.87% | 250 |
| N1046 | 0.5 | 2.5 | 2 | 0 | BAL | 1.16 | 0.74 | 8 | 0 | 0.76 | 3 | 0 | 0 | 8.77% | 17.58% | 1.04% | 150 |
| N1047 | 0.5 | 2.5 | 2 | 0 | BAL | 1.16 | 0.74 | 10 | 0 | 0.76 | 3 | 0 | 0 | 7.50% | 20.38% | 0.87% | 150 |
| N1048 | 0.5 | 2.5 | 4 | 0 | BAL | 1.16 | 0.74 | 6 | 0 | 0.76 | 3 | 0 | 0 | 8.25% | 18.33% | 1.28% | 100 |
| N1049 | 0.5 | 2.5 | 4 | 0 | BAL | 1.16 | 0.74 | 8 | 0 | 0.76 | 3 | 0 | 0 | 7.15% | 20.77% | 1.04% | 100 |
| N1050 | 0.5 | 2.5 | 4 | 0 | BAL | 1.16 | 0.74 | 10 | 0 | 0.76 | 3 | 0 | 0 | 7.65% | 21.16% | 0.84% | 100 |
| N1051 | 0.5 | 2.5 | 6 | 0 | BAL | 1.16 | 0.74 | 6 | 0 | 0.76 | 3 | 0 | 0 | 7.85% | 20.43% | 1.28% | 100 |
| N1052 | 0.5 | 2.5 | 6 | 0 | BAL | 1.16 | 0.74 | 8 | 0 | 0.76 | 3 | 0 | 0 | 9.16% | 20.31% | 1.05% | 50 |
| N1053 | 0.5 | 2.5 | 6 | 0 | BAL | 1.16 | 0.74 | 10 | 0 | 0.76 | 3 | 0 | 0 | 6.94% | 19.90% | 0.82% | 100 |
| N1054 | 0.5 | 2.5 | 8 | 0 | BAL | 1.16 | 0.74 | 8 | 0 | 0.76 | 3 | 0 | 0 | 8.44% | 18.49% | 1.05% | 50 |
| N1055 | 0.5 | 2.5 | 8 | 0 | BAL | 1.16 | 0.74 | 10 | 0 | 0.76 | 3 | 0 | 0 | 2.35% | 25.10% | 0.83% | 0 |
| N1056 | 0.5 | 2.5 | 10 | 0 | BAL | 1.16 | 0.74 | 10 | 0 | 0.76 | 3 | 0 | 0 | 3.83% | 24.56% | 0.83% | 0 |
| N1057 | 0 | 1 | 0 | 0 | BAL | 1.16 | 1 | 0 | 0 | 0.76 | 3 | 0.5 | 0 | 2.15% | 7.69% | 0.76% | 800 |
| N1058 | 0 | 1 | 0 | 0 | BAL | 1.16 | 1 | 0 | 0 | 0.76 | 3 | 0.5 | 5 | 3.77% | 7.78% | 0.73% | 450 |
| N1059 | 0 | 1 | 0 | 0 | BAL | 1.16 | 1 | 0 | 0 | 0.76 | 3 | 0.5 | 10 | 1.07% | 7.55% | 0.70% | 300 |
| N1060 | 0 | 2 | 0 | 0 | BAL | 1.16 | 1 | 0 | 0 | 0.76 | 3 | 0.5 | 15 | 1.91% | 8.39% | 1.35% | 100 |
| N1061 | 0 | 2 | 0 | 0 | BAL | 1.16 | 1 | 0 | 0 | 0.76 | 3 | 0.5 | 20 | 5.71% | 8.67% | 1.32% | 50 |
| N1062 | 0 | 2 | 0 | 0 | BAL | 1.16 | 1 | 2 | 0 | 0.76 | 3 | 0.5 | 0 | 1.75% | 8.76% | 1.28% | 600 |
| N1063 | 0 | 2 | 0 | 0 | BAL | 1.16 | 1 | 2 | 0 | 0.76 | 3 | 0.5 | 20 | 8.07% | 11.22% | 1.11% | 50 |
| N1064 | 0 | 2 | 0 | 0 | BAL | 1.16 | 1 | 4 | 0 | 0.76 | 3 | 0.5 | 0 | 1.79% | 11.08% | 1.04% | 600 |
| N1065 | 0 | 2 | 0 | 0 | BAL | 1.16 | 1 | 4 | 0 | 0.76 | 3 | 0.5 | 10 | 8.21% | 11.77% | 1.00% | 150 |
| N1066 | 0 | 2 | 0 | 0 | BAL | 1.16 | 1 | 4 | 0 | 0.76 | 3 | 0.5 | 15 | 9.75% | 12.20% | 0.98% | 100 |
| N1067 | 0 | 2 | 0 | 0 | BAL | 1.16 | 1 | 4 | 0 | 0.76 | 3 | 0.5 | 20 | 3.92% | 12.66% | 0.96% | 50 |
| N1068 | 0 | 2 | 0 | 0 | BAL | 1.16 | 1 | 4 | 0 | 0.76 | 3 | 0.5 | 25 | 2.84% | 13.15% | 0.93% | 50 |
| N1069 | 0 | 2 | 0 | 0 | BAL | 1.16 | 1 | 4 | 0 | 0.76 | 3 | 0.5 | 30 | 2.58% | 24.05% | 0.89% | 1150 |
| N1070 | 0 | 2 | 0 | 0 | BAL | 1.16 | 1 | 6 | 0 | 0.76 | 3 | 0.5 | 0 | 1.81% | 13.43% | 0.88% | 600 |
| N1071 | 0 | 2 | 0 | 0 | BAL | 1.16 | 1 | 6 | 0 | 0.76 | 3 | 0.5 | 5 | 6.08% | 13.78% | 0.82% | 400 |
| N1072 | 0 | 2 | 0 | 0 | BAL | 1.16 | 1 | 6 | 0 | 0.76 | 3 | 0.5 | 10 | 4.77% | 14.26% | 0.80% | 150 |
| N1073 | 0 | 2 | 0 | 0 | BAL | 1.16 | 1 | 6 | 0 | 0.76 | 3 | 0.5 | 25 | 0.91% | 33.37% | 0.75% | 0 |
| N1074 | 1 | 1 | 0 | 0 | BAL | 1.16 | 1 | 0 | 0 | 0.76 | 3 | 0.5 | 25 | 8.08% | 7.95% | 1.00% | 300 |
| N1075 | 1 | 1 | 0 | 0 | BAL | 1.16 | 1 | 0 | 0 | 0.76 | 3 | 0.5 | 30 | 8.81% | 8.18% | 1.00% | 200 |
| N1076 | 0.2 | 1.3 | 0.5 | 0 | BAL | 0.75 | 0.7 | 2 | 0 | 0.44 | 0.5 | 0.36 | 0 | 4.66% | 3.89% | 1.10% | 255 |
| N1077 | 0.2 | 1.3 | 0.5 | 0 | BAL | 0.75 | 0.7 | 2 | 0 | 0.44 | 1 | 0.36 | 0 | 2.85% | 5.33% | 1.00% | 250 |
| N1078 | 0.2 | 1.3 | 0.5 | 0 | BAL | 0.75 | 0.7 | 2 | 0 | 0.44 | 1.5 | 0.36 | 0 | 2.16% | 6.25% | 0.92% | 310 |
| N1079 | 0.2 | 1.3 | 0.5 | 0 | BAL | 0.75 | 0.7 | 2 | 0 | 0.44 | 2 | 0.36 | 0 | 1.32% | 7.10% | 0.83% | 345 |
| N1080 | 0.2 | 1.3 | 0.5 | 0 | BAL | 0.75 | 0.7 | 2 | 0 | 0.44 | 2.5 | 0.36 | 0 | 0.92% | 8.06% | 0.75% | 370 |
| N1081 | 0.2 | 1.3 | 0.5 | 0 | BAL | 0.75 | 0.7 | 2.5 | 0 | 0.44 | 0.5 | 0.36 | 0 | 3.53% | 4.55% | 1.05% | 250 |
| N1082 | 0.2 | 1.3 | 0.5 | 0 | BAL | 0.75 | 0.7 | 2.5 | 0 | 0.44 | 1 | 0.36 | 0 | 1.77% | 5.90% | 0.95% | 250 |
| N1083 | 0.2 | 1.3 | 0.5 | 0 | BAL | 0.75 | 0.7 | 2.5 | 0 | 0.44 | 1.5 | 0.36 | 0 | 2.40% | 6.88% | 0.86% | 300 |
| N1084 | 0.2 | 1.3 | 0.5 | 0 | BAL | 0.75 | 0.7 | 2.5 | 0 | 0.44 | 2 | 0.36 | 0 | 1.52% | 7.71% | 0.78% | 335 |
| N1085 | 0.2 | 1.3 | 0.5 | 0 | BAL | 0.75 | 0.7 | 2.5 | 0 | 0.44 | 2.5 | 0.36 | 0 | 0.93% | 8.61% | 0.70% | 365 |
| N1086 | 0.2 | 1.3 | 0.5 | 0 | BAL | 0.75 | 0.7 | 3 | 0 | 0.44 | 0.5 | 0.36 | 0 | 2.68% | 5.21% | 1.00% | 250 |
| N1087 | 0.2 | 1.3 | 0.5 | 0 | BAL | 0.75 | 0.7 | 3 | 0 | 0.44 | 1 | 0.36 | 0 | 1.77% | 6.48% | 0.90% | 240 |
| N1088 | 0.2 | 1.3 | 0.5 | 0 | BAL | 0.75 | 0.7 | 3 | 0 | 0.44 | 1.5 | 0.36 | 0 | 1.59% | 7.49% | 0.81% | 295 |
| N1089 | 0.2 | 1.3 | 0.5 | 0 | BAL | 0.75 | 0.7 | 3 | 0 | 0.44 | 2 | 0.36 | 0 | 1.65% | 8.30% | 0.73% | 335 |
| N1090 | 0.2 | 1.3 | 0.5 | 0 | BAL | 0.75 | 0.7 | 3.5 | 0 | 0.44 | 0.5 | 0.36 | 0 | 1.78% | 5.88% | 0.95% | 240 |
| N1091 | 0.2 | 1.3 | 0.5 | 0 | BAL | 0.75 | 0.7 | 3.5 | 0 | 0.44 | 1 | 0.36 | 0 | 1.78% | 7.06% | 0.86% | 240 |
| N1092 | 0.2 | 1.3 | 0.5 | 0 | BAL | 0.75 | 0.7 | 3.5 | 0 | 0.44 | 1.5 | 0.36 | 0 | 1.70% | 8.09% | 0.76% | 285 |
| N1093 | 0.2 | 1.3 | 0.5 | 0 | BAL | 0.75 | 0.7 | 4 | 0 | 0.44 | 0.5 | 0.36 | 0 | 1.78% | 6.54% | 0.91% | 240 |
| N1094 | 0.2 | 1.3 | 0.5 | 0 | BAL | 0.75 | 0.7 | 4 | 0 | 0.44 | 1 | 0.36 | 0 | 1.78% | 7.63% | 0.81% | 235 |
| N1095 | 0.2 | 1.3 | 0.5 | 0 | BAL | 0.75 | 0.7 | 4 | 0 | 0.44 | 1.5 | 0.36 | 0 | 1.75% | 8.67% | 0.72% | 280 |
| N1096 | 0.2 | 1.3 | 0.5 | 0 | BAL | 0.75 | 0.7 | 4.5 | 0 | 0.44 | 0.5 | 0.36 | 0 | 1.78% | 7.21% | 0.86% | 235 |
| N1097 | 0.2 | 1.3 | 0.5 | 0 | BAL | 0.75 | 0.7 | 4.5 | 0 | 0.44 | 1 | 0.36 | 0 | 1.78% | 8.21% | 0.77% | 230 |
| N1098 | 0.2 | 1.3 | 0.5 | 0 | BAL | 0.75 | 0.7 | 5 | 0 | 0.44 | 0.5 | 0.36 | 0 | 1.79% | 7.78% | 0.82% | 230 |
| N1099 | 0.2 | 1.3 | 0.5 | 0 | BAL | 0.75 | 0.7 | 5 | 0 | 0.44 | 1 | 0.36 | 0 | 1.79% | 8.77% | 0.72% | 225 |
| N1100 | 0.2 | 1.4 | 0.5 | 0 | BAL | 0.75 | 0.7 | 2 | 0 | 0.44 | 0.5 | 0.36 | 0 | 6.56% | 3.89% | 1.19% | 260 |
| N1101 | 0.2 | 1.4 | 0.5 | 0 | BAL | 0.75 | 0.7 | 2 | 0 | 0.44 | 1 | 0.36 | 0 | 4.34% | 5.33% | 1.09% | 260 |
| N1102 | 0.2 | 1.4 | 0.5 | 0 | BAL | 0.75 | 0.7 | 2 | 0 | 0.44 | 1.5 | 0.36 | 0 | 2.69% | 6.31% | 1.00% | 300 |
| N1103 | 0.2 | 1.4 | 0.5 | 0 | BAL | 0.75 | 0.7 | 2 | 0 | 0.44 | 2 | 0.36 | 0 | 1.51% | 7.17% | 0.92% | 340 |
| N1104 | 0.2 | 1.4 | 0.5 | 0 | BAL | 0.75 | 0.7 | 2 | 0 | 0.44 | 2.5 | 0.36 | 0 | 0.92% | 8.09% | 0.83% | 365 |
| N1105 | 0.2 | 1.4 | 0.5 | 0 | BAL | 0.75 | 0.7 | 2 | 0 | 0.44 | 3 | 0.36 | 0 | 0.90% | 9.14% | 0.76% | 385 |
| N1106 | 0.2 | 1.4 | 0.5 | 0 | BAL | 0.75 | 0.7 | 2.5 | 0 | 0.44 | 0.5 | 0.36 | 0 | 5.36% | 4.55% | 1.14% | 255 |
| N1107 | 0.2 | 1.4 | 0.5 | 0 | BAL | 0.75 | 0.7 | 2.5 | 0 | 0.44 | 1 | 0.36 | 0 | 3.23% | 5.91% | 1.04% | 255 |
| N1108 | 0.2 | 1.4 | 0.5 | 0 | BAL | 0.75 | 0.7 | 2.5 | 0 | 0.44 | 1.5 | 0.36 | 0 | 2.57% | 6.94% | 0.95% | 290 |
| N1109 | 0.2 | 1.4 | 0.5 | 0 | BAL | 0.75 | 0.7 | 2.5 | 0 | 0.44 | 2 | 0.36 | 0 | 1.74% | 7.79% | 0.86% | 330 |
| N1110 | 0.2 | 1.4 | 0.5 | 0 | BAL | 0.75 | 0.7 | 2.5 | 0 | 0.44 | 2.5 | 0.36 | 0 | 0.97% | 8.65% | 0.78% | 355 |
| N1111 | 0.2 | 1.4 | 0.5 | 0 | BAL | 0.75 | 0.7 | 2.5 | 0 | 0.44 | 3 | 0.36 | 0 | 0.91% | 9.68% | 0.71% | 380 |
| N1112 | 0.2 | 1.4 | 0.5 | 0 | BAL | 0.75 | 0.7 | 3 | 0 | 0.44 | 0.5 | 0.36 | 0 | 4.20% | 5.22% | 1.09% | 255 |
| N1113 | 0.2 | 1.4 | 0.5 | 0 | BAL | 0.75 | 0.7 | 3 | 0 | 0.44 | 1 | 0.36 | 0 | 2.38% | 6.50% | 0.99% | 250 |
| N1114 | 0.2 | 1.4 | 0.5 | 0 | BAL | 0.75 | 0.7 | 3 | 0 | 0.44 | 1.5 | 0.36 | 0 | 1.77% | 7.56% | 0.90% | 285 |
| N1115 | 0.2 | 1.4 | 0.5 | 0 | BAL | 0.75 | 0.7 | 3 | 0 | 0.44 | 2 | 0.36 | 0 | 1.91% | 8.39% | 0.81% | 325 |
| N1116 | 0.2 | 1.4 | 0.5 | 0 | BAL | 0.75 | 0.7 | 3 | 0 | 0.44 | 2.5 | 0.36 | 0 | 1.09% | 9.23% | 0.73% | 355 |
| N1117 | 0.2 | 1.4 | 0.5 | 0 | BAL | 0.75 | 0.7 | 3.5 | 0 | 0.44 | 0.5 | 0.36 | 0 | 3.09% | 5.89% | 1.04% | 250 |
| N1118 | 0.2 | 1.4 | 0.5 | 0 | BAL | 0.75 | 0.7 | 3.5 | 0 | 0.44 | 1 | 0.36 | 0 | 1.77% | 7.08% | 0.94% | 245 |
| N1119 | 0.2 | 1.4 | 0.5 | 0 | BAL | 0.75 | 0.7 | 3.5 | 0 | 0.44 | 1.5 | 0.36 | 0 | 1.77% | 8.13% | 0.85% | 275 |
| N1120 | 0.2 | 1.4 | 0.5 | 0 | BAL | 0.75 | 0.7 | 3.5 | 0 | 0.44 | 2 | 0.36 | 0 | 2.02% | 8.98% | 0.76% | 320 |
| N1121 | 0.2 | 1.4 | 0.5 | 0 | BAL | 0.75 | 0.7 | 4 | 0 | 0.44 | 0.5 | 0.36 | 0 | 2.20% | 6.57% | 0.99% | 245 |
| N1122 | 0.2 | 1.4 | 0.5 | 0 | BAL | 0.75 | 0.7 | 4 | 0 | 0.44 | 1 | 0.36 | 0 | 1.77% | 7.66% | 0.89% | 240 |
| N1123 | 0.2 | 1.4 | 0.5 | 0 | BAL | 0.75 | 0.7 | 4 | 0 | 0.44 | 1.5 | 0.36 | 0 | 1.77% | 8.70% | 0.80% | 275 |
| N1124 | 0.2 | 1.4 | 0.5 | 0 | BAL | 0.75 | 0.7 | 4 | 0 | 0.44 | 2 | 0.36 | 0 | 1.10% | 9.56% | 0.71% | 315 |
| N1125 | 0.2 | 1.4 | 0.5 | 0 | BAL | 0.75 | 0.7 | 4.5 | 0 | 0.44 | 0.5 | 0.36 | 0 | 1.78% | 7.24% | 0.94% | 240 |
| N1126 | 0.2 | 1.4 | 0.5 | 0 | BAL | 0.75 | 0.7 | 4.5 | 0 | 0.44 | 1 | 0.36 | 0 | 1.78% | 8.23% | 0.85% | 235 |
| N1127 | 0.2 | 1.4 | 0.5 | 0 | BAL | 0.75 | 0.7 | 4.5 | 0 | 0.44 | 1.5 | 0.36 | 0 | 1.78% | 9.27% | 0.75% | 270 |
| N1128 | 0.2 | 1.4 | 0.5 | 0 | BAL | 0.75 | 0.7 | 5 | 0 | 0.44 | 0.5 | 0.36 | 0 | 1.78% | 7.82% | 0.90% | 240 |
| N1129 | 0.2 | 1.4 | 0.5 | 0 | BAL | 0.75 | 0.7 | 5 | 0 | 0.44 | 1 | 0.36 | 0 | 1.78% | 8.80% | 0.80% | 230 |
| N1130 | 0.2 | 1.4 | 0.5 | 0 | BAL | 0.75 | 0.7 | 5 | 0 | 0.44 | 1.5 | 0.36 | 0 | 1.78% | 9.83% | 0.70% | 265 |
| N1131 | 0.2 | 1.5 | 0.5 | 0 | BAL | 0.75 | 0.7 | 2 | 0 | 0.44 | 0.5 | 0.36 | 0 | 8.51% | 3.88% | 1.28% | 270 |
| N1132 | 0.2 | 1.5 | 0.5 | 0 | BAL | 0.75 | 0.7 | 2 | 0 | 0.44 | 1 | 0.36 | 0 | 6.21% | 5.32% | 1.18% | 265 |
| N1133 | 0.2 | 1.5 | 0.5 | 0 | BAL | 0.75 | 0.7 | 2 | 0 | 0.44 | 1.5 | 0.36 | 0 | 4.88% | 6.41% | 1.09% | 290 |
| N1134 | 0.2 | 1.5 | 0.5 | 0 | BAL | 0.75 | 0.7 | 2 | 0 | 0.44 | 2 | 0.36 | 0 | 1.66% | 7.23% | 1.00% | 330 |
| N1135 | 0.2 | 1.5 | 0.5 | 0 | BAL | 0.75 | 0.7 | 2 | 0 | 0.44 | 2.5 | 0.36 | 0 | 0.96% | 8.13% | 0.92% | 355 |
| N1136 | 0.2 | 1.5 | 0.5 | 0 | BAL | 0.75 | 0.7 | 2 | 0 | 0.44 | 3 | 0.36 | 0 | 0.90% | 9.17% | 0.83% | 375 |
| N1137 | 0.2 | 1.5 | 0.5 | 0 | BAL | 0.75 | 0.7 | 2.5 | 0 | 0.44 | 0.5 | 0.36 | 0 | 7.28% | 4.55% | 1.23% | 260 |
| N1138 | 0.2 | 1.5 | 0.5 | 0 | BAL | 0.75 | 0.7 | 2.5 | 0 | 0.44 | 1 | 0.36 | 0 | 5.04% | 5.91% | 1.13% | 260 |
| N1139 | 0.2 | 1.5 | 0.5 | 0 | BAL | 0.75 | 0.7 | 2.5 | 0 | 0.44 | 1.5 | 0.36 | 0 | 4.10% | 7.00% | 1.04% | 285 |
| N1140 | 0.2 | 1.5 | 0.5 | 0 | BAL | 0.75 | 0.7 | 2.5 | 0 | 0.44 | 2 | 0.36 | 0 | 1.91% | 7.85% | 0.95% | 320 |
| N1141 | 0.2 | 1.5 | 0.5 | 0 | BAL | 0.75 | 0.7 | 2.5 | 0 | 0.44 | 2.5 | 0.36 | 0 | 1.18% | 8.73% | 0.86% | 350 |
| N1142 | 0.2 | 1.5 | 0.5 | 0 | BAL | 0.75 | 0.7 | 2.5 | 0 | 0.44 | 3 | 0.36 | 0 | 0.91% | 9.72% | 0.78% | 370 |
| N1143 | 0.2 | 1.5 | 0.5 | 0 | BAL | 0.75 | 0.7 | 3 | 0 | 0.44 | 0.5 | 0.36 | 0 | 6.07% | 5.22% | 1.18% | 260 |
| N1144 | 0.2 | 1.5 | 0.5 | 0 | BAL | 0.75 | 0.7 | 3 | 0 | 0.44 | 1 | 0.36 | 0 | 3.91% | 6.50% | 1.07% | 255 |
| N1145 | 0.2 | 1.5 | 0.5 | 0 | BAL | 0.75 | 0.7 | 3 | 0 | 0.44 | 1.5 | 0.36 | 0 | 2.05% | 7.57% | 0.98% | 280 |
| N1146 | 0.2 | 1.5 | 0.5 | 0 | BAL | 0.75 | 0.7 | 3 | 0 | 0.44 | 2 | 0.36 | 0 | 2.11% | 8.47% | 0.90% | 315 |
| N1147 | 0.2 | 1.5 | 0.5 | 0 | BAL | 0.75 | 0.7 | 3 | 0 | 0.44 | 2.5 | 0.36 | 0 | 1.35% | 9.33% | 0.81% | 345 |
| N1148 | 0.2 | 1.5 | 0.5 | 0 | BAL | 0.75 | 0.7 | 3 | 0 | 0.44 | 3 | 0.36 | 0 | 0.92% | 10.26% | 0.73% | 370 |
| N1149 | 0.2 | 1.5 | 0.5 | 0 | BAL | 0.75 | 0.7 | 3.5 | 0 | 0.44 | 0.5 | 0.36 | 0 | 4.88% | 5.90% | 1.13% | 255 |
| N1150 | 0.2 | 1.5 | 0.5 | 0 | BAL | 0.75 | 0.7 | 3.5 | 0 | 0.44 | 1 | 0.36 | 0 | 3.00% | 7.09% | 1.03% | 250 |
| N1151 | 0.2 | 1.5 | 0.5 | 0 | BAL | 0.75 | 0.7 | 3.5 | 0 | 0.44 | 1.5 | 0.36 | 0 | 1.77% | 8.14% | 0.93% | 270 |
| N1152 | 0.2 | 1.5 | 0.5 | 0 | BAL | 0.75 | 0.7 | 3.5 | 0 | 0.44 | 2 | 0.36 | 0 | 2.25% | 9.07% | 0.84% | 310 |
| N1153 | 0.2 | 1.5 | 0.5 | 0 | BAL | 0.75 | 0.7 | 3.5 | 0 | 0.44 | 2.5 | 0.36 | 0 | 1.45% | 9.91% | 0.76% | 340 |
| N1154 | 0.2 | 1.5 | 0.5 | 0 | BAL | 0.75 | 0.7 | 4 | 0 | 0.44 | 0.5 | 0.36 | 0 | 3.74% | 6.58% | 1.08% | 250 |
| N1155 | 0.2 | 1.5 | 0.5 | 0 | BAL | 0.75 | 0.7 | 4 | 0 | 0.44 | 1 | 0.36 | 0 | 1.93% | 7.68% | 0.98% | 245 |
| N1156 | 0.2 | 1.5 | 0.5 | 0 | BAL | 0.75 | 0.7 | 4 | 0 | 0.44 | 1.5 | 0.36 | 0 | 1.77% | 8.72% | 0.88% | 265 |
| N1157 | 0.2 | 1.5 | 0.5 | 0 | BAL | 0.75 | 0.7 | 4 | 0 | 0.44 | 2 | 0.36 | 0 | 1.38% | 9.66% | 0.79% | 305 |
| N1158 | 0.2 | 1.5 | 0.5 | 0 | BAL | 0.75 | 0.7 | 4 | 0 | 0.44 | 2.5 | 0.36 | 0 | 1.51% | 10.47% | 0.71% | 340 |
| N1159 | 0.2 | 1.5 | 0.5 | 0 | BAL | 0.75 | 0.7 | 4.5 | 0 | 0.44 | 0.5 | 0.36 | 0 | 2.92% | 7.27% | 1.03% | 245 |
| N1160 | 0.2 | 1.5 | 0.5 | 0 | BAL | 0.75 | 0.7 | 4.5 | 0 | 0.44 | 1 | 0.36 | 0 | 1.77% | 8.26% | 0.93% | 245 |
| N1161 | 0.2 | 1.5 | 0.5 | 0 | BAL | 0.75 | 0.7 | 4.5 | 0 | 0.44 | 1.5 | 0.36 | 0 | 1.77% | 9.29% | 0.83% | 260 |
| N1162 | 0.2 | 1.5 | 0.5 | 0 | BAL | 0.75 | 0.7 | 4.5 | 0 | 0.44 | 2 | 0.36 | 0 | 1.42% | 10.23% | 0.74% | 300 |
| N1163 | 0.2 | 1.5 | 0.5 | 0 | BAL | 0.75 | 0.7 | 5 | 0 | 0.44 | 0.5 | 0.36 | 0 | 1.77% | 7.86% | 0.99% | 245 |
| N1164 | 0.2 | 1.5 | 0.5 | 0 | BAL | 0.75 | 0.7 | 5 | 0 | 0.44 | 1 | 0.36 | 0 | 1.77% | 8.83% | 0.88% | 235 |
| N1165 | 0.2 | 1.5 | 0.5 | 0 | BAL | 0.75 | 0.7 | 5 | 0 | 0.44 | 1.5 | 0.36 | 0 | 1.77% | 9.86% | 0.78% | 255 |
| N1166 | 0.2 | 1.6 | 0.5 | 0 | BAL | 0.75 | 0.7 | 2 | 0 | 0.44 | 1 | 0.36 | 0 | 8.13% | 5.32% | 1.27% | 270 |
| N1167 | 0.2 | 1.6 | 0.5 | 0 | BAL | 0.75 | 0.7 | 2 | 0 | 0.44 | 1.5 | 0.36 | 0 | 6.75% | 6.42% | 1.18% | 285 |
| N1168 | 0.2 | 1.6 | 0.5 | 0 | BAL | 0.75 | 0.7 | 2 | 0 | 0.44 | 2 | 0.36 | 0 | 3.58% | 7.29% | 1.09% | 320 |
| N1169 | 0.2 | 1.6 | 0.5 | 0 | BAL | 0.75 | 0.7 | 2 | 0 | 0.44 | 2.5 | 0.36 | 0 | 1.11% | 8.18% | 1.00% | 345 |
| N1170 | 0.2 | 1.6 | 0.5 | 0 | BAL | 0.75 | 0.7 | 2 | 0 | 0.44 | 3 | 0.36 | 0 | 0.90% | 9.20% | 0.92% | 375 |
| N1171 | 0.2 | 1.6 | 0.5 | 0 | BAL | 0.75 | 0.7 | 2.5 | 0 | 0.44 | 0.5 | 0.36 | 0 | 9.23% | 4.54% | 1.32% | 265 |
| N1172 | 0.2 | 1.6 | 0.5 | 0 | BAL | 0.75 | 0.7 | 2.5 | 0 | 0.44 | 1 | 0.36 | 0 | 6.93% | 5.91% | 1.22% | 260 |
| N1173 | 0.2 | 1.6 | 0.5 | 0 | BAL | 0.75 | 0.7 | 2.5 | 0 | 0.44 | 1.5 | 0.36 | 0 | 5.63% | 7.00% | 1.13% | 275 |
| N1174 | 0.2 | 1.6 | 0.5 | 0 | BAL | 0.75 | 0.7 | 2.5 | 0 | 0.44 | 2 | 0.36 | 0 | 2.72% | 7.92% | 1.03% | 315 |
| N1175 | 0.2 | 1.6 | 0.5 | 0 | BAL | 0.75 | 0.7 | 2.5 | 0 | 0.44 | 2.5 | 0.36 | 0 | 1.36% | 8.80% | 0.95% | 340 |
| N1176 | 0.2 | 1.6 | 0.5 | 0 | BAL | 0.75 | 0.7 | 2.5 | 0 | 0.44 | 3 | 0.36 | 0 | 0.91% | 9.75% | 0.86% | 365 |
| N1177 | 0.2 | 1.6 | 0.5 | 0 | BAL | 0.75 | 0.7 | 3 | 0 | 0.44 | 0.5 | 0.36 | 0 | 7.99% | 5.21% | 1.27% | 260 |
| N1178 | 0.2 | 1.6 | 0.5 | 0 | BAL | 0.75 | 0.7 | 3 | 0 | 0.44 | 1 | 0.36 | 0 | 5.75% | 6.50% | 1.17% | 260 |
| N1179 | 0.2 | 1.6 | 0.5 | 0 | BAL | 0.75 | 0.7 | 3 | 0 | 0.44 | 1.5 | 0.36 | 0 | 3.57% | 7.58% | 1.07% | 265 |
| N1180 | 0.2 | 1.6 | 0.5 | 0 | BAL | 0.75 | 0.7 | 3 | 0 | 0.44 | 2 | 0.36 | 0 | 2.28% | 8.53% | 0.98% | 310 |
| N1181 | 0.2 | 1.6 | 0.5 | 0 | BAL | 0.75 | 0.7 | 3 | 0 | 0.44 | 2.5 | 0.36 | 0 | 1.55% | 9.40% | 0.89% | 340 |
| N1182 | 0.2 | 1.6 | 0.5 | 0 | BAL | 0.75 | 0.7 | 3 | 0 | 0.44 | 3 | 0.36 | 0 | 0.93% | 10.29% | 0.81% | 360 |
| N1183 | 0.2 | 1.6 | 0.5 | 0 | BAL | 0.75 | 0.7 | 3.5 | 0 | 0.44 | 0.5 | 0.36 | 0 | 6.77% | 5.90% | 1.22% | 260 |
| N1184 | 0.2 | 1.6 | 0.5 | 0 | BAL | 0.75 | 0.7 | 3.5 | 0 | 0.44 | 1 | 0.36 | 0 | 4.59% | 7.09% | 1.12% | 260 |
| N1185 | 0.2 | 1.6 | 0.5 | 0 | BAL | 0.75 | 0.7 | 3.5 | 0 | 0.44 | 1.5 | 0.36 | 0 | 2.77% | 8.16% | 1.02% | 260 |
| N1186 | 0.2 | 1.6 | 0.5 | 0 | BAL | 0.75 | 0.7 | 3.5 | 0 | 0.44 | 2 | 0.36 | 0 | 2.45% | 9.14% | 0.93% | 300 |
| N1187 | 0.2 | 1.6 | 0.5 | 0 | BAL | 0.75 | 0.7 | 3.5 | 0 | 0.44 | 2.5 | 0.36 | 0 | 1.69% | 9.99% | 0.84% | 330 |
| N1188 | 0.2 | 1.6 | 0.5 | 0 | BAL | 0.75 | 0.7 | 3.5 | 0 | 0.44 | 3 | 0.36 | 0 | 0.97% | 10.85% | 0.76% | 355 |
| N1189 | 0.2 | 1.6 | 0.5 | 0 | BAL | 0.75 | 0.7 | 4 | 0 | 0.44 | 0.5 | 0.36 | 0 | 5.57% | 6.58% | 1.17% | 260 |
| N1190 | 0.2 | 1.6 | 0.5 | 0 | BAL | 0.75 | 0.7 | 4 | 0 | 0.44 | 1 | 0.36 | 0 | 3.47% | 7.68% | 1.06% | 250 |
| N1191 | 0.2 | 1.6 | 0.5 | 0 | BAL | 0.75 | 0.7 | 4 | 0 | 0.44 | 1.5 | 0.36 | 0 | 1.76% | 8.73% | 0.97% | 260 |
| N1192 | 0.2 | 1.6 | 0.5 | 0 | BAL | 0.75 | 0.7 | 4 | 0 | 0.44 | 2 | 0.36 | 0 | 1.61% | 9.74% | 0.88% | 300 |
| N1193 | 0.2 | 1.6 | 0.5 | 0 | BAL | 0.75 | 0.7 | 4 | 0 | 0.44 | 2.5 | 0.36 | 0 | 1.79% | 10.57% | 0.79% | 330 |
| N1194 | 0.2 | 1.6 | 0.5 | 0 | BAL | 0.75 | 0.7 | 4 | 0 | 0.44 | 3 | 0.36 | 0 | 1.01% | 11.40% | 0.71% | 355 |
| N1195 | 0.2 | 1.6 | 0.5 | 0 | BAL | 0.75 | 0.7 | 4.5 | 0 | 0.44 | 0.5 | 0.36 | 0 | 4.41% | 7.27% | 1.12% | 250 |
| N1196 | 0.2 | 1.6 | 0.5 | 0 | BAL | 0.75 | 0.7 | 4.5 | 0 | 0.44 | 1 | 0.36 | 0 | 2.64% | 8.27% | 1.02% | 250 |
| N1197 | 0.2 | 1.6 | 0.5 | 0 | BAL | 0.75 | 0.7 | 4.5 | 0 | 0.44 | 1.5 | 0.36 | 0 | 1.76% | 9.30% | 0.92% | 250 |
| N1198 | 0.2 | 1.6 | 0.5 | 0 | BAL | 0.75 | 0.7 | 4.5 | 0 | 0.44 | 2 | 0.36 | 0 | 1.69% | 10.32% | 0.82% | 295 |
| N1199 | 0.2 | 1.6 | 0.5 | 0 | BAL | 0.75 | 0.7 | 4.5 | 0 | 0.44 | 2.5 | 0.36 | 0 | 1.84% | 11.14% | 0.74% | 325 |
| N1200 | 0.2 | 1.6 | 0.5 | 0 | BAL | 0.75 | 0.7 | 5 | 0 | 0.44 | 0.5 | 0.36 | 0 | 3.29% | 7.87% | 1.07% | 250 |
| N1201 | 0.2 | 1.6 | 0.5 | 0 | BAL | 0.75 | 0.7 | 5 | 0 | 0.44 | 1 | 0.36 | 0 | 1.77% | 8.86% | 0.96% | 245 |
| N1202 | 0.2 | 1.6 | 0.5 | 0 | BAL | 0.75 | 0.7 | 5 | 0 | 0.44 | 1.5 | 0.36 | 0 | 1.77% | 9.88% | 0.87% | 250 |
| N1203 | 0.2 | 1.6 | 0.5 | 0 | BAL | 0.75 | 0.7 | 5 | 0 | 0.44 | 2 | 0.36 | 0 | 1.72% | 10.90% | 0.78% | 295 |
| N1204 | 0.2 | 1.7 | 0.5 | 0 | BAL | 0.75 | 0.7 | 2 | 0 | 0.44 | 1.5 | 0.36 | 0 | 8.63% | 6.42% | 1.27% | 280 |
| N1205 | 0.2 | 1.7 | 0.5 | 0 | BAL | 0.75 | 0.7 | 2 | 0 | 0.44 | 2 | 0.36 | 0 | 5.75% | 7.36% | 1.18% | 315 |
| N1206 | 0.2 | 1.7 | 0.5 | 0 | BAL | 0.75 | 0.7 | 2 | 0 | 0.44 | 2.5 | 0.36 | 0 | 2.49% | 8.23% | 1.09% | 340 |
| N1207 | 0.2 | 1.7 | 0.5 | 0 | BAL | 0.75 | 0.7 | 2 | 0 | 0.44 | 3 | 0.36 | 0 | 0.90% | 9.22% | 1.00% | 360 |
| N1208 | 0.2 | 1.7 | 0.5 | 0 | BAL | 0.75 | 0.7 | 2.5 | 0 | 0.44 | 1 | 0.36 | 0 | 8.86% | 5.90% | 1.31% | 270 |
| N1209 | 0.2 | 1.7 | 0.5 | 0 | BAL | 0.75 | 0.7 | 2.5 | 0 | 0.44 | 1.5 | 0.36 | 0 | 7.47% | 6.99% | 1.22% | 270 |
| N1210 | 0.2 | 1.7 | 0.5 | 0 | BAL | 0.75 | 0.7 | 2.5 | 0 | 0.44 | 2 | 0.36 | 0 | 4.91% | 8.00% | 1.12% | 310 |
| N1211 | 0.2 | 1.7 | 0.5 | 0 | BAL | 0.75 | 0.7 | 2.5 | 0 | 0.44 | 2.5 | 0.36 | 0 | 1.58% | 8.85% | 1.03% | 335 |
| N1212 | 0.2 | 1.7 | 0.5 | 0 | BAL | 0.75 | 0.7 | 2.5 | 0 | 0.44 | 3 | 0.36 | 0 | 0.91% | 9.77% | 0.95% | 360 |
| N1213 | 0.2 | 1.7 | 0.5 | 0 | BAL | 0.75 | 0.7 | 3 | 0 | 0.44 | 0.5 | 0.36 | 0 | 9.95% | 5.21% | 1.36% | 265 |
| N1214 | 0.2 | 1.7 | 0.5 | 0 | BAL | 0.75 | 0.7 | 3 | 0 | 0.44 | 1 | 0.36 | 0 | 7.65% | 6.49% | 1.26% | 265 |
| N1215 | 0.2 | 1.7 | 0.5 | 0 | BAL | 0.75 | 0.7 | 3 | 0 | 0.44 | 1.5 | 0.36 | 0 | 5.38% | 7.57% | 1.16% | 260 |
| N1216 | 0.2 | 1.7 | 0.5 | 0 | BAL | 0.75 | 0.7 | 3 | 0 | 0.44 | 2 | 0.36 | 0 | 4.03% | 8.62% | 1.07% | 305 |
| N1217 | 0.2 | 1.7 | 0.5 | 0 | BAL | 0.75 | 0.7 | 3 | 0 | 0.44 | 2.5 | 0.36 | 0 | 1.72% | 9.46% | 0.98% | 330 |
| N1218 | 0.2 | 1.7 | 0.5 | 0 | BAL | 0.75 | 0.7 | 3 | 0 | 0.44 | 3 | 0.36 | 0 | 1.07% | 10.35% | 0.89% | 355 |
| N1219 | 0.2 | 1.7 | 0.5 | 0 | BAL | 0.75 | 0.7 | 3.5 | 0 | 0.44 | 0.5 | 0.36 | 0 | 8.71% | 5.89% | 1.31% | 265 |
| N1220 | 0.2 | 1.7 | 0.5 | 0 | BAL | 0.75 | 0.7 | 3.5 | 0 | 0.44 | 1 | 0.36 | 0 | 6.46% | 7.08% | 1.20% | 260 |
| N1221 | 0.2 | 1.7 | 0.5 | 0 | BAL | 0.75 | 0.7 | 3.5 | 0 | 0.44 | 1.5 | 0.36 | 0 | 4.25% | 8.15% | 1.11% | 260 |
| N1222 | 0.2 | 1.7 | 0.5 | 0 | BAL | 0.75 | 0.7 | 3.5 | 0 | 0.44 | 2 | 0.36 | 0 | 3.38% | 9.22% | 1.01% | 295 |
| N1223 | 0.2 | 1.7 | 0.5 | 0 | BAL | 0.75 | 0.7 | 3.5 | 0 | 0.44 | 2.5 | 0.36 | 0 | 1.89% | 10.06% | 0.92% | 325 |
| N1224 | 0.2 | 1.7 | 0.5 | 0 | BAL | 0.75 | 0.7 | 3.5 | 0 | 0.44 | 3 | 0.36 | 0 | 1.21% | 10.94% | 0.84% | 350 |
| N1225 | 0.2 | 1.7 | 0.5 | 0 | BAL | 0.75 | 0.7 | 4 | 0 | 0.44 | 0.5 | 0.36 | 0 | 7.48% | 6.58% | 1.26% | 260 |
| N1226 | 0.2 | 1.7 | 0.5 | 0 | BAL | 0.75 | 0.7 | 4 | 0 | 0.44 | 1 | 0.36 | 0 | 5.28% | 7.68% | 1.15% | 260 |
| N1227 | 0.2 | 1.7 | 0.5 | 0 | BAL | 0.75 | 0.7 | 4 | 0 | 0.44 | 1.5 | 0.36 | 0 | 3.16% | 8.74% | 1.05% | 255 |
| N1228 | 0.2 | 1.7 | 0.5 | 0 | BAL | 0.75 | 0.7 | 4 | 0 | 0.44 | 2 | 0.36 | 0 | 1.76% | 9.79% | 0.96% | 290 |
| N1229 | 0.2 | 1.7 | 0.5 | 0 | BAL | 0.75 | 0.7 | 4 | 0 | 0.44 | 2.5 | 0.36 | 0 | 2.02% | 10.65% | 0.87% | 320 |
| N1230 | 0.2 | 1.7 | 0.5 | 0 | BAL | 0.75 | 0.7 | 4 | 0 | 0.44 | 3 | 0.36 | 0 | 1.30% | 11.51% | 0.79% | 350 |
| N1231 | 0.2 | 1.7 | 0.5 | 0 | BAL | 0.75 | 0.7 | 4.5 | 0 | 0.44 | 0.5 | 0.36 | 0 | 6.27% | 7.27% | 1.21% | 260 |
| N1232 | 0.2 | 1.7 | 0.5 | 0 | BAL | 0.75 | 0.7 | 4.5 | 0 | 0.44 | 1 | 0.36 | 0 | 4.14% | 8.27% | 1.11% | 255 |
| N1233 | 0.2 | 1.7 | 0.5 | 0 | BAL | 0.75 | 0.7 | 4.5 | 0 | 0.44 | 1.5 | 0.36 | 0 | 2.31% | 9.32% | 1.00% | 250 |
| N1234 | 0.2 | 1.7 | 0.5 | 0 | BAL | 0.75 | 0.7 | 4.5 | 0 | 0.44 | 2 | 0.36 | 0 | 1.76% | 10.36% | 0.91% | 285 |
| N1235 | 0.2 | 1.7 | 0.5 | 0 | BAL | 0.75 | 0.7 | 4.5 | 0 | 0.44 | 2.5 | 0.36 | 0 | 2.10% | 11.23% | 0.82% | 315 |
| N1236 | 0.2 | 1.7 | 0.5 | 0 | BAL | 0.75 | 0.7 | 4.5 | 0 | 0.44 | 3 | 0.36 | 0 | 1.34% | 12.07% | 0.73% | 345 |
| N1237 | 0.2 | 1.7 | 0.5 | 0 | BAL | 0.75 | 0.7 | 5 | 0 | 0.44 | 0.5 | 0.36 | 0 | 5.08% | 7.88% | 1.16% | 255 |
| N1238 | 0.2 | 1.7 | 0.5 | 0 | BAL | 0.75 | 0.7 | 5 | 0 | 0.44 | 1 | 0.36 | 0 | 3.05% | 8.87% | 1.05% | 250 |
| N1239 | 0.2 | 1.7 | 0.5 | 0 | BAL | 0.75 | 0.7 | 5 | 0 | 0.44 | 1.5 | 0.36 | 0 | 1.76% | 9.89% | 0.95% | 250 |
| N1240 | 0.2 | 1.7 | 0.5 | 0 | BAL | 0.75 | 0.7 | 5 | 0 | 0.44 | 2 | 0.36 | 0 | 1.76% | 10.93% | 0.86% | 285 |
| N1241 | 0.2 | 1.7 | 0.5 | 0 | BAL | 0.75 | 0.7 | 5 | 0 | 0.44 | 2.5 | 0.36 | 0 | 1.18% | 11.80% | 0.77% | 315 |
| N1242 | 0.2 | 1.8 | 0.5 | 0 | BAL | 0.75 | 0.7 | 2 | 0 | 0.44 | 2 | 0.36 | 0 | 7.91% | 7.42% | 1.27% | 310 |
| N1243 | 0.2 | 1.8 | 0.5 | 0 | BAL | 0.75 | 0.7 | 2 | 0 | 0.44 | 2.5 | 0.36 | 0 | 4.66% | 8.28% | 1.18% | 335 |
| N1244 | 0.2 | 1.8 | 0.5 | 0 | BAL | 0.75 | 0.7 | 2 | 0 | 0.44 | 3 | 0.36 | 0 | 1.63% | 9.25% | 1.09% | 355 |
| N1245 | 0.2 | 1.8 | 0.5 | 0 | BAL | 0.75 | 0.7 | 2.5 | 0 | 0.44 | 1.5 | 0.36 | 0 | 9.37% | 6.98% | 1.31% | 270 |
| N1246 | 0.2 | 1.8 | 0.5 | 0 | BAL | 0.75 | 0.7 | 2.5 | 0 | 0.44 | 2 | 0.36 | 0 | 7.07% | 8.08% | 1.22% | 300 |
| N1247 | 0.2 | 1.8 | 0.5 | 0 | BAL | 0.75 | 0.7 | 2.5 | 0 | 0.44 | 2.5 | 0.36 | 0 | 3.77% | 8.91% | 1.12% | 330 |
| N1248 | 0.2 | 1.8 | 0.5 | 0 | BAL | 0.75 | 0.7 | 2.5 | 0 | 0.44 | 3 | 0.36 | 0 | 1.01% | 9.81% | 1.03% | 350 |
| N1249 | 0.2 | 1.8 | 0.5 | 0 | BAL | 0.75 | 0.7 | 3 | 0 | 0.44 | 1 | 0.36 | 0 | 9.59% | 6.48% | 1.35% | 265 |
| N1250 | 0.2 | 1.8 | 0.5 | 0 | BAL | 0.75 | 0.7 | 3 | 0 | 0.44 | 1.5 | 0.36 | 0 | 7.25% | 7.56% | 1.25% | 270 |
| N1251 | 0.2 | 1.8 | 0.5 | 0 | BAL | 0.75 | 0.7 | 3 | 0 | 0.44 | 2 | 0.36 | 0 | 5.94% | 8.65% | 1.16% | 290 |
| N1252 | 0.2 | 1.8 | 0.5 | 0 | BAL | 0.75 | 0.7 | 3 | 0 | 0.44 | 2.5 | 0.36 | 0 | 2.84% | 9.52% | 1.07% | 325 |
| N1253 | 0.2 | 1.8 | 0.5 | 0 | BAL | 0.75 | 0.7 | 3 | 0 | 0.44 | 3 | 0.36 | 0 | 1.23% | 10.41% | 0.98% | 350 |
| N1254 | 0.2 | 1.8 | 0.5 | 0 | BAL | 0.75 | 0.7 | 3.5 | 0 | 0.44 | 1 | 0.36 | 0 | 8.38% | 7.07% | 1.30% | 265 |
| N1255 | 0.2 | 1.8 | 0.5 | 0 | BAL | 0.75 | 0.7 | 3.5 | 0 | 0.44 | 1.5 | 0.36 | 0 | 6.08% | 8.15% | 1.20% | 265 |
| N1256 | 0.2 | 1.8 | 0.5 | 0 | BAL | 0.75 | 0.7 | 3.5 | 0 | 0.44 | 2 | 0.36 | 0 | 4.85% | 9.22% | 1.10% | 290 |
| N1257 | 0.2 | 1.8 | 0.5 | 0 | BAL | 0.75 | 0.7 | 3.5 | 0 | 0.44 | 2.5 | 0.36 | 0 | 2.05% | 10.11% | 1.01% | 315 |
| N1258 | 0.2 | 1.8 | 0.5 | 0 | BAL | 0.75 | 0.7 | 3.5 | 0 | 0.44 | 3 | 0.36 | 0 | 1.40% | 11.00% | 0.92% | 340 |
| N1259 | 0.2 | 1.8 | 0.5 | 0 | BAL | 0.75 | 0.7 | 4 | 0 | 0.44 | 0.5 | 0.36 | 0 | 9.42% | 6.57% | 1.35% | 265 |
| N1260 | 0.2 | 1.8 | 0.5 | 0 | BAL | 0.75 | 0.7 | 4 | 0 | 0.44 | 1 | 0.36 | 0 | 7.17% | 7.67% | 1.25% | 265 |
| N1261 | 0.2 | 1.8 | 0.5 | 0 | BAL | 0.75 | 0.7 | 4 | 0 | 0.44 | 1.5 | 0.36 | 0 | 4.94% | 8.73% | 1.14% | 260 |
| N1262 | 0.2 | 1.8 | 0.5 | 0 | BAL | 0.75 | 0.7 | 4 | 0 | 0.44 | 2 | 0.36 | 0 | 3.02% | 9.80% | 1.05% | 285 |
| N1263 | 0.2 | 1.8 | 0.5 | 0 | BAL | 0.75 | 0.7 | 4 | 0 | 0.44 | 2.5 | 0.36 | 0 | 2.20% | 10.71% | 0.96% | 315 |
| N1264 | 0.2 | 1.8 | 0.5 | 0 | BAL | 0.75 | 0.7 | 4 | 0 | 0.44 | 3 | 0.36 | 0 | 1.53% | 11.59% | 0.87% | 340 |
| N1265 | 0.2 | 1.8 | 0.5 | 0 | BAL | 0.75 | 0.7 | 4.5 | 0 | 0.44 | 0.5 | 0.36 | 0 | 8.18% | 7.26% | 1.30% | 265 |
| N1266 | 0.2 | 1.8 | 0.5 | 0 | BAL | 0.75 | 0.7 | 4.5 | 0 | 0.44 | 1 | 0.36 | 0 | 5.98% | 8.27% | 1.19% | 255 |
| N1267 | 0.2 | 1.8 | 0.5 | 0 | BAL | 0.75 | 0.7 | 4.5 | 0 | 0.44 | 1.5 | 0.36 | 0 | 3.82% | 9.32% | 1.09% | 255 |
| N1268 | 0.2 | 1.8 | 0.5 | 0 | BAL | 0.75 | 0.7 | 4.5 | 0 | 0.44 | 2 | 0.36 | 0 | 1.97% | 10.37% | 1.00% | 280 |
| N1269 | 0.2 | 1.8 | 0.5 | 0 | BAL | 0.75 | 0.7 | 4.5 | 0 | 0.44 | 2.5 | 0.36 | 0 | 2.32% | 11.30% | 0.90% | 310 |
| N1270 | 0.2 | 1.8 | 0.5 | 0 | BAL | 0.75 | 0.7 | 4.5 | 0 | 0.44 | 3 | 0.36 | 0 | 1.61% | 12.16% | 0.81% | 335 |
| N1271 | 0.2 | 1.8 | 0.5 | 0 | BAL | 0.75 | 0.7 | 5 | 0 | 0.44 | 0.5 | 0.36 | 0 | 6.96% | 7.87% | 1.25% | 255 |
| N1272 | 0.2 | 1.8 | 0.5 | 0 | BAL | 0.75 | 0.7 | 5 | 0 | 0.44 | 1 | 0.36 | 0 | 4.82% | 8.87% | 1.14% | 255 |
| N1273 | 0.2 | 1.8 | 0.5 | 0 | BAL | 0.75 | 0.7 | 5 | 0 | 0.44 | 1.5 | 0.36 | 0 | 2.90% | 9.90% | 1.04% | 250 |
| N1274 | 0.2 | 1.8 | 0.5 | 0 | BAL | 0.75 | 0.7 | 5 | 0 | 0.44 | 2 | 0.36 | 0 | 1.76% | 10.94% | 0.95% | 280 |
| N1275 | 0.2 | 1.8 | 0.5 | 0 | BAL | 0.75 | 0.7 | 5 | 0 | 0.44 | 2.5 | 0.36 | 0 | 1.43% | 11.89% | 0.85% | 310 |
| N1276 | 0.2 | 1.8 | 0.5 | 0 | BAL | 0.75 | 0.7 | 5 | 0 | 0.44 | 3 | 0.36 | 0 | 1.65% | 12.72% | 0.77% | 335 |
| N1277 | 0.2 | 1.9 | 0.5 | 0 | BAL | 0.75 | 0.7 | 2 | 0 | 0.44 | 2.5 | 0.36 | 0 | 6.86% | 8.36% | 1.27% | 330 |
| N1278 | 0.2 | 1.9 | 0.5 | 0 | BAL | 0.75 | 0.7 | 2 | 0 | 0.44 | 3 | 0.36 | 0 | 3.85% | 9.31% | 1.18% | 350 |
| N1279 | 0.2 | 1.9 | 0.5 | 0 | BAL | 0.75 | 0.7 | 2.5 | 0 | 0.44 | 2 | 0.36 | 0 | 8.93% | 8.07% | 1.31% | 295 |
| N1280 | 0.2 | 1.9 | 0.5 | 0 | BAL | 0.75 | 0.7 | 2.5 | 0 | 0.44 | 2.5 | 0.36 | 0 | 5.93% | 8.97% | 1.22% | 325 |
| N1281 | 0.2 | 1.9 | 0.5 | 0 | BAL | 0.75 | 0.7 | 2.5 | 0 | 0.44 | 3 | 0.36 | 0 | 2.76% | 9.85% | 1.12% | 345 |
| N1282 | 0.2 | 1.9 | 0.5 | 0 | BAL | 0.75 | 0.7 | 3 | 0 | 0.44 | 1.5 | 0.36 | 0 | 9.17% | 7.55% | 1.35% | 275 |
| N1283 | 0.2 | 1.9 | 0.5 | 0 | BAL | 0.75 | 0.7 | 3 | 0 | 0.44 | 2 | 0.36 | 0 | 7.78% | 8.64% | 1.25% | 285 |
| N1284 | 0.2 | 1.9 | 0.5 | 0 | BAL | 0.75 | 0.7 | 3 | 0 | 0.44 | 2.5 | 0.36 | 0 | 5.03% | 9.60% | 1.16% | 315 |
| N1285 | 0.2 | 1.9 | 0.5 | 0 | BAL | 0.75 | 0.7 | 3 | 0 | 0.44 | 3 | 0.36 | 0 | 1.81% | 10.46% | 1.07% | 345 |
| N1286 | 0.2 | 1.9 | 0.5 | 0 | BAL | 0.75 | 0.7 | 3.5 | 0 | 0.44 | 1.5 | 0.36 | 0 | 7.98% | 8.14% | 1.29% | 265 |
| N1287 | 0.2 | 1.9 | 0.5 | 0 | BAL | 0.75 | 0.7 | 3.5 | 0 | 0.44 | 2 | 0.36 | 0 | 6.64% | 9.22% | 1.20% | 285 |
| N1288 | 0.2 | 1.9 | 0.5 | 0 | BAL | 0.75 | 0.7 | 3.5 | 0 | 0.44 | 2.5 | 0.36 | 0 | 4.09% | 10.20% | 1.10% | 310 |
| N1289 | 0.2 | 1.9 | 0.5 | 0 | BAL | 0.75 | 0.7 | 3.5 | 0 | 0.44 | 3 | 0.36 | 0 | 1.56% | 11.05% | 1.01% | 335 |
| N1290 | 0.2 | 1.9 | 0.5 | 0 | BAL | 0.75 | 0.7 | 4 | 0 | 0.44 | 1 | 0.36 | 0 | 9.10% | 7.66% | 1.34% | 265 |
| N1291 | 0.2 | 1.9 | 0.5 | 0 | BAL | 0.75 | 0.7 | 4 | 0 | 0.44 | 1.5 | 0.36 | 0 | 6.80% | 8.72% | 1.24% | 265 |
| N1292 | 0.2 | 1.9 | 0.5 | 0 | BAL | 0.75 | 0.7 | 4 | 0 | 0.44 | 2 | 0.36 | 0 | 4.58% | 9.79% | 1.14% | 275 |
| N1293 | 0.2 | 1.9 | 0.5 | 0 | BAL | 0.75 | 0.7 | 4 | 0 | 0.44 | 2.5 | 0.36 | 0 | 3.11% | 10.78% | 1.05% | 310 |
| N1294 | 0.2 | 1.9 | 0.5 | 0 | BAL | 0.75 | 0.7 | 4 | 0 | 0.44 | 3 | 0.36 | 0 | 1.71% | 11.65% | 0.96% | 335 |
| N1295 | 0.2 | 1.9 | 0.5 | 0 | BAL | 0.75 | 0.7 | 4.5 | 0 | 0.44 | 1 | 0.36 | 0 | 7.89% | 8.26% | 1.29% | 265 |
| N1296 | 0.2 | 1.9 | 0.5 | 0 | BAL | 0.75 | 0.7 | 4.5 | 0 | 0.44 | 1.5 | 0.36 | 0 | 5.64% | 9.31% | 1.19% | 265 |
| N1297 | 0.2 | 1.9 | 0.5 | 0 | BAL | 0.75 | 0.7 | 4.5 | 0 | 0.44 | 2 | 0.36 | 0 | 3.49% | 10.37% | 1.09% | 275 |
| N1298 | 0.2 | 1.9 | 0.5 | 0 | BAL | 0.75 | 0.7 | 4.5 | 0 | 0.44 | 2.5 | 0.36 | 0 | 2.49% | 11.36% | 0.99% | 305 |
| N1299 | 0.2 | 1.9 | 0.5 | 0 | BAL | 0.75 | 0.7 | 4.5 | 0 | 0.44 | 3 | 0.36 | 0 | 1.83% | 12.23% | 0.90% | 325 |
| N1300 | 0.2 | 1.9 | 0.5 | 0 | BAL | 0.75 | 0.7 | 5 | 0 | 0.44 | 0.5 | 0.36 | 0 | 8.89% | 7.86% | 1.34% | 265 |
| N1301 | 0.2 | 1.9 | 0.5 | 0 | BAL | 0.75 | 0.7 | 5 | 0 | 0.44 | 1 | 0.36 | 0 | 6.69% | 8.86% | 1.24% | 260 |
| N1302 | 0.2 | 1.9 | 0.5 | 0 | BAL | 0.75 | 0.7 | 5 | 0 | 0.44 | 1.5 | 0.36 | 0 | 4.50% | 9.90% | 1.13% | 255 |
| N1303 | 0.2 | 1.9 | 0.5 | 0 | BAL | 0.75 | 0.7 | 5 | 0 | 0.44 | 2 | 0.36 | 0 | 2.68% | 10.95% | 1.04% | 270 |
| N1304 | 0.2 | 1.9 | 0.5 | 0 | BAL | 0.75 | 0.7 | 5 | 0 | 0.44 | 2.5 | 0.36 | 0 | 1.63% | 11.95% | 0.94% | 300 |
| N1305 | 0.2 | 1.9 | 0.5 | 0 | BAL | 0.75 | 0.7 | 5 | 0 | 0.44 | 3 | 0.36 | 0 | 1.90% | 12.81% | 0.85% | 325 |
| N1306 | 0.2 | 2 | 0.5 | 0 | BAL | 0.75 | 0.7 | 2 | 0 | 0.44 | 2.5 | 0.36 | 0 | 9.05% | 8.44% | 1.36% | 325 |
| N1307 | 0.2 | 2 | 0.5 | 0 | BAL | 0.75 | 0.7 | 2 | 0 | 0.44 | 3 | 0.36 | 0 | 6.04% | 9.38% | 1.27% | 350 |
| N1308 | 0.2 | 2 | 0.5 | 0 | BAL | 0.75 | 0.7 | 2.5 | 0 | 0.44 | 2.5 | 0.36 | 0 | 8.08% | 9.02% | 1.30% | 315 |
| N1309 | 0.2 | 2 | 0.5 | 0 | BAL | 0.75 | 0.7 | 2.5 | 0 | 0.44 | 3 | 0.36 | 0 | 4.97% | 9.92% | 1.21% | 345 |
| N1310 | 0.2 | 2 | 0.5 | 0 | BAL | 0.75 | 0.7 | 3 | 0 | 0.44 | 2 | 0.36 | 0 | 9.66% | 8.63% | 1.34% | 285 |
| N1311 | 0.2 | 2 | 0.5 | 0 | BAL | 0.75 | 0.7 | 3 | 0 | 0.44 | 2.5 | 0.36 | 0 | 7.20% | 9.67% | 1.25% | 310 |
| N1312 | 0.2 | 2 | 0.5 | 0 | BAL | 0.75 | 0.7 | 3 | 0 | 0.44 | 3 | 0.36 | 0 | 3.98% | 10.51% | 1.15% | 335 |
| N1313 | 0.2 | 2 | 0.5 | 0 | BAL | 0.75 | 0.7 | 3.5 | 0 | 0.44 | 1.5 | 0.36 | 0 | 9.91% | 8.12% | 1.38% | 275 |
| N1314 | 0.2 | 2 | 0.5 | 0 | BAL | 0.75 | 0.7 | 3.5 | 0 | 0.44 | 2 | 0.36 | 0 | 8.50% | 9.20% | 1.29% | 275 |
| N1315 | 0.2 | 2 | 0.5 | 0 | BAL | 0.75 | 0.7 | 3.5 | 0 | 0.44 | 2.5 | 0.36 | 0 | 6.26% | 10.28% | 1.19% | 305 |
| N1316 | 0.2 | 2 | 0.5 | 0 | BAL | 0.75 | 0.7 | 3.5 | 0 | 0.44 | 3 | 0.36 | 0 | 3.02% | 11.11% | 1.10% | 330 |
| N1317 | 0.2 | 2 | 0.5 | 0 | BAL | 0.75 | 0.7 | 4 | 0 | 0.44 | 1.5 | 0.36 | 0 | 8.71% | 8.71% | 1.33% | 270 |
| N1318 | 0.2 | 2 | 0.5 | 0 | BAL | 0.75 | 0.7 | 4 | 0 | 0.44 | 2 | 0.36 | 0 | 6.41% | 9.78% | 1.23% | 270 |
| N1319 | 0.2 | 2 | 0.5 | 0 | BAL | 0.75 | 0.7 | 4 | 0 | 0.44 | 2.5 | 0.36 | 0 | 5.17% | 10.85% | 1.13% | 300 |
| N1320 | 0.2 | 2 | 0.5 | 0 | BAL | 0.75 | 0.7 | 4 | 0 | 0.44 | 3 | 0.36 | 0 | 2.01% | 11.70% | 1.04% | 330 |
| N1321 | 0.2 | 2 | 0.5 | 0 | BAL | 0.75 | 0.7 | 4.5 | 0 | 0.44 | 1 | 0.36 | 0 | 9.82% | 8.24% | 1.38% | 270 |
| N1322 | 0.2 | 2 | 0.5 | 0 | BAL | 0.75 | 0.7 | 4.5 | 0 | 0.44 | 1.5 | 0.36 | 0 | 7.52% | 9.30% | 1.28% | 265 |
| N1323 | 0.2 | 2 | 0.5 | 0 | BAL | 0.75 | 0.7 | 4.5 | 0 | 0.44 | 2 | 0.36 | 0 | 5.27% | 10.36% | 1.18% | 270 |
| N1324 | 0.2 | 2 | 0.5 | 0 | BAL | 0.75 | 0.7 | 4.5 | 0 | 0.44 | 2.5 | 0.36 | 0 | 4.11% | 11.42% | 1.08% | 295 |
| N1325 | 0.2 | 2 | 0.5 | 0 | BAL | 0.75 | 0.7 | 4.5 | 0 | 0.44 | 3 | 0.36 | 0 | 2.00% | 12.29% | 0.99% | 320 |
| N1326 | 0.2 | 2 | 0.5 | 0 | BAL | 0.75 | 0.7 | 5 | 0 | 0.44 | 1 | 0.36 | 0 | 8.60% | 8.84% | 1.33% | 260 |
| N1327 | 0.2 | 2 | 0.5 | 0 | BAL | 0.75 | 0.7 | 5 | 0 | 0.44 | 1.5 | 0.36 | 0 | 6.34% | 9.89% | 1.22% | 260 |
| N1328 | 0.2 | 2 | 0.5 | 0 | BAL | 0.75 | 0.7 | 5 | 0 | 0.44 | 2 | 0.36 | 0 | 4.16% | 10.94% | 1.12% | 260 |
| N1329 | 0.2 | 2 | 0.5 | 0 | BAL | 0.75 | 0.7 | 5 | 0 | 0.44 | 2.5 | 0.36 | 0 | 2.33% | 11.99% | 1.03% | 295 |
| N1330 | 0.2 | 2 | 0.5 | 0 | BAL | 0.75 | 0.7 | 5 | 0 | 0.44 | 3 | 0.36 | 0 | 2.11% | 12.87% | 0.94% | 320 |
| N1331 | 0.2 | 2.1 | 0.5 | 0 | BAL | 0.75 | 0.7 | 2 | 0 | 0.44 | 3 | 0.36 | 0 | 8.23% | 9.45% | 1.36% | 345 |
| N1332 | 0.2 | 2.1 | 0.5 | 0 | BAL | 0.75 | 0.7 | 2.5 | 0 | 0.44 | 3 | 0.36 | 0 | 7.17% | 10.00% | 1.30% | 335 |
| N1333 | 0.2 | 2.1 | 0.5 | 0 | BAL | 0.75 | 0.7 | 3 | 0 | 0.44 | 2.5 | 0.36 | 0 | 9.23% | 9.70% | 1.34% | 305 |
| N1334 | 0.2 | 2.1 | 0.5 | 0 | BAL | 0.75 | 0.7 | 3 | 0 | 0.44 | 3 | 0.36 | 0 | 6.14% | 10.56% | 1.25% | 330 |
| N1335 | 0.2 | 2.1 | 0.5 | 0 | BAL | 0.75 | 0.7 | 3.5 | 0 | 0.44 | 2.5 | 0.36 | 0 | 8.09% | 10.27% | 1.28% | 295 |
| N1336 | 0.2 | 2.1 | 0.5 | 0 | BAL | 0.75 | 0.7 | 3.5 | 0 | 0.44 | 3 | 0.36 | 0 | 5.20% | 11.18% | 1.19% | 325 |
| N1337 | 0.2 | 2.1 | 0.5 | 0 | BAL | 0.75 | 0.7 | 4 | 0 | 0.44 | 2 | 0.36 | 0 | 8.30% | 9.77% | 1.33% | 275 |
| N1338 | 0.2 | 2.1 | 0.5 | 0 | BAL | 0.75 | 0.7 | 4 | 0 | 0.44 | 2.5 | 0.36 | 0 | 6.95% | 10.84% | 1.23% | 295 |
| N1339 | 0.2 | 2.1 | 0.5 | 0 | BAL | 0.75 | 0.7 | 4 | 0 | 0.44 | 3 | 0.36 | 0 | 4.22% | 11.78% | 1.13% | 325 |
| N1340 | 0.2 | 2.1 | 0.5 | 0 | BAL | 0.75 | 0.7 | 4.5 | 0 | 0.44 | 1.5 | 0.36 | 0 | 9.44% | 9.28% | 1.37% | 270 |
| N1341 | 0.2 | 2.1 | 0.5 | 0 | BAL | 0.75 | 0.7 | 4.5 | 0 | 0.44 | 2 | 0.36 | 0 | 7.13% | 10.35% | 1.27% | 265 |
| N1342 | 0.2 | 2.1 | 0.5 | 0 | BAL | 0.75 | 0.7 | 4.5 | 0 | 0.44 | 2.5 | 0.36 | 0 | 5.84% | 11.41% | 1.17% | 290 |
| N1343 | 0.2 | 2.1 | 0.5 | 0 | BAL | 0.75 | 0.7 | 4.5 | 0 | 0.44 | 3 | 0.36 | 0 | 3.21% | 12.36% | 1.08% | 315 |
| N1344 | 0.2 | 2.1 | 0.5 | 0 | BAL | 0.75 | 0.7 | 5 | 0 | 0.44 | 1.5 | 0.36 | 0 | 8.24% | 9.87% | 1.32% | 270 |
| N1345 | 0.2 | 2.1 | 0.5 | 0 | BAL | 0.75 | 0.7 | 5 | 0 | 0.44 | 2 | 0.36 | 0 | 5.97% | 10.93% | 1.22% | 265 |
| N1346 | 0.2 | 2.1 | 0.5 | 0 | BAL | 0.75 | 0.7 | 5 | 0 | 0.44 | 2.5 | 0.36 | 0 | 3.81% | 11.99% | 1.12% | 290 |
| N1347 | 0.2 | 2.1 | 0.5 | 0 | BAL | 0.75 | 0.7 | 5 | 0 | 0.44 | 3 | 0.36 | 0 | 2.28% | 12.92% | 1.03% | 315 |
| N1348 | 0.2 | 2.2 | 0.5 | 0 | BAL | 0.75 | 0.7 | 2.5 | 0 | 0.44 | 3 | 0.36 | 0 | 9.36% | 10.07% | 1.40% | 330 |
| N1349 | 0.2 | 2.2 | 0.5 | 0 | BAL | 0.75 | 0.7 | 3 | 0 | 0.44 | 3 | 0.36 | 0 | 8.30% | 10.62% | 1.34% | 325 |
| N1350 | 0.2 | 2.2 | 0.5 | 0 | BAL | 0.75 | 0.7 | 3.5 | 0 | 0.44 | 2.5 | 0.36 | 0 | 9.96% | 10.25% | 1.38% | 295 |
| N1351 | 0.2 | 2.2 | 0.5 | 0 | BAL | 0.75 | 0.7 | 3.5 | 0 | 0.44 | 3 | 0.36 | 0 | 7.36% | 11.24% | 1.28% | 315 |
| N1352 | 0.2 | 2.2 | 0.5 | 0 | BAL | 0.75 | 0.7 | 4 | 0 | 0.44 | 2.5 | 0.36 | 0 | 8.80% | 10.82% | 1.32% | 290 |
| N1353 | 0.2 | 2.2 | 0.5 | 0 | BAL | 0.75 | 0.7 | 4 | 0 | 0.44 | 3 | 0.36 | 0 | 6.41% | 11.85% | 1.22% | 315 |
| N1354 | 0.2 | 2.2 | 0.5 | 0 | BAL | 0.75 | 0.7 | 4.5 | 0 | 0.44 | 2 | 0.36 | 0 | 9.03% | 10.33% | 1.37% | 270 |
| N1355 | 0.2 | 2.2 | 0.5 | 0 | BAL | 0.75 | 0.7 | 4.5 | 0 | 0.44 | 2.5 | 0.36 | 0 | 7.66% | 11.40% | 1.27% | 290 |
| N1356 | 0.2 | 2.2 | 0.5 | 0 | BAL | 0.75 | 0.7 | 4.5 | 0 | 0.44 | 3 | 0.36 | 0 | 5.41% | 12.44% | 1.17% | 310 |
| N1357 | 0 | 2.5 | 0 | 0 | BAL | 1.16 | 0.74 | 4 | 0 | 0.76 | 4 | 0 | 0 | 3.91% | 13.01% | 1.33% | 520 |
| N1358 | 0 | 2.5 | 0 | 0 | BAL | 1.16 | 0.74 | 4 | 0 | 0.76 | 6 | 0 | 0 | 1.76% | 17.26% | 0.98% | 680 |
| N1359 | 0 | 2.5 | 0 | 0 | BAL | 1.16 | 0.74 | 5 | 0 | 0.76 | 4 | 0 | 0 | 3.37% | 14.17% | 1.21% | 560 |
| N1360 | 0 | 2.5 | 0 | 0 | BAL | 1.16 | 0.74 | 5 | 0 | 0.76 | 6 | 0 | 0 | 1.21% | 18.43% | 0.86% | 640 |
| N1361 | 0 | 2.5 | 0 | 0 | BAL | 1.16 | 0.74 | 6 | 0 | 0.76 | 4 | 0 | 0 | 2.83% | 15.34% | 1.09% | 560 |
| N1362 | 0 | 2.5 | 0 | 0 | BAL | 1.16 | 0.74 | 6 | 0 | 0.76 | 6 | 0 | 0 | 0.66% | 19.60% | 0.75% | 640 |
| N1363 | 0 | 2.5 | 0 | 0 | BAL | 1.16 | 0.74 | 7 | 0 | 0.76 | 2 | 0 | 0 | 4.46% | 12.21% | 1.40% | 560 |
| N1364 | 0 | 2.5 | 0 | 0 | BAL | 1.16 | 0.74 | 7 | 0 | 0.76 | 4 | 0 | 0 | 2.28% | 16.52% | 1.02% | 600 |
| N1365 | 0 | 2.5 | 0 | 0 | BAL | 1.16 | 0.74 | 8 | 0 | 0.76 | 2 | 0 | 0 | 3.92% | 13.38% | 1.29% | 560 |
| N1366 | 0 | 2.5 | 0 | 0 | BAL | 1.16 | 0.74 | 8 | 0 | 0.76 | 4 | 0 | 0 | 1.73% | 17.70% | 0.91% | 600 |
| N1367 | 0 | 2.5 | 0 | 0 | BAL | 1.16 | 0.74 | 9 | 0 | 0.76 | 2 | 0 | 0 | 3.37% | 14.56% | 1.18% | 560 |
| N1368 | 0 | 2.5 | 0 | 0 | BAL | 1.16 | 0.74 | 9 | 0 | 0.76 | 4 | 0 | 0 | 1.17% | 18.89% | 0.81% | 600 |
| N1369 | 0 | 2.5 | 0 | 0 | BAL | 1.16 | 0.74 | 10 | 0 | 0.76 | 2 | 0 | 0 | 2.81% | 15.75% | 1.07% | 560 |
| N1370 | 0 | 2.5 | 0 | 0 | BAL | 1.16 | 0.74 | 10 | 0 | 0.76 | 4 | 0 | 0 | 0.54% | 20.09% | 0.71% | 600 |
| N1371 | 0 | 2.5 | 2 | 0 | BAL | 1.16 | 0.74 | 4 | 0 | 0.76 | 4 | 0 | 0 | 1.93% | 16.95% | 1.33% | 520 |
| N1372 | 0 | 2.5 | 2 | 0 | BAL | 1.16 | 0.74 | 4 | 0 | 0.76 | 6 | 0 | 0 | 0.94% | 19.32% | 0.97% | 680 |
| N1373 | 0 | 2.5 | 2 | 0 | BAL | 1.16 | 0.74 | 5 | 0 | 0.76 | 4 | 0 | 0 | 1.39% | 18.12% | 1.21% | 560 |
| N1374 | 0 | 2.5 | 2 | 0 | BAL | 1.16 | 0.74 | 5 | 0 | 0.76 | 6 | 0 | 0 | 2.11% | 19.58% | 0.86% | 680 |
| N1375 | 0 | 2.5 | 2 | 0 | BAL | 1.16 | 0.74 | 6 | 0 | 0.76 | 4 | 0 | 0 | 0.83% | 19.30% | 1.09% | 600 |
| N1376 | 0 | 2.5 | 2 | 0 | BAL | 1.16 | 0.74 | 6 | 0 | 0.76 | 6 | 0 | 0 | 1.67% | 19.67% | 0.75% | 680 |
| N1377 | 0 | 2.5 | 2 | 0 | BAL | 1.16 | 0.74 | 7 | 0 | 0.76 | 2 | 0 | 0 | 2.45% | 16.20% | 1.41% | 440 |
| N1378 | 0 | 2.5 | 2 | 0 | BAL | 1.16 | 0.74 | 7 | 0 | 0.76 | 4 | 0 | 0 | 1.04% | 20.03% | 1.02% | 600 |
| N1379 | 0 | 2.5 | 2 | 0 | BAL | 1.16 | 0.74 | 8 | 0 | 0.76 | 2 | 0 | 0 | 1.90% | 17.39% | 1.30% | 480 |
| N1380 | 0 | 2.5 | 2 | 0 | BAL | 1.16 | 0.74 | 8 | 0 | 0.76 | 4 | 0 | 0 | 0.64% | 20.42% | 0.91% | 600 |
| N1381 | 0 | 2.5 | 2 | 0 | BAL | 1.16 | 0.74 | 9 | 0 | 0.76 | 2 | 0 | 0 | 1.34% | 18.58% | 1.19% | 520 |
| N1382 | 0 | 2.5 | 2 | 0 | BAL | 1.16 | 0.74 | 9 | 0 | 0.76 | 4 | 0 | 0 | 0.77% | 20.38% | 0.81% | 600 |
| N1383 | 0 | 2.5 | 2 | 0 | BAL | 1.16 | 0.74 | 10 | 0 | 0.76 | 2 | 0 | 0 | 0.78% | 19.78% | 1.08% | 560 |
| N1384 | 0 | 2.5 | 2 | 0 | BAL | 1.16 | 0.74 | 10 | 0 | 0.76 | 4 | 0 | 0 | 1.42% | 20.21% | 0.71% | 640 |
| N1385 | 0 | 2.5 | 4 | 0 | BAL | 1.16 | 0.74 | 4 | 0 | 0.76 | 4 | 0 | 0 | 4.95% | 17.62% | 1.33% | 400 |
| N1386 | 0 | 2.5 | 4 | 0 | BAL | 1.16 | 0.74 | 4 | 0 | 0.76 | 6 | 0 | 0 | 3.81% | 18.41% | 0.97% | 640 |
| N1387 | 0 | 2.5 | 4 | 0 | BAL | 1.16 | 0.74 | 5 | 0 | 0.76 | 4 | 0 | 0 | 2.03% | 18.52% | 1.21% | 440 |
| N1388 | 0 | 2.5 | 4 | 0 | BAL | 1.16 | 0.74 | 5 | 0 | 0.76 | 6 | 0 | 0 | 3.50% | 18.39% | 0.86% | 640 |
| N1389 | 0 | 2.5 | 4 | 0 | BAL | 1.16 | 0.74 | 6 | 0 | 0.76 | 4 | 0 | 0 | 4.95% | 18.92% | 1.09% | 440 |
| N1390 | 0 | 2.5 | 4 | 0 | BAL | 1.16 | 0.74 | 6 | 0 | 0.76 | 6 | 0 | 0 | 1.82% | 19.32% | 0.75% | 640 |
| N1391 | 0 | 2.5 | 4 | 0 | BAL | 1.16 | 0.74 | 7 | 0 | 0.76 | 2 | 0 | 0 | 0.02% | 20.14% | 1.41% | 320 |
| N1392 | 0 | 2.5 | 4 | 0 | BAL | 1.16 | 0.74 | 7 | 0 | 0.76 | 4 | 0 | 0 | 2.77% | 19.07% | 0.99% | 520 |
| N1393 | 0 | 2.5 | 4 | 0 | BAL | 1.16 | 0.74 | 8 | 0 | 0.76 | 2 | 0 | 0 | 0.95% | 19.82% | 1.30% | 360 |
| N1394 | 0 | 2.5 | 4 | 0 | BAL | 1.16 | 0.74 | 8 | 0 | 0.76 | 4 | 0 | 0 | 3.03% | 18.84% | 0.92% | 560 |
| N1395 | 0 | 2.5 | 4 | 0 | BAL | 1.16 | 0.74 | 9 | 0 | 0.76 | 2 | 0 | 0 | 0.00% | 20.44% | 1.19% | 400 |
| N1396 | 0 | 2.5 | 4 | 0 | BAL | 1.16 | 0.74 | 9 | 0 | 0.76 | 4 | 0 | 0 | 3.89% | 18.87% | 0.81% | 600 |
| N1397 | 0 | 2.5 | 4 | 0 | BAL | 1.16 | 0.74 | 10 | 0 | 0.76 | 2 | 0 | 0 | 1.24% | 20.05% | 1.09% | 440 |
| N1398 | 0 | 2.5 | 4 | 0 | BAL | 1.16 | 0.74 | 10 | 0 | 0.76 | 4 | 0 | 0 | 1.82% | 19.75% | 0.72% | 640 |
| N1399 | 0.5 | 2.5 | 0 | 0 | BAL | 1.16 | 0.74 | 4 | 0 | 0.76 | 6 | 0 | 0 | 8.79% | 16.93% | 1.03% | 600 |
| N1400 | 0.5 | 2.5 | 0 | 0 | BAL | 1.16 | 0.74 | 5 | 0 | 0.76 | 6 | 0 | 0 | 8.28% | 18.08% | 0.91% | 600 |
| N1401 | 0.5 | 2.5 | 0 | 0 | BAL | 1.16 | 0.74 | 6 | 0 | 0.76 | 4 | 0 | 0 | 9.91% | 15.05% | 1.11% | 400 |
| N1402 | 0.5 | 2.5 | 0 | 0 | BAL | 1.16 | 0.74 | 6 | 0 | 0.76 | 6 | 0 | 0 | 7.76% | 19.23% | 0.80% | 640 |
| N1403 | 0.5 | 2.5 | 0 | 0 | BAL | 1.16 | 0.74 | 7 | 0 | 0.76 | 4 | 0 | 0 | 9.39% | 16.20% | 1.01% | 400 |
| N1404 | 0.5 | 2.5 | 0 | 0 | BAL | 1.16 | 0.74 | 7 | 0 | 0.76 | 6 | 0 | 0 | 4.38% | 20.40% | 0.70% | 600 |
| N1405 | 0.5 | 2.5 | 0 | 0 | BAL | 1.16 | 0.74 | 8 | 0 | 0.76 | 4 | 0 | 0 | 8.88% | 17.36% | 0.92% | 440 |
| N1406 | 0.5 | 2.5 | 0 | 0 | BAL | 1.16 | 0.74 | 9 | 0 | 0.76 | 4 | 0 | 0 | 8.36% | 18.53% | 0.81% | 440 |
| N1407 | 0.5 | 2.5 | 0 | 0 | BAL | 1.16 | 0.74 | 10 | 0 | 0.76 | 4 | 0 | 0 | 7.83% | 19.71% | 0.72% | 480 |
| N1408 | 0.5 | 2.5 | 2 | 0 | BAL | 1.16 | 0.74 | 4 | 0 | 0.76 | 6 | 0 | 0 | 7.99% | 18.49% | 1.01% | 560 |
| N1409 | 0.5 | 2.5 | 2 | 0 | BAL | 1.16 | 0.74 | 5 | 0 | 0.76 | 4 | 0 | 0 | 9.56% | 15.56% | 1.21% | 320 |
| N1410 | 0.5 | 2.5 | 2 | 0 | BAL | 1.16 | 0.74 | 5 | 0 | 0.76 | 6 | 0 | 0 | 7.45% | 19.68% | 0.90% | 600 |
| N1411 | 0.5 | 2.5 | 2 | 0 | BAL | 1.16 | 0.74 | 6 | 0 | 0.76 | 4 | 0 | 0 | 9.02% | 16.78% | 1.09% | 320 |
| N1412 | 0.5 | 2.5 | 2 | 0 | BAL | 1.16 | 0.74 | 6 | 0 | 0.76 | 6 | 0 | 0 | 6.91% | 20.89% | 0.79% | 560 |
| N1413 | 0.5 | 2.5 | 2 | 0 | BAL | 1.16 | 0.74 | 7 | 0 | 0.76 | 4 | 0 | 0 | 8.47% | 17.99% | 0.98% | 320 |
| N1414 | 0.5 | 2.5 | 2 | 0 | BAL | 1.16 | 0.74 | 8 | 0 | 0.76 | 2 | 0 | 0 | 9.67% | 15.84% | 1.27% | 160 |
| N1415 | 0.5 | 2.5 | 2 | 0 | BAL | 1.16 | 0.74 | 8 | 0 | 0.76 | 4 | 0 | 0 | 7.86% | 19.35% | 0.90% | 320 |
| N1416 | 0.5 | 2.5 | 2 | 0 | BAL | 1.16 | 0.74 | 9 | 0 | 0.76 | 2 | 0 | 0 | 9.05% | 17.22% | 1.15% | 120 |
| N1417 | 0.5 | 2.5 | 2 | 0 | BAL | 1.16 | 0.74 | 9 | 0 | 0.76 | 4 | 0 | 0 | 6.36% | 20.80% | 0.80% | 320 |
| N1418 | 0.5 | 2.5 | 2 | 0 | BAL | 1.16 | 0.74 | 10 | 0 | 0.76 | 2 | 0 | 0 | 8.44% | 18.55% | 1.04% | 120 |
| N1419 | 0.5 | 2.5 | 2 | 0 | BAL | 1.16 | 0.74 | 10 | 0 | 0.76 | 4 | 0 | 0 | 6.95% | 21.43% | 0.70% | 360 |
| N1420 | 0.5 | 2.5 | 4 | 0 | BAL | 1.16 | 0.74 | 4 | 0 | 0.76 | 4 | 0 | 0 | 8.27% | 17.97% | 1.31% | 200 |
| N1421 | 0.5 | 2.5 | 4 | 0 | BAL | 1.16 | 0.74 | 4 | 0 | 0.76 | 6 | 0 | 0 | 7.29% | 19.98% | 1.00% | 400 |
| N1422 | 0.5 | 2.5 | 4 | 0 | BAL | 1.16 | 0.74 | 5 | 0 | 0.76 | 4 | 0 | 0 | 7.73% | 19.18% | 1.19% | 200 |
| N1423 | 0.5 | 2.5 | 4 | 0 | BAL | 1.16 | 0.74 | 5 | 0 | 0.76 | 6 | 0 | 0 | 6.79% | 20.29% | 0.88% | 440 |
| N1424 | 0.5 | 2.5 | 4 | 0 | BAL | 1.16 | 0.74 | 6 | 0 | 0.76 | 2 | 0 | 0 | 9.30% | 16.27% | 1.47% | 80 |
| N1425 | 0.5 | 2.5 | 4 | 0 | BAL | 1.16 | 0.74 | 6 | 0 | 0.76 | 4 | 0 | 0 | 7.19% | 20.39% | 1.08% | 160 |
| N1426 | 0.5 | 2.5 | 4 | 0 | BAL | 1.16 | 0.74 | 6 | 0 | 0.76 | 6 | 0 | 0 | 9.21% | 20.05% | 0.78% | 440 |
| N1427 | 0.5 | 2.5 | 4 | 0 | BAL | 1.16 | 0.74 | 7 | 0 | 0.76 | 2 | 0 | 0 | 8.75% | 17.50% | 1.38% | 120 |
| N1428 | 0.5 | 2.5 | 4 | 0 | BAL | 1.16 | 0.74 | 7 | 0 | 0.76 | 4 | 0 | 0 | 6.86% | 21.12% | 0.96% | 160 |
| N1429 | 0.5 | 2.5 | 4 | 0 | BAL | 1.16 | 0.74 | 8 | 0 | 0.76 | 2 | 0 | 0 | 8.20% | 18.72% | 1.27% | 80 |
| N1430 | 0.5 | 2.5 | 4 | 0 | BAL | 1.16 | 0.74 | 8 | 0 | 0.76 | 4 | 0 | 0 | 7.41% | 20.85% | 0.85% | 200 |
| N1431 | 0.5 | 2.5 | 4 | 0 | BAL | 1.16 | 0.74 | 9 | 0 | 0.76 | 2 | 0 | 0 | 7.65% | 19.96% | 1.16% | 80 |
| N1432 | 0.5 | 2.5 | 4 | 0 | BAL | 1.16 | 0.74 | 9 | 0 | 0.76 | 4 | 0 | 0 | 6.91% | 20.70% | 0.78% | 200 |
| N1433 | 0.2 | 2.2 | 0.5 | 0 | BAL | 0.75 | 0.7 | 5 | 0 | 0.44 | 2 | 0.36 | 0 | 7.85% | 10.92% | 1.31% | 270 |
| N1434 | 0.2 | 2.2 | 0.5 | 0 | BAL | 0.75 | 0.7 | 5 | 0 | 0.44 | 2.5 | 0.36 | 0 | 5.60% | 11.98% | 1.21% | 280 |
| N1435 | 0.2 | 2.2 | 0.5 | 0 | BAL | 0.75 | 0.7 | 5 | 0 | 0.44 | 3 | 0.36 | 0 | 4.39% | 13.02% | 1.12% | 310 |
| N1436 | 0.2 | 2.3 | 0.5 | 0 | BAL | 0.75 | 0.7 | 3.5 | 0 | 0.44 | 3 | 0.36 | 0 | 9.51% | 11.30% | 1.38% | 315 |
| N1437 | 0.2 | 2.3 | 0.5 | 0 | BAL | 0.75 | 0.7 | 4 | 0 | 0.44 | 3 | 0.36 | 0 | 8.39% | 11.87% | 1.32% | 310 |
| N1438 | 0.2 | 2.3 | 0.5 | 0 | BAL | 0.75 | 0.7 | 4.5 | 0 | 0.44 | 2.5 | 0.36 | 0 | 9.52% | 11.38% | 1.36% | 280 |
| N1439 | 0.2 | 2.3 | 0.5 | 0 | BAL | 0.75 | 0.7 | 4.5 | 0 | 0.44 | 3 | 0.36 | 0 | 7.26% | 12.44% | 1.26% | 305 |
| N1440 | 0.2 | 2.3 | 0.5 | 0 | BAL | 0.75 | 0.7 | 5 | 0 | 0.44 | 2 | 0.36 | 0 | 9.75% | 10.89% | 1.41% | 270 |
| N1441 | 0.2 | 2.3 | 0.5 | 0 | BAL | 0.75 | 0.7 | 5 | 0 | 0.44 | 2.5 | 0.36 | 0 | 7.45% | 11.96% | 1.31% | 275 |
| N1442 | 0.2 | 2.3 | 0.5 | 0 | BAL | 0.75 | 0.7 | 5 | 0 | 0.44 | 3 | 0.36 | 0 | 6.16% | 13.02% | 1.21% | 300 |
| N1443 | 0.5 | 2.5 | 4 | 0 | BAL | 1.16 | 0.74 | 10 | 0 | 0.76 | 0 | 0 | 0 | 8.83% | 17.84% | 1.48% | 80 |
| N1444 | 0.5 | 2.5 | 4 | 0 | BAL | 1.16 | 0.74 | 10 | 0 | 0.76 | 2 | 0 | 0 | 7.09% | 21.20% | 1.05% | 80 |
| N1445 | 1 | 2.5 | 0 | 0 | BAL | 1.16 | 0.74 | 4 | 0 | 0.76 | 8 | 0 | 0 | 3.87% | 20.49% | 0.89% | 680 |
| N1446 | 1 | 2.5 | 0 | 0 | BAL | 1.16 | 0.74 | 5 | 0 | 0.76 | 8 | 0 | 0 | 3.88% | 20.56% | 0.77% | 680 |
| N1447 | 1 | 2.5 | 2 | 0 | BAL | 1.16 | 0.74 | 4 | 0 | 0.76 | 8 | 0 | 0 | 7.47% | 20.46% | 0.87% | 680 |
| N1448 | 1 | 2.5 | 2 | 0 | BAL | 1.16 | 0.74 | 5 | 0 | 0.76 | 8 | 0 | 0 | 8.87% | 20.53% | 0.76% | 680 |
| N1449 | 1 | 2.5 | 2 | 0 | BAL | 1.16 | 0.74 | 7 | 0 | 0.76 | 6 | 0 | 0 | 6.13% | 20.74% | 0.88% | 600 |
| N1450 | 1 | 2.5 | 2 | 0 | BAL | 1.16 | 0.74 | 8 | 0 | 0.76 | 6 | 0 | 0 | 7.73% | 20.82% | 0.77% | 600 |
| N1451 | 1.5 | 2.5 | 0 | 0 | BAL | 1.16 | 0.74 | 4 | 0 | 0.76 | 10 | 0 | 0 | 3.79% | 20.06% | 0.74% | 720 |
| N1452 | 1.5 | 2.5 | 0 | 0 | BAL | 1.16 | 0.74 | 7 | 0 | 0.76 | 8 | 0 | 0 | 3.84% | 20.33% | 0.75% | 640 |
| N1453 | 1.5 | 2.5 | 2 | 0 | BAL | 1.16 | 0.74 | 4 | 0 | 0.76 | 10 | 0 | 0 | 7.87% | 20.14% | 0.72% | 680 |
| N1454 | 1.5 | 2.5 | 2 | 0 | BAL | 1.16 | 0.74 | 5 | 0 | 0.76 | 8 | 0 | 0 | 6.14% | 20.16% | 0.96% | 640 |
| N1455 | 1.5 | 2.5 | 2 | 0 | BAL | 1.16 | 0.74 | 6 | 0 | 0.76 | 8 | 0 | 0 | 7.20% | 20.23% | 0.85% | 640 |
| N1456 | 1.5 | 2.5 | 2 | 0 | BAL | 1.16 | 0.74 | 7 | 0 | 0.76 | 8 | 0 | 0 | 8.54% | 20.30% | 0.74% | 640 |
| N1457 | 1.5 | 2.5 | 2 | 0 | BAL | 1.16 | 0.74 | 10 | 0 | 0.76 | 6 | 0 | 0 | 7.40% | 20.61% | 0.75% | 480 |
| N1458 | 2 | 2.5 | 0 | 0 | BAL | 1.16 | 0.74 | 6 | 0 | 0.76 | 10 | 0 | 0 | 3.75% | 19.84% | 0.72% | 680 |
| N1459 | 2 | 2.5 | 2 | 0 | BAL | 1.16 | 0.74 | 4 | 0 | 0.76 | 10 | 0 | 0 | 6.71% | 19.68% | 0.93% | 680 |
| N1460 | 2 | 2.5 | 2 | 0 | BAL | 1.16 | 0.74 | 5 | 0 | 0.76 | 10 | 0 | 0 | 7.95% | 19.75% | 0.82% | 680 |
| N1461 | 2 | 2.5 | 2 | 0 | BAL | 1.16 | 0.74 | 6 | 0 | 0.76 | 10 | 0 | 0 | 8.04% | 19.89% | 0.70% | 680 |
| N1462 | 2 | 2.5 | 2 | 0 | BAL | 1.16 | 0.74 | 8 | 0 | 0.76 | 8 | 0 | 0 | 6.94% | 20.01% | 0.83% | 560 |
| N1463 | 2 | 2.5 | 2 | 0 | BAL | 1.16 | 0.74 | 9 | 0 | 0.76 | 8 | 0 | 0 | 8.21% | 20.09% | 0.72% | 560 |
| N1464 | 0.2 | 1.8 | 0.5 | 0 | BAL | 0.75 | 0.7 | 6 | 0 | 0.44 | 2 | 0.36 | 0 | 3.72% | 12.24% | 0.85% | 300 |
| N1465 | 0.2 | 1.8 | 0.5 | 0 | BAL | 0.75 | 0.7 | 7 | 0 | 0.44 | 2 | 0.36 | 0 | 3.73% | 13.44% | 0.78% | 300 |
| N1466 | 0.2 | 1.8 | 0.5 | 0 | BAL | 0.75 | 0.7 | 8 | 0 | 0.44 | 2 | 0.36 | 0 | 3.74% | 14.65% | 0.70% | 300 |
| N1467 | 0.2 | 2 | 0.5 | 0 | BAL | 0.75 | 0.7 | 6 | 0 | 0.44 | 2 | 0.36 | 0 | 5.90% | 12.16% | 1.03% | 250 |
| N1468 | 0.2 | 2 | 0.5 | 0 | BAL | 0.75 | 0.7 | 7 | 0 | 0.44 | 2 | 0.36 | 0 | 3.70% | 13.35% | 0.92% | 250 |
| N1469 | 0.2 | 2 | 0.5 | 0 | BAL | 0.75 | 0.7 | 7 | 0 | 0.44 | 3 | 0.36 | 0 | 3.71% | 15.51% | 0.77% | 350 |
| N1470 | 0.2 | 2 | 0.5 | 0 | BAL | 0.75 | 0.7 | 8 | 0 | 0.44 | 2 | 0.36 | 0 | 4.79% | 14.55% | 0.83% | 300 |
| N1471 | 0.2 | 2.2 | 0.5 | 0 | BAL | 0.75 | 0.7 | 6 | 0 | 0.44 | 2 | 0.36 | 0 | 3.67% | 12.08% | 1.22% | 250 |
| N1472 | 0.2 | 2.2 | 0.5 | 0 | BAL | 0.75 | 0.7 | 7 | 0 | 0.44 | 2 | 0.36 | 0 | 6.18% | 13.26% | 1.11% | 250 |
| N1473 | 0.2 | 2.2 | 0.5 | 0 | BAL | 0.75 | 0.7 | 7 | 0 | 0.44 | 3 | 0.36 | 0 | 3.68% | 15.41% | 0.90% | 300 |
| N1474 | 0.2 | 2.2 | 0.5 | 0 | BAL | 0.75 | 0.7 | 8 | 0 | 0.44 | 2 | 0.36 | 0 | 5.63% | 14.45% | 1.00% | 250 |
| N1475 | 0.2 | 2.2 | 0.5 | 0 | BAL | 0.75 | 0.7 | 8 | 0 | 0.44 | 3 | 0.36 | 0 | 3.69% | 16.61% | 0.82% | 300 |
| N1476 | 0.2 | 2.4 | 0.5 | 0 | BAL | 0.75 | 0.7 | 6 | 0 | 0.44 | 2 | 0.36 | 0 | 3.64% | 12.00% | 1.42% | 300 |
| N1477 | 0.2 | 2.4 | 0.5 | 0 | BAL | 0.75 | 0.7 | 7 | 0 | 0.44 | 2 | 0.36 | 0 | 3.65% | 13.17% | 1.31% | 250 |
| N1478 | 0.2 | 2.4 | 0.5 | 0 | BAL | 0.75 | 0.7 | 7 | 0 | 0.44 | 3 | 0.36 | 0 | 5.93% | 15.30% | 1.09% | 300 |
| N1479 | 0.2 | 2.4 | 0.5 | 0 | BAL | 0.75 | 0.7 | 8 | 0 | 0.44 | 2 | 0.36 | 0 | 6.47% | 14.35% | 1.19% | 250 |
| N1480 | 0.2 | 2.4 | 0.5 | 0 | BAL | 0.75 | 0.7 | 8 | 0 | 0.44 | 3 | 0.36 | 0 | 5.38% | 16.49% | 0.98% | 250 |
| N1481 | 0.2 | 2.6 | 0.5 | 0 | BAL | 0.75 | 0.7 | 7 | 0 | 0.44 | 3 | 0.36 | 0 | 3.63% | 15.20% | 1.29% | 300 |
| N1482 | 0.2 | 2.6 | 0.5 | 0 | BAL | 0.75 | 0.7 | 8 | 0 | 0.44 | 2 | 0.36 | 0 | 3.64% | 14.25% | 1.39% | 300 |
| N1483 | 0.2 | 2.6 | 0.5 | 0 | BAL | 0.75 | 0.7 | 8 | 0 | 0.44 | 3 | 0.36 | 0 | 6.20% | 16.38% | 1.18% | 250 |
| N1484 | 0.2 | 2.8 | 0.5 | 0 | BAL | 0.75 | 0.7 | 7 | 0 | 0.44 | 3 | 0.36 | 0 | 3.61% | 15.10% | 1.49% | 300 |
| N1485 | 0.2 | 2.8 | 0.5 | 0 | BAL | 0.75 | 0.7 | 8 | 0 | 0.44 | 3 | 0.36 | 0 | 3.61% | 16.27% | 1.38% | 300 |
| N1486 | 0 | 2.5 | 0 | 0 | BAL | 1.16 | 0.74 | 12 | 0 | 0.76 | 0 | 0 | 0 | 3.99% | 13.71% | 1.31% | 500 |
| N1487 | 0 | 2.5 | 0 | 0 | BAL | 1.16 | 0.74 | 12 | 0 | 0.76 | 2 | 0 | 0 | 1.70% | 18.15% | 0.91% | 600 |
| N1488 | 0 | 2.5 | 0 | 0 | BAL | 1.16 | 0.74 | 14 | 0 | 0.76 | 0 | 0 | 0 | 2.87% | 16.12% | 1.09% | 550 |
| N1489 | 0 | 2.5 | 0 | 0 | BAL | 1.16 | 0.74 | 14 | 0 | 0.76 | 2 | 0 | 0 | 0.39% | 20.57% | 0.73% | 600 |
| N1490 | 0 | 2.5 | 0 | 0 | BAL | 1.16 | 0.74 | 16 | 0 | 0.76 | 0 | 0 | 0 | 1.74% | 18.56% | 0.94% | 600 |
| N1491 | 0 | 2.5 | 0 | 0 | BAL | 1.16 | 0.74 | 18 | 0 | 0.76 | 0 | 0 | 0 | 0.52% | 21.01% | 0.76% | 600 |
| N1492 | 0 | 3 | 0 | 0 | BAL | 1.16 | 0.74 | 12 | 0 | 0.76 | 2 | 0 | 0 | 3.84% | 17.84% | 1.35% | 550 |
| N1493 | 0 | 3 | 0 | 0 | BAL | 1.16 | 0.74 | 12 | 0 | 0.76 | 4 | 0 | 0 | 1.65% | 22.14% | 0.96% | 600 |
| N1494 | 0 | 3 | 0 | 0 | BAL | 1.16 | 0.74 | 14 | 0 | 0.76 | 2 | 0 | 0 | 2.74% | 20.24% | 1.12% | 550 |
| N1495 | 0 | 3 | 0 | 0 | BAL | 1.16 | 0.74 | 14 | 0 | 0.76 | 4 | 0 | 0 | 0.27% | 24.56% | 0.76% | 600 |
| N1496 | 0 | 3 | 0 | 0 | BAL | 1.16 | 0.74 | 16 | 0 | 0.76 | 0 | 0 | 0 | 3.92% | 18.24% | 1.36% | 500 |
| N1497 | 0 | 3 | 0 | 0 | BAL | 1.16 | 0.74 | 16 | 0 | 0.76 | 2 | 0 | 0 | 1.63% | 22.67% | 0.96% | 600 |
| N1498 | 0 | 3 | 0 | 0 | BAL | 1.16 | 0.74 | 18 | 0 | 0.76 | 0 | 0 | 0 | 2.81% | 20.68% | 1.13% | 500 |
| N1499 | 0 | 3 | 0 | 0 | BAL | 1.16 | 0.74 | 18 | 0 | 0.76 | 2 | 0 | 0 | 0.24% | 25.09% | 0.76% | 600 |
| N1500 | 0 | 3 | 0 | 0 | BAL | 1.16 | 0.74 | 20 | 0 | 0.76 | 0 | 0 | 0 | 1.68% | 23.15% | 0.95% | 600 |
| N1501 | 0 | 3.5 | 0 | 0 | BAL | 1.16 | 0.74 | 12 | 0 | 0.76 | 4 | 0 | 0 | 3.75% | 21.77% | 1.42% | 550 |
| N1502 | 0 | 3.5 | 0 | 0 | BAL | 1.16 | 0.74 | 12 | 0 | 0.76 | 6 | 0 | 0 | 1.61% | 25.97% | 1.03% | 600 |
| N1503 | 0 | 3.5 | 0 | 0 | BAL | 1.16 | 0.74 | 14 | 0 | 0.76 | 4 | 0 | 0 | 2.67% | 24.15% | 1.18% | 550 |
| N1504 | 0 | 3.5 | 0 | 0 | BAL | 1.16 | 0.74 | 14 | 0 | 0.76 | 6 | 0 | 0 | 0.22% | 28.37% | 0.81% | 600 |
| N1505 | 0 | 3.5 | 0 | 0 | BAL | 1.16 | 0.74 | 16 | 0 | 0.76 | 2 | 0 | 0 | 3.77% | 22.28% | 1.41% | 500 |
| N1506 | 0 | 3.5 | 0 | 0 | BAL | 1.16 | 0.74 | 16 | 0 | 0.76 | 4 | 0 | 0 | 1.57% | 26.57% | 1.00% | 600 |
| N1507 | 0 | 3.5 | 0 | 0 | BAL | 1.16 | 0.74 | 18 | 0 | 0.76 | 2 | 0 | 0 | 2.67% | 24.70% | 1.18% | 500 |
| N1508 | 0 | 3.5 | 0 | 0 | BAL | 1.16 | 0.74 | 18 | 0 | 0.76 | 4 | 0 | 0 | 0.06% | 28.99% | 0.79% | 600 |
| N1509 | 0 | 3.5 | 0 | 0 | BAL | 1.16 | 0.74 | 20 | 0 | 0.76 | 0 | 0 | 0 | 3.86% | 22.75% | 1.41% | 500 |
| N1510 | 0 | 3.5 | 0 | 0 | BAL | 1.16 | 0.74 | 20 | 0 | 0.76 | 2 | 0 | 0 | 1.56% | 27.16% | 0.97% | 600 |
| N1511 | 0 | 4 | 0 | 0 | BAL | 1.16 | 0.74 | 12 | 0 | 0.76 | 6 | 0 | 0 | 3.67% | 25.54% | 1.50% | 550 |
| N1512 | 0 | 4 | 0 | 0 | BAL | 1.16 | 0.74 | 12 | 0 | 0.76 | 8 | 0 | 0 | 1.57% | 29.65% | 1.04% | 600 |
| N1513 | 0 | 4 | 0 | 0 | BAL | 1.16 | 0.74 | 12 | 0 | 0.76 | 10 | 0 | 0 | 0.68% | 33.20% | 0.71% | 700 |
| N1514 | 0 | 4 | 0 | 0 | BAL | 1.16 | 0.74 | 14 | 0 | 0.76 | 6 | 0 | 0 | 2.61% | 27.91% | 1.25% | 550 |
| N1515 | 0 | 4 | 0 | 0 | BAL | 1.16 | 0.74 | 14 | 0 | 0.76 | 8 | 0 | 0 | 0.18% | 32.03% | 0.87% | 600 |
| N1516 | 0 | 4 | 0 | 0 | BAL | 1.16 | 0.74 | 16 | 0 | 0.76 | 4 | 0 | 0 | 3.67% | 26.12% | 1.48% | 500 |
| N1517 | 0 | 4 | 0 | 0 | BAL | 1.16 | 0.74 | 16 | 0 | 0.76 | 6 | 0 | 0 | 1.53% | 30.30% | 1.02% | 600 |
| N1518 | 0 | 4 | 0 | 0 | BAL | 1.16 | 0.74 | 18 | 0 | 0.76 | 4 | 0 | 0 | 2.59% | 28.53% | 1.24% | 550 |
| N1519 | 0 | 4 | 0 | 0 | BAL | 1.16 | 0.74 | 18 | 0 | 0.76 | 6 | 0 | 0 | 0.00% | 32.71% | 0.84% | 600 |
| N1520 | 0 | 4 | 0 | 0 | BAL | 1.16 | 0.74 | 20 | 0 | 0.76 | 2 | 0 | 0 | 3.70% | 26.70% | 1.47% | 500 |
| N1521 | 0 | 4 | 0 | 0 | BAL | 1.16 | 0.74 | 20 | 0 | 0.76 | 4 | 0 | 0 | 1.50% | 30.97% | 1.00% | 550 |
| N1522 | 0 | 4.5 | 0 | 0 | BAL | 1.16 | 0.74 | 12 | 0 | 0.76 | 10 | 0 | 0 | 1.53% | 33.19% | 1.12% | 600 |
| N1523 | 0 | 4.5 | 0 | 0 | BAL | 1.16 | 0.74 | 14 | 0 | 0.76 | 8 | 0 | 0 | 2.55% | 31.51% | 1.33% | 600 |
| N1524 | 0 | 4.5 | 0 | 0 | BAL | 1.16 | 0.74 | 14 | 0 | 0.76 | 10 | 0 | 0 | 0.15% | 35.55% | 0.94% | 650 |
| N1525 | 0 | 4.5 | 0 | 0 | BAL | 1.16 | 0.74 | 16 | 0 | 0.76 | 8 | 0 | 0 | 1.50% | 33.89% | 1.08% | 550 |
| N1526 | 0 | 4.5 | 0 | 0 | BAL | 1.16 | 0.74 | 16 | 0 | 0.76 | 10 | 0 | 0 | 0.00% | 37.34% | 0.72% | 700 |
| N1527 | 0 | 4.5 | 0 | 0 | BAL | 1.16 | 0.74 | 18 | 0 | 0.76 | 6 | 0 | 0 | 2.53% | 32.19% | 1.31% | 550 |
| N1528 | 0 | 4.5 | 0 | 0 | BAL | 1.16 | 0.74 | 18 | 0 | 0.76 | 8 | 0 | 0 | 0.00% | 36.28% | 0.90% | 600 |
| N1529 | 0 | 4.5 | 0 | 0 | BAL | 1.16 | 0.74 | 20 | 0 | 0.76 | 6 | 0 | 0 | 1.46% | 34.61% | 1.06% | 550 |
| N1530 | 0 | 5 | 0 | 0 | BAL | 1.16 | 0.74 | 14 | 0 | 0.76 | 10 | 0 | 0 | 2.50% | 34.99% | 1.42% | 600 |
| N1531 | 0 | 5 | 0 | 0 | BAL | 1.16 | 0.74 | 16 | 0 | 0.76 | 10 | 0 | 0 | 1.46% | 37.34% | 1.16% | 600 |
| N1532 | 0 | 5 | 0 | 0 | BAL | 1.16 | 0.74 | 18 | 0 | 0.76 | 8 | 0 | 0 | 4.17% | 35.71% | 1.39% | 550 |
| N1533 | 0 | 5 | 0 | 0 | BAL | 1.16 | 0.74 | 18 | 0 | 0.76 | 10 | 0 | 0 | 0.00% | 39.71% | 0.96% | 600 |
| N1534 | 0 | 5 | 0 | 0 | BAL | 1.16 | 0.74 | 20 | 0 | 0.76 | 8 | 0 | 0 | 1.42% | 38.11% | 1.13% | 550 |
| N1535 | 0 | 5 | 0 | 0 | BAL | 1.16 | 0.74 | 20 | 0 | 0.76 | 10 | 0 | 0 | 0.00% | 41.46% | 0.75% | 650 |
| N1536 | 1 | 3 | 0.5 | 0 | BAL | 0.75 | 0.7 | 8 | 0 | 0.44 | 8 | 0.36 | 0 | 8.02% | 2.92% | 0.84% | 670 |
| N1537 | 2 | 3 | 0.5 | 0 | BAL | 0.75 | 0.7 | 11 | 0 | 0.44 | 9 | 0.36 | 0 | 8.79% | 23.21% | 0.77% | 650 |
| N1538 | 2.5 | 3 | 0.5 | 0 | BAL | 0.75 | 0.7 | 8 | 0 | 0.44 | 12 | 0.36 | 0 | 5.61% | 22.46% | 0.77% | 700 |
| N1539 | 0 | 1 | 0 | 0 | BAL | 1.16 | 0.74 | 0 | 0 | 0.76 | 1 | 0 | 0 | 3.05% | 2.24% | 1.00% | 700 |
| N1540 | 0 | 1 | 0 | 0 | BAL | 1.16 | 0.74 | 0 | 0 | 0.76 | 2 | 0 | 0 | 1.93% | 4.47% | 0.92% | 700 |
| N1541 | 0 | 1 | 0 | 0 | BAL | 1.16 | 0.74 | 0 | 0 | 0.76 | 3 | 0 | 0 | 0.81% | 6.69% | 0.76% | 750 |
| N1542 | 0 | 1 | 0 | 0 | BAL | 1.16 | 0.74 | 1 | 0 | 0.76 | 1 | 0 | 0 | 2.48% | 3.40% | 0.90% | 600 |
| N1543 | 0 | 1 | 0 | 0 | BAL | 1.16 | 0.74 | 1 | 0 | 0.76 | 2 | 0 | 0 | 1.36% | 5.64% | 0.75% | 650 |
| N1544 | 0 | 1 | 0 | 0 | BAL | 1.16 | 0.74 | 2 | 0 | 0.76 | 0 | 0 | 0 | 3.06% | 2.32% | 1.00% | 600 |
| N1545 | 0 | 1 | 0 | 0 | BAL | 1.16 | 0.74 | 2 | 0 | 0.76 | 1 | 0 | 0 | 1.91% | 4.58% | 0.79% | 600 |
| N1546 | 0 | 1 | 0 | 0 | BAL | 1.16 | 0.74 | 3 | 0 | 0.76 | 0 | 0 | 0 | 2.49% | 3.49% | 0.94% | 600 |
| N1547 | 0 | 1 | 0 | 0 | BAL | 1.16 | 0.74 | 3 | 0 | 0.76 | 1 | 0 | 0 | 1.34% | 5.76% | 0.70% | 600 |
| N1548 | 0 | 1 | 0 | 0 | BAL | 1.16 | 0.74 | 4 | 0 | 0.76 | 0 | 0 | 0 | 1.92% | 4.67% | 0.85% | 600 |
| N1549 | 0 | 1 | 0 | 0 | BAL | 1.16 | 0.74 | 5 | 0 | 0.76 | 0 | 0 | 0 | 1.34% | 5.86% | 0.77% | 600 |
| N1550 | 0 | 1.5 | 0 | 0 | BAL | 1.16 | 0.74 | 0 | 0 | 0.76 | 1 | 0 | 0 | 5.19% | 2.20% | 1.48% | 650 |
| N1551 | 0 | 1.5 | 0 | 0 | BAL | 1.16 | 0.74 | 0 | 0 | 0.76 | 2 | 0 | 0 | 4.08% | 4.39% | 1.28% | 650 |
| N1552 | 0 | 1.5 | 0 | 0 | BAL | 1.16 | 0.74 | 0 | 0 | 0.76 | 3 | 0 | 0 | 2.98% | 6.58% | 1.10% | 700 |
| N1553 | 0 | 1.5 | 0 | 0 | BAL | 1.16 | 0.74 | 0 | 0 | 0.76 | 4 | 0 | 0 | 1.88% | 8.76% | 0.98% | 700 |
| N1554 | 0 | 1.5 | 0 | 0 | BAL | 1.16 | 0.74 | 0 | 0 | 0.76 | 5 | 0 | 0 | 0.79% | 10.93% | 0.81% | 750 |
| N1555 | 0 | 1.5 | 0 | 0 | BAL | 1.16 | 0.74 | 1 | 0 | 0.76 | 1 | 0 | 0 | 4.64% | 3.34% | 1.30% | 550 |
| N1556 | 0 | 1.5 | 0 | 0 | BAL | 1.16 | 0.74 | 1 | 0 | 0.76 | 2 | 0 | 0 | 3.53% | 5.54% | 1.12% | 600 |
| N1557 | 0 | 1.5 | 0 | 0 | BAL | 1.16 | 0.74 | 1 | 0 | 0.76 | 3 | 0 | 0 | 2.43% | 7.73% | 1.01% | 700 |
| N1558 | 0 | 1.5 | 0 | 0 | BAL | 1.16 | 0.74 | 1 | 0 | 0.76 | 4 | 0 | 0 | 1.32% | 9.92% | 0.84% | 700 |
| N1559 | 0 | 1.5 | 0 | 0 | BAL | 1.16 | 0.74 | 2 | 0 | 0.76 | 0 | 0 | 0 | 5.21% | 2.28% | 1.42% | 500 |
| N1560 | 0 | 1.5 | 0 | 0 | BAL | 1.16 | 0.74 | 2 | 0 | 0.76 | 1 | 0 | 0 | 4.09% | 4.50% | 1.19% | 550 |
| N1561 | 0 | 1.5 | 0 | 0 | BAL | 1.16 | 0.74 | 2 | 0 | 0.76 | 2 | 0 | 0 | 2.97% | 6.70% | 1.05% | 600 |
| N1562 | 0 | 1.5 | 0 | 0 | BAL | 1.16 | 0.74 | 2 | 0 | 0.76 | 3 | 0 | 0 | 1.87% | 8.90% | 0.88% | 650 |
| N1563 | 0 | 1.5 | 0 | 0 | BAL | 1.16 | 0.74 | 2 | 0 | 0.76 | 4 | 0 | 0 | 0.76% | 11.09% | 0.72% | 700 |
| N1564 | 0 | 1.5 | 0 | 0 | BAL | 1.16 | 0.74 | 3 | 0 | 0.76 | 0 | 0 | 0 | 4.67% | 3.43% | 1.32% | 500 |
| N1565 | 0 | 1.5 | 0 | 0 | BAL | 1.16 | 0.74 | 3 | 0 | 0.76 | 1 | 0 | 0 | 3.53% | 5.66% | 1.10% | 600 |
| N1566 | 0 | 1.5 | 0 | 0 | BAL | 1.16 | 0.74 | 3 | 0 | 0.76 | 2 | 0 | 0 | 2.41% | 7.87% | 0.94% | 600 |
| N1567 | 0 | 1.5 | 0 | 0 | BAL | 1.16 | 0.74 | 3 | 0 | 0.76 | 3 | 0 | 0 | 1.30% | 10.08% | 0.77% | 650 |
| N1568 | 0 | 1.5 | 0 | 0 | BAL | 1.16 | 0.74 | 4 | 0 | 0.76 | 0 | 0 | 0 | 4.11% | 4.59% | 1.21% | 550 |
| N1569 | 0 | 1.5 | 0 | 0 | BAL | 1.16 | 0.74 | 4 | 0 | 0.76 | 1 | 0 | 0 | 2.97% | 6.83% | 1.02% | 600 |
| N1570 | 0 | 1.5 | 0 | 0 | BAL | 1.16 | 0.74 | 4 | 0 | 0.76 | 2 | 0 | 0 | 1.85% | 9.05% | 0.83% | 600 |
| N1571 | 0 | 1.5 | 0 | 0 | BAL | 1.16 | 0.74 | 5 | 0 | 0.76 | 0 | 0 | 0 | 3.56% | 5.76% | 1.11% | 550 |
| N1572 | 0 | 1.5 | 0 | 0 | BAL | 1.16 | 0.74 | 5 | 0 | 0.76 | 1 | 0 | 0 | 2.40% | 8.01% | 0.93% | 600 |
| N1573 | 0 | 1.5 | 0 | 0 | BAL | 1.16 | 0.74 | 5 | 0 | 0.76 | 2 | 0 | 0 | 1.28% | 10.24% | 0.74% | 600 |
| N1574 | 0 | 2.5 | 0 | 0 | BAL | 1.16 | 0.74 | 1 | 0 | 0.76 | 5 | 0 | 0 | 4.44% | 11.70% | 1.50% | 650 |
| N1575 | 0 | 2.5 | 0 | 0 | BAL | 1.16 | 0.74 | 2 | 0 | 0.76 | 5 | 0 | 0 | 3.91% | 12.83% | 1.37% | 650 |
| N1576 | 0 | 2.5 | 0 | 0 | BAL | 1.16 | 0.74 | 3 | 0 | 0.76 | 4 | 0 | 0 | 4.45% | 11.86% | 1.45% | 600 |
| N1577 | 0 | 2.5 | 0 | 0 | BAL | 1.16 | 0.74 | 3 | 0 | 0.76 | 5 | 0 | 0 | 3.38% | 13.98% | 1.25% | 650 |
| N1578 | 0 | 2.5 | 0 | 0 | BAL | 1.16 | 0.74 | 5 | 0 | 0.76 | 3 | 0 | 0 | 4.46% | 12.04% | 1.42% | 550 |
| N1579 | 0 | 2.5 | 0 | 0 | BAL | 1.16 | 0.74 | 5 | 0 | 0.76 | 5 | 0 | 0 | 2.29% | 16.30% | 1.06% | 650 |
| N1580 | 0.5 | 1 | 0 | 0 | BAL | 1.16 | 0.74 | 0 | 0 | 0.76 | 2 | 0 | 0 | 9.25% | 4.38% | 1.00% | 550 |
| N1581 | 0.5 | 1 | 0 | 0 | BAL | 1.16 | 0.74 | 0 | 0 | 0.76 | 3 | 0 | 0 | 5.19% | 6.56% | 1.00% | 650 |
| N1582 | 0.5 | 1 | 0 | 0 | BAL | 1.16 | 0.74 | 0 | 0 | 0.76 | 4 | 0 | 0 | 4.11% | 8.70% | 1.00% | 700 |
| N1583 | 0.5 | 1 | 0 | 0 | BAL | 1.16 | 0.74 | 0 | 0 | 0.76 | 5 | 0 | 0 | 1.75% | 8.91% | 1.00% | 750 |
| N1584 | 0.5 | 1 | 0 | 0 | BAL | 1.16 | 0.74 | 1 | 0 | 0.76 | 1 | 0 | 0 | 9.84% | 3.34% | 0.89% | 350 |
| N1585 | 0.5 | 1 | 0 | 0 | BAL | 1.16 | 0.74 | 1 | 0 | 0.76 | 2 | 0 | 0 | 8.72% | 5.53% | 0.77% | 500 |
| N1586 | 0.5 | 1 | 0 | 0 | BAL | 1.16 | 0.74 | 1 | 0 | 0.76 | 5 | 0 | 0 | 1.01% | 9.30% | 1.00% | 950 |
| N1587 | 0.5 | 1 | 0 | 0 | BAL | 1.16 | 0.74 | 2 | 0 | 0.76 | 1 | 0 | 0 | 9.30% | 4.49% | 0.76% | 300 |
| N1588 | 0.5 | 1 | 0 | 0 | BAL | 1.16 | 0.74 | 3 | 0 | 0.76 | 0 | 0 | 0 | 9.91% | 3.42% | 0.87% | 200 |
| N1589 | 0.5 | 1 | 0 | 0 | BAL | 1.16 | 0.74 | 4 | 0 | 0.76 | 0 | 0 | 0 | 9.38% | 4.58% | 0.77% | 200 |
| N1590 | 0.5 | 1.5 | 0 | 0 | BAL | 1.16 | 0.74 | 0 | 0 | 0.76 | 4 | 0 | 0 | 9.06% | 8.59% | 1.02% | 650 |
| N1591 | 0.5 | 1.5 | 0 | 0 | BAL | 1.16 | 0.74 | 0 | 0 | 0.76 | 5 | 0 | 0 | 5.08% | 10.72% | 0.85% | 650 |
| N1592 | 0.5 | 1.5 | 0 | 0 | BAL | 1.16 | 0.74 | 1 | 0 | 0.76 | 3 | 0 | 0 | 9.63% | 7.58% | 1.04% | 550 |
| N1593 | 0.5 | 1.5 | 0 | 0 | BAL | 1.16 | 0.74 | 1 | 0 | 0.76 | 4 | 0 | 0 | 5.63% | 9.73% | 0.88% | 600 |
| N1594 | 0.5 | 1.5 | 0 | 0 | BAL | 1.16 | 0.74 | 1 | 0 | 0.76 | 5 | 0 | 0 | 4.55% | 11.86% | 0.72% | 650 |
| N1595 | 0.5 | 1.5 | 0 | 0 | BAL | 1.16 | 0.74 | 2 | 0 | 0.76 | 3 | 0 | 0 | 9.11% | 8.73% | 0.90% | 500 |
| N1596 | 0.5 | 1.5 | 0 | 0 | BAL | 1.16 | 0.74 | 2 | 0 | 0.76 | 4 | 0 | 0 | 5.10% | 10.88% | 0.75% | 600 |
| N1597 | 0.5 | 1.5 | 0 | 0 | BAL | 1.16 | 0.74 | 3 | 0 | 0.76 | 2 | 0 | 0 | 9.69% | 7.72% | 0.93% | 400 |
| N1598 | 0.5 | 1.5 | 0 | 0 | BAL | 1.16 | 0.74 | 3 | 0 | 0.76 | 3 | 0 | 0 | 8.58% | 9.88% | 0.78% | 550 |
| N1599 | 0.5 | 1.5 | 0 | 0 | BAL | 1.16 | 0.74 | 4 | 0 | 0.76 | 2 | 0 | 0 | 9.16% | 8.87% | 0.82% | 350 |
| N1600 | 0.5 | 1.5 | 0 | 0 | BAL | 1.16 | 0.74 | 5 | 0 | 0.76 | 1 | 0 | 0 | 9.74% | 7.86% | 0.88% | 200 |
| N1601 | 0.5 | 1.5 | 0 | 0 | BAL | 1.16 | 0.74 | 5 | 0 | 0.76 | 2 | 0 | 0 | 8.63% | 10.04% | 0.71% | 350 |
| N1602 | 0.5 | 2 | 0 | 0 | BAL | 1.16 | 0.74 | 0 | 0 | 0.76 | 5 | 0 | 0 | 9.95% | 10.54% | 1.27% | 650 |
| N1603 | 0.5 | 2 | 0 | 0 | BAL | 1.16 | 0.74 | 1 | 0 | 0.76 | 5 | 0 | 0 | 9.44% | 11.67% | 1.14% | 650 |
| N1604 | 0.5 | 2 | 0 | 0 | BAL | 1.16 | 0.74 | 2 | 0 | 0.76 | 5 | 0 | 0 | 8.92% | 12.80% | 1.01% | 600 |
| N1605 | 0.5 | 2 | 0 | 0 | BAL | 1.16 | 0.74 | 3 | 0 | 0.76 | 4 | 0 | 0 | 9.49% | 11.84% | 1.05% | 550 |
| N1606 | 0.5 | 2 | 0 | 0 | BAL | 1.16 | 0.74 | 3 | 0 | 0.76 | 5 | 0 | 0 | 8.41% | 13.95% | 0.88% | 600 |
| N1607 | 0.5 | 2 | 0 | 0 | BAL | 1.16 | 0.74 | 4 | 0 | 0.76 | 4 | 0 | 0 | 8.97% | 12.98% | 0.93% | 500 |
| N1608 | 0.5 | 2 | 0 | 0 | BAL | 1.16 | 0.74 | 4 | 0 | 0.76 | 5 | 0 | 0 | 5.00% | 15.10% | 0.77% | 600 |
| N1609 | 0.5 | 2 | 0 | 0 | BAL | 1.16 | 0.74 | 5 | 0 | 0.76 | 3 | 0 | 0 | 9.54% | 12.01% | 0.97% | 400 |
| N1610 | 0.5 | 2 | 0 | 0 | BAL | 1.16 | 0.74 | 5 | 0 | 0.76 | 4 | 0 | 0 | 8.45% | 14.14% | 0.82% | 550 |
| N1611 | 0.5 | 2.5 | 0 | 0 | BAL | 1.16 | 0.74 | 4 | 0 | 0.76 | 5 | 0 | 0 | 9.85% | 14.85% | 1.21% | 550 |
| N1612 | 0.5 | 2.5 | 0 | 0 | BAL | 1.16 | 0.74 | 5 | 0 | 0.76 | 5 | 0 | 0 | 9.34% | 15.99% | 1.09% | 550 |
| N1613 | 1 | 1 | 0 | 0 | BAL | 1.16 | 0.74 | 0 | 0 | 0.76 | 4 | 0 | 0 | 4.03% | 8.54% | 1.01% | 750 |
| N1614 | 1 | 1 | 0 | 0 | BAL | 1.16 | 0.74 | 0 | 0 | 0.76 | 5 | 0 | 0 | 4.02% | 8.52% | 1.01% | 750 |
| N1615 | 1 | 1 | 0 | 0 | BAL | 1.16 | 0.74 | 1 | 0 | 0.76 | 4 | 0 | 0 | 4.05% | 8.57% | 1.01% | 700 |
| N1616 | 1 | 1 | 0 | 0 | BAL | 1.16 | 0.74 | 1 | 0 | 0.76 | 5 | 0 | 0 | 4.04% | 8.55% | 1.01% | 750 |
| N1617 | 1 | 1.5 | 0 | 0 | BAL | 1.16 | 0.74 | 1 | 0 | 0.76 | 5 | 0 | 0 | 4.46% | 11.64% | 0.91% | 700 |
| N1618 | 1 | 1.5 | 0 | 0 | BAL | 1.16 | 0.74 | 2 | 0 | 0.76 | 5 | 0 | 0 | 3.99% | 12.67% | 0.78% | 700 |
| N1619 | 1.5 | 1 | 0 | 0 | BAL | 1.16 | 0.74 | 0 | 0 | 0.76 | 5 | 0 | 0 | 3.95% | 8.36% | 1.03% | 750 |
| N1620 | 1.5 | 1 | 0 | 0 | BAL | 1.16 | 0.74 | 1 | 0 | 0.76 | 5 | 0 | 0 | 3.96% | 8.39% | 1.03% | 700 |
| N1621 | 0 | 2.5 | 0 | 0 | BAL | 1.16 | 0.74 | 4 | 0 | 0.76 | 4 | 2 | 0 | 8.09% | 12.99% | 1.30% | 650 |
| N1622 | 0 | 2.5 | 0 | 0 | BAL | 1.16 | 0.74 | 4 | 0 | 0.76 | 5 | 0 | 0 | 2.84% | 15.14% | 1.12% | 600 |
| N1623 | 0 | 2.5 | 0 | 0 | BAL | 1.16 | 0.74 | 4 | 0 | 0.76 | 5 | 2 | 0 | 6.96% | 15.12% | 1.09% | 650 |
| N1624 | 0 | 2.5 | 0 | 0 | BAL | 1.16 | 0.74 | 4 | 0 | 0.76 | 5 | 6 | 0 | 9.93% | 14.63% | 1.06% | 750 |
| N1625 | 0 | 2.5 | 0 | 0 | BAL | 1.16 | 0.74 | 4 | 0 | 0.76 | 6 | 2 | 0 | 5.84% | 17.10% | 0.90% | 750 |
| N1626 | 0 | 2.5 | 0 | 0 | BAL | 1.16 | 0.74 | 4 | 0 | 0.76 | 6 | 4 | 0 | 1.97% | 16.73% | 0.89% | 800 |
| N1627 | 0 | 2.5 | 0 | 0 | BAL | 1.16 | 0.74 | 4 | 0 | 0.76 | 6 | 6 | 0 | 0.47% | 16.43% | 0.88% | 750 |
| N1628 | 0 | 2.5 | 0 | 0 | BAL | 1.16 | 0.74 | 4 | 0 | 0.76 | 7 | 0 | 0 | 0.69% | 19.37% | 0.81% | 700 |
| N1629 | 0 | 2.5 | 0 | 0 | BAL | 1.16 | 0.74 | 4 | 0 | 0.76 | 7 | 2 | 0 | 4.06% | 18.82% | 0.81% | 800 |
| N1630 | 0 | 2.5 | 0 | 0 | BAL | 1.16 | 0.74 | 4 | 0 | 0.76 | 7 | 4 | 0 | 0.44% | 18.49% | 0.77% | 800 |
| N1631 | 0 | 2.5 | 0 | 0 | BAL | 1.16 | 0.74 | 4 | 0 | 0.76 | 7 | 6 | 0 | 0.74% | 18.33% | 0.72% | 750 |
| N1632 | 0 | 2.5 | 0 | 0 | BAL | 1.16 | 0.74 | 6 | 0 | 0.76 | 2 | 2 | 0 | 9.23% | 11.03% | 1.50% | 550 |
| N1633 | 0 | 2.5 | 0 | 0 | BAL | 1.16 | 0.74 | 6 | 0 | 0.76 | 3 | 2 | 0 | 8.13% | 13.17% | 1.28% | 600 |
| N1634 | 0 | 2.5 | 0 | 0 | BAL | 1.16 | 0.74 | 6 | 0 | 0.76 | 3 | 6 | 0 | 8.99% | 12.72% | 1.27% | 800 |
| N1635 | 0 | 2.5 | 0 | 0 | BAL | 1.16 | 0.74 | 6 | 0 | 0.76 | 4 | 2 | 0 | 6.96% | 15.31% | 1.08% | 650 |
| N1636 | 0 | 2.5 | 0 | 0 | BAL | 1.16 | 0.74 | 6 | 0 | 0.76 | 4 | 4 | 0 | 7.49% | 14.93% | 1.07% | 800 |
| N1637 | 0 | 2.5 | 0 | 0 | BAL | 1.16 | 0.74 | 6 | 0 | 0.76 | 5 | 0 | 0 | 1.74% | 17.48% | 0.95% | 650 |
| N1638 | 0.2 | 3 | 0.5 | 0 | BAL | 0 | 0 | 5 | 0 | 0.44 | 8 | 0 | 0 | 4.02% | 22.53% | 0.91% | 705 |
| N1639 | 0.2 | 3 | 0.5 | 0 | BAL | 0 | 0 | 5 | 0 | 0.44 | 8 | 4 | 0 | 7.25% | 20.83% | 0.85% | 1040 |
| N1640 | 0.2 | 3 | 0.5 | 0 | BAL | 0 | 0 | 5 | 0 | 0.44 | 8 | 6 | 0 | 8.88% | 20.46% | 0.84% | 1085 |
| N1641 | 0.2 | 3 | 0.5 | 0 | BAL | 0 | 0 | 5 | 0 | 0.44 | 8 | 8 | 0 | 0.85% | 20.28% | 0.83% | 930 |
| N1642 | 0.2 | 3 | 0.5 | 0 | BAL | 0 | 0 | 5 | 0 | 0.44 | 8 | 10 | 0 | 0.18% | 19.79% | 0.82% | 820 |
| N1643 | 0.2 | 3 | 0.5 | 0 | BAL | 0 | 2 | 5 | 0 | 0.44 | 8 | 0 | 0 | 3.42% | 23.25% | 0.89% | 295 |
| N1644 | 0.2 | 3 | 0.5 | 0 | BAL | 0 | 2 | 5 | 0 | 0.44 | 8 | 4 | 0 | 3.06% | 21.56% | 0.83% | 335 |
| N1645 | 0.2 | 3 | 0.5 | 0 | BAL | 0 | 2 | 5 | 0 | 0.44 | 8 | 6 | 0 | 9.81% | 21.15% | 0.82% | 380 |
| N1646 | 0.2 | 3 | 0.5 | 0 | BAL | 0 | 4 | 5 | 0 | 0.44 | 8 | 0 | 0 | 4.66% | 23.42% | 0.87% | 165 |
| N1647 | 0.2 | 3 | 0.5 | 0 | BAL | 0 | 4 | 5 | 0 | 0.44 | 8 | 2 | 0 | 8.56% | 21.92% | 0.83% | 165 |
| N1648 | 0.2 | 3 | 0.5 | 0 | BAL | 0 | 4 | 5 | 0 | 0.44 | 8 | 6 | 0 | 6.15% | 21.31% | 0.79% | 270 |
| N1649 | 0.2 | 3 | 0.5 | 0 | BAL | 0 | 4 | 5 | 0 | 0.44 | 8 | 10 | 0 | 6.22% | 20.52% | 0.78% | 310 |
| N1650 | 0.2 | 3 | 0.5 | 0 | BAL | 0 | 6 | 5 | 0 | 0.44 | 8 | 0 | 0 | 6.59% | 23.60% | 0.85% | 110 |
| N1651 | 0.2 | 3 | 0.5 | 0 | BAL | 0 | 6 | 5 | 0 | 0.44 | 8 | 4 | 0 | 8.95% | 21.70% | 0.79% | 110 |
| N1652 | 0.2 | 3 | 0.5 | 0 | BAL | 0 | 6 | 5 | 0 | 0.44 | 8 | 6 | 0 | 9.84% | 21.46% | 0.78% | 140 |
| N1653 | 0.2 | 3 | 0.5 | 0 | BAL | 0 | 6 | 5 | 0 | 0.44 | 8 | 10 | 0 | 9.95% | 20.54% | 0.76% | 200 |
| N1654 | 0.2 | 3 | 0.5 | 0 | BAL | 0 | 8 | 5 | 0 | 0.44 | 8 | 0 | 0 | 8.53% | 23.79% | 0.83% | 90 |
| N1655 | 0.2 | 3 | 0.5 | 0 | BAL | 2 | 0 | 5 | 0 | 0.44 | 8 | 0 | 0 | 4.72% | 22.83% | 0.90% | 545 |
| N1656 | 0.2 | 3 | 0.5 | 0 | BAL | 2 | 0 | 5 | 0 | 0.44 | 8 | 4 | 0 | 6.42% | 20.50% | 0.83% | 880 |
| N1657 | 0.2 | 3 | 0.5 | 0 | BAL | 2 | 0 | 5 | 0 | 0.44 | 8 | 6 | 0 | 0.00% | 20.21% | 0.81% | 1075 |
| N1658 | 0.2 | 3 | 0.5 | 0 | BAL | 2 | 0 | 5 | 0 | 0.44 | 8 | 8 | 0 | 0.00% | 20.01% | 0.80% | 915 |
| N1659 | 0.2 | 3 | 0.5 | 0 | BAL | 2 | 0 | 5 | 0 | 0.44 | 8 | 10 | 0 | 0.16% | 19.79% | 0.79% | 810 |
| N1660 | 0.2 | 3 | 0.5 | 0 | BAL | 2 | 2 | 5 | 0 | 0.44 | 8 | 0 | 0 | 5.25% | 23.24% | 0.88% | 285 |
| N1661 | 0.2 | 3 | 0.5 | 0 | BAL | 2 | 2 | 5 | 0 | 0.44 | 8 | 2 | 0 | 8.38% | 21.96% | 0.83% | 280 |
| N1662 | 0.2 | 3 | 0.5 | 0 | BAL | 2 | 2 | 5 | 0 | 0.44 | 8 | 4 | 0 | 4.38% | 21.57% | 0.80% | 320 |
| N1663 | 0.2 | 3 | 0.5 | 0 | BAL | 2 | 2 | 5 | 0 | 0.44 | 8 | 6 | 0 | 9.81% | 21.15% | 0.79% | 365 |
| N1664 | 0.2 | 3 | 0.5 | 0 | BAL | 2 | 4 | 5 | 0 | 0.44 | 8 | 0 | 0 | 7.25% | 23.13% | 0.86% | 155 |
| N1665 | 0.2 | 3 | 0.5 | 0 | BAL | 2 | 4 | 5 | 0 | 0.44 | 8 | 4 | 0 | 6.71% | 21.61% | 0.79% | 215 |
| N1666 | 0.2 | 3 | 0.5 | 0 | BAL | 2 | 6 | 5 | 0 | 0.44 | 8 | 0 | 0 | 9.33% | 22.94% | 0.83% | 105 |
| N1667 | 0.2 | 3 | 0.5 | 0 | BAL | 2 | 6 | 5 | 0 | 0.44 | 8 | 2 | 0 | 9.89% | 22.03% | 0.79% | 95 |
| N1668 | 0.2 | 3 | 0.5 | 0 | BAL | 4 | 0 | 5 | 0 | 0.44 | 8 | 0 | 0 | 6.71% | 22.62% | 0.89% | 385 |
| N1669 | 0.2 | 3 | 0.5 | 0 | BAL | 4 | 0 | 5 | 0 | 0.44 | 8 | 2 | 0 | 6.90% | 21.75% | 0.84% | 525 |
| N1670 | 0.2 | 3 | 0.5 | 0 | BAL | 4 | 0 | 5 | 0 | 0.44 | 8 | 4 | 0 | 0.00% | 24.17% | 0.80% | 815 |
| N1671 | 0.2 | 3 | 0.5 | 0 | BAL | 4 | 0 | 5 | 0 | 0.44 | 8 | 10 | 0 | 0.02% | 19.88% | 0.77% | 750 |
| N1672 | 0.2 | 3 | 0.5 | 0 | BAL | 4 | 2 | 5 | 0 | 0.44 | 8 | 0 | 0 | 7.78% | 22.58% | 0.86% | 275 |
| N1673 | 0.2 | 3 | 0.5 | 0 | BAL | 4 | 2 | 5 | 0 | 0.44 | 8 | 2 | 0 | 7.18% | 21.82% | 0.82% | 270 |
| N1674 | 0.2 | 3 | 0.5 | 0 | BAL | 4 | 2 | 5 | 0 | 0.44 | 8 | 4 | 0 | 8.45% | 21.57% | 0.78% | 310 |
| N1675 | 0.2 | 3 | 0.5 | 0 | BAL | 4 | 2 | 5 | 0 | 0.44 | 8 | 6 | 0 | 4.46% | 21.16% | 0.77% | 355 |
| N1676 | 0.2 | 3 | 0.5 | 0 | BAL | 4 | 2 | 5 | 0 | 0.44 | 8 | 8 | 0 | 5.01% | 21.01% | 0.75% | 400 |
| N1677 | 0.2 | 3 | 0.5 | 0 | BAL | 4 | 2 | 5 | 0 | 0.44 | 8 | 10 | 0 | 6.00% | 20.46% | 0.74% | 390 |
| N1678 | 0.2 | 3 | 0.5 | 0 | BAL | 4 | 4 | 5 | 0 | 0.44 | 8 | 0 | 0 | 9.59% | 22.66% | 0.84% | 145 |
| N1679 | 0.2 | 3 | 0.5 | 0 | BAL | 4 | 4 | 5 | 0 | 0.44 | 8 | 2 | 0 | 7.02% | 21.96% | 0.79% | 145 |
| N1680 | 0.2 | 3 | 0.5 | 0 | BAL | 4 | 4 | 5 | 0 | 0.44 | 8 | 4 | 0 | 4.63% | 21.60% | 0.76% | 205 |
| N1681 | 0.2 | 3 | 0.5 | 0 | BAL | 4 | 4 | 5 | 0 | 0.44 | 8 | 6 | 0 | 8.11% | 21.31% | 0.74% | 245 |
| N1682 | 0.2 | 3 | 0.5 | 0 | BAL | 4 | 4 | 5 | 0 | 0.44 | 8 | 8 | 0 | 8.73% | 21.15% | 0.73% | 240 |
| N1683 | 0.2 | 3 | 0.5 | 0 | BAL | 4 | 4 | 5 | 0 | 0.44 | 8 | 10 | 0 | 9.92% | 20.49% | 0.72% | 285 |
| N1684 | 0.2 | 3 | 0.5 | 0 | BAL | 4 | 6 | 5 | 0 | 0.44 | 8 | 2 | 0 | 9.27% | 22.02% | 0.77% | 85 |
| N1685 | 0.2 | 3 | 0.5 | 0 | BAL | 4 | 6 | 5 | 0 | 0.44 | 8 | 4 | 0 | 8.28% | 21.74% | 0.74% | 85 |
| N1686 | 0.2 | 3 | 0.5 | 0 | BAL | 6 | 0 | 5 | 0 | 0.44 | 8 | 0 | 0 | 8.85% | 22.18% | 0.87% | 225 |
| N1687 | 0.2 | 3 | 0.5 | 0 | BAL | 6 | 0 | 5 | 0 | 0.44 | 8 | 2 | 0 | 7.52% | 21.65% | 0.82% | 315 |
| N1688 | 0.2 | 3 | 0.5 | 0 | BAL | 6 | 0 | 5 | 0 | 0.44 | 8 | 4 | 0 | 2.75% | 24.16% | 0.78% | 805 |
| N1689 | 0.2 | 3 | 0.5 | 0 | BAL | 6 | 0 | 5 | 0 | 0.44 | 8 | 10 | 0 | 0.00% | 19.90% | 0.74% | 740 |
| N1690 | 0.2 | 3 | 0.5 | 0 | BAL | 6 | 2 | 5 | 0 | 0.44 | 8 | 2 | 0 | 7.18% | 21.82% | 0.80% | 260 |
| N1691 | 0.2 | 3 | 0.5 | 0 | BAL | 6 | 2 | 5 | 0 | 0.44 | 8 | 4 | 0 | 8.45% | 21.56% | 0.76% | 300 |
| N1692 | 0.2 | 3 | 0.5 | 0 | BAL | 6 | 2 | 5 | 0 | 0.44 | 8 | 6 | 0 | 6.79% | 21.18% | 0.74% | 345 |
| N1693 | 0.2 | 3 | 0.5 | 0 | BAL | 6 | 2 | 5 | 0 | 0.44 | 8 | 8 | 0 | 7.52% | 21.01% | 0.72% | 385 |
| N1694 | 0.2 | 3 | 0.5 | 0 | BAL | 6 | 2 | 5 | 0 | 0.44 | 8 | 10 | 0 | 8.45% | 20.55% | 0.72% | 380 |
| N1695 | 0.2 | 3 | 0.5 | 0 | BAL | 6 | 4 | 5 | 0 | 0.44 | 8 | 2 | 0 | 7.03% | 21.95% | 0.78% | 140 |
| N1696 | 0.2 | 3 | 0.5 | 0 | BAL | 6 | 4 | 5 | 0 | 0.44 | 8 | 4 | 0 | 4.63% | 21.59% | 0.74% | 190 |
| N1697 | 0.2 | 3 | 0.5 | 0 | BAL | 6 | 6 | 5 | 0 | 0.44 | 8 | 2 | 0 | 9.27% | 22.01% | 0.76% | 80 |
| N1698 | 0.2 | 3 | 0.5 | 0 | BAL | 6 | 6 | 5 | 0 | 0.44 | 8 | 4 | 0 | 8.30% | 21.73% | 0.72% | 75 |
| N1699 | 0.2 | 3 | 0.5 | 0 | BAL | 8 | 0 | 5 | 0 | 0.44 | 8 | 2 | 0 | 3.90% | 25.27% | 0.81% | 145 |
| N1700 | 0.2 | 3 | 0.5 | 0 | BAL | 8 | 0 | 5 | 0 | 0.44 | 8 | 4 | 0 | 0.00% | 24.15% | 0.76% | 845 |
| N1701 | 0.2 | 3 | 0.5 | 0 | BAL | 8 | 0 | 5 | 0 | 0.44 | 8 | 6 | 0 | 0.00% | 20.28% | 0.74% | 990 |
| N1702 | 0.2 | 3 | 0.5 | 0 | BAL | 8 | 0 | 5 | 0 | 0.44 | 8 | 8 | 0 | 0.00% | 20.04% | 0.73% | 785 |
| N1703 | 0.2 | 3 | 0.5 | 0 | BAL | 8 | 0 | 5 | 0 | 0.44 | 8 | 10 | 0 | 0.00% | 19.90% | 0.71% | 730 |
| N1704 | 0.2 | 3 | 0.5 | 0 | BAL | 8 | 2 | 5 | 0 | 0.44 | 8 | 2 | 0 | 7.18% | 21.81% | 0.79% | 200 |
| N1705 | 0.2 | 3 | 0.5 | 0 | BAL | 8 | 2 | 5 | 0 | 0.44 | 8 | 4 | 0 | 8.44% | 21.55% | 0.74% | 285 |
| N1706 | 0.2 | 3 | 0.5 | 0 | BAL | 8 | 2 | 5 | 0 | 0.44 | 8 | 6 | 0 | 9.01% | 21.21% | 0.72% | 330 |
| N1707 | 0.2 | 3 | 0.5 | 0 | BAL | 8 | 4 | 5 | 0 | 0.44 | 8 | 2 | 0 | 7.03% | 21.95% | 0.76% | 130 |
| N1708 | 0.2 | 3 | 0.5 | 0 | BAL | 8 | 4 | 5 | 0 | 0.44 | 8 | 4 | 0 | 7.22% | 21.59% | 0.72% | 180 |
| N1709 | 0.2 | 3 | 0.5 | 0 | BAL | 8 | 6 | 5 | 0 | 0.44 | 8 | 2 | 0 | 9.28% | 22.01% | 0.74% | 75 |
| N1710 | 0.2 | 3 | 0.5 | 0 | BAL | 10 | 0 | 5 | 0 | 0.44 | 8 | 2 | 0 | 3.90% | 25.26% | 0.80% | 65 |
| N1711 | 0.2 | 3 | 0.5 | 0 | BAL | 10 | 0 | 5 | 0 | 0.44 | 8 | 4 | 0 | 0.00% | 24.14% | 0.75% | 840 |
| N1712 | 0.2 | 3 | 0.5 | 0 | BAL | 10 | 0 | 5 | 0 | 0.44 | 8 | 6 | 0 | 0.00% | 20.28% | 0.72% | 930 |
| N1713 | 0.2 | 3 | 0.5 | 0 | BAL | 10 | 0 | 5 | 0 | 0.44 | 8 | 8 | 0 | 0.00% | 20.06% | 0.70% | 725 |
| N1714 | 0.2 | 3 | 0.5 | 0 | BAL | 10 | 2 | 5 | 0 | 0.44 | 8 | 2 | 0 | 7.18% | 21.80% | 0.77% | 65 |
| N1715 | 0.2 | 3 | 0.5 | 0 | BAL | 10 | 2 | 5 | 0 | 0.44 | 8 | 4 | 0 | 4.89% | 21.55% | 0.72% | 280 |
| N1716 | 0.2 | 3 | 0.5 | 0 | BAL | 10 | 4 | 5 | 0 | 0.44 | 8 | 0 | 0 | 9.85% | 21.97% | 0.80% | 70 |
| N1717 | 0.2 | 3 | 0.5 | 0 | BAL | 10 | 4 | 5 | 0 | 0.44 | 8 | 2 | 0 | 7.04% | 21.94% | 0.75% | 75 |
| N1718 | 0.2 | 3 | 0.5 | 0 | BAL | 10 | 4 | 5 | 0 | 0.44 | 8 | 4 | 0 | 7.23% | 21.58% | 0.70% | 165 |
| N1719 | 0.2 | 3 | 0.5 | 0 | BAL | 10 | 6 | 5 | 0 | 0.44 | 8 | 2 | 0 | 9.29% | 22.00% | 0.73% | 70 |
| N1720 | 0.2 | 3 | 0.5 | 0 | BAL | 0 | 0 | 5 | 0 | 0.44 | 8 | 2 | 0 | 1.17% | 25.40% | 0.88% | 795 |
| N1721 | 0.2 | 3 | 0 | 0 | BAL | 0.75 | 0 | 5 | 0 | 0.44 | 8 | 2 | 0 | 5.45% | 21.53% | 0.87% | 695 |
| N1722 | 0.2 | 3 | 0 | 0 | BAL | 0.75 | 0 | 5 | 0 | 0.44 | 8 | 4 | 0 | 6.42% | 20.51% | 0.84% | 1235 |
| N1723 | 0.2 | 3 | 0 | 0 | BAL | 0.75 | 0 | 5 | 0 | 0.44 | 8 | 6 | 0 | 8.28% | 20.22% | 0.83% | 1080 |
| N1724 | 0.2 | 3 | 0 | 0 | BAL | 0.75 | 0 | 5 | 0 | 0.44 | 8 | 8 | 0 | 8.73% | 20.03% | 0.82% | 925 |
| N1725 | 0.2 | 3 | 0 | 0 | BAL | 0.75 | 0 | 5 | 0 | 0.44 | 8 | 10 | 0 | 9.10% | 19.82% | 0.81% | 820 |
| N1726 | 0.2 | 3 | 0 | 0 | BAL | 0.75 | 2 | 5 | 0 | 0.44 | 8 | 0 | 0 | 2.46% | 22.28% | 0.89% | 295 |
| N1727 | 0.2 | 3 | 0 | 0 | BAL | 0.75 | 2 | 5 | 0 | 0.44 | 8 | 4 | 0 | 8.45% | 21.58% | 0.82% | 330 |
| N1728 | 0.2 | 3 | 0 | 0 | BAL | 0.75 | 2 | 5 | 0 | 0.44 | 8 | 6 | 0 | 9.81% | 21.16% | 0.81% | 375 |
| N1729 | 0.2 | 3 | 0 | 0 | BAL | 0.75 | 4 | 5 | 0 | 0.44 | 8 | 0 | 0 | 5.69% | 22.45% | 0.87% | 185 |
| N1730 | 0.2 | 3 | 0 | 0 | BAL | 0.75 | 4 | 5 | 0 | 0.44 | 8 | 2 | 0 | 8.07% | 21.98% | 0.83% | 180 |
| N1731 | 0.2 | 3 | 0 | 0 | BAL | 0.75 | 6 | 5 | 0 | 0.44 | 8 | 0 | 0 | 7.43% | 22.62% | 0.84% | 105 |
| N1732 | 0.2 | 3 | 0 | 0 | BAL | 0.75 | 8 | 5 | 0 | 0.44 | 8 | 0 | 0 | 9.38% | 22.80% | 0.83% | 85 |
| N1733 | 0.2 | 3 | 2 | 0 | BAL | 0.75 | 0 | 5 | 0 | 0.44 | 8 | 0 | 0 | 2.88% | 24.91% | 0.90% | 495 |
| N1734 | 0.2 | 3 | 2 | 0 | BAL | 0.75 | 0 | 5 | 0 | 0.44 | 8 | 4 | 0 | 8.71% | 21.38% | 0.83% | 685 |
| N1735 | 0.2 | 3 | 2 | 0 | BAL | 0.75 | 0 | 5 | 0 | 0.44 | 8 | 6 | 0 | 8.58% | 20.31% | 0.82% | 825 |
| N1736 | 0.2 | 3 | 2 | 0 | BAL | 0.75 | 0 | 5 | 0 | 0.44 | 8 | 8 | 0 | 8.74% | 20.00% | 0.82% | 920 |
| N1737 | 0.2 | 3 | 2 | 0 | BAL | 0.75 | 0 | 5 | 0 | 0.44 | 8 | 10 | 0 | 9.23% | 19.69% | 0.82% | 815 |
| N1738 | 0.2 | 3 | 2 | 0 | BAL | 0.75 | 2 | 5 | 0 | 0.44 | 8 | 0 | 0 | 5.01% | 24.00% | 0.88% | 290 |
| N1739 | 0.2 | 3 | 2 | 0 | BAL | 0.75 | 2 | 5 | 0 | 0.44 | 8 | 2 | 0 | 7.16% | 21.82% | 0.84% | 280 |
| N1740 | 0.2 | 3 | 2 | 0 | BAL | 0.75 | 2 | 5 | 0 | 0.44 | 8 | 4 | 0 | 8.86% | 21.54% | 0.82% | 325 |
| N1741 | 0.2 | 3 | 2 | 0 | BAL | 0.75 | 2 | 5 | 0 | 0.44 | 8 | 6 | 0 | 9.82% | 21.13% | 0.81% | 370 |
| N1742 | 0.2 | 3 | 2 | 0 | BAL | 0.75 | 4 | 5 | 0 | 0.44 | 8 | 0 | 0 | 7.56% | 23.40% | 0.85% | 180 |
| N1743 | 0.2 | 3 | 2 | 0 | BAL | 0.75 | 4 | 5 | 0 | 0.44 | 8 | 2 | 0 | 8.91% | 21.85% | 0.82% | 175 |
| N1744 | 0.2 | 3 | 2 | 0 | BAL | 0.75 | 6 | 5 | 0 | 0.44 | 8 | 0 | 0 | 9.86% | 22.93% | 0.84% | 105 |
| N1745 | 0.2 | 3 | 4 | 0 | BAL | 0.75 | 0 | 5 | 0 | 0.44 | 8 | 0 | 0 | 6.25% | 23.30% | 0.89% | 345 |
| N1746 | 0.2 | 3 | 4 | 0 | BAL | 0.75 | 0 | 5 | 0 | 0.44 | 8 | 4 | 0 | 8.72% | 21.36% | 0.84% | 530 |
| N1747 | 0.2 | 3 | 4 | 0 | BAL | 0.75 | 0 | 5 | 0 | 0.44 | 8 | 6 | 0 | 9.85% | 20.86% | 0.83% | 675 |
| N1748 | 0.2 | 3 | 4 | 0 | BAL | 0.75 | 0 | 5 | 0 | 0.44 | 8 | 8 | 0 | 8.73% | 19.97% | 0.82% | 715 |
| N1749 | 0.2 | 3 | 4 | 0 | BAL | 0.75 | 0 | 5 | 0 | 0.44 | 8 | 10 | 0 | 9.32% | 19.60% | 0.83% | 760 |
| N1750 | 0.2 | 3 | 4 | 0 | BAL | 0.75 | 2 | 5 | 0 | 0.44 | 8 | 0 | 0 | 8.34% | 22.58% | 0.87% | 285 |
| N1751 | 0.2 | 3 | 4 | 0 | BAL | 0.75 | 2 | 5 | 0 | 0.44 | 8 | 2 | 0 | 8.87% | 21.60% | 0.83% | 275 |
| N1752 | 0.2 | 3 | 4 | 0 | BAL | 0.75 | 2 | 5 | 0 | 0.44 | 8 | 4 | 0 | 9.34% | 21.43% | 0.82% | 325 |
| N1753 | 0.2 | 3 | 4 | 0 | BAL | 0.75 | 2 | 5 | 0 | 0.44 | 8 | 6 | 0 | 9.81% | 21.10% | 0.80% | 370 |
| N1754 | 0 | 2.5 | 0 | 0 | BAL | 1.16 | 0.74 | 6 | 0 | 0.76 | 5 | 2 | 0 | 5.89% | 17.26% | 0.89% | 700 |
| N1755 | 0 | 2.5 | 0 | 0 | BAL | 1.16 | 0.74 | 6 | 0 | 0.76 | 5 | 4 | 0 | 6.97% | 16.91% | 0.87% | 750 |
| N1756 | 0 | 2.5 | 0 | 0 | BAL | 1.16 | 0.74 | 6 | 0 | 0.76 | 5 | 6 | 0 | 0.49% | 16.61% | 0.88% | 750 |
| N1757 | 0 | 2.5 | 0 | 0 | BAL | 1.16 | 0.74 | 6 | 0 | 0.76 | 6 | 2 | 0 | 1.68% | 21.43% | 0.77% | 800 |
| N1758 | 0 | 2.5 | 0 | 0 | BAL | 1.16 | 0.74 | 6 | 0 | 0.76 | 6 | 4 | 0 | 1.06% | 18.69% | 0.75% | 800 |
| N1759 | 0 | 2.5 | 0 | 0 | BAL | 1.16 | 0.74 | 6 | 0 | 0.76 | 6 | 6 | 0 | 1.10% | 18.31% | 0.71% | 700 |
| N1760 | 0 | 2.5 | 0 | 0 | BAL | 1.16 | 0.74 | 8 | 0 | 0.76 | 2 | 2 | 0 | 8.17% | 13.36% | 1.28% | 600 |
| N1761 | 0 | 2.5 | 0 | 0 | BAL | 1.16 | 0.74 | 8 | 0 | 0.76 | 3 | 2 | 0 | 6.96% | 15.51% | 1.07% | 600 |
| N1762 | 0 | 2.5 | 0 | 0 | BAL | 1.16 | 0.74 | 8 | 0 | 0.76 | 3 | 4 | 0 | 7.57% | 15.09% | 1.07% | 800 |
| N1763 | 0 | 2.5 | 0 | 0 | BAL | 1.16 | 0.74 | 8 | 0 | 0.76 | 3 | 6 | 0 | 2.25% | 14.94% | 1.07% | 750 |
| N1764 | 0 | 2.5 | 0 | 0 | BAL | 1.16 | 0.74 | 8 | 0 | 0.76 | 4 | 2 | 0 | 5.95% | 17.45% | 0.87% | 700 |
| N1765 | 0 | 2.5 | 0 | 0 | BAL | 1.16 | 0.74 | 8 | 0 | 0.76 | 4 | 4 | 0 | 7.04% | 17.08% | 0.87% | 750 |
| N1766 | 0 | 2.5 | 0 | 0 | BAL | 1.16 | 0.74 | 8 | 0 | 0.76 | 4 | 6 | 0 | 0.49% | 16.77% | 0.88% | 700 |
| N1767 | 0 | 2.5 | 0 | 0 | BAL | 1.16 | 0.74 | 8 | 0 | 0.76 | 5 | 0 | 0 | 0.64% | 19.85% | 0.74% | 650 |
| N1768 | 0 | 2.5 | 0 | 0 | BAL | 1.16 | 0.74 | 8 | 0 | 0.76 | 5 | 2 | 0 | 4.14% | 19.22% | 0.75% | 800 |
| N1769 | 0 | 2.5 | 0 | 0 | BAL | 1.16 | 0.74 | 8 | 0 | 0.76 | 5 | 4 | 0 | 1.06% | 18.88% | 0.74% | 800 |
| N1770 | 0 | 2.5 | 0 | 0 | BAL | 1.16 | 0.74 | 8 | 0 | 0.76 | 5 | 6 | 0 | 1.20% | 17.59% | 0.71% | 700 |
| N1771 | 0 | 2.5 | 0 | 0 | BAL | 1.16 | 0.74 | 10 | 0 | 0.76 | 0 | 6 | 0 | 1.53% | 22.84% | 1.47% | 750 |
| N1772 | 0 | 2.5 | 0 | 0 | BAL | 1.16 | 0.74 | 10 | 0 | 0.76 | 1 | 0 | 0 | 3.93% | 13.56% | 1.30% | 550 |
| N1773 | 0 | 2.5 | 0 | 0 | BAL | 1.16 | 0.74 | 10 | 0 | 0.76 | 1 | 2 | 0 | 4.74% | 17.02% | 1.29% | 550 |
| N1774 | 0 | 2.5 | 0 | 0 | BAL | 1.16 | 0.74 | 10 | 0 | 0.76 | 2 | 2 | 0 | 7.00% | 15.70% | 1.07% | 600 |
| N1775 | 0 | 2.5 | 0 | 0 | BAL | 1.16 | 0.74 | 10 | 0 | 0.76 | 2 | 4 | 0 | 7.68% | 15.24% | 1.08% | 800 |
| N1776 | 0 | 2.5 | 0 | 0 | BAL | 1.16 | 0.74 | 10 | 0 | 0.76 | 3 | 2 | 0 | 1.89% | 21.77% | 0.86% | 650 |
| N1777 | 0 | 2.5 | 0 | 0 | BAL | 1.16 | 0.74 | 10 | 0 | 0.76 | 3 | 4 | 0 | 7.13% | 17.24% | 0.87% | 750 |
| N1778 | 0 | 2.5 | 0 | 0 | BAL | 1.16 | 0.74 | 10 | 0 | 0.76 | 3 | 6 | 0 | 0.82% | 16.70% | 0.89% | 700 |
| N1779 | 0 | 2.5 | 0 | 0 | BAL | 1.16 | 0.74 | 10 | 0 | 0.76 | 4 | 2 | 0 | 4.21% | 19.41% | 0.74% | 800 |
| N1780 | 0 | 2.5 | 0 | 0 | BAL | 1.16 | 0.74 | 10 | 0 | 0.76 | 4 | 4 | 0 | 1.05% | 19.05% | 0.72% | 750 |
| N1781 | 0 | 2.5 | 0 | 0 | BAL | 1.16 | 0.74 | 10 | 0 | 0.76 | 4 | 6 | 0 | 1.06% | 17.13% | 0.71% | 650 |
| N1782 | 0 | 3 | 0 | 0 | BAL | 1.16 | 0.74 | 4 | 0 | 0.76 | 6 | 0 | 0 | 3.83% | 16.97% | 1.42% | 650 |
| N1783 | 0 | 3 | 0 | 0 | BAL | 1.16 | 0.74 | 4 | 0 | 0.76 | 7 | 0 | 0 | 2.77% | 19.05% | 1.21% | 650 |
| N1784 | 0 | 3 | 0 | 0 | BAL | 1.16 | 0.74 | 4 | 0 | 0.76 | 7 | 2 | 0 | 6.79% | 19.04% | 1.15% | 650 |
| N1785 | 0 | 3 | 0 | 0 | BAL | 1.16 | 0.74 | 4 | 0 | 0.76 | 7 | 4 | 0 | 8.08% | 18.64% | 1.10% | 750 |
| N1786 | 0 | 3 | 0 | 0 | BAL | 1.16 | 0.74 | 4 | 0 | 0.76 | 7 | 6 | 0 | 9.83% | 18.43% | 1.07% | 800 |
| N1787 | 0 | 3 | 0 | 0 | BAL | 1.16 | 0.74 | 4 | 0 | 0.76 | 8 | 0 | 0 | 1.72% | 21.12% | 1.06% | 700 |
| N1788 | 0 | 3 | 0 | 0 | BAL | 1.16 | 0.74 | 4 | 0 | 0.76 | 8 | 2 | 0 | 5.71% | 20.99% | 0.95% | 700 |
| N1789 | 0 | 3 | 0 | 0 | BAL | 1.16 | 0.74 | 4 | 0 | 0.76 | 8 | 4 | 0 | 6.86% | 20.50% | 0.92% | 800 |
| N1790 | 0 | 3 | 0 | 0 | BAL | 1.16 | 0.74 | 4 | 0 | 0.76 | 8 | 6 | 0 | 0.41% | 20.16% | 0.90% | 750 |
| N1791 | 0 | 3 | 0 | 0 | BAL | 1.16 | 0.74 | 4 | 0 | 0.76 | 9 | 0 | 0 | 0.67% | 23.18% | 0.88% | 750 |
| N1792 | 0 | 3 | 0 | 0 | BAL | 1.16 | 0.74 | 4 | 0 | 0.76 | 9 | 2 | 0 | 4.10% | 22.56% | 0.85% | 800 |
| N1793 | 0 | 3 | 0 | 0 | BAL | 1.16 | 0.74 | 4 | 0 | 0.76 | 9 | 4 | 0 | 0.37% | 22.18% | 0.77% | 850 |
| N1794 | 0 | 3 | 0 | 0 | BAL | 1.16 | 0.74 | 4 | 0 | 0.76 | 9 | 6 | 0 | 0.72% | 21.97% | 0.74% | 750 |
| N1795 | 0 | 3 | 0 | 0 | BAL | 1.16 | 0.74 | 4 | 0 | 0.76 | 10 | 0 | 0 | 0.00% | 24.87% | 0.71% | 750 |
| N1796 | 0 | 3 | 0 | 0 | BAL | 1.16 | 0.74 | 4 | 0 | 0.76 | 10 | 2 | 0 | 1.03% | 24.21% | 0.70% | 850 |
| N1797 | 0 | 3 | 0 | 0 | BAL | 1.16 | 0.74 | 6 | 0 | 0.76 | 5 | 0 | 0 | 3.83% | 17.19% | 1.39% | 600 |
| N1798 | 0 | 3 | 0 | 0 | BAL | 1.16 | 0.74 | 6 | 0 | 0.76 | 5 | 2 | 0 | 7.96% | 17.16% | 1.34% | 600 |
| N1799 | 0 | 3 | 0 | 0 | BAL | 1.16 | 0.74 | 6 | 0 | 0.76 | 6 | 0 | 0 | 2.77% | 19.28% | 1.17% | 600 |
| N1800 | 0 | 3 | 0 | 0 | BAL | 1.16 | 0.74 | 6 | 0 | 0.76 | 6 | 2 | 0 | 6.80% | 19.25% | 1.13% | 650 |
| N1801 | 0 | 3 | 0 | 0 | BAL | 1.16 | 0.74 | 6 | 0 | 0.76 | 6 | 6 | 0 | 9.93% | 18.62% | 1.08% | 750 |
| N1802 | 0 | 3 | 0 | 0 | BAL | 1.16 | 0.74 | 6 | 0 | 0.76 | 7 | 0 | 0 | 1.70% | 21.37% | 1.03% | 650 |
| N1803 | 0 | 3 | 0 | 0 | BAL | 1.16 | 0.74 | 6 | 0 | 0.76 | 7 | 4 | 0 | 2.48% | 20.70% | 0.91% | 750 |
| N1804 | 0 | 3 | 0 | 0 | BAL | 1.16 | 0.74 | 6 | 0 | 0.76 | 7 | 6 | 0 | 0.43% | 20.37% | 0.90% | 750 |
| N1805 | 0 | 3 | 0 | 0 | BAL | 1.16 | 0.74 | 6 | 0 | 0.76 | 8 | 0 | 0 | 0.64% | 23.45% | 0.84% | 700 |
| N1806 | 0 | 3 | 0 | 0 | BAL | 1.16 | 0.74 | 6 | 0 | 0.76 | 8 | 2 | 0 | 4.15% | 22.77% | 0.83% | 800 |
| N1807 | 0 | 3 | 0 | 0 | BAL | 1.16 | 0.74 | 6 | 0 | 0.76 | 8 | 4 | 0 | 0.39% | 22.41% | 0.76% | 800 |
| N1808 | 0 | 3 | 0 | 0 | BAL | 1.16 | 0.74 | 6 | 0 | 0.76 | 8 | 6 | 0 | 0.74% | 22.20% | 0.74% | 700 |
| N1809 | 0 | 3 | 0 | 0 | BAL | 1.16 | 0.74 | 8 | 0 | 0.76 | 4 | 0 | 0 | 3.83% | 17.40% | 1.36% | 550 |
| N1810 | 0 | 3 | 0 | 0 | BAL | 1.16 | 0.74 | 8 | 0 | 0.76 | 4 | 2 | 0 | 8.00% | 17.37% | 1.33% | 600 |
| N1811 | 0 | 3 | 0 | 0 | BAL | 1.16 | 0.74 | 8 | 0 | 0.76 | 5 | 0 | 0 | 2.76% | 19.52% | 1.15% | 550 |
| N1812 | 0 | 3 | 0 | 0 | BAL | 1.16 | 0.74 | 8 | 0 | 0.76 | 5 | 2 | 0 | 6.81% | 19.48% | 1.12% | 600 |
| N1813 | 0 | 3 | 0 | 0 | BAL | 1.16 | 0.74 | 8 | 0 | 0.76 | 5 | 4 | 0 | 7.47% | 19.02% | 1.10% | 750 |
| N1814 | 0 | 3 | 0 | 0 | BAL | 1.16 | 0.74 | 8 | 0 | 0.76 | 6 | 0 | 0 | 1.68% | 21.62% | 1.00% | 650 |
| N1815 | 0 | 3 | 0 | 0 | BAL | 1.16 | 0.74 | 8 | 0 | 0.76 | 6 | 2 | 0 | 5.86% | 21.36% | 0.91% | 650 |
| N1816 | 0 | 3 | 0 | 0 | BAL | 1.16 | 0.74 | 8 | 0 | 0.76 | 6 | 4 | 0 | 6.99% | 20.91% | 0.90% | 750 |
| N1817 | 0 | 3 | 0 | 0 | BAL | 1.16 | 0.74 | 8 | 0 | 0.76 | 6 | 6 | 0 | 0.44% | 20.58% | 0.90% | 700 |
| N1818 | 0 | 3 | 0 | 0 | BAL | 1.16 | 0.74 | 8 | 0 | 0.76 | 7 | 0 | 0 | 0.62% | 23.72% | 0.81% | 650 |
| N1819 | 0 | 3 | 0 | 0 | BAL | 1.16 | 0.74 | 8 | 0 | 0.76 | 7 | 2 | 0 | 4.19% | 23.00% | 0.80% | 800 |
| N1820 | 0 | 3 | 0 | 0 | BAL | 1.16 | 0.74 | 8 | 0 | 0.76 | 7 | 4 | 0 | 0.91% | 22.64% | 0.75% | 800 |
| N1821 | 0 | 3 | 0 | 0 | BAL | 1.16 | 0.74 | 8 | 0 | 0.76 | 7 | 6 | 0 | 1.30% | 22.08% | 0.74% | 700 |
| N1822 | 0 | 3 | 0 | 0 | BAL | 1.16 | 0.74 | 10 | 0 | 0.76 | 3 | 0 | 0 | 3.83% | 17.62% | 1.35% | 550 |
| N1823 | 0 | 3 | 0 | 0 | BAL | 1.16 | 0.74 | 10 | 0 | 0.76 | 3 | 2 | 0 | 8.04% | 17.59% | 1.33% | 550 |
| N1824 | 0 | 3 | 0 | 0 | BAL | 1.16 | 0.74 | 10 | 0 | 0.76 | 4 | 0 | 0 | 2.75% | 19.76% | 1.13% | 550 |
| N1825 | 0 | 3 | 0 | 0 | BAL | 1.16 | 0.74 | 10 | 0 | 0.76 | 4 | 2 | 0 | 6.82% | 19.71% | 1.11% | 600 |
| N1826 | 0 | 3 | 0 | 0 | BAL | 1.16 | 0.74 | 10 | 0 | 0.76 | 4 | 4 | 0 | 7.54% | 19.21% | 1.10% | 750 |
| N1827 | 0 | 3 | 0 | 0 | BAL | 1.16 | 0.74 | 10 | 0 | 0.76 | 5 | 0 | 0 | 1.67% | 21.88% | 0.97% | 600 |
| N1828 | 0 | 3 | 0 | 0 | BAL | 1.16 | 0.74 | 10 | 0 | 0.76 | 5 | 2 | 0 | 5.91% | 21.58% | 0.90% | 650 |
| N1829 | 0 | 3 | 0 | 0 | BAL | 1.16 | 0.74 | 10 | 0 | 0.76 | 5 | 4 | 0 | 7.06% | 21.12% | 0.90% | 750 |
| N1830 | 0 | 3 | 0 | 0 | BAL | 1.16 | 0.74 | 10 | 0 | 0.76 | 5 | 6 | 0 | 0.44% | 20.78% | 0.91% | 700 |
| N1831 | 0 | 3 | 0 | 0 | BAL | 1.16 | 0.74 | 10 | 0 | 0.76 | 6 | 0 | 0 | 0.50% | 24.00% | 0.78% | 650 |
| N1832 | 0 | 3 | 0 | 0 | BAL | 1.16 | 0.74 | 10 | 0 | 0.76 | 6 | 2 | 0 | 4.23% | 23.23% | 0.79% | 800 |
| N1833 | 0 | 3 | 0 | 0 | BAL | 1.16 | 0.74 | 10 | 0 | 0.76 | 6 | 4 | 0 | 0.91% | 22.87% | 0.74% | 800 |
| N1834 | 0 | 3 | 0 | 0 | BAL | 1.16 | 0.74 | 10 | 0 | 0.76 | 6 | 6 | 0 | 2.40% | 21.63% | 0.73% | 650 |
| N1835 | 0.2 | 3 | 6 | 0 | BAL | 0.75 | 0 | 5 | 0 | 0.44 | 8 | 0 | 0 | 9.35% | 22.00% | 0.88% | 290 |
| N1836 | 0.2 | 3 | 6 | 0 | BAL | 0.75 | 0 | 5 | 0 | 0.44 | 8 | 4 | 0 | 8.71% | 21.33% | 0.83% | 425 |
| N1837 | 0.2 | 3 | 6 | 0 | BAL | 0.75 | 0 | 5 | 0 | 0.44 | 8 | 8 | 0 | 9.61% | 20.39% | 0.83% | 615 |
| N1838 | 0.2 | 3 | 6 | 0 | BAL | 0.75 | 0 | 5 | 0 | 0.44 | 8 | 10 | 0 | 9.40% | 19.51% | 0.83% | 705 |
| N1839 | 0.2 | 3 | 6 | 0 | BAL | 0.75 | 2 | 5 | 0 | 0.44 | 8 | 4 | 0 | 9.33% | 21.40% | 0.82% | 320 |
| N1840 | 0.2 | 3 | 6 | 0 | BAL | 0.75 | 2 | 5 | 0 | 0.44 | 8 | 6 | 0 | 9.80% | 21.07% | 0.81% | 365 |
| N1841 | 0.2 | 3 | 8 | 0 | BAL | 0.75 | 0 | 5 | 0 | 0.44 | 8 | 4 | 0 | 8.70% | 21.30% | 0.83% | 270 |
| N1842 | 0.2 | 3 | 8 | 0 | BAL | 0.75 | 0 | 5 | 0 | 0.44 | 8 | 8 | 0 | 9.64% | 20.38% | 0.84% | 510 |
| N1843 | 0.2 | 3 | 8 | 0 | BAL | 0.75 | 0 | 5 | 0 | 0.44 | 8 | 10 | 0 | 9.49% | 19.41% | 0.85% | 605 |
| N1844 | 0.2 | 3 | 8 | 0 | BAL | 0.75 | 2 | 5 | 0 | 0.44 | 8 | 4 | 0 | 9.31% | 21.37% | 0.81% | 265 |
| N1845 | 0.2 | 3 | 8 | 0 | BAL | 0.75 | 2 | 5 | 0 | 0.44 | 8 | 6 | 0 | 9.80% | 21.04% | 0.82% | 360 |
| N1846 | 0.2 | 3 | 10 | 0 | BAL | 0.75 | 0 | 5 | 0 | 0.44 | 8 | 4 | 0 | 8.68% | 21.28% | 0.83% | 165 |
| N1847 | 0.2 | 3 | 10 | 0 | BAL | 0.75 | 0 | 5 | 0 | 0.44 | 8 | 8 | 0 | 9.77% | 20.41% | 0.84% | 460 |
| N1848 | 0.2 | 3 | 10 | 0 | BAL | 0.75 | 0 | 5 | 0 | 0.44 | 8 | 10 | 0 | 9.57% | 19.32% | 0.86% | 550 |
| N1849 | 0.2 | 3 | 10 | 0 | BAL | 0.75 | 2 | 5 | 0 | 0.44 | 8 | 4 | 0 | 9.30% | 21.34% | 0.82% | 160 |
| N1850 | 0.2 | 3 | 10 | 0 | BAL | 0.75 | 2 | 5 | 0 | 0.44 | 8 | 6 | 0 | 9.79% | 21.01% | 0.83% | 310 |
| N1851 | 0.2 | 3 | 0 | 0 | BAL | 0.75 | 0 | 5 | 0 | 0.44 | 8 | 0 | 0 | 4.23% | 22.12% | 0.91% | 700 |
| N1852 | 0.2 | 3 | 0 | 0 | BAL | 0.75 | 0 | 5 | 0 | 0.44 | 8 | 0 | 1 | 4.11% | 22.25% | 0.91% | 700 |
| N1853 | 0.2 | 3 | 0 | 0 | BAL | 0.75 | 0 | 5 | 0 | 0.44 | 8 | 0 | 2 | 4.34% | 22.40% | 0.89% | 695 |
| N1854 | 0.2 | 3 | 0 | 0 | BAL | 0.75 | 0 | 5 | 0 | 0.44 | 8 | 0 | 3 | 4.64% | 22.54% | 0.88% | 595 |
| N1855 | 0.2 | 3 | 0 | 0 | BAL | 0.75 | 0 | 5 | 0 | 0.44 | 8 | 0 | 4 | 2.55% | 22.68% | 0.87% | 495 |
| N1856 | 0.2 | 3 | 0 | 0 | BAL | 0.75 | 0 | 5 | 0 | 0.44 | 8 | 0 | 5 | 5.26% | 22.83% | 0.85% | 390 |
| N1857 | 0.2 | 3 | 0 | 0 | BAL | 0.75 | 0 | 5 | 0 | 0.44 | 8 | 0 | 6 | 5.58% | 22.98% | 0.84% | 340 |
| N1858 | 0.2 | 3 | 0 | 0 | BAL | 0.75 | 0 | 5 | 0 | 0.44 | 8 | 0 | 7 | 2.95% | 23.13% | 0.84% | 290 |
| N1859 | 0.2 | 3 | 0 | 0 | BAL | 0.75 | 0 | 5 | 0 | 0.44 | 8 | 0 | 8 | 3.36% | 23.27% | 0.82% | 235 |
| N1860 | 0.2 | 3 | 0 | 0 | BAL | 0.75 | 0 | 5 | 0 | 0.44 | 8 | 0 | 9 | 3.71% | 23.30% | 0.81% | 185 |
| N1861 | 0.2 | 3 | 0 | 0 | BAL | 0.75 | 0 | 5 | 0 | 0.44 | 8 | 0 | 10 | 5.89% | 23.46% | 0.80% | 130 |
| N1862 | 0.2 | 3 | 0 | 0 | BAL | 0.75 | 0 | 5 | 0 | 0.44 | 8 | 0 | 11 | 5.64% | 23.62% | 0.79% | 100 |
| N1863 | 0.2 | 3 | 0 | 0 | BAL | 0.75 | 0 | 5 | 0 | 0.44 | 8 | 0 | 12 | 5.39% | 23.78% | 0.78% | 95 |
| N1864 | 0.2 | 3 | 0 | 0 | BAL | 0.75 | 0 | 5 | 0 | 0.44 | 8 | 0 | 13 | 5.14% | 23.94% | 0.77% | 80 |
| N1865 | 0.2 | 3 | 0 | 0 | BAL | 0.75 | 0 | 5 | 0 | 0.44 | 8 | 0 | 14 | 4.88% | 24.10% | 0.76% | 75 |
| N1866 | 0.2 | 3 | 0 | 0 | BAL | 0.75 | 0 | 5 | 0 | 0.44 | 8 | 0 | 15 | 4.62% | 24.27% | 0.75% | 70 |
| N1867 | 0.2 | 3 | 0 | 0 | BAL | 0.75 | 0 | 5 | 0 | 0.44 | 8 | 0 | 16 | 4.36% | 24.44% | 0.75% | 70 |
| N1868 | 0.2 | 3 | 0 | 0 | BAL | 0.75 | 0 | 5 | 0 | 0.44 | 8 | 0 | 17 | 4.09% | 24.61% | 0.74% | 70 |
| N1869 | 0.2 | 3 | 0 | 0 | BAL | 0.75 | 0 | 5 | 0 | 0.44 | 8 | 0 | 18 | 3.82% | 24.78% | 0.73% | 55 |
| N1870 | 0.2 | 3 | 0 | 0 | BAL | 0.75 | 0 | 5 | 0 | 0.44 | 8 | 0 | 19 | 3.54% | 24.95% | 0.72% | 45 |
| N1871 | 0.2 | 3 | 0 | 0 | BAL | 0.75 | 0 | 5 | 0 | 0.44 | 8 | 0 | 20 | 3.51% | 25.07% | 0.71% | 40 |
| N1872 | 0.2 | 3.25 | 0 | 0 | BAL | 0.75 | 0 | 5 | 0 | 0.44 | 8 | 0 | 0 | 5.23% | 21.94% | 1.14% | 585 |
| N1873 | 0.2 | 3.25 | 0 | 0 | BAL | 0.75 | 0 | 5 | 0 | 0.44 | 8 | 0 | 1 | 5.12% | 22.07% | 1.13% | 585 |
| N1874 | 0.2 | 3.25 | 0 | 0 | BAL | 0.75 | 0 | 5 | 0 | 0.44 | 8 | 0 | 2 | 5.35% | 22.21% | 1.11% | 630 |
| N1875 | 0.2 | 3.25 | 0 | 0 | BAL | 0.75 | 0 | 5 | 0 | 0.44 | 8 | 0 | 3 | 5.66% | 22.35% | 1.10% | 630 |
| N1876 | 0.2 | 3.25 | 0 | 0 | BAL | 0.75 | 0 | 5 | 0 | 0.44 | 8 | 0 | 4 | 5.97% | 22.49% | 1.09% | 530 |
| N1877 | 0.2 | 3.25 | 0 | 0 | BAL | 0.75 | 0 | 5 | 0 | 0.44 | 8 | 0 | 5 | 6.29% | 22.64% | 1.07% | 430 |
| N1878 | 0.2 | 3.25 | 0 | 0 | BAL | 0.75 | 0 | 5 | 0 | 0.44 | 8 | 0 | 6 | 6.61% | 22.78% | 1.06% | 325 |
| N1879 | 0.2 | 3.25 | 0 | 0 | BAL | 0.75 | 0 | 5 | 0 | 0.44 | 8 | 0 | 7 | 6.93% | 22.93% | 1.05% | 275 |
| N1880 | 0.2 | 3.25 | 0 | 0 | BAL | 0.75 | 0 | 5 | 0 | 0.44 | 8 | 0 | 8 | 7.26% | 23.08% | 1.03% | 225 |
| N1881 | 0.2 | 3.25 | 0 | 0 | BAL | 0.75 | 0 | 5 | 0 | 0.44 | 8 | 0 | 9 | 7.60% | 23.23% | 1.02% | 155 |
| N1882 | 0.2 | 3.25 | 0 | 0 | BAL | 0.75 | 0 | 5 | 0 | 0.44 | 8 | 0 | 10 | 7.93% | 23.39% | 1.01% | 125 |
| N1883 | 0.2 | 3.25 | 0 | 0 | BAL | 0.75 | 0 | 5 | 0 | 0.44 | 8 | 0 | 11 | 8.11% | 23.54% | 0.99% | 105 |
| N1884 | 0.2 | 3.25 | 0 | 0 | BAL | 0.75 | 0 | 5 | 0 | 0.44 | 8 | 0 | 12 | 8.39% | 23.67% | 0.98% | 95 |
| N1885 | 0.2 | 3.25 | 0 | 0 | BAL | 0.75 | 0 | 5 | 0 | 0.44 | 8 | 0 | 13 | 8.44% | 23.73% | 0.97% | 85 |
| N1886 | 0.2 | 3.25 | 0 | 0 | BAL | 0.75 | 0 | 5 | 0 | 0.44 | 8 | 0 | 14 | 8.21% | 23.89% | 0.96% | 70 |
| N1887 | 0.2 | 3.25 | 0 | 0 | BAL | 0.75 | 0 | 5 | 0 | 0.44 | 8 | 0 | 15 | 7.97% | 24.05% | 0.95% | 65 |
| N1888 | 0.2 | 3.25 | 0 | 0 | BAL | 0.75 | 0 | 5 | 0 | 0.44 | 8 | 0 | 16 | 7.74% | 24.22% | 0.94% | 60 |
| N1889 | 0.2 | 3.25 | 0 | 0 | BAL | 0.75 | 0 | 5 | 0 | 0.44 | 8 | 0 | 17 | 7.49% | 24.38% | 0.93% | 55 |
| N1890 | 0.2 | 3.25 | 0 | 0 | BAL | 0.75 | 0 | 5 | 0 | 0.44 | 8 | 0 | 18 | 7.25% | 24.55% | 0.92% | 55 |
| N1891 | 0.2 | 3.25 | 0 | 0 | BAL | 0.75 | 0 | 5 | 0 | 0.44 | 8 | 0 | 19 | 7.00% | 24.72% | 0.90% | 55 |
| N1892 | 0.2 | 3.25 | 0 | 0 | BAL | 0.75 | 0 | 5 | 0 | 0.44 | 8 | 0 | 20 | 6.75% | 24.90% | 0.89% | 50 |
| N1893 | 0.2 | 3.5 | 0 | 0 | BAL | 0.75 | 0 | 5 | 0 | 0.44 | 8 | 0 | 0 | 6.21% | 21.76% | 1.38% | 415 |
| N1894 | 0.2 | 3.5 | 0 | 0 | BAL | 0.75 | 0 | 5 | 0 | 0.44 | 8 | 0 | 1 | 6.11% | 21.89% | 1.36% | 465 |
| N1895 | 0.2 | 3.5 | 0 | 0 | BAL | 0.75 | 0 | 5 | 0 | 0.44 | 8 | 0 | 2 | 6.34% | 22.03% | 1.35% | 465 |
| N1896 | 0.2 | 3.5 | 0 | 0 | BAL | 0.75 | 0 | 5 | 0 | 0.44 | 8 | 0 | 3 | 6.66% | 22.17% | 1.34% | 515 |
| N1897 | 0.2 | 3.5 | 0 | 0 | BAL | 0.75 | 0 | 5 | 0 | 0.44 | 8 | 0 | 4 | 6.97% | 22.31% | 1.32% | 510 |
| N1898 | 0.2 | 3.5 | 0 | 0 | BAL | 0.75 | 0 | 5 | 0 | 0.44 | 8 | 0 | 5 | 7.29% | 22.45% | 1.31% | 460 |
| N1899 | 0.2 | 3.5 | 0 | 0 | BAL | 0.75 | 0 | 5 | 0 | 0.44 | 8 | 0 | 6 | 7.62% | 22.59% | 1.29% | 360 |
| N1900 | 0.2 | 3.5 | 0 | 0 | BAL | 0.75 | 0 | 5 | 0 | 0.44 | 8 | 0 | 7 | 7.95% | 22.74% | 1.27% | 310 |
| N1901 | 0.2 | 3.5 | 0 | 0 | BAL | 0.75 | 0 | 5 | 0 | 0.44 | 8 | 0 | 8 | 8.28% | 22.89% | 1.26% | 255 |
| N1902 | 0.2 | 3.5 | 0 | 0 | BAL | 0.75 | 0 | 5 | 0 | 0.44 | 8 | 0 | 9 | 8.62% | 23.03% | 1.25% | 205 |
| N1903 | 0.2 | 3.5 | 0 | 0 | BAL | 0.75 | 0 | 5 | 0 | 0.44 | 8 | 0 | 10 | 2.74% | 23.18% | 1.23% | 135 |
| N1904 | 0.2 | 3.5 | 0 | 0 | BAL | 0.75 | 0 | 5 | 0 | 0.44 | 8 | 0 | 11 | 9.30% | 23.34% | 1.22% | 115 |
| N1905 | 0.2 | 3.5 | 0 | 0 | BAL | 0.75 | 0 | 5 | 0 | 0.44 | 8 | 0 | 12 | 9.66% | 23.49% | 1.21% | 100 |
| N1906 | 0.2 | 3.5 | 0 | 0 | BAL | 0.75 | 0 | 5 | 0 | 0.44 | 8 | 0 | 13 | 2.80% | 23.65% | 1.19% | 85 |
| N1907 | 0.2 | 3.5 | 0 | 0 | BAL | 0.75 | 0 | 5 | 0 | 0.44 | 8 | 0 | 14 | 2.82% | 23.81% | 1.18% | 75 |
| N1908 | 0.2 | 3.5 | 0 | 0 | BAL | 0.75 | 0 | 5 | 0 | 0.44 | 8 | 0 | 17 | 4.21% | 24.16% | 1.13% | 60 |
| N1909 | 0.2 | 3.5 | 0 | 0 | BAL | 0.75 | 0 | 5 | 0 | 0.44 | 8 | 0 | 18 | 5.28% | 24.33% | 1.11% | 50 |
| N1910 | 0.2 | 3.75 | 0 | 0 | BAL | 0.75 | 0 | 5 | 0 | 0.44 | 8 | 0 | 8 | 9.28% | 22.69% | 1.50% | 235 |
| N1911 | 0.2 | 3.75 | 0 | 0 | BAL | 0.75 | 0 | 5 | 0 | 0.44 | 8 | 0 | 9 | 9.62% | 22.84% | 1.48% | 170 |
| N1912 | 0.2 | 3.75 | 0 | 0 | BAL | 0.75 | 0 | 5 | 0 | 0.44 | 8 | 0 | 10 | 9.96% | 22.99% | 1.47% | 145 |
| N1913 | 0.2 | 3.75 | 0 | 0 | BAL | 0.75 | 0 | 5 | 0 | 0.44 | 8 | 0 | 15 | 2.81% | 23.76% | 1.39% | 75 |
| N1914 | 0 | 3.5 | 0 | 0 | BAL | 1.16 | 0.74 | 4 | 0 | 0.76 | 8 | 2 | 0 | 7.73% | 20.77% | 1.41% | 700 |
| N1915 | 0 | 3.5 | 0 | 0 | BAL | 1.16 | 0.74 | 4 | 0 | 0.76 | 8 | 6 | 0 | 9.99% | 20.13% | 1.27% | 800 |
| N1916 | 0 | 3.5 | 0 | 0 | BAL | 1.16 | 0.74 | 4 | 0 | 0.76 | 9 | 0 | 0 | 2.71% | 22.81% | 1.29% | 650 |
| N1917 | 0 | 3.5 | 0 | 0 | BAL | 1.16 | 0.74 | 4 | 0 | 0.76 | 9 | 2 | 0 | 6.61% | 22.83% | 1.20% | 700 |
| N1918 | 0 | 3.5 | 0 | 0 | BAL | 1.16 | 0.74 | 4 | 0 | 0.76 | 9 | 4 | 0 | 8.09% | 22.39% | 1.13% | 750 |
| N1919 | 0 | 3.5 | 0 | 0 | BAL | 1.16 | 0.74 | 4 | 0 | 0.76 | 9 | 6 | 0 | 9.72% | 22.11% | 1.08% | 750 |
| N1920 | 0 | 3.5 | 0 | 0 | BAL | 1.16 | 0.74 | 4 | 0 | 0.76 | 10 | 0 | 0 | 1.68% | 24.83% | 1.08% | 650 |
| N1921 | 0 | 3.5 | 0 | 0 | BAL | 1.16 | 0.74 | 4 | 0 | 0.76 | 10 | 2 | 0 | 5.54% | 24.77% | 1.00% | 750 |
| N1922 | 0 | 3.5 | 0 | 0 | BAL | 1.16 | 0.74 | 4 | 0 | 0.76 | 10 | 4 | 0 | 6.84% | 24.15% | 0.95% | 800 |
| N1923 | 0 | 3.5 | 0 | 0 | BAL | 1.16 | 0.74 | 4 | 0 | 0.76 | 10 | 6 | 0 | 0.33% | 23.76% | 0.91% | 750 |
| N1924 | 0 | 3.5 | 0 | 0 | BAL | 1.16 | 0.74 | 6 | 0 | 0.76 | 7 | 0 | 0 | 3.75% | 21.02% | 1.47% | 600 |
| N1925 | 0 | 3.5 | 0 | 0 | BAL | 1.16 | 0.74 | 6 | 0 | 0.76 | 8 | 0 | 0 | 2.70% | 23.07% | 1.26% | 650 |
| N1926 | 0 | 3.5 | 0 | 0 | BAL | 1.16 | 0.74 | 6 | 0 | 0.76 | 8 | 2 | 0 | 6.65% | 23.05% | 1.19% | 650 |
| N1927 | 0 | 3.5 | 0 | 0 | BAL | 1.16 | 0.74 | 6 | 0 | 0.76 | 8 | 4 | 0 | 8.19% | 22.56% | 1.13% | 750 |
| N1928 | 0 | 3.5 | 0 | 0 | BAL | 1.16 | 0.74 | 6 | 0 | 0.76 | 8 | 6 | 0 | 3.25% | 22.31% | 1.09% | 750 |
| N1929 | 0 | 3.5 | 0 | 0 | BAL | 1.16 | 0.74 | 6 | 0 | 0.76 | 9 | 0 | 0 | 1.66% | 25.11% | 1.06% | 700 |
| N1930 | 0 | 3.5 | 0 | 0 | BAL | 1.16 | 0.74 | 6 | 0 | 0.76 | 9 | 2 | 0 | 5.70% | 24.90% | 0.98% | 700 |
| N1931 | 0 | 3.5 | 0 | 0 | BAL | 1.16 | 0.74 | 6 | 0 | 0.76 | 9 | 4 | 0 | 6.92% | 24.35% | 0.94% | 750 |
| N1932 | 0 | 3.5 | 0 | 0 | BAL | 1.16 | 0.74 | 6 | 0 | 0.76 | 9 | 6 | 0 | 0.35% | 24.00% | 0.92% | 750 |
| N1933 | 0 | 3.5 | 0 | 0 | BAL | 1.16 | 0.74 | 6 | 0 | 0.76 | 10 | 0 | 0 | 0.62% | 27.15% | 0.91% | 750 |
| N1934 | 0 | 3.5 | 0 | 0 | BAL | 1.16 | 0.74 | 6 | 0 | 0.76 | 10 | 2 | 0 | 4.13% | 26.42% | 0.85% | 800 |
| N1935 | 0 | 3.5 | 0 | 0 | BAL | 1.16 | 0.74 | 6 | 0 | 0.76 | 10 | 4 | 0 | 0.15% | 26.01% | 0.77% | 800 |
| N1936 | 0 | 3.5 | 0 | 0 | BAL | 1.16 | 0.74 | 6 | 0 | 0.76 | 10 | 6 | 0 | 0.71% | 25.73% | 0.76% | 750 |
| N1937 | 0 | 3.5 | 0 | 0 | BAL | 1.16 | 0.74 | 8 | 0 | 0.76 | 6 | 0 | 0 | 3.75% | 21.27% | 1.45% | 600 |
| N1938 | 0 | 3.5 | 0 | 0 | BAL | 1.16 | 0.74 | 8 | 0 | 0.76 | 6 | 2 | 0 | 7.84% | 21.23% | 1.39% | 600 |
| N1939 | 0 | 3.5 | 0 | 0 | BAL | 1.16 | 0.74 | 8 | 0 | 0.76 | 7 | 0 | 0 | 2.70% | 23.33% | 1.23% | 600 |
| N1940 | 0 | 3.5 | 0 | 0 | BAL | 1.16 | 0.74 | 8 | 0 | 0.76 | 7 | 2 | 0 | 6.65% | 23.30% | 1.17% | 650 |
| N1941 | 0 | 3.5 | 0 | 0 | BAL | 1.16 | 0.74 | 8 | 0 | 0.76 | 7 | 4 | 0 | 7.33% | 22.78% | 1.13% | 750 |
| N1942 | 0 | 3.5 | 0 | 0 | BAL | 1.16 | 0.74 | 8 | 0 | 0.76 | 7 | 6 | 0 | 9.92% | 22.53% | 1.10% | 750 |
| N1943 | 0 | 3.5 | 0 | 0 | BAL | 1.16 | 0.74 | 8 | 0 | 0.76 | 8 | 0 | 0 | 1.64% | 25.39% | 1.05% | 650 |
| N1944 | 0 | 3.5 | 0 | 0 | BAL | 1.16 | 0.74 | 8 | 0 | 0.76 | 8 | 4 | 0 | 6.98% | 24.59% | 0.94% | 750 |
| N1945 | 0 | 3.5 | 0 | 0 | BAL | 1.16 | 0.74 | 8 | 0 | 0.76 | 8 | 6 | 0 | 0.37% | 24.24% | 0.92% | 700 |
| N1946 | 0 | 3.5 | 0 | 0 | BAL | 1.16 | 0.74 | 8 | 0 | 0.76 | 9 | 0 | 0 | 0.58% | 27.45% | 0.88% | 700 |
| N1947 | 0 | 3.5 | 0 | 0 | BAL | 1.16 | 0.74 | 8 | 0 | 0.76 | 9 | 2 | 0 | 4.19% | 26.66% | 0.83% | 800 |
| N1948 | 0 | 3.5 | 0 | 0 | BAL | 1.16 | 0.74 | 8 | 0 | 0.76 | 9 | 4 | 0 | 0.33% | 26.28% | 0.76% | 800 |
| N1949 | 0 | 3.5 | 0 | 0 | BAL | 1.16 | 0.74 | 8 | 0 | 0.76 | 9 | 6 | 0 | 0.73% | 25.99% | 0.76% | 700 |
| N1950 | 0 | 3.5 | 0 | 0 | BAL | 1.16 | 0.74 | 8 | 0 | 0.76 | 10 | 0 | 0 | 0.00% | 29.05% | 0.70% | 700 |
| N1951 | 0 | 3.5 | 0 | 0 | BAL | 1.16 | 0.74 | 10 | 0 | 0.76 | 5 | 0 | 0 | 3.75% | 21.52% | 1.43% | 550 |
| N1952 | 0 | 3.5 | 0 | 0 | BAL | 1.16 | 0.74 | 10 | 0 | 0.76 | 5 | 2 | 0 | 7.88% | 21.48% | 1.38% | 600 |
| N1953 | 0 | 3.5 | 0 | 0 | BAL | 1.16 | 0.74 | 10 | 0 | 0.76 | 6 | 0 | 0 | 2.69% | 23.60% | 1.21% | 550 |
| N1954 | 0 | 3.5 | 0 | 0 | BAL | 1.16 | 0.74 | 10 | 0 | 0.76 | 6 | 2 | 0 | 6.66% | 23.56% | 1.16% | 600 |
| N1955 | 0 | 3.5 | 0 | 0 | BAL | 1.16 | 0.74 | 10 | 0 | 0.76 | 6 | 4 | 0 | 7.40% | 23.00% | 1.13% | 750 |
| N1956 | 0 | 3.5 | 0 | 0 | BAL | 1.16 | 0.74 | 10 | 0 | 0.76 | 7 | 0 | 0 | 1.63% | 25.68% | 1.04% | 650 |
| N1957 | 0 | 3.5 | 0 | 0 | BAL | 1.16 | 0.74 | 10 | 0 | 0.76 | 7 | 2 | 0 | 5.81% | 25.36% | 0.95% | 650 |
| N1958 | 0 | 3.5 | 0 | 0 | BAL | 1.16 | 0.74 | 10 | 0 | 0.76 | 7 | 4 | 0 | 7.04% | 24.83% | 0.93% | 750 |
| N1959 | 0 | 3.5 | 0 | 0 | BAL | 1.16 | 0.74 | 10 | 0 | 0.76 | 7 | 6 | 0 | 0.38% | 24.48% | 0.93% | 700 |
| N1960 | 0 | 3.5 | 0 | 0 | BAL | 1.16 | 0.74 | 10 | 0 | 0.76 | 8 | 0 | 0 | 0.46% | 27.75% | 0.85% | 650 |
| N1961 | 0 | 3.5 | 0 | 0 | BAL | 1.16 | 0.74 | 10 | 0 | 0.76 | 8 | 2 | 0 | 4.23% | 26.92% | 0.82% | 800 |
| N1962 | 0 | 3.5 | 0 | 0 | BAL | 1.16 | 0.74 | 10 | 0 | 0.76 | 8 | 4 | 0 | 0.71% | 26.53% | 0.75% | 750 |
| N1963 | 0 | 3.5 | 0 | 0 | BAL | 1.16 | 0.74 | 10 | 0 | 0.76 | 8 | 6 | 0 | 1.30% | 25.90% | 0.76% | 700 |
| N1964 | 0 | 4 | 0 | 0 | BAL | 1.16 | 0.74 | 4 | 0 | 0.76 | 10 | 2 | 0 | 7.54% | 24.47% | 1.47% | 700 |
| N1965 | 0 | 4 | 0 | 0 | BAL | 1.16 | 0.74 | 4 | 0 | 0.76 | 10 | 4 | 0 | 9.61% | 24.42% | 1.36% | 750 |
| N1966 | 0 | 4 | 0 | 0 | BAL | 1.16 | 0.74 | 6 | 0 | 0.76 | 10 | 0 | 0 | 2.65% | 26.71% | 1.34% | 650 |
| N1967 | 0 | 4 | 0 | 0 | BAL | 1.16 | 0.74 | 6 | 0 | 0.76 | 10 | 2 | 0 | 6.48% | 26.71% | 1.24% | 700 |
| N1968 | 0 | 4 | 0 | 0 | BAL | 1.16 | 0.74 | 6 | 0 | 0.76 | 10 | 4 | 0 | 8.16% | 26.17% | 1.16% | 750 |
| N1969 | 0 | 4 | 0 | 0 | BAL | 1.16 | 0.74 | 6 | 0 | 0.76 | 10 | 6 | 0 | 9.73% | 25.86% | 1.10% | 750 |
| N1970 | 0 | 4 | 0 | 0 | BAL | 1.16 | 0.74 | 8 | 0 | 0.76 | 8 | 2 | 0 | 7.68% | 24.95% | 1.45% | 600 |
| N1971 | 0 | 4 | 0 | 0 | BAL | 1.16 | 0.74 | 8 | 0 | 0.76 | 9 | 0 | 0 | 2.64% | 27.00% | 1.31% | 650 |
| N1972 | 0 | 4 | 0 | 0 | BAL | 1.16 | 0.74 | 8 | 0 | 0.76 | 9 | 2 | 0 | 6.50% | 26.97% | 1.23% | 650 |
| N1973 | 0 | 4 | 0 | 0 | BAL | 1.16 | 0.74 | 8 | 0 | 0.76 | 9 | 4 | 0 | 8.24% | 26.41% | 1.16% | 750 |
| N1974 | 0 | 4 | 0 | 0 | BAL | 1.16 | 0.74 | 8 | 0 | 0.76 | 9 | 6 | 0 | 9.82% | 26.10% | 1.12% | 750 |
| N1975 | 0 | 4 | 0 | 0 | BAL | 1.16 | 0.74 | 8 | 0 | 0.76 | 10 | 0 | 0 | 1.61% | 29.02% | 1.09% | 650 |
| N1976 | 0 | 4 | 0 | 0 | BAL | 1.16 | 0.74 | 8 | 0 | 0.76 | 10 | 2 | 0 | 5.66% | 28.75% | 1.02% | 700 |
| N1977 | 0 | 4 | 0 | 0 | BAL | 1.16 | 0.74 | 8 | 0 | 0.76 | 10 | 4 | 0 | 3.79% | 28.12% | 0.97% | 750 |
| N1978 | 0 | 4 | 0 | 0 | BAL | 1.16 | 0.74 | 8 | 0 | 0.76 | 10 | 6 | 0 | 0.04% | 27.78% | 0.94% | 750 |
| N1979 | 0 | 4 | 0 | 0 | BAL | 1.16 | 0.74 | 10 | 0 | 0.76 | 7 | 2 | 0 | 7.72% | 25.22% | 1.44% | 600 |
| N1980 | 0 | 4 | 0 | 0 | BAL | 1.16 | 0.74 | 10 | 0 | 0.76 | 8 | 0 | 0 | 2.63% | 27.30% | 1.29% | 600 |
| N1981 | 0 | 4 | 0 | 0 | BAL | 1.16 | 0.74 | 10 | 0 | 0.76 | 8 | 2 | 0 | 6.52% | 27.25% | 1.22% | 600 |
| N1982 | 0 | 4 | 0 | 0 | BAL | 1.16 | 0.74 | 10 | 0 | 0.76 | 8 | 4 | 0 | 7.28% | 26.66% | 1.16% | 750 |
| N1983 | 0 | 4 | 0 | 0 | BAL | 1.16 | 0.74 | 10 | 0 | 0.76 | 8 | 6 | 0 | 9.91% | 26.35% | 1.13% | 750 |
| N1984 | 0 | 4 | 0 | 0 | BAL | 1.16 | 0.74 | 10 | 0 | 0.76 | 9 | 0 | 0 | 1.59% | 29.33% | 1.07% | 600 |
| N1985 | 0 | 4 | 0 | 0 | BAL | 1.16 | 0.74 | 10 | 0 | 0.76 | 9 | 2 | 0 | 5.72% | 29.01% | 1.01% | 650 |
| N1986 | 0 | 4 | 0 | 0 | BAL | 1.16 | 0.74 | 10 | 0 | 0.76 | 9 | 4 | 0 | 7.04% | 28.39% | 0.97% | 750 |
| N1987 | 0 | 4 | 0 | 0 | BAL | 1.16 | 0.74 | 10 | 0 | 0.76 | 9 | 6 | 0 | 0.05% | 28.05% | 0.94% | 700 |
| N1988 | 0 | 4 | 0 | 0 | BAL | 1.16 | 0.74 | 10 | 0 | 0.76 | 10 | 0 | 0 | 0.43% | 31.36% | 0.92% | 700 |
| N1989 | 0 | 4 | 0 | 0 | BAL | 1.16 | 0.74 | 10 | 0 | 0.76 | 10 | 2 | 0 | 0.72% | 33.95% | 0.83% | 800 |
| N1990 | 0 | 4 | 0 | 0 | BAL | 1.16 | 0.74 | 10 | 0 | 0.76 | 10 | 4 | 0 | 0.12% | 30.07% | 0.78% | 750 |
| N1991 | 0 | 4 | 0 | 0 | BAL | 1.16 | 0.74 | 10 | 0 | 0.76 | 10 | 6 | 0 | 0.72% | 29.71% | 0.78% | 700 |
| N1992 | 0 | 4.5 | 0 | 0 | BAL | 1.16 | 0.74 | 10 | 0 | 0.76 | 9 | 2 | 0 | 7.56% | 28.82% | 1.50% | 600 |
| N1993 | 0 | 4.5 | 0 | 0 | BAL | 1.16 | 0.74 | 10 | 0 | 0.76 | 10 | 0 | 0 | 2.57% | 30.86% | 1.38% | 600 |
| N1994 | 0 | 4.5 | 0 | 0 | BAL | 1.16 | 0.74 | 10 | 0 | 0.76 | 10 | 2 | 0 | 6.37% | 30.82% | 1.27% | 650 |
| N1995 | 0 | 4.5 | 0 | 0 | BAL | 1.16 | 0.74 | 10 | 0 | 0.76 | 10 | 6 | 0 | 9.81% | 29.82% | 1.14% | 750 |
| N1996 | 0 | 1 | 5.04 | 0 | BAL | 1.16 | 0.74 | 0 | 0 | 0.76 | 2 | 0 | 0 | 0.50% | 4.63% | 0.90% | 550 |
| N1997 | 0 | 1 | 5.04 | 0 | BAL | 1.16 | 0.74 | 2 | 0 | 0.76 | 0 | 0 | 0 | 1.06% | 5.21% | 1.00% | 400 |
| N1998 | 0 | 1 | 5.04 | 0 | BAL | 1.16 | 0.74 | 4 | 0 | 0.76 | 0 | 0 | 0 | 0.00% | 5.73% | 0.84% | 500 |
| N1999 | 0 | 1 | 5.04 | 0 | BAL | 1.16 | 0.74 | 6 | 0 | 0.76 | 0 | 0 | 0 | 4.82% | 7.35% | 0.71% | 600 |
| N2000 | 0 | 1.5 | 5.04 | 0 | BAL | 1.16 | 0.74 | 0 | 0 | 0.76 | 4 | 0 | 0 | 3.99% | 9.07% | 0.95% | 600 |
| N2001 | 0 | 1.5 | 5.04 | 0 | BAL | 1.16 | 0.74 | 2 | 0 | 0.76 | 0 | 0 | 0 | 5.11% | 7.49% | 1.44% | 250 |
| N2002 | 0 | 1.5 | 5.04 | 0 | BAL | 1.16 | 0.74 | 2 | 0 | 0.76 | 2 | 0 | 0 | 7.50% | 8.08% | 1.00% | 450 |
| N2003 | 0 | 1.5 | 5.04 | 0 | BAL | 1.16 | 0.74 | 2 | 0 | 0.76 | 4 | 0 | 0 | 0.00% | 10.90% | 0.71% | 600 |
| N2004 | 0 | 1.5 | 5.04 | 0 | BAL | 1.16 | 0.74 | 4 | 0 | 0.76 | 0 | 0 | 0 | 6.13% | 10.32% | 1.24% | 300 |
| N2005 | 0 | 1.5 | 5.04 | 0 | BAL | 1.16 | 0.74 | 4 | 0 | 0.76 | 2 | 0 | 0 | 3.96% | 9.77% | 0.84% | 500 |
| N2006 | 0 | 1.5 | 5.04 | 0 | BAL | 1.16 | 0.74 | 6 | 0 | 0.76 | 0 | 0 | 0 | 3.86% | 10.63% | 1.04% | 400 |
| N2007 | 0 | 1.5 | 5.04 | 0 | BAL | 1.16 | 0.74 | 8 | 0 | 0.76 | 0 | 0 | 0 | 3.20% | 10.78% | 0.84% | 450 |
| N2008 | 0 | 1.5 | 5.04 | 0 | BAL | 1.16 | 0.74 | 10 | 0 | 0.76 | 0 | 0 | 0 | 0.00% | 12.20% | 0.71% | 600 |
| N2009 | 0 | 2 | 5.04 | 0 | BAL | 1.16 | 0.74 | 0 | 0 | 0.76 | 4 | 0 | 0 | 9.60% | 9.69% | 1.33% | 400 |
| N2010 | 0 | 2 | 5.04 | 0 | BAL | 1.16 | 0.74 | 0 | 0 | 0.76 | 6 | 0 | 0 | 0.00% | 13.26% | 0.96% | 650 |
| N2011 | 0 | 2 | 5.04 | 0 | BAL | 1.16 | 0.74 | 2 | 0 | 0.76 | 2 | 0 | 0 | 7.22% | 11.22% | 1.48% | 300 |
| N2012 | 0 | 2 | 5.04 | 0 | BAL | 1.16 | 0.74 | 2 | 0 | 0.76 | 4 | 0 | 0 | 7.49% | 12.13% | 1.08% | 450 |
| N2013 | 0 | 2 | 5.04 | 0 | BAL | 1.16 | 0.74 | 4 | 0 | 0.76 | 2 | 0 | 0 | 2.52% | 13.04% | 1.25% | 300 |
| N2014 | 0 | 2 | 5.04 | 0 | BAL | 1.16 | 0.74 | 4 | 0 | 0.76 | 4 | 0 | 0 | 4.58% | 13.86% | 0.91% | 550 |
| N2015 | 0 | 2 | 5.04 | 0 | BAL | 1.16 | 0.74 | 6 | 0 | 0.76 | 0 | 0 | 0 | 2.04% | 15.68% | 1.50% | 250 |
| N2016 | 0 | 2 | 5.04 | 0 | BAL | 1.16 | 0.74 | 6 | 0 | 0.76 | 2 | 0 | 0 | 3.93% | 14.61% | 1.03% | 400 |
| N2017 | 0 | 2 | 5.04 | 0 | BAL | 1.16 | 0.74 | 8 | 0 | 0.76 | 0 | 0 | 0 | 0.55% | 15.91% | 1.29% | 300 |
| N2018 | 0 | 2 | 5.04 | 0 | BAL | 1.16 | 0.74 | 8 | 0 | 0.76 | 2 | 0 | 0 | 3.96% | 14.38% | 0.89% | 500 |
| N2019 | 0 | 2 | 5.04 | 0 | BAL | 1.16 | 0.74 | 10 | 0 | 0.76 | 0 | 0 | 0 | 3.33% | 15.39% | 1.08% | 400 |
| N2020 | 0 | 2.5 | 5.04 | 0 | BAL | 1.16 | 0.74 | 0 | 0 | 0.76 | 6 | 0 | 0 | 9.33% | 13.78% | 1.39% | 500 |
| N2021 | 0 | 2.5 | 5.04 | 0 | BAL | 1.16 | 0.74 | 0 | 0 | 0.76 | 8 | 0 | 0 | 4.51% | 17.26% | 0.98% | 600 |
| N2022 | 0 | 2.5 | 5.04 | 0 | BAL | 1.16 | 0.74 | 0 | 0 | 0.76 | 10 | 0 | 0 | 5.47% | 20.19% | 0.71% | 750 |
| N2023 | 0 | 2.5 | 5.04 | 0 | BAL | 1.16 | 0.74 | 2 | 0 | 0.76 | 6 | 0 | 0 | 7.02% | 16.30% | 1.15% | 500 |
| N2024 | 0 | 2.5 | 5.04 | 0 | BAL | 1.16 | 0.74 | 4 | 0 | 0.76 | 4 | 0 | 0 | 5.58% | 16.23% | 1.33% | 350 |
| N2025 | 0 | 2.5 | 5.04 | 0 | BAL | 1.16 | 0.74 | 4 | 0 | 0.76 | 6 | 0 | 0 | 4.53% | 17.82% | 0.95% | 550 |
| N2026 | 0 | 2.5 | 5.04 | 0 | BAL | 1.16 | 0.74 | 6 | 0 | 0.76 | 4 | 0 | 0 | 3.16% | 18.58% | 1.10% | 400 |
| N2027 | 0 | 2.5 | 5.04 | 0 | BAL | 1.16 | 0.74 | 6 | 0 | 0.76 | 6 | 0 | 0 | 0.00% | 19.27% | 0.76% | 600 |
| N2028 | 0 | 2.5 | 5.04 | 0 | BAL | 1.16 | 0.74 | 8 | 0 | 0.76 | 2 | 0 | 0 | 4.89% | 19.15% | 1.31% | 300 |
| N2029 | 0 | 2.5 | 5.04 | 0 | BAL | 1.16 | 0.74 | 8 | 0 | 0.76 | 4 | 0 | 0 | 4.42% | 18.29% | 0.92% | 500 |
| N2030 | 0 | 2.5 | 5.04 | 0 | BAL | 1.16 | 0.74 | 10 | 0 | 0.76 | 2 | 0 | 0 | 3.92% | 19.08% | 1.09% | 350 |
| N2031 | 0.2 | 2 | 0.5 | 0 | BAL | 0.75 | 0 | 0 | 0 | 0 | 3 | 0 | 4 | 9.33% | 6.93% | 1.50% | 365 |
| N2032 | 0.2 | 2 | 0.5 | 0 | BAL | 0.75 | 0 | 1 | 0 | 0 | 3 | 0 | 0 | 7.55% | 7.81% | 1.41% | 430 |
| N2033 | 0.2 | 2 | 0.5 | 0 | BAL | 0.75 | 0 | 1 | 0 | 0 | 3 | 0 | 2 | 8.21% | 7.92% | 1.40% | 425 |
| N2034 | 0.2 | 2 | 0.5 | 0 | BAL | 0.75 | 0 | 1 | 0 | 0 | 3 | 0 | 4 | 8.90% | 8.02% | 1.38% | 320 |
| N2035 | 0.2 | 2 | 0.5 | 0 | BAL | 0.75 | 0 | 1 | 0 | 0 | 3 | 0 | 6 | 9.60% | 8.13% | 1.37% | 195 |
| N2036 | 0.2 | 2 | 0.5 | 0 | BAL | 0.75 | 0 | 2 | 0 | 0 | 2 | 0 | 0 | 8.09% | 6.85% | 1.47% | 375 |
| N2037 | 0.2 | 2 | 0.5 | 0 | BAL | 0.75 | 0 | 2 | 0 | 0 | 2 | 0 | 2 | 8.70% | 6.99% | 1.46% | 370 |
| N2038 | 0.2 | 2 | 0.5 | 0 | BAL | 0.75 | 0 | 2 | 0 | 0 | 2 | 0 | 4 | 9.39% | 7.08% | 1.45% | 215 |
| N2039 | 0.2 | 2 | 0.5 | 0 | BAL | 0.75 | 0 | 2 | 0 | 0 | 3 | 0 | 0 | 7.00% | 8.99% | 1.29% | 485 |
| N2040 | 0.2 | 2 | 0.5 | 0 | BAL | 0.75 | 0 | 2 | 0 | 0 | 3 | 0 | 2 | 7.65% | 9.12% | 1.28% | 485 |
| N2041 | 0.2 | 2 | 0.5 | 0 | BAL | 0.75 | 0 | 2 | 0 | 0 | 3 | 0 | 4 | 8.33% | 9.24% | 1.26% | 280 |
| N2042 | 0.2 | 2 | 0.5 | 0 | BAL | 0.75 | 0 | 2 | 0 | 0 | 3 | 0 | 6 | 9.03% | 9.36% | 1.25% | 180 |
| N2043 | 0.2 | 2 | 0.5 | 0 | BAL | 0.75 | 0 | 2 | 0 | 0 | 3 | 0 | 8 | 9.75% | 9.49% | 1.23% | 145 |
| N2044 | 0.2 | 2 | 0.5 | 0 | BAL | 0.75 | 0 | 3 | 0 | 0 | 2 | 0 | 0 | 7.52% | 8.07% | 1.35% | 380 |
| N2045 | 0.2 | 2 | 0.5 | 0 | BAL | 0.75 | 0 | 3 | 0 | 0 | 2 | 0 | 2 | 7.88% | 8.38% | 1.35% | 325 |
| N2046 | 0.2 | 2 | 0.5 | 0 | BAL | 0.75 | 0 | 3 | 0 | 0 | 2 | 0 | 4 | 8.57% | 8.50% | 1.34% | 205 |
| N2047 | 0.2 | 2 | 0.5 | 0 | BAL | 0.75 | 0 | 3 | 0 | 0 | 2 | 0 | 6 | 9.28% | 8.61% | 1.33% | 165 |
| N2048 | 0.2 | 2 | 0.5 | 0 | BAL | 0.75 | 0 | 3 | 0 | 0 | 3 | 0 | 0 | 6.45% | 10.19% | 1.17% | 495 |
| N2049 | 0.2 | 2 | 0.5 | 0 | BAL | 0.75 | 0 | 3 | 0 | 0 | 3 | 0 | 2 | 6.92% | 10.45% | 1.16% | 440 |
| N2050 | 0.2 | 2 | 0.5 | 0 | BAL | 0.75 | 0 | 3 | 0 | 0 | 3 | 0 | 4 | 7.59% | 10.59% | 1.14% | 225 |
| N2051 | 0.2 | 2 | 0.5 | 0 | BAL | 0.75 | 0 | 3 | 0 | 0 | 3 | 0 | 6 | 8.28% | 10.73% | 1.14% | 170 |
| N2052 | 0.2 | 2 | 0.5 | 0 | BAL | 0.75 | 0 | 3 | 0 | 0 | 3 | 0 | 8 | 8.99% | 10.88% | 1.12% | 135 |
| N2053 | 0.2 | 2 | 0.5 | 0 | BAL | 0.75 | 0 | 3 | 0 | 0 | 3 | 0 | 10 | 9.72% | 11.03% | 1.11% | 115 |
| N2054 | 0.2 | 2 | 0.5 | 0 | BAL | 0.75 | 0 | 4 | 0 | 0 | 1 | 0 | 0 | 7.90% | 7.44% | 1.44% | 285 |
| N2055 | 0.2 | 2 | 0.5 | 0 | BAL | 0.75 | 0 | 4 | 0 | 0 | 1 | 0 | 2 | 8.04% | 7.71% | 1.44% | 250 |
| N2056 | 0.2 | 2 | 0.5 | 0 | BAL | 0.75 | 0 | 4 | 0 | 0 | 1 | 0 | 4 | 8.73% | 7.81% | 1.43% | 195 |
| N2057 | 0.2 | 2 | 0.5 | 0 | BAL | 0.75 | 0 | 4 | 0 | 0 | 1 | 0 | 6 | 9.44% | 7.92% | 1.43% | 165 |
| N2058 | 0.2 | 2 | 0.5 | 0 | BAL | 0.75 | 0 | 4 | 0 | 0 | 2 | 0 | 0 | 6.91% | 9.39% | 1.25% | 390 |
| N2059 | 0.2 | 2 | 0.5 | 0 | BAL | 0.75 | 0 | 4 | 0 | 0 | 2 | 0 | 2 | 7.12% | 9.74% | 1.24% | 265 |
| N2060 | 0.2 | 2 | 0.5 | 0 | BAL | 0.75 | 0 | 4 | 0 | 0 | 2 | 0 | 4 | 7.80% | 9.87% | 1.23% | 190 |
| N2061 | 0.2 | 2 | 0.5 | 0 | BAL | 0.75 | 0 | 4 | 0 | 0 | 2 | 0 | 6 | 8.50% | 10.01% | 1.22% | 155 |
| N2062 | 0.2 | 2 | 0.5 | 0 | BAL | 0.75 | 0 | 4 | 0 | 0 | 2 | 0 | 8 | 9.21% | 10.14% | 1.21% | 135 |
| N2063 | 0.2 | 2 | 0.5 | 0 | BAL | 0.75 | 0 | 4 | 0 | 0 | 2 | 0 | 10 | 9.95% | 10.28% | 1.20% | 120 |
| N2064 | 0.2 | 2 | 0.5 | 0 | BAL | 0.75 | 0 | 4 | 0 | 0 | 3 | 0 | 0 | 5.87% | 11.42% | 1.05% | 550 |
| N2065 | 0.2 | 2 | 0.5 | 0 | BAL | 0.75 | 0 | 4 | 0 | 0 | 3 | 0 | 2 | 6.17% | 11.79% | 1.04% | 395 |
| N2066 | 0.2 | 2 | 0.5 | 0 | BAL | 0.75 | 0 | 4 | 0 | 0 | 3 | 0 | 4 | 6.84% | 11.95% | 1.04% | 245 |
| N2067 | 0.2 | 2 | 0.5 | 0 | BAL | 0.75 | 0 | 4 | 0 | 0 | 3 | 0 | 6 | 7.52% | 12.11% | 1.03% | 160 |
| N2068 | 0.2 | 2 | 0.5 | 0 | BAL | 0.75 | 0 | 4 | 0 | 0 | 3 | 0 | 8 | 8.22% | 12.28% | 1.01% | 125 |
| N2069 | 0.2 | 2 | 0.5 | 0 | BAL | 0.75 | 0 | 4 | 0 | 0 | 3 | 0 | 10 | 8.94% | 12.45% | 1.00% | 110 |
| N2070 | 0.2 | 2 | 0.5 | 0 | BAL | 0.75 | 0 | 5 | 0 | 0 | 1 | 0 | 0 | 7.32% | 8.69% | 1.34% | 280 |
| N2071 | 0.2 | 2 | 0.5 | 0 | BAL | 0.75 | 0 | 5 | 0 | 0 | 1 | 0 | 2 | 7.44% | 8.93% | 1.33% | 240 |
| N2072 | 0.2 | 2 | 0.5 | 0 | BAL | 0.75 | 0 | 5 | 0 | 0 | 1 | 0 | 4 | 8.13% | 9.05% | 1.33% | 185 |
| N2073 | 0.2 | 2 | 0.5 | 0 | BAL | 0.75 | 0 | 5 | 0 | 0 | 1 | 0 | 6 | 8.83% | 9.18% | 1.32% | 155 |
| N2074 | 0.2 | 2 | 0.5 | 0 | BAL | 0.75 | 0 | 5 | 0 | 0 | 1 | 0 | 8 | 9.56% | 9.30% | 1.32% | 135 |
| N2075 | 0.2 | 2 | 0.5 | 0 | BAL | 0.75 | 0 | 5 | 0 | 0 | 2 | 0 | 0 | 6.30% | 10.68% | 1.14% | 395 |
| N2076 | 0.2 | 2 | 0.5 | 0 | BAL | 0.75 | 0 | 5 | 0 | 0 | 2 | 0 | 2 | 6.44% | 11.04% | 1.13% | 245 |
| N2077 | 0.2 | 2 | 0.5 | 0 | BAL | 0.75 | 0 | 5 | 0 | 0 | 2 | 0 | 4 | 7.11% | 11.18% | 1.12% | 180 |
| N2078 | 0.2 | 2 | 0.5 | 0 | BAL | 0.75 | 0 | 5 | 0 | 0 | 2 | 0 | 6 | 7.80% | 11.34% | 1.11% | 145 |
| N2079 | 0.2 | 2 | 0.5 | 0 | BAL | 0.75 | 0 | 5 | 0 | 0 | 2 | 0 | 8 | 8.51% | 11.49% | 1.11% | 130 |
| N2080 | 0.2 | 2 | 0.5 | 0 | BAL | 0.75 | 0 | 5 | 0 | 0 | 2 | 0 | 10 | 9.24% | 11.65% | 1.10% | 115 |
| N2081 | 0.2 | 2 | 0.5 | 0 | BAL | 0.75 | 0 | 5 | 0 | 0 | 3 | 0 | 0 | 5.27% | 12.71% | 0.94% | 555 |
| N2082 | 0.2 | 2 | 0.5 | 0 | BAL | 0.75 | 0 | 5 | 0 | 0 | 3 | 0 | 2 | 5.46% | 13.12% | 0.94% | 355 |
| N2083 | 0.2 | 2 | 0.5 | 0 | BAL | 0.75 | 0 | 5 | 0 | 0 | 3 | 0 | 4 | 6.12% | 13.29% | 0.93% | 190 |
| N2084 | 0.2 | 2 | 0.5 | 0 | BAL | 0.75 | 0 | 5 | 0 | 0 | 3 | 0 | 6 | 6.80% | 13.47% | 0.92% | 145 |
| N2085 | 0.2 | 2 | 0.5 | 0 | BAL | 0.75 | 0 | 5 | 0 | 0 | 3 | 0 | 8 | 7.49% | 13.66% | 0.91% | 120 |
| N2086 | 0.2 | 2 | 0.5 | 0 | BAL | 0.75 | 0 | 5 | 0 | 0 | 3 | 0 | 10 | 7.75% | 13.98% | 0.90% | 100 |

N559 0.5 1.25 2.5 0 BAL 0 1 4.5 0 0.5 0 0.5 0 7.49% 10.31% 0.94% 200 N560 0.5 1.25 3 0 BAL 0 1 2.5 0 0.5 0.5 0.5 0 8.87% 7.34% 1.02% 200 N561 0.5 1.25 3 0 BAL 0 1 2.5 0 0.5 1 0.5 0 9.67% 7.00% 0.92% 200 N562 0.5 1.25 3 0 BAL 0 1 3 0 0.5 0 0.5 0 7.05% 8.02% 1.09% 200 N563 0.5 1.25 3 0 BAL 0 1 3 0 0.5 1 0.5 0 8.33% 7.74% 0.87% 200 N564 0.5 1.25 3 0 BAL 0 1 3 0 0.5 1.5 0.5 0 8.32% 8.70% 0.78% 200 N565 0.5 1.25 3 0 BAL 0 1 3.5 0 0.5 0 0.5 0 7.07% 9.16% 1.04% 150 N566 0.5 1.25 3 0 BAL 0 1 3.5 0 0.5 1.5 0.5 0 8.34% 9.47% 0.72% 200 N567 0.5 1.25 3 0 BAL 0 1 4 0 0.5 0 0.5 0 5.70% 10.30% 0.99% 150 N568 0.5 1.25 3 0.5 0 BAL 0 1 2.5 0 0.5 0.5 0.5 0 7.03% 8.14% 1.02% 150 N569 0.5 1.25 3 0.5 0 BAL 0 1 2.5 0 0.5 1.5 0.5 0 7.39% 10.25% 0.83% 200 N570 0.5 1.25 3 0.5 0 BAL 0 1 2.5 0 0.5 2 0.5 0 8.26% 9.74% 0.75% 250 N571 0.5 1.25 3 0.5 0 BAL 0 1 3 0 0.5 0 0.5 0 8.56% 8.02% 1.08% 150 N572 0.5 1.25 3 0.5 0 BAL 0 1 3 0 0.5 0.5 0.5 0 8.33% 7.51% 0.97% 150 N573 0.5 1.25 3 0.5 0 BAL 0 1 3 0 0.5 1.5 0.5 0 8.32% 9.60% 0.78% 200 N574 0.5 1.25 3 0.5 0 BAL 0 1 3 0 0.5 2 0.5 0 8.21% 9.70% 0.70% 250 N575 0.5 1.25 3 0.5 0 BAL 0 1 3.5 0 0.5 0 0.5 0 8.01% 9.16% 1.04% 150 N576 0.5 1.25 3 0.5 0 BAL 0 1 3.5 0 0.5 1.5 0.5 0 8.28% 9.80% 0.73% 150 N577 0.5 1.25 3 0.5 0 BAL 0 1 4 0 0.5 0 0.5 0 8.76% 9.01% 0.99% 150 N578 0.5 1.25 3 0.5 0 BAL 0 1 4 0 0.5 1 0.5 0 7.07% 11.05% 0.77% 150 N579 0.5 1.25 3 0.5 0 BAL 0 1 4.5 0 0.5 0 0.5 0 7.09% 11.09% 0.94% 150 N580 0.5 1.25 3 0.5 0 BAL 0 1 4.5 0 0.5 1 0.5 0 5.70% 11.08% 0.72% 150 N581 0.5 1.25 3 0.5 0 BAL 0 1 5 0 0.5 0.5 0.5 0 5.72% 11.11% 0.78% 150 N582 0.5 1.25 3 0.5 0 BAL 0 1 5.5 0 0.5 0.5 0.5 0 8.30% 9.96% 0.73% 150 N583 0.5 1.25 4 0 BAL 0 1 2.5 0 0.5 1 0.5 0 8.75% 8.83% 0.92% 150 N584 0.5 1.25 4 0 BAL 0 1 2.5 0 0.5 2 0.5 0 9.53% 8.73% 0.75% 250 N585 0.5 1.25 4 0 BAL 0 1 3 0 0.5 0.5 0.5 0 8.33% 8.41% 0.97% 150 N586 0.5 1.25 4 0 BAL 0 1 3 0 0.5 1 0.5 0 8.45% 9.47% 0.87% 150 N587 0.5 1.25 4 0 BAL 0 1 3 0 0.5 1.5 0.5 0 8.23% 9.53% 0.78% 150 N588 0.5 1.25 4 0 BAL 0 1 3.5 0 0.5 0.5 0.5 0 7.06% 10.35% 0.92% 150 N589 0.5 1.25 4 0 BAL 0 1 3.5 0 0.5 1 0.5 0 8.30% 9.79% 0.82% 150 N590 0.5 1.25 4 0 BAL 0 1 4 0 0.5 0 0.5 0 8.76% 9.00% 1.00% 150 N591 0.5 1.25 4 0 BAL 0 1 4 0 0.5 0.5 0.5 0 8.39% 9.71% 0.87% 150 N592 0.5 1.25 4 0 BAL 0 1 4 0 0.5 1 0.5 0 6.86% 9.89% 0.77% 150 N593 0.5 1.25 4 0 BAL 0 1 4.5 0 0.5 0 0.5 0 8.38% 9.80% 0.95% 150 N594 0.5 1.25 4 0 BAL 0 1 4.5 0 0.5 0.5 0.5 0 8.31% 9.86% 0.83% 150 N595 0.5 1.25 4 0 BAL 0 1 4.5 0 0.5 1 0.5 0 8.56% 9.77% 0.72% 150 N596 0.5 1.25 4 0 BAL 0 1 5 0 0.5 0 0.5 0 8.38% 9.84% 0.90% 150 N597 0.5 1.25 4 0 BAL 0 1 5 0 0.5 0.5 0.5 0 8.26% 9.97% 0.78% 100 N598 0.5 1.25 4 0 BAL 0 1 5.5 0 0.5 0 0.5 0 8.32% 9.94% 0.85% 150 N599 0.5 1.25 4 0 BAL 0 1 5.5 0 0.5 0.5 0.5 0 8.32% 10.05% 0.73% 100 N600 0.5 1.25 4.5 0 BAL 0 1 2.5 0 0.5 0.5 0.5 0 7.53% 9.99% 1.02% 150 N601 0.5 1.25 4.5 0 BAL 0 1 3 0 0.5 0.5 0.5 0 7.04% 10.63% 0.97% 150 N602 0.5 1.25 4.5 0 BAL 0 1 3 0 0.5 1 0.5 0 7.33% 9.44% 0.87% 150 N603 0.5 1.25 4.5 0 BAL 0 1 3 0 0.5 1.5 0.5 0 8.77% 8.62% 0.78% 150 N604 0.5 1.25 4.5 0 BAL 0 1 3.5 0 0.5 0.5 0.5 0 8.31% 9.78% 0.92% 150 N605 0.5 1.25 4.5 0 BAL 0 1 3.5 0 0.5 1 0.5 0 7.79% 9.12% 0.82% 150 N606 0.5 1.25 4.5 0 BAL 0 1 3.5 0 0.5 1 0.5 0.5 0 9.87% 8.88% 0.73% 150 N607 0.5 1.25 4.5 0 BAL 0 1 4 0 0.5 0.5 0.5 0 8.26% 9.88% 0.87% 150 N608 0.5 1.25 4.5 0 BAL 0 1 4.5 0 0.5 0 0.5 0 8.33% 9.85% 0.95% 150 N609 0.5 1.25 4.5 0 BAL 0 1 4.5 0 0.5 1 0.5 0 8.37% 10.53% 0.72% 100 N610 0.5 1.25 4.5 0 BAL 0 1 5 0 0.5 0 0.5 0 8.28% 9.96% 0.90% 150 N611 0.5 1.25 4.5 0 BAL 0 1 5 0 0.5 0.5 0.5 0 8.88% 9.77% 0.78% 100

### Microstructural Criteria: Toughness and Crack Resistance

In some embodiments, the alloy can be described by microstructural features which can result in the desired performance of the alloy. For example, an alloy can be said to meet the microstructural criteria when it possess a minimum volume fraction of primary carbides and a maximum volume fraction of grain boundary carbides. Both carbides are beneficial towards the wear resistance and hardness of the material. However, the grain boundary carbides are detrimental to the toughness and crack resistance of the material and thus should be minimized Grain boundary carbides, which are identified via microscopy, are typically the same as secondary carbides which are defined according to thermodynamic modeling.

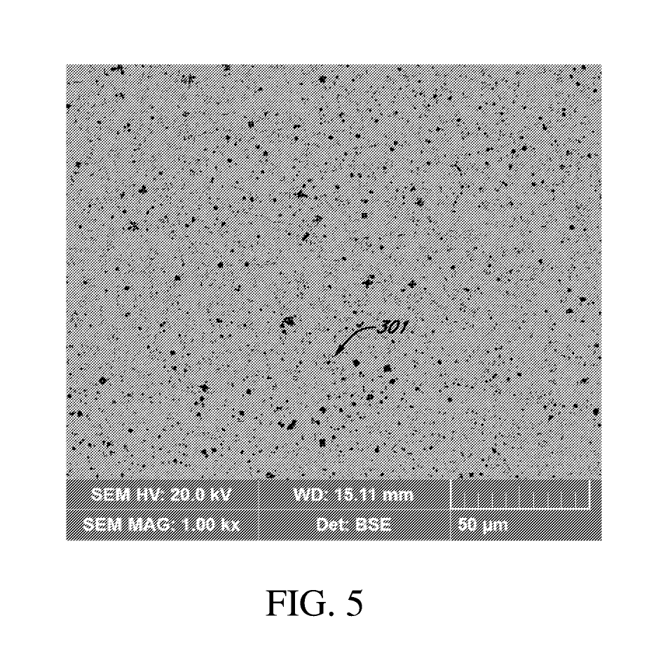

In some embodiments, the microstructure can possess a minimum primary carbide volume fraction of 2% (or about 2%) and a maximum grain boundary carbide fraction of 10% (or about 10%). In some embodiments, the microstructure can possess a minimum primary carbide volume fraction of 5% (or about 5%) and a maximum grain boundary carbide fraction of 5% (or about 5%). In a still preferred embodiment, the microstructure possesses a minimum primary carbide volume fraction of 8% (or about 8%) and a maximum grain boundary carbide fraction of 2% (or about 2%). FIG. 5 shows an SEM micrograph of an Alloy 7 weld bead. The microstructural phase fraction was evaluated using image analysis techniques and the primary carbide fraction was measured at 6% (or about 6%) and the grain boundary phase fraction was measured at 0% (or about 0%). In the case of Alloy 7, titanium carbide is the primary carbide as identified by the darker regions of the SEM micrograph [301]. Another weld trial using the material manufactured for example 3, resulted in a 3% (or about 3%) measured primary carbide fraction (0% (or about 0%) grain boundary carbides).

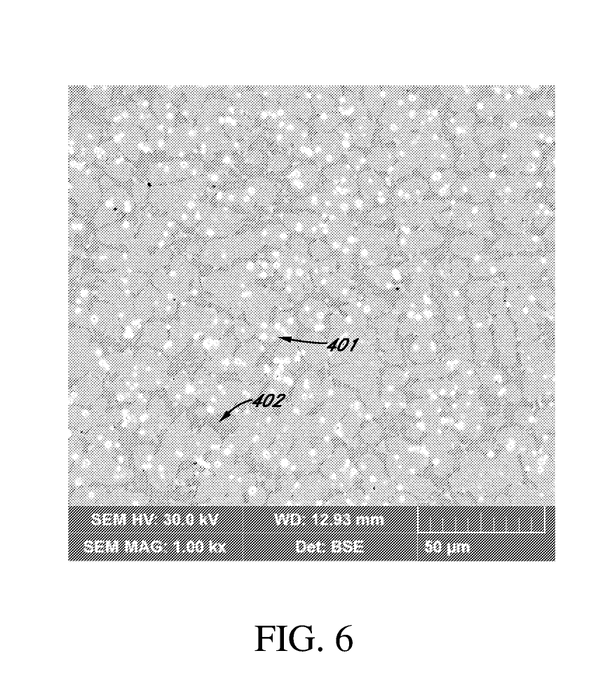

In contrast, an SEM micrograph of a conventional hardfacing material is shown in FIG. 6. As shown a significant volume fraction of grain boundary carbides [402] exists in addition to the primary carbides [401].

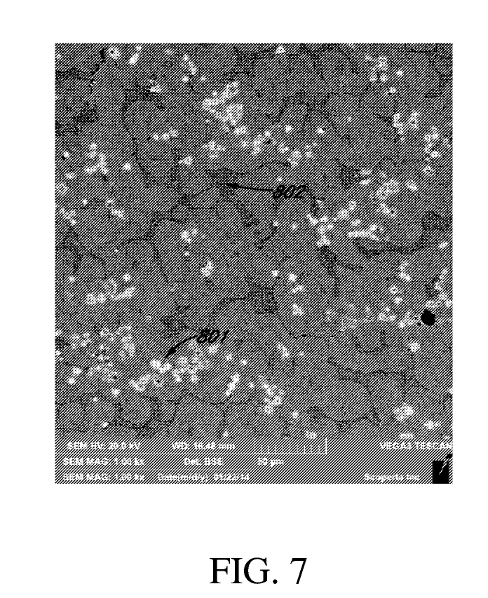

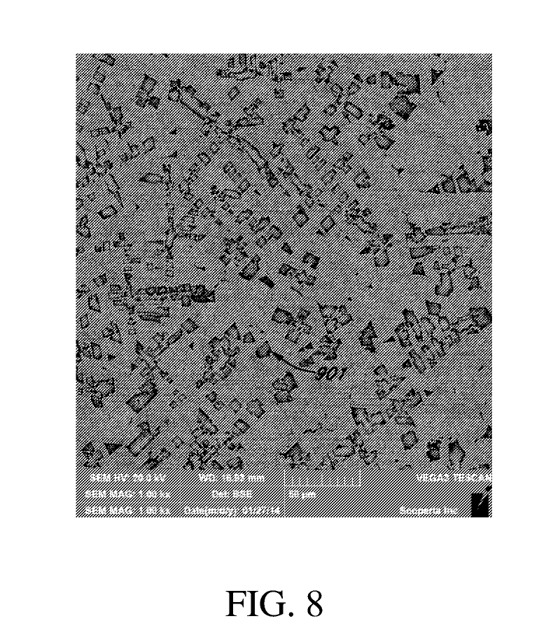

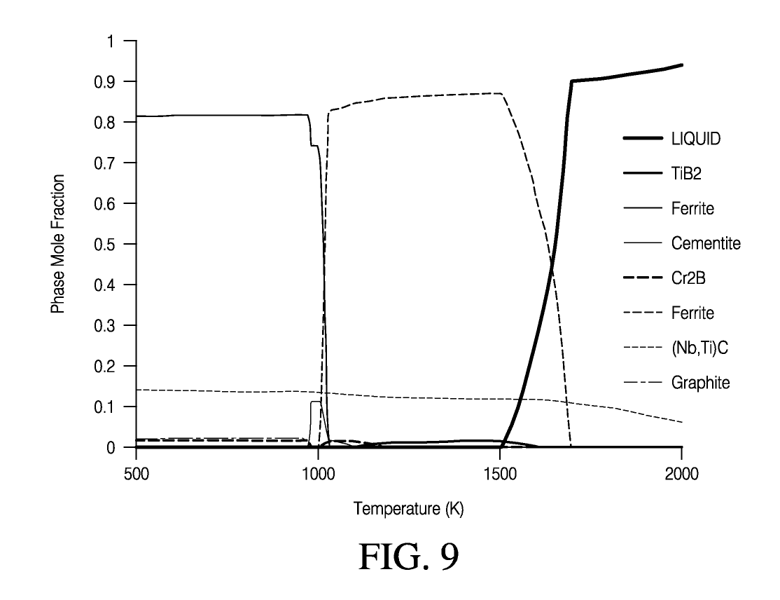

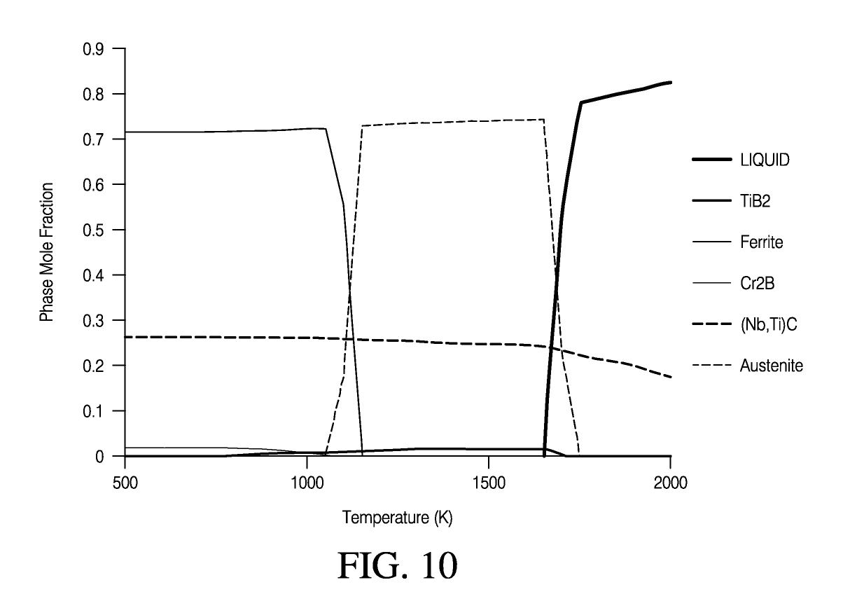

By utilizing the thermodynamic criteria appropriately, it is possible to design alloys possessing a certain primary carbide phase fraction. The ideal primary carbide phase fraction content can vary depending on application. In some embodiments, the primary carbide phase fraction can be between 1-5 (or between about 1 to about 5) volume %. An example of this alloy is shown in FIG. 5. In some embodiments, the primary carbide phase fraction can be between 5-15 (or between about 5 to about 15) volume %. An example of this alloy is shown in FIG. 7. As shown in FIG. 7, alloy P21-X30 contains primary carbides [801] and a grain boundary phase [802], which is not a carbide as identified via scanning electron microscopy. In some embodiments, the primary carbide phase fraction can be between 15-25 (or between about 15 to about 25) volume %. An example of this alloy is shown in FIG. 8. As shown in FIG. 8, alloy P21-X33 contains primary carbides [901]. In some embodiments, the primary carbide phase fraction can be above 25 (or above about 25) volume %. In some embodiments, the grain boundary carbide phase fraction can be minimized. In some embodiments, the grain boundary carbide phase fraction can be below 10 (or below about 10) volume %. In some embodiments, the grain boundary carbide phase fraction can be below 5 (or below about 5) volume %. In some embodiments, the grain boundary carbide phase fraction can be below 3 (or below about 3) volume %. FIGS. 9 and 10 show phase evolution diagrams of P21-X30 and P21-X33, respectively.

Primary carbides can be defined as hard metal-carbide or metal-boride type phases which solidify prior to the formation of austenite in a cooling Fe-based weld. Generally, it can be advantageous for the primary carbides to possess a small grain size. In some embodiments, the primary carbide grain size can be below 50 μm (or below about 50 μm). In some embodiments, the primary carbide grain size can be below 25 μm (or below about 25 μm). In some embodiments, the primary carbide grain size can be below 10 μm (or below about 10 μm). The alloy shown in the micrograph in FIG. 8 possess a primary carbide grain size on the order of 10 μm (or about 10 μm).

Any metallic element is capable of forming a primary carbide including, but not limited to, Mg, Al, Ca, Sc, Ti, V, Cr, Mn, Fe, Co, Ni, Cu, Zn, Y, Zr, Nb, Mo, Ag, Ta, or W. Some embodiments may possess one or more of the following the primary carbides: chromium boride, chromium carbide, titanium boride, titanium carbide, niobium carbide, niobium-titanium carbide, niobium boride, tungsten carbide, or tungsten boride. Alloy 7 possesses titanium carbide particles as shown in FIG. 5. P210X30 possesses titanium boride and niobium carbide particles as shown in FIG. 7. P21X31 possesses (Nb,Ti) carbide particles as shown in FIG. 8. The alloys shown in Table 3 were produced in the form of experimental ingots and/or welding wires and evaluated. The thermodynamic, microstructural, and performance characteristics of these alloys are shown in Table 4.

TABLE 3
Alloys Produced as Experimental Ingots and/or Welding Wire

| Alloy | | | | | | | | | | |
|---|---|---|---|---|---|---|---|---|---|---|
| # | B | C | Cr | Mn | Mo | Nb | Si | Ti | V | W |
| 7 | 0 | 1 | 5 | 1.1 | 0.75 | 0 | 0.77 | 3 | 0 | 0 |
| 7* | 0 | 1.2 | 6 | 1 | 0.85 | 0 | 0.9 | 3 | 0 | 0.85 |
| 8 | 1.1 | 0.65 | 0.5 | 0.7 | 1 | 3.5 | 0.5 | 2.5 | 0.5 | 0 |
| 9 | 1.1 | 0.65 | 1.5 | 0.7 | 1 | 2.5 | 0.5 | 2.5 | 0.5 | 0 |
| 10 | 1.1 | 0.65 | 3 | 0.7 | 1 | 2.5 | 0.5 | 2 | 0.5 | 0 |
| 11 | 1.1 | 0.65 | 3 | 0.7 | 0.35 | 2.5 | 0.5 | 2 | 0.07 | 0 |
| 12 | 0.8 | 0.95 | 1 | 0.7 | 1 | 3.5 | 0.5 | 2.5 | 0.5 | 0 |
| 13 | 0.8 | 0.95 | 0.5 | 0.7 | 1 | 3 | 0.5 | 2.5 | 0.5 | 0 |
| 14 | 0.8 | 0.95 | 0.5 | 0.7 | 1 | 4 | 0.5 | 2 | 0.5 | 0 |
| 15 | 0.8 | 0.95 | 2 | 0.7 | 1 | 3 | 0.5 | 2.5 | 0.5 | 0 |
| 16 | 0.8 | 0.95 | 0.5 | 1 | 1 | 1 | 0.5 | 2 | 0.5 | 0 |
| 17 | 0.8 | 0.95 | 0.5 | 1 | 1 | 1.5 | 0.5 | 1 | 0.5 | 0 |
| 18 | 0.2 | 1.5 | 0.5 | 0.78 | 0.68 | 2.67 | 0.44 | 0.45 | 0.36 | 0 |
| 19 | 0.2 | 2.3 | 0.5 | 0.75 | 0.7 | 5 | 0.44 | 3 | 0.36 | 0 |
| 20 | 0.2 | 2.1 | 0.5 | 0.75 | 0.7 | 5 | 0.44 | 3 | 0.36 | 0 |
| 21 | 0.2 | 1.8 | 0.5 | 0.75 | 0.7 | 5 | 0.44 | 3 | 0.36 | 0 |
| 22 | 0.2 | 1.6 | 0.5 | 0.75 | 0.7 | 5 | 0.44 | 3 | 0.36 | 0 |
| 23 | 0.2 | 3 | 0.5 | 0.75 | 0.7 | 8 | 0.44 | 8 | 0.36 | 0 |
| 24 | 0.2 | 2.4 | 0.5 | 0.75 | 0.7 | 8 | 0.44 | 8 | 0.36 | 0 |
| 25 | 0.2 | 1.8 | 0.5 | 0.75 | 0.7 | 6 | 0.44 | 7 | 0.36 | 0 |
| 26 | 0.2 | 3 | 0.5 | 0.75 | 0.7 | 5 | 0.44 | 8 | 0.36 | 0 |
| 27 | 1.5 | 3 | 0.5 | 0.75 | 0.7 | 9 | 0.44 | 9 | 0.36 | 0 |
| 28 | 1.5 | 4 | 0.5 | 0.75 | 0.7 | 12 | 0.44 | 11 | 0.36 | 0 |
| 29 | 2 | 4 | 0.5 | 0.75 | 0.7 | 12 | 0.44 | 12 | 0.36 | 0 |
| 30 | 0.2 | 3 | 6 | 0.75 | 0 | 5 | 0.44 | 8 | 0 | 0 |
| 31 | 0.2 | 3 | 0 | 0.75 | 0 | 5 | 0.44 | 8 | 10 | 0 |
| 32 | 0.2 | 3 | 0 | 0.75 | 8 | 5 | 0.44 | 8 | 0 | 0 |
| 33 | 0.2 | 3 | 0 | 0.75 | 8 | 5 | 0.44 | 8 | 0 | 0 |
| 34 | 0.2 | 3.25 | 0 | 0.75 | 0 | 5 | 0.44 | 8 | 0 | 13 |
| 34 | 0.2 | 2 | 0.5 | 0.75 | 0 | 0 | 0 | 3 | 0 | 4 |
| 35 | 0.2 | 2 | 0.5 | 0.75 | 0 | 2 | 0 | 3 | 0 | 8 |
| 36 | 0.2 | 2 | 0.5 | 0.75 | 0 | 3 | 0 | 3 | 0 | 2 |
| 37 | 0.2 | 2 | 0.5 | 0.75 | 0 | 5 | 0 | 2 | 0 | 6 |
| 38 | 0.2 | 2 | 0.5 | 0.75 | 0 | 5 | 0 | 3 | 0 | 6 |
| 39 | 0.2 | 1.7 | 0.5 | 0.75 | 0 | 5 | 0 | 2 | 0 | 0 |
| 40 | 0.2 | 2 | 0.5 | 0.75 | 0 | 5 | 0 | 2 | 0 | 0 |
| 41 | 0.2 | 1.7 | 0.5 | 0.75 | 0 | 3 | 0 | 3 | 0 | 0 |
| 42 | 0.2 | 2 | 0.5 | 0.75 | 0 | 3 | 0 | 3 | 0 | 0 |
| 43 | 0 | 1.1 | 5.04 | 1.16 | 0.74 | 4 | 0.76 | 0 | 0 | 0 |
| 44 | 0 | 1.3 | 5.04 | 1.16 | 0.74 | 4 | 0.76 | 0 | 0 | 0 |
| 45 | 0 | 1.5 | 5.04 | 1.16 | 0.74 | 4 | 0.76 | 0 | 0 | 0 |

### Performance Criteria: Toughness and Crack Resistance

In some embodiments, the alloy can be described by a set of performance criteria. For example, an alloy can be said to meet the performance criteria when it possesses a minimum hardness or wear resistance and exhibits a minimum level of toughness or crack resistance. Hardness and toughness are typically inversely proportional, very hard materials tend to possess low toughness, and very tough materials tend to exhibit low hardness. In the field of hardbanding, which resides in the high hardness spectrum of materials, it is generally very difficult to produce materials which are simultaneously hard and resist cracking under certain deposition conditions. Embodiments of the alloys presented in this disclosure are likely to form high hardness, high toughness materials due to the thermodynamic and microstructural characteristics defined in this disclosure.

The first performance criterion of this disclosure is related to the hardness and/or wear resistance of the material. In the hardfacing industry, Rockwell C hardness and ASTM G65 dry sand wear testing can be used to measure the performance of coating solutions. In some embodiments, the alloy can possess a minimum Rockwell C hardness of 50 (or about 50). In some embodiments, the alloy can possess a minimum Rockwell C hardness of 55 (or about 55). In some embodiments, the alloy can possess a minimum Rockwell C hardness of 60 (or about 60). In some embodiments, the alloy can exhibit a material loss of less than 0.6 g (or less than about 0.6 g) under ASTM G65 Procedure A testing. In some embodiments, the alloy can exhibit a material loss of less than 0.4 g (or less than about 0.4 g) under ASTM G65 Procedure A testing. In some embodiments, the alloy can exhibit a material loss of less than 0.2 g (or less than about 0.2 g) under ASTM G65 Procedure A testing. In the case of Alloy 7, the weld bead exhibited 0.25 g lost when subject to ASTM G65 testing. The weld is 59-60 HRC.

The second criterion of this invention is related to the toughness and/or crack resistance of the material. A relevant measure of a hardfacing material's resistance to cracking is to weld the material under conditions where the cracking is increasingly likely. Cracks can then be identified by using a conventional method, such as the dye penetrant or magnetic particle inspection, to determine the alloy's level of crack resistance. For example, hardbanding is typically done on 6⅝″ steel pipes pre-heated to 500° F., which shall be referred to as process #1. Many conventional hardfacing materials do not crack under this condition as the pre-heat lowers the process cooling rate and limits the thermal stress on the weld. Hardbanding on a steel pipe which is pre-heated to 300° F. and contains an internal reservoir of cooling water is a more crack prone process, which shall be referred to as process #2. However, this technique is commonly used in the industry to protect the interior plastic lining and is thus relevant to hardfacing. Most hardfacing materials crack when welded under process #2. Furthermore, as additional weld beads are deposited next to or on top of existing bands, cracking becomes increasingly likely.

In some embodiments, the disclosed material does not exhibit any cracking when welded under process #2. In some embodiments, the disclosed material does not exhibit any cracking when welded under process #2 as three neighboring and overlapping bands. In some embodiments, the material does not exhibit any cracking when welded under process #2 as three neighboring and overlapping bands which are then double layer welded.

Hardfacing is also commonly done on flat plates. Most hardfacing materials crack when welded onto flat plate. Similar to hardfacing on pipe, weld beads are commonly overlapped over each other to form a single continuous layer on the surface of a steel plate. A single or multiple layers of weld material may be deposited to form a wear resistant coating. In process example #3, an 8″×8″×½″ thick steel plate is coated with two layers of hardfacing material. Before welding each subsequent deposit, the plate is allowed to cool to at least below 250 F before initiating an additional weld bead. Common hardfacing weld overlays crack in this type of process.

### EXAMPLES

The following illustrative examples are intended to be non-limiting.

### Example 1

Alloy 7 was produced in the form of a 1/16″ metal core wire intended for use in the MIG welding process. The precise chemistry of the wire was measured via optical emission spectroscopy and a LECO carbon analyzer and was determined to be (in weight percent):
Fe: balance, Al: 0.56, C: 1.23, Cr: 6.05, Cu: 0.17, Mn: 1.02, Mo: 0.85, Ni: 0.25, Si: 0.90, Ti: 2.85, W: 0.85

Alloy 7 was welded onto a 6⅝″ maximum outer diameter box tool joint. The following weld parameters were used to deposit the material:

Stick Out: 1¼″

Wire Feed: 300 in/min

Drag/Push Angle: 12-17°

Power Supply: Deltaweld 452

Voltage: 27.5

Amperage: 270-300

Oscillation. Cycle/Min: 55

Rotation: 2 Min 20 Sec

Traverse/Step: 1⅛″

Overlap: ⅛″

Weld Thickness: 3 4/32″

IP Temperature ° F.: 400

Furthermore, in this test a constant stream of cool water was run through the interior of the tool joint. Three consecutive overlapping bands were deposited on the tool joint in a method common to many hardbanding applications. At the end of the weld process and after the tool joint had cooled to room temperature, the 7 alloy was verified as crack free using the dye penetrant test. The hardness of the weld was 60 HRC.

### Example 2

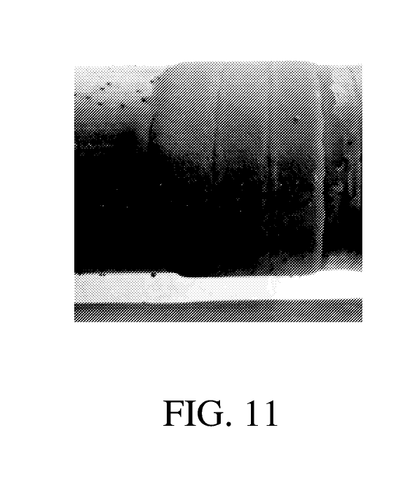

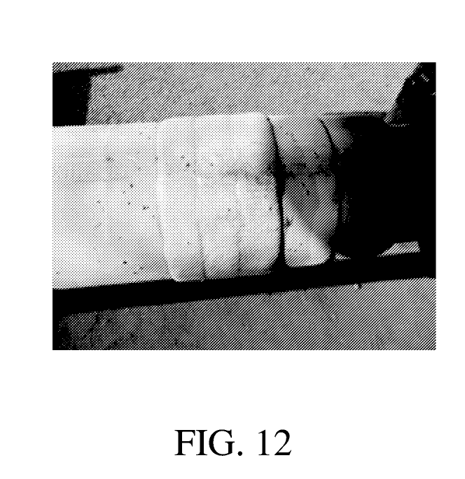

A similar form of Alloy 7 as used in example 1 was used in a welding trial on full length drill pipe with attached tool joints. Similar welding parameters were used to deposit the material. However, in this case the interior of the pipe was filled with a reservoir of water and each end of the pipe was capped off. Thus, as opposed to a constant flow of water a constant volume of cooling water remained in the pipe. At the end of the weld process and after the drill pipe/tool joint assembly had cooled, the 7 alloy was verified as crack free via magnetic particle inspection. FIG. 11 shows a photograph of the deposited hardband. FIG. 12 shows the hardband during magnetic particle inspection indicating a crack free overlay.

### Example 3

Alloy 7 was produced in the form of a 1/16″ metal core wire intended for use in the MIG welding process in a second manufacturing run. The alloy met the performance and microstructural criteria outlined in this disclosure. The hardness of a weld specimen was 59 HRC. The precise chemistry of the wire was measured via optical emission spectroscopy and a LECO carbon analyzer and was determined to be (in weight percent):
Fe: balance, Al: 0.36, C: 1.38, Cr: 6.80, Cu: 0.17, Mn: 1.31, Mo: 0.97, Ni: 0.14, Si: 0.99, Ti: 3.37

### Example 4

Alloy 7 was produced in the form of a 1/16: welding wire and deposited onto a steel plate according to Process #3. Two layers were deposited to form a total hardfacing coating thickness of 8-10 mm. The hardness of the resultant weld specimen was 59-60 HRC and no cracks were present in the weld.

Stick Out: ⅞″

Wire Feed: 300 in/min

Drag/Push Angle: 12-17°

Power Supply: Deltaweld 452

Voltage: 27

Amperage: 330

Oscillation. Cycle/Min: 55

Oscillation 1″

Traverse (IPM): 15

Overlap: ⅛″

Weld Thickness: 4-5 mm

IP Temperature ° F.: <250

Table 4 shows a comparison between the thermodynamic, microstructural and performance criteria for the disclosed experimental alloys. Table 4 is a demonstration of the inventive process used to generate and evaluate the thermodynamic criteria used to predict the unique microstructural features and performance characteristics disclosed. In Table 4, GB is grain boundary carbides and PC is primary carbides, both values are calculated via modeling (mole) and measured experimentally (volume). Cmin (liquid) is the local carbon minimum in the liquid, GBΔT is the difference in temperature (Kelvin) between the formation of the Fe-rich matrix and the highest grain boundary carbide formation temperature. HRC denotes the Rockwell C hardness measured experimentally. At the time of their creation it was believed by those skilled in the art that each of the alloys disclosed in Table 4 would meet the microstructural and performance criteria. 8 of the 34 alloys evaluated meet the performance and microstructural criteria (23.5%). 16 out of the 34 alloys met all the thermodynamic criteria, and ˜80% of those alloys also met the microstructural and performance criteria. The three alloys which possessed a greater than 25% primary carbide phase fraction developed a high grain boundary carbide fraction. Achieving the microstructural carbide phase fraction may be possible with additional processing such as a heat treatment. 1 out of the 34 alloys (2.9%) did not meet the thermodynamic criteria, but still met the microstructural criteria, representing a false negative.

TABLE 4
Characteristics of Disclosed Alloys

| | Thermodynamic | | | | | | |
|---|---|---|---|---|---|---|---|
| Alloy | | | Cmin | | Microstructural | | Perform |
| # | PC | GB | (liquid) | GBΔT | PC | GB | HRC |
| 7 | 8% | 8% | 0.8% | 615 | 8.8 | 0.2 | 58 |
| 7* | 8% | 8% | 0.8% | 615 | 8.6 | 0.4 | 60 |
| 8 | 9.99% | 5.07% | 0.4% | 195 | NA | NA | 42.1 |
| 9 | 9.80% | 5.73% | 0.5% | 265 | NA | NA | 40.6 |
| 10 | 7.51% | 9.26% | 0.4% | 170 | NA | NA | 40.9 |
| 11 | 7.95% | 9.17% | 0.4% | 205 | NA | NA | 30.5 |
| 12 | 11.43% | 5.54% | 0.5% | 520 | 5.7 | 11.6 | 40.3 |
| 13 | 10.90% | 6.36% | 0.5% | 505 | 6.3 | 12.03 | 46.6 |
| 14 | 10.90% | 6.56% | 0.5% | 450 | 6.5 | 11.26 | 45.8 |
| 15 | 10.40% | 7.61% | 0.5% | 500 | 6.2 | 12.57 | 41 |
| 16 | 6.78% | 12.10% | 0.8% | 345 | NA | NA | 53.6 |
| 17 | 5.21% | 12.93% | 0.8% | 445 | 7.28 | 22.72 | 51.4 |
| 18 | 4.70% | 6.83% | 1.2% | 495 | 7.13 | 0 | 62 |
| 19 | 13.87% | 5.73% | 1.2% | 300 | 4.41 | 0 | 60.3 |
| 20 | 13.97% | 4.90% | 1.0% | 315 | 10.22 | 0 | 58.8 |
| 21 | 14.11% | 3.64% | 0.8% | 335 | 6.88 | 0 | 53.4 |
| 22 | 14.08% | 2.87% | 0.6% | 350 | 14.09 | 0 | 47.1 |
| 23 | 25.87% | 2.93% | 0.6% | 450 | 5.45 | 18.13 | 53.4 |
| 24 | 22.75% | 6.13% | 0.2% | 500 | 28.32 | 22.85 | 13.6 |
| 25 | 17.62% | 8.07% | 0.1% | 350 | 25.14 | 5.62 | 12.9 |
| 26 | 23.85% | 3.32% | 0.9% | 400 | 15.62 | 10.32 | 61.6 |
| 27 | 30.46% | 7.53% | 0.8% | 350 | 29.54 | 13.22 | 52.8 |
| 28 | 36.31% | 9.95% | 1.0% | 350 | 34.21 | 6.55 | 50 |
| 29 | 38.54% | 10.39% | 1.0% | 350 | 40.55 | 10.78 | 51.6 |
| 30 | 22.00% | 9.35% | 0.88% | | 35.66 | 14.63 | 58 |
| 31 | 21.19% | 9.69% | 0.81% | | 23.21 | 15.32 | 26.8 |
| 32 | 22.80% | 9.38% | 0.83% | | 31.8 | 15.1 | 62.4 |
| 33 | 21.47% | 9.34% | 0.86% | | 29.92 | 5.6 | 62.4 |
| 34 | 23.73% | 9.06% | 0.91% | | 23.98 | 7.11 | 61 |
| 35 | 6.93% | 9.33% | 1.50% | | 5.92 | 9 | 42.6 |
| 36 | 9.49% | 9.75% | 1.23% | | 8.6 | 7.5 | 59.4 |
| 37 | 10.45% | 6.92% | 1.16% | | 5.96 | 8 | 41.6 |
| 38 | 11.34% | 7.80% | 1.11% | | 5 | 8 | 58.4 |
| 39 | 13.47% | 6.80% | 0.92% | | 13.5 | 9.4 | 56.6 |

Table 4.1 shows a list of exemplary alloys and the corresponding thermodynamic criteria which meets the requirements of this disclosure.

TABLE 4.1
Thermodynamic Characteristics of Disclosed Alloys

| Alloy # | PC | GB | Cmin (liquid) |
|---|---|---|---|
| 40 | 10.79% | 5.04% | 0.87% |
| 41 | 10.68% | 6.30% | 1.14% |
| 42 | 10.29% | 5.20% | 0.90% |
| 43 | 10.19% | 6.45% | 1.17% |
| 44 | 6.74% | 7.82% | 0.89% |
| 45 | 8.78% | 6.89% | 1.06% |
| 46 | 10.32% | 6.13% | 1.22% |

Table 4.2 shows a list of exemplary alloys produced directly in the form of welding wire, which were designed by making minor alloying adjustments to alloys disclosed in this patent in order to improve general welding characteristics. All of the alloys in Table 4.2 met the thermodynamic, and microstructural characteristics and contained a minimum hardness of about 50 HRC in the welded condition.

TABLE 4.2
Exemplary Alloys Produced in the Form of Experimental Welding Wire

| Alloy | Al | B | C | Cr | Cu | Mn | Mo | Nb | Ni | Si | Ti | V |
|---|---|---|---|---|---|---|---|---|---|---|---|---|
| 47 | 0 | 0.3 | 1.25 | 0.75 | 0 | 1.1 | 1 | 3.8 | 0 | 0.65 | 0.65 | 0.5 |
| 48 | 0 | 0.3 | 1.15 | 0.75 | 0 | 1.1 | 1 | 3.8 | 0 | 0.65 | 0.65 | 0.5 |
| 49 | 0 | 0.3 | 0.95 | 0.75 | 0 | 1.1 | 1 | 3.8 | 0 | 0.65 | 0.65 | 0.5 |
| 50 | 0 | 0.3 | 1.75 | 1.75 | 0 | 1 | 1 | 3 | 0 | 0.65 | 0.65 | 0.5 |
| 51 | 0 | 0.3 | 1.1 | 1.75 | 0 | 1 | 1 | 3 | 0 | 0.6 | 0.6 | 0.5 |
| 52 | 0.26 | 0 | 1.15 | 7.82 | 0.06 | 1.38 | 1.16 | 0 | 0.10 | 1.01 | 3.37 | 0.10 |
| 53 | 0.26 | 0 | 1.00 | 7.82 | 0.06 | 1.38 | 1.16 | 0 | 0.10 | 1.01 | 3.37 | 0.10 |
| 54 | 0.26 | 0 | 0.85 | 7.82 | 0.06 | 1.38 | 1.16 | 0 | 0.10 | 1.01 | 3.37 | 0.10 |
| 55 | 0 | 0.3 | 1.25 | 0.75 | 0 | 1.1 | 1 | 3.8 | 0 | 0.65 | 0.65 | 0.5 |
| 56 | 0 | 0.3 | 1.15 | 0.75 | 0 | 1.1 | 1 | 3.8 | 0 | 0.65 | 0.65 | 0.5 |
| 57 | 0 | 0.3 | 0.95 | 0.75 | 0 | 1.1 | 1 | 3.8 | 0 | 0.65 | 0.65 | 0.5 |
| 58 | 0 | 0.3 | 1.75 | 1.75 | 0 | 1 | 1 | 3 | 0 | 0.65 | 0.65 | 0.5 |
| 59 | 0 | 0.3 | 1.1 | 1.75 | 0 | 1 | 1 | 3 | 0 | 0.6 | 0.6 | 0.5 |
| 60 | 0.26 | 0 | 1.15 | 7.82 | 0.06 | 1.38 | 1.16 | 0 | 0.10 | 1.01 | 3.37 | 0.10 |
| 61 | 0.26 | 0 | 1.00 | 7.82 | 0.06 | 1.38 | 1.16 | 0 | 0.10 | 1.01 | 3.37 | 0.10 |
| 62 | 0.26 | 0 | 0.85 | 7.82 | 0.06 | 1.38 | 1.16 | 0 | 0.10 | 1.01 | 3.37 | 0.10 |

### Non-Cracking Trait 2:

In some embodiments, the mole fraction of all the carbide phases can remain thermodynamically stable within the temperature range defined as the re-heat zone. In some embodiments, stability can be defined as a mole fraction which does not vary by more than 25% (or about 25%). In some embodiments, stability can be defined as a mole fraction which does not vary by more than 10% (or about 10%). In some embodiments, stability can be defines as a mole fraction does not vary be more than 5%.

Carbides which are thermodynamically stable within the re-heat zone can be advantageous for the purposes of creating an alloy which is resistant to re-heat cracking. In the case of a cracking prone alloy, the re-heating of the alloy can cause the precipitation and/or growth of additional carbide or the dissolution and shrinking of existing carbides. Growing or re-precipitation of carbides can cause stresses in the matrix as described previously. The dissolution of carbides can also be detrimental as it increases the carbon and/or boron in the iron-based matrix. This increase in carbon in the matrix can cause other carbides to precipitate or grow causing stresses in different regions of the microstructure, or it can lead to supersaturation of carbon in the matrix which can make the material prone to re-heat cracking.

In some embodiments, all of the secondary carbides can be only thermodynamically stable below the reheat zone.

### Non-Cracking Trait 3:

An alloy which possesses the described thermodynamics can be resistant to cracking in the re-heat zone. The solidification routine of such an alloy when initially deposited can be similar to previously described: the Fe-based matrix and primary carbides solidify to form the microstructure. The secondary carbides can be kinetically unable to form due to the rapid cooling of the process, leaving the Fe-based matrix supersaturated with carbon and/or boron. However, as the temperature of the material is increased into the reheat zone, the secondary carbide phase is not thermodynamically stable so it does not form. The material then cools rapidly down to room temperature, and the secondary carbide phase is once again unable to precipitate due to sluggish kinetics.

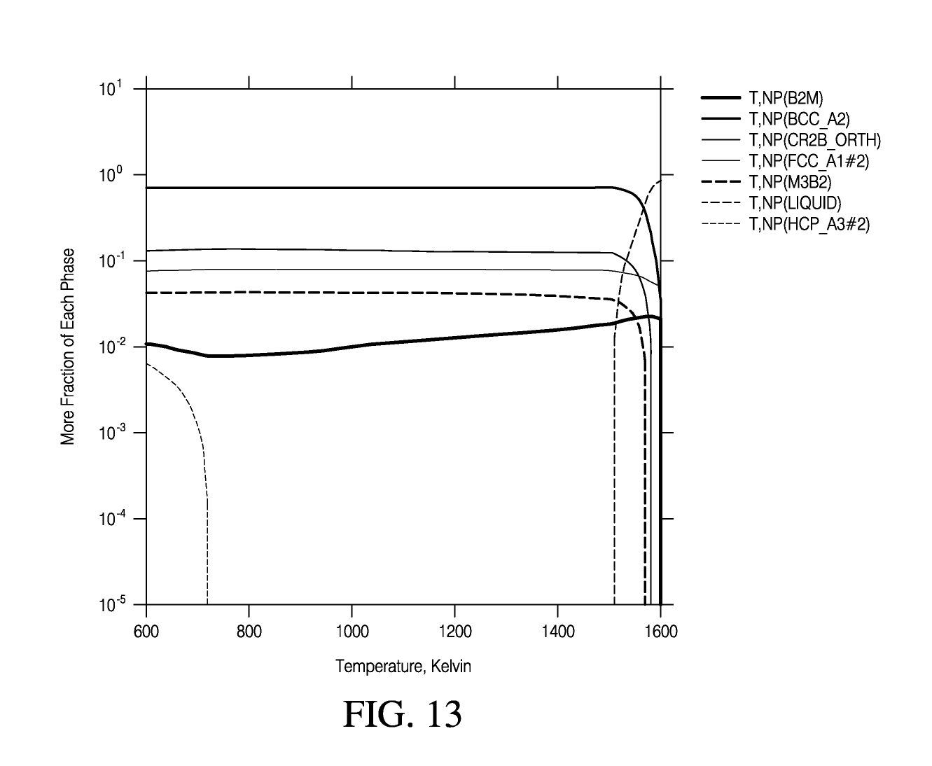

An embodiment of Alloy Fe_{bal}B_{1.45}C_{0.91}Cr_{4.82}Mn_{1.01}Mo_{3.22}Nb₆Si_{0.59}Ti₁V₂ is shown in FIG. 13. As shown, Phase 8, is a secondary carbide phase which is only thermodynamically stable below the reheat zone. Phase 8 is unlikely to form during the original deposition of the weld bead, and unlikely to form as the material is reheated. This embodiment can allow the alloy to be supersaturated with carbon, increasing hardness, but still maintains crack resistance.

### Non-Cracking Trait 4:

In some embodiments, a selection of the carbides may not contain more than 50% Fe (or more than about 50% Fe). During reheating in the weld bead, the Fe-rich carbides can form much easily than other carbide. This phenomenon can occur because the matrix can be Fe-rich and carbon can have a much higher likelihood of diffusing into a region of the microstructure where Fe is free to react and precipitate new carbides. Furthermore, as the newly precipitated carbides or existing carbides are driven to grow in the alloy, the ability to utilize the large availability of Fe as opposed to lower concentration alloying elements can increase the growth rate of such carbides. Carbides which are more likely to precipitate and capable of growing rapidly in the re-heated alloy will make the alloy more susceptible to re-heat cracking.

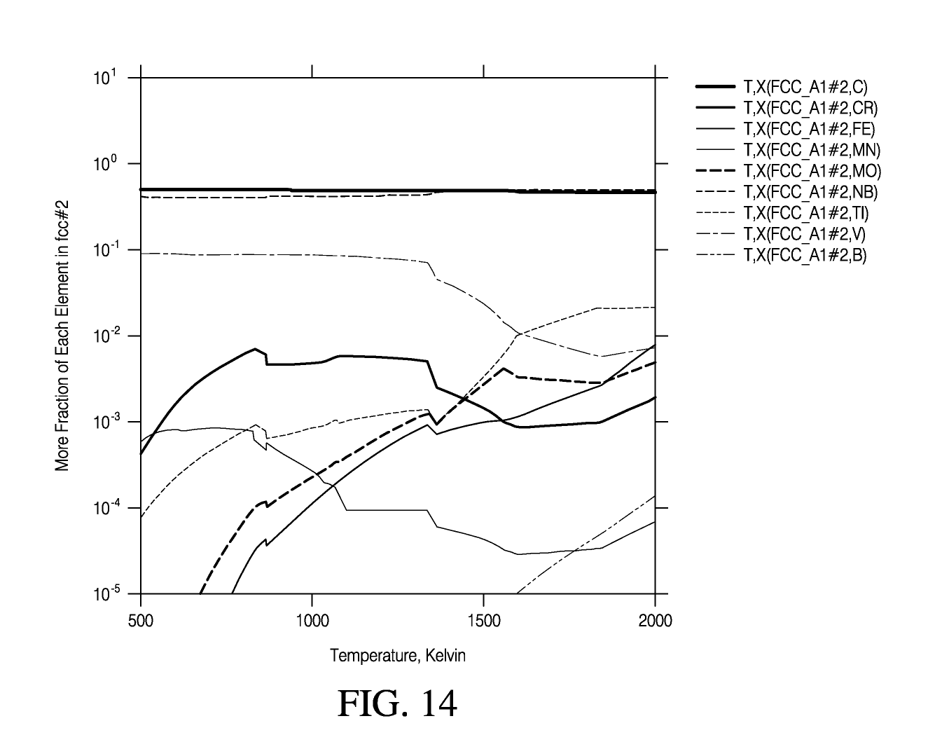

FIG. 14 shows the variation of the mole fraction of each element in NbC, which is a common carbide in the presented hardfacing alloys. The NbC phase can contain primarily Nb and C with a slight amount of V, but trace concentrations of Fe. Such a carbide may be unlikely to grow any larger during the reheating of the weld, because both Nb and V may be relatively scarce around the local region of the carbide.

In some embodiments, all of the secondary carbide phases may not contain more than 50% Fe (or more than about 50% Fe).

In some embodiments, all of the primary carbide phases may not contain more than 50% Fe (or more than about 50% Fe).

In some embodiments, the carbide phases precipitating in the alloy may have of at least one of TiB₂, CrB₂, NbC, WC, MoB₂, and/or VC.

### Non-Cracking Trait 5:

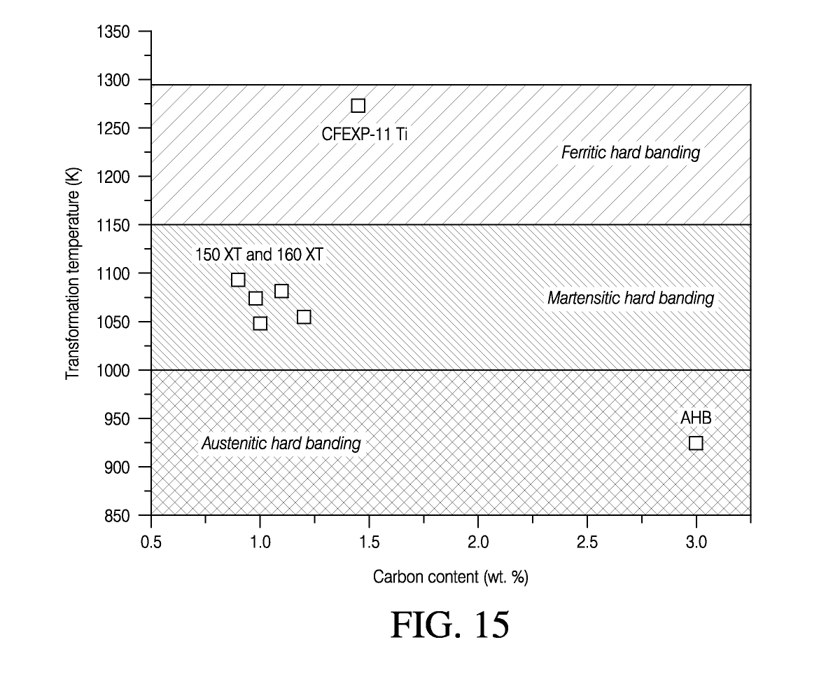

In some embodiments, the alloy can be designed such that the FCC austenite/BCC ferrite transition temperature is not within the RZ. Avoiding this phase transformation at the RZ can minimize the stress in the microstructure and make the alloy less prone to reheat cracking. By avoiding the FCC to BCC transition upon re-heating, the alloy can be more capable of handling the stresses created by newly precipitated carbides or growth of existing carbides. FIG. 15 demonstrates how the transition temperature of the hardfacing alloy can be controlled by compositional variation.

In some embodiments, the RZ can be shifted by adjusting the welding parameters used in the weld process in order to avoid the FCC austenite/BCC ferrite transition temperature in a particular alloy. The FCC austenite/BCC ferrite transition is the biggest phase transformation in the steel and can introduce significant stress causing cracking.

FIG. 15 shows the relationship between the FCC austenite/BCC ferrite transition temperature vs. carbon content. The final microstructure (ferrite, austenite or martensite) after welding may be determined by calculating the FCC austenite/BCC ferrite transition temperature. The FCC austenite/BCC ferrite transition temperature can be adjusted by changing some elements, then obtain the optimum microstructure.

### Non-Cracking Trait 6:

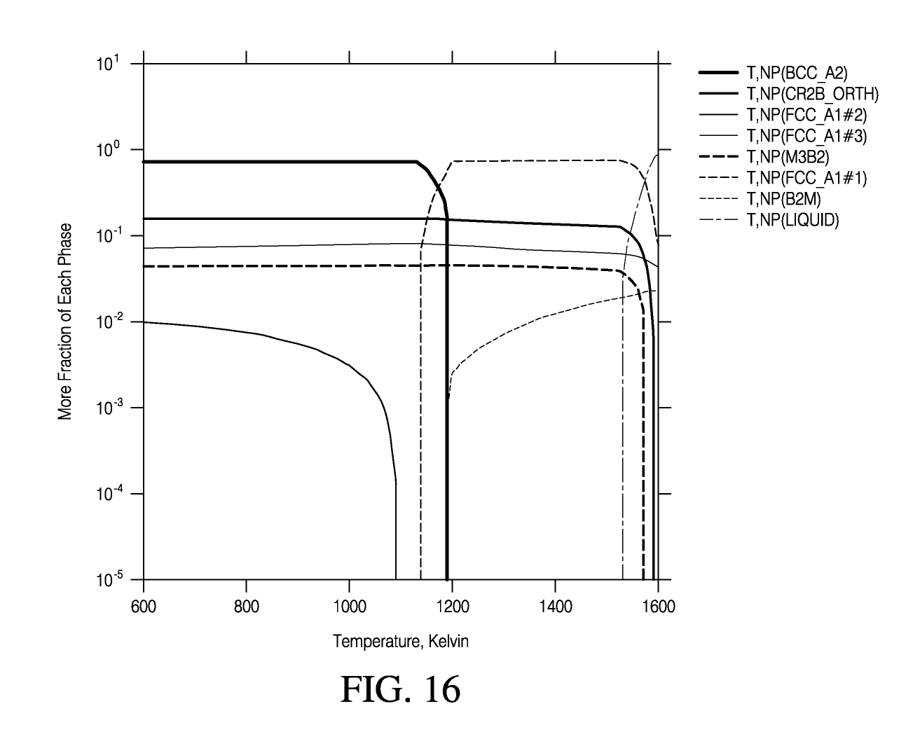

In some embodiments, carbides may not form in the austenitic zone of the alloy during re-heating. Carbides which become stable in the austenitic zone can precipitate and/or grow upon reheating of the alloy when the matrix is austenitic. When the alloy is in the austenite phase, grain growth is typical and carbides typically precipitate along the previous grain boundaries of the initially deposited ferrite matrix. Therefore, the carbides which have precipitated in the austenite are now located in the center regions of the matrix grains. As the alloy cools and transforms back to ferrite, the newly grown carbides in the center of the grains can cause stress on the microstructure and create cracks. An alloy which avoids the precipitation of carbides in the austenite zone is shown in FIG. 16. The VC, phase 3, is not thermodynamically stable in the austenite region (phase 6). Thus, any precipitation of VC due to the re-heating of the weld occurs after the alloy has transitioned from BCC to FCC upon heating and back to BCC upon cooling. Therefore, the newly formed carbide may not be present during the potentially stress-inducing, and thereby crack prone, solid state transition.

In some embodiments, the hardfacing alloy can be Fe-based containing one or more of the following alloying elements B, C, Cr, Mn, Mo, Nb, Si, Ti, W, and V with additional impurities known to be present due to manufacturing procedures and possesses one of the preferred non-cracking traits described in this disclosure.

In some embodiments, a hardfacing alloy can be in the form of a cored welding wire.

In some embodiments, a hardfacing alloy composition, as defined by the composition of the feedstock material or the deposited coating, can comprise, in wt. %: Fe_{bal}C_{0.5-4}B₀₋₃Mn₀₋₁₀Al₀₋₅Si₀₋₅Ni₀₋₅Cr₀₋₃₀Mo₀₋₁₀V₀₋₁₀W₀₋₁₅Ti₀₋₁₀Nb₀₋₁₀

In some embodiments, a hardfacing alloy composition, as defined by the composition of the feedstock material or the deposited coating, can comprise, in wt. %: Fe_{bal}C₁₋₂B_{1-2.5}Mn₁₋₂Al₀₋₅Si_{0-1.5}Ni_{0-0.2}Cr₀₋₁₀Mo_{0-3.5}V_{0-2.5}W_{0-0.15}Ti₀₋₂Nb₂₋₆ or Fe: bal, C: about 1-2, B: about 1-2.5, Mn: about 1-2, Al: about 0-0.5, Si: about 0-1.5, Ni: about 0-0.2, Cr: about 0-10, Mo: about 0-3.5, V: about 0-2.5, W: about 0-0.15, Ti: about 0-2, Nb: 2-6.

In some embodiments, a hardfacing alloy composition can comprise of the following compositions, in wt. %:
Fe_{bal}B_{1.45}C_{0.91}Cr_{4.82}Mn_{1.01}Mo_{3.22}Nb_{4.54}Si_{0.59}Ti_{0.39}V_{0.54}; or Fe: bal, B: about 1.45, C: about 0.91, Cr: about 4.82, Mn: about 1.01, Mo: about 3.22, Nb: about 4.54, Si: about 0.59, Ti: about 0.39, V: about 0.54 [alloy 1]
Fe_{bal}B_{1.45}C_{0.91}Cr_{4.82}Mn_{1.01}Mo_{3.22}Nb₆Si_{0.59}Ti₁V_{0.54}; or Fe: bal, B: about 1.45, C: about 0.91, Cr: about 4.82, Mn: about 1.01, Mo: about 3.22, Nb: about 6, Si: about 0.59, Ti: about 1, V: about 0.54 [alloy 2]
Fe_{bal}B_{1.45}C_{0.91}Cr_{4.82}Mn_{1.01}Mo_{3.22}Nb₆Si_{0.59}Ti₁V₂; or Fe: bal, B: about 1.45, C: about 0.91, Cr: about 4.82, Mn: about 1.01, Mo: about 3.22, Nb: about 6, Si: about 0.59, Ti: about 1, V: about 2 [alloy 3]
Fe_{bal}B_{1.45}C_{0.91}Cr_{4.82}Mn_{1.01}Mo_{3.22}Nb_{4.5}Si_{0.59}Ti₁V_{0.54}; or Fe: bal, B: about 1.45, C: about 0.91, Cr: about 4.82, Mn: about 1.01, Mo: about 3.22, Nb: about 4.5, Si: about 0.59, Ti: about 1, V: about 0.54 [alloy 4]
Fe_{bal}C_{1.2}B₂Mn₁Si_{1.1}Ni_{0.07}Cr_{8.33}Mo_{3.33}V_{0.5}W_{0.07}Ti_{1.83}Nb₄; or Fe: bal C: about 1.2; B: about 2; Mn: about 1; Si: about 1.1; about Ni: about 0.07; about Cr: about 8.33; Mo: about 3.33; V: about 0.5 W: about 0.07; Ti: about 1.83; Nb: about 4 [alloy 5]
Fe_{bal}C₁B_{2.5}Mn₂Si_{1.1}Ni_{0.1}Cr_{8.73}Mo₁V_{0.03}W_{0.03}Ti_{1.91}Nb_{4.47}; or Fe: bal, C: about 1, B: about 2.5, Mn: about 2, Si: about 1.1, Ni: about 0.1, Cr: about 8.73, Mo: about 1, V: about 0.03, W: 0.03, Ti: about 1.91, Nb: 4.47 [alloy 6]

### Examples, Alloys 5 and 6

One of the purposes of designing alloys which possess the non-cracking traits described within this disclosure can be to create a hardfacing material which exhibits very high hardness and wear resistance but is not prone to re-heat cracking. Two alloys which exhibit both high hardness and resistance to re-heat cracking are alloys 5 and 6. Alloys 5 and 6 were produced in the form of welding wires and welded onto a standard 6⅝″ O.D. tool joint in a manner customary to the hardband process used in the oil and gas industry. The feedstock wires were also melted into small ingots in an arc-melter, for the purposes of measuring un-diluted hardness and examining microstructure. The results of the hardness measurements for both ingot form and weld bead form are shown in Table 5. Both alloys exhibit high hardness of 60 HRC or above (or about 60 HRC or above), a region which is not typical for crack resistant hardfacing alloys.

TABLE 5
Hardness values of selected disclosed alloys

| Alloy | Form | Hardness |
|---|---|---|
| 5 | Ingot | 63-67 |
| 5 | Weld Bead | 61-63 |
| 6 | Ingot | 59-60 |

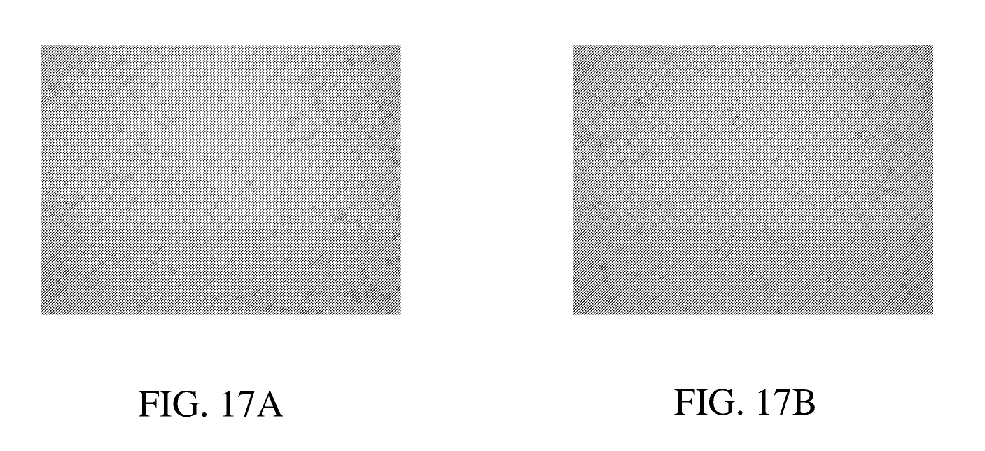

The microstructures of alloy 5 and 6 are shown in FIG. 17A-B. Both alloys show a high frequency of carbides within the microstructure which provides good hardness and wear resistance, but is typically an indicator for the alloy being prone to cracking. However, both alloys were deposited via a process typically used in hardbanding as three consecutive bands and were free of any cracks. The hardbanding process used reheats existing bead deposits, and is known to generate both dip cracks and circumferential cracks in crack prone alloys of lesser hardness.

Features, materials, characteristics, or groups described in conjunction with a particular aspect, embodiment, or example are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

While certain embodiments have been described, these embodiments have been presented by way of example only, and are not intended to limit the scope of protection. Indeed, the novel methods and systems described herein may be embodied in a variety of other forms. Furthermore, various omissions, substitutions and changes in the form of the methods and systems described herein may be made. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure.

Although the present disclosure includes certain embodiments, examples and applications, it will be understood by those skilled in the art that the present disclosure extends beyond the specifically disclosed embodiments to other alternative embodiments and/or uses and obvious modifications and equivalents thereof, including embodiments which do not provide all of the features and advantages set forth herein. Accordingly, the scope of the present disclosure is not intended to be limited by the specific disclosures of preferred embodiments herein, and may be defined by claims as presented herein or as presented in the future.

What is claimed is:

1. A work piece having at least a portion of its surface covered by a layer comprising a microstructure containing primary hard particles comprising one or more of boride, carbide, borocarbide, nitride, carbonitride, aluminide, silicide, oxide, intermetallic, and laves phase, wherein the layer comprises a macro-hardness of 50 HRC or greater and a high resistance to cracking, wherein:
primary hard particles are defined as forming at least 10K above the solidification temperature of Fe-rich matrix in the alloy; and
high resistance to cracking is defined as exhibiting no cracks when hardbanding on a steel pipe which is pre-heated to 300° F. and contains an internal reservoir of cooling water.

2. The work piece of claim 1, wherein the primary hard particle fraction is a minimum of 2 volume percent.

3. The work piece of any one of claims 1-2, wherein the secondary hard particle fraction is a maximum of 10 volume percent.

4. The work piece of any one of claims 1-3, wherein the surface exhibits a mass loss of less than 0.1 grams when subject to 500 carbide hammer impacts possessing 8J of impact energy.

5. The work piece of any one of claims 1-4, wherein a surface of the layer exhibits high wear resistance as characterized by an ASTM G65 dry sand wear test mass loss of 0.6 grams or less.

6. The work piece of any one of claims 1-5, wherein the layer comprises in wt. % of Fe: bal, B: 0-1, C: 0-2, Co: 0-2, Cr, 0-20, Mn, 0-3, Mo: 0-15, Nb: 0-6, Ni: 0-2, Si: 0-3, Ti: 0-10, V: 0-2, W: 0-10.

7. The work piece of any one of claims 1-5, wherein the layer comprises in wt. % of Fe: bal, B: 0-2.5, C: 0.7-8.5, Mo: 0-30, Nb: 0-20, Ti: 0-12, V: 0-10, W: 0-30.

8. The work piece of any one of claims 1-5 and 7, wherein the layer comprises in wt. % of Cr: 0-18, Cu: 0-2, Mn: 0-10, and Si: 0-3.

9. The work piece of any one of claims 1-5, wherein the alloy composition is selected from the group consisting of alloys comprising in wt. %:
Fe: bal, C: 1, Cr, 5, Mn, 1.1, Mo: 0.75, Ni: 0.1, Si: 0.77, Ti: 3;
Fe: bal, C: 1.2, Cr, 6, Mn, 1, Mo: 0.85, Ni: 0.25, Si: 0.9, Ti: 3, W: 0.85;
Fe: bal, B: 0.2, C: 1.5, Cr: 0.5, Mn: 0.78, Mo: 0.68, Nb: 2.67, Si: 0.44, Ti: 0.45, V: 0.36;
Fe: bal, B: 0.2, C: 2.3, Cr: 0.5, Mn: 0.75, Mo: 0.7, Nb: 5, Si: 0.44, Ti: 3, V: 0.36;
Fe: bal, B: 0.2, C: 2.1, Cr: 0.5, Mn: 0.75, Mo: 0.7, Nb: 5, Si: 0.44, Ti: 3, V: 0.36;
Fe: bal, B: 0.2, C: 1.8, Cr: 0.5, Mn: 0.75, Mo: 0.7, Nb: 5, Si: 0.44, Ti: 3, V: 0.36;
Fe: bal, B: 0.2, C: 1.6, Cr: 0.5, Mn: 0.75, Mo: 0.7, Nb: 5, Si: 0.44, Ti: 3, V: 0.36;
Fe: bal, B: 0.2, C: 3, Cr: 0.5, Mn: 0.75, Mo: 0.7, Nb: 5, Si: 0.44, Ti: 8, V: 0.36;
Fe: bal, B: 0-0.2, C: 1.1-2, Cr: 0.5-5.04, Mn: 0.75-1.16, Mo: 0-0.74, Nb: 3-5, Si: 0-0.76, Ti: 0-3;
Fe: bal, C: 0.95-1.25, Cr: 0.75-1.75, Mn: 1-1.1, Mo: 1, Nb: 3-3.8, Si: 0.6-0.65, Ti: 0.6-0.65, V: 0.5; and
Fe: bal, A1:0.26, C: 1, Cr: 7.82, Mn: 1.38, Mo: 1.16, Ni: 0.1, Si: 1.01, Ti: 3.37, V: 0.1.

10. The work piece of any one of claims 1-9, where the layer is used as a hardfacing layer configured to protect oilfield components used in drilling applications against abrasive wear.

11. The work piece of any one of claims 1-9, where the layer is used as a hardfacing layer configured to protect mining or oil sands applications against abrasive wear and impact.

12. A method of forming a coated work piece comprising:
depositing a layer on at least a portion of a surface of a work piece;
wherein the layer comprises a microstructure containing primary hard particles comprising one or more of boride, carbide, borocarbide, nitride, carbonitride, aluminide, silicide, oxide, intermetallic, and laves phase, wherein the layer comprises a macro-hardness of 50 HRC or greater and a high resistance to cracking, wherein:
primary hard particles are defined as forming at least 10K above the solidification temperature of a Fe-based matrix in the alloy; and
high resistance to cracking is defined as exhibiting no cracks when hardbanding on a steel pipe which is pre-heated to 300° F. and contains an internal reservoir of cooling water.

13. The method of claim 12, wherein the primary hard particle fraction is a minimum of 2 volume percent.

14. The method of any one of claims 12-13, wherein the secondary hard particle fraction is a maximum of 10 volume percent.

15. The method of any one of claims 12-14, wherein the surface exhibits a mass loss of less than 0.1 grams when subject to 500 carbide hammer impacts possessing 8J of impact energy.

16. The method of any one of claims 12-15, wherein a surface of the of the layer exhibits high wear resistance as characterized by an ASTM G65 dry sand wear test mass loss of 0.6 grams or less.

17. The method of any one of claims 12-16, wherein the layer comprises in wt. % of Fe: bal, B: 0-1, C: 0-2, Co: 0-2, Cr, 0-20, Mn, 0-3, Mo: 0-15, Nb: 0-6, Ni: 0-2, Si: 0-3, Ti: 0-10, V: 0-2, W: 0-10.

18. The method of any one of claims 12-16, wherein the layer comprises in wt. % of Fe: bal, B: 0-2.5, C: 0.7-8.5, Mo: 0-30, Nb: 0-20, Ti: 0-12, V: 0-10, W: 0-30.

19. The method of any one of claims 12-16 and 18, wherein the layer comprises in wt. % of Cr: 0-18, Cu: 0-2, Mn: 0-10, and Si: 0-3.

20. The method of any one of claims 12-16, wherein the alloy composition is selected from the group consisting of alloys comprising in wt. %:
Fe: bal, C: 1, Cr, 5, Mn, 1.1, Mo: 0.75, Ni: 0.1, Si: 0.77, Ti: 3;
Fe: bal, C: 1.2, Cr, 6, Mn, 1, Mo: 0.85, Ni: 0.25, Si: 0.9, Ti: 3, W: 0.85;
Fe: bal, B: 0.2, C: 1.5, Cr: 0.5, Mn: 0.78, Mo: 0.68, Nb: 2.67, Si: 0.44, Ti: 0.45, V: 0.36;
Fe: bal, B: 0.2, C: 2.3, Cr: 0.5, Mn: 0.75, Mo: 0.7, Nb: 5, Si: 0.44, Ti: 3, V: 0.36;
Fe: bal, B: 0.2, C: 2.1, Cr: 0.5, Mn: 0.75, Mo: 0.7, Nb: 5, Si: 0.44, Ti: 3, V: 0.36;
Fe: bal, B: 0.2, C: 1.8, Cr: 0.5, Mn: 0.75, Mo: 0.7, Nb: 5, Si: 0.44, Ti: 3, V: 0.36;
Fe: bal, B: 0.2, C: 1.6, Cr: 0.5, Mn: 0.75, Mo: 0.7, Nb: 5, Si: 0.44, Ti: 3, V: 0.36;
Fe: bal, B: 0.2, C: 3, Cr: 0.5, Mn: 0.75, Mo: 0.7, Nb: 5, Si: 0.44, Ti: 8, V: 0.36;
Fe: bal, B: 0-0.2, C: 1.1-2, Cr: 0.5-5.04, Mn: 0.75-1.16, Mo: 0-0.74, Nb: 3-5, Si: 0-0.76, Ti: 0-3;
Fe: bal, C: 0.95-1.25, Cr: 0.75-1.75, Mn: 1-1.1, Mo: 1, Nb: 3-3.8, Si: 0.6-0.65, Ti: 0.6-0.65, V: 0.5; and
Fe: bal, A1:0.26, C: 1, Cr: 7.82, Mn: 1.38, Mo: 1.16, Ni: 0.1, Si: 1.01, Ti: 3.37, V: 0.1.

21. The method of any one of claims 12-20, where the layer is used as a hardfacing layer configured to protect oilfield components used in directional drilling applications against abrasive wear.

22. The method of any one of claims 12-20, where the layer is used as a hardfacing layer configured to protect mining or oil sands applications against abrasive wear and impact.

23. A work piece having at least a portion of its surface covered by a layer comprising an alloy having an primary hard particle mole fraction equal to or above 2% and an secondary hard particle mole fraction equal to or less than 10%, wherein:
primary hard particles are defined as forming at least 10K above the solidification temperature of an Fe-based matrix in the alloy; and
secondary hard particles are defined as forming at least 50K below the solidification temperature of the Fe-based matrix.

24. The work piece of claim 23, wherein the minimum carbon content in a liquid phase prior to the formation of austenite or ferrite is between 0.7 and 1.5 weight percent.

25. The work piece of any one of claims 23-24, wherein the surface exhibits a mass loss of less than 0.1 grams when subject to 500 carbide hammer impacts possessing 8J of impact energy.

26. The work piece of any one of claims 23-25, wherein a surface of the of the layer exhibits high wear resistance as characterized by an ASTM G65 dry sand wear test mass loss of 0.6 grams or less.

27. The work piece of any one of claims 23-26, wherein a surface of the of the layer exhibits high hardness as characterized by a Rockwell C hardness of 50 HRC or greater.

28. The work piece of any one of claims 23-27, wherein a surface of the of the layer exhibits high crack resistance as characterized by a crack free surface when welded on a steel pipe which is pre-heated to 300° F. and contains an internal reservoir of cooling water.

29. The work piece of any one of claims 23-28, wherein the layer comprises in wt. % of Fe: bal, B: 0-1, C: 0-2, Co: 0-2, Cr, 0-20, Mn, 0-3, Mo: 0-15, Nb: 0-6, Ni: 0-2, Si: 0-3, Ti: 0-10, V: 0-2, W: 0-10.

30. The work piece of any one of claims 23-28, wherein the layer comprises in wt. % of Fe: bal, B: 0-2.5, C: 0.7-8.5, Mo: 0-30, Nb: 0-20, Ti: 0-12, V: 0-10, W: 0-30.

31. The work piece of any one of claims 23-28, wherein the layer comprises in wt. % of Cr: 0-18, Cu: 0-2, Mn: 0-10, and Si: 0-3.

32. The work piece of any one of claims 23-28, wherein the alloy composition is selected from the group consisting of alloys comprising in wt. %:
Fe: bal, C: 1, Cr, 5, Mn, 1.1, Mo: 0.75, Ni: 0.1, Si: 0.77, Ti: 3;
Fe: bal, C: 1.2, Cr, 6, Mn, 1, Mo: 0.85, Ni: 0.25, Si: 0.9, Ti: 3, W: 0.85;
Fe: bal, B: 0.2, C: 1.5, Cr: 0.5, Mn: 0.78, Mo: 0.68, Nb: 2.67, Si: 0.44, Ti: 0.45, V: 0.36;
Fe: bal, B: 0.2, C: 2.3, Cr: 0.5, Mn: 0.75, Mo: 0.7, Nb: 5, Si: 0.44, Ti: 3, V: 0.36;
Fe: bal, B: 0.2, C: 2.1, Cr: 0.5, Mn: 0.75, Mo: 0.7, Nb: 5, Si: 0.44, Ti: 3, V: 0.36;
Fe: bal, B: 0.2, C: 1.8, Cr: 0.5, Mn: 0.75, Mo: 0.7, Nb: 5, Si: 0.44, Ti: 3, V: 0.36;
Fe: bal, B: 0.2, C: 1.6, Cr: 0.5, Mn: 0.75, Mo: 0.7, Nb: 5, Si: 0.44, Ti: 3, V: 0.36;
Fe: bal, B: 0.2, C: 3, Cr: 0.5, Mn: 0.75, Mo: 0.7, Nb: 5, Si: 0.44, Ti: 8, V: 0.36;
Fe: bal, B: 0-0.2, C: 1.1-2, Cr: 0.5-5.04, Mn: 0.75-1.16, Mo: 0-0.74, Nb: 3-5, Si: 0-0.76, Ti: 0-3;
Fe: bal, C: 0.95-1.25, Cr: 0.75-1.75, Mn: 1-1.1, Mo: 1, Nb: 3-3.8, Si: 0.6-0.65, Ti: 0.6-0.65, V: 0.5;
Fe: bal, A1:0.26, C: 1, Cr: 7.82, Mn: 1.38, Mo: 1.16, Ni: 0.1, Si: 1.01, Ti: 3.37, V: 0.1.
